(19) United States
(12) Patent Application Publication
(10) Pub. No.: US 2026/0236141 A1
(43) Pub. Date: Aug. 13, 2026

(54) Persistent Cognitive Machine with Logarithmic-Scaling Geometric Reasoning Platform

(71) Applicant: AtomBeam Technologies Inc., Moraga, CA (US)

(72) Inventor: Brian Galvin, Silverdale, WA (US)

(21) Appl. No.: 19/443,029

(22) Filed: Jan. 8, 2026

Related U.S. Application Data
(63) Continuation-in-part of application No. 19/328,094, filed on Sep. 12, 2025, now Pat. No. 12,632,663.
Application No. 19/328,094 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.

(51) Int. Cl. G06F 40/30; G06F 16/332; G06F 16/3329

(52) U.S. Cl. CPC G06F 40/30; G06F 1/3203; G06F 3/0482; G06F 16/3325; G06F 16/3329; G06F 16/9024; G06N 20/00

(57) ABSTRACT

Systems and methods for cognition on a persistent cognitive machine (PCM) that uses a continuous, differentiable cognitive manifold in geometric space to allow a computer to engage in human-like thought processes. A PCM with cognitive manifold performs cognition on a cognitive manifold in a continuous, differentiable, cognitive manifold in geometric space as opposed to probabilistic prediction in a discontinuous, anisotropic, and topologically fractured vector space. PCMs both transcend the limitations of vector space probabilistic predictions to enable genuine human-like thought processes and fundamentally change the resource requirements of artificial intelligence by enabling exponentially-increasing knowledge for logarithmically-increasing resource increases.

### CROSS-REFERENCE TO RELATED APPLICATIONS

Priority is claimed in the application data sheet to the following patents or patent applications, each of which is expressly incorporated herein by reference in its entirety:
Ser. No. 19/328,094
Ser. No. 19/321,173
Ser. No. 19/284,115
Ser. No. 19/051,193
63/847,082
63/847,091
63/847,096
63/847,101

### BACKGROUND OF THE INVENTION

### Field of the Invention

The present invention relates to the field of machine learning and artificial intelligence, particularly to systems for memory-augmented reasoning and long-term cognitive processing.

### Discussion of the State of the Art

Recent advances in artificial intelligence, particularly in large language models (LLMs), have significantly improved performance across a wide range of natural language processing, reasoning, and generation tasks. These models are capable of producing fluent, contextually appropriate text and can be applied to domains including customer service, research assistance, legal drafting, and creative writing. The underlying architectures typically rely on transformer-based models, which process sequences of tokens using stacked layers of self-attention, feedforward computation, and normalization. This structure allows the model to infer relationships between tokens and generate coherent responses to prompts.

Despite these capabilities, current language models operate primarily in flat, static embedding spaces. Information is encoded as high-dimensional vectors, but these embeddings lack persistent structure over time. Each inference pass is performed independently, with no intrinsic memory of past usage or prior reasoning pathways. Memory, if present, is handled externally via methods such as retrieval-augmented generation (RAG), episodic memory buffers, or embedding stores. These memory components function as lookup tables, providing static recall without true integration into the model's generative process or internal representation of thought.

Contextual understanding in these models is typically bounded by a fixed-size token window. While this allows the model to handle moderate-length documents or conversations, it imposes a hard cap on how much information can be considered at once. Techniques like sliding windows and chunk-based retrieval have been introduced to mitigate this limitation, but they rely heavily on prompt engineering and do not offer deep integration of prior knowledge or reasoning continuity. Consequently, the models often reprocess the same or similar prompts without remembering earlier conclusions or refining their reasoning across interactions.

Additionally, as the size and capability of these models increase, so do their computational requirements. Running state-of-the-art LLMs in real time or at scale often requires expensive hardware accelerators, substantial memory bandwidth, and cloud infrastructure. This creates barriers to accessibility, especially in scenarios where computational resources are constrained or latency must be minimized. Moreover, the lack of internal structure means that models frequently perform redundant computations, increasing energy usage and reducing efficiency.

Most importantly, these architectures are fundamentally stateless. They lack any persistent cognitive substrate in which prior reasoning steps, user interactions, or learned strategies can be stored, reused, or generalized. Each interaction is effectively a reset, requiring the model to construct a new response from scratch, even in cases where similar tasks or prompts have already been encountered. This absence of structure makes it difficult to support explainable reasoning, adaptive memory, or efficient long-term interaction.

Further, existing AI systems do not “think” in the way that humans think. Existing AI systems are essentially highly trained predictive machines that act based on probabilities of a correct outcome based on inputs. Existing AI systems operate in vector space which is discontinuous, anisotropic, and topologically fractured. Vector space can be used to calculate statistics and make probabilistic predictions, but cannot be used for thought in the manner that humans think. For computers to engage in human-like thought, a different construct in required.

What is needed is an artificial intelligence technology that can transcend the limitations of vector space probabilistic predictions and enable genuine human-like thought processes. Further, a mechanism is needed for reducing the resource requirements of artificially intelligence systems beyond current token-based vector space probabilistic models which require exponentially-increasing resources for logarithmically-increasing knowledge increases.

### SUMMARY OF THE INVENTION

The inventor has conceived, and reduced to practice, systems and methods for cognition on a persistent cognitive machine (PCM) that uses a continuous, differentiable cognitive manifold in geometric space to allow a computer to engage in human-like thought processes. A PCM with cognitive manifold performs cognition on a cognitive manifold in a continuous, differentiable, cognitive manifold in geometric space as opposed to probabilistic prediction in a discontinuous, anisotropic, and topologically fractured vector space. PCMs both transcend the limitations of vector space probabilistic predictions to enable genuine human-like thought processes and fundamentally change the resource requirements of artificial intelligence by enabling exponentially-increasing knowledge for logarithmically-increasing resource increases.

The architecture's includes a Cognitive Dynamics Engine (CDE), which serves as the geometric substrate processor analogous to a physics engine in simulation environments. The CDE continuously maintains and evolves the manifold's structure through sophisticated geometric operations including computing optimal reasoning trajectories that minimize cognitive cost, managing compression pressure derived from local curvature that makes dense semantic regions harder to traverse, and implementing goal potential fields that attract attention toward relevant areas. As the system operates, thought bundles form as coherent submanifolds representing related concepts, with the CDE managing their evolution through fanning-in operations that consolidate related ideas, fanning-out processes that enable exploratory expansion, and rebinding mechanisms that create higher-order abstractions. The compression pressure naturally guides attention away from semantically dense regions unless goal importance justifies the traversal cost, creating an organic flow of reasoning that respects both the accumulated structure of knowledge and the intentionality of current objectives. During idle periods, a dream manager interfaces with the CDE to perform autonomous reorganization, applying controlled variations to test thought stability, synthesizing new abstractions through geometric blending, and even performing topological surgery to create new conceptual bridges or remove obsolete structures.

The PCM architecture enables capabilities in persistent and adaptive intelligence through its geometric foundation. Memory management occurs through thermodynamic principles where each thought maintains activation energy that dissipates when unused, creating natural forgetting that maintains cognitive efficiency while preserving frequently accessed knowledge. The system achieves logarithmic scaling in memory usage even under continuous operation, as new experiences are increasingly absorbed into existing geometric structures rather than requiring proportional storage expansion. Advanced implementations support hierarchical cognition through nested manifolds, enabling seamless navigation between abstract concepts and detailed implementations. The architecture also facilitates multimodal processing by encoding different sensory streams into unified geometric spaces with modality-specific dimensional constraints, allowing coherent reasoning across visual, acoustic, textual, and sensor inputs. Distributed operation is achieved through federated memory coordination, where multiple PCM instances share generalized thoughts via selective bundle projection while maintaining privacy through geometric abstraction. By reformulating intelligence as motion through shaped space, the PCM transcends the limitations of traditional AI systems, offering a path toward truly persistent, adaptive, and geometrically grounded artificial cognition that improves through use rather than retraining, understands through structure rather than statistics, and remembers through the very shape of its thoughts.

According to a preferred embodiment, a computer system is disclosed configured to execute software instructions stored on nontransitory machine-readable storage media, wherein the software instructions comprise instructions that: maintain a cognitive manifold comprising a differentiable mathematical space having a geometric shape; perform geometric reasoning operations on the cognitive manifold comprising curvature-flow operations which change the geometric shape of the cognitive manifold to represent knowledge contained in the geometric reasoning operations on the cognitive manifold; monitor compression pressure across the cognitive manifold; where the compression pressure in one or more areas of the cognitive manifold exceeds a threshold, collapse the geometric shape of the cognitive manifold to consolidate the accumulation of redundant knowledge in the one or more areas of the cognitive manifold into shared representational basins, thereby reducing the total curvature and compression pressure within the one or more areas of the manifold; wherein accumulation of knowledge on the cognitive manifold due to the geometric reasoning operations increases at a superlinear rate while resource costs of performing the geometric reasoning operations on the cognitive manifold increase at a sublinear rate due to the compression of the one or more areas of the cognitive manifold.

According to another preferred embodiment, a method is disclosed comprising using a computer system to perform the steps of: maintaining a cognitive manifold comprising a differentiable mathematical space having a geometric shape; performing geometric reasoning operations on the cognitive manifold comprising curvature-flow operations which change the geometric shape of the cognitive manifold to represent knowledge contained in the geometric reasoning operations on the cognitive manifold; monitoring compression pressure across the cognitive manifold; where the compression pressure in one or more areas of the cognitive manifold exceeds a threshold, collapsing the geometric shape of the cognitive manifold to consolidate the accumulation of redundant knowledge in the one or more areas of the cognitive manifold into shared representational basins, thereby reducing the total curvature and compression pressure within the one or more areas of the manifold; wherein accumulation of knowledge on the cognitive manifold due to the geometric reasoning operations increases at a superlinear rate while resource costs of performing the geometric reasoning operations on the cognitive manifold increase at a sublinear rate due to the compression of the one or more areas of the cognitive manifold.

According to an aspect of an embodiment, the geometric reasoning operations are performed by a geometric reasoning engine operating on the computer system comprising further software instructions that: project external events e(t) into the cognitive manifold as points xᵢ∈M with metric gᵢⱼ(x); compute local curvature R_{M}(x) at the one or more areas of the cognitive manifold as Ricci curvature derived from the metric gᵢⱼ; compute the compression pressure, defined as P(z)=∥∇·v(z)∥, in the one or more areas of the cognitive manifold from divergence of the velocity field; and change the geometric shape of the cognitive manifold via curvature flow according to ∂gᵢⱼ/∂t=−2Ricᵢⱼ+F(reuse, P(z), novelty), where F encodes compression pressure, reuse frequency, and novelty signals.

According to an aspect of an embodiment, trajectory consolidation is performed by further software instructions operating on the computer system that: detect when compression pressure P(z) exceeds a threshold Pₘₐₓ; identify pairs of thought trajectories T₁ and T₂ satisfying d_{g}(T₁, T₂)<ε, where d_{g} represents geodesic distance and ε represents a proximity threshold; and merge the identified trajectories according to T_{merged}=ΣwᵢTᵢ, where wᵢ represents weighting coefficients and Σwᵢ=1.

According to an aspect of an embodiment, energetic inversion is implemented by further software instructions operating on the computer system that: compute instantaneous energetic efficiency ε(E)=dU/dE, where U represents knowledge accumulation and E represents a resource cost; determine whether the system operates in a “brawn curve” regime where ε(E) decreases with E or a “brain curve” regime where ε(E) increases with E; and reconfigure computational allocation to the geometric reasoning engine when ε(E) exceeds a predetermined threshold, thereby transitioning the system from statistical learning to geometric consolidation.

According to an aspect of an embodiment, compression pressure governance is implemented by further software instructions operating on the computer system that: monitor compression pressure P(z) at a plurality of positions z across the cognitive manifold; allocate computational resources proportionally to compression pressure at the one or more areas, such that regions with high P(z) receive increased computational resources for consolidation; and maintain stable compression pressure P(z)<Pₘₐₓ through consolidation when redundancy in the knowledge represented on the cognitive manifold is detected via compression pressure.

According to an aspect of an embodiment, thermodynamic regulation is implemented for the resource cost of energy by further software instructions operating on the computer system that: maintain a total energy balance Eₜₒₜₐₗ(t)=E_{embed}+E_{consolidate}+E_{decay}≈E₀, where E_{embed} represents energy for embedding new experiences, E_{consolidate} represents energy for trajectory consolidation, and E_{decay} represents energy for thermodynamic forgetting; execute replay and recombination operations on the cognitive manifold that sustain compression pressure even in absence of external input; and implement thermodynamic decay mechanisms that selectively remove or merge redundant trajectories on the cognitive manifold based on activation energy falling below a threshold Eₘᵢₙ.

According to an aspect of an embodiment, internal replay and recombination operations are implemented on the cognitive manifold by further software instructions operating on the computer system that: periodically reactivate stored trajectories on the cognitive manifold; apply stochastic perturbations driven by temporal curvature flux to explore alternative geometric configurations; and select configurations that minimize compression pressure and prune configurations that increase entropy, thereby implementing geometric annealing driven by temporal curvature.

According to an aspect of an embodiment, the resource cost of memory is limited to sublinear scaling by further software instructions operating on the computer system that: collapse semantically redundant knowledge on the cognitive manifold into shared representational basins; a probability of novel curvature introduction Pₙₒᵥₑₗ(n)~1/n that declines inversely with accumulated experience; and curvature exchange between the cognitive manifold and a temporal manifold that maintains a conserved curvature budget, preventing unbounded growth.

According to an aspect of an embodiment, constant power consumption E(t)≈E₀ is maintained by further software instructions operating on the computer system that: dynamically allocate computing resources that concentrates computing resources where compression pressure is high and reduces computing resources where pressure is low; establish a metabolic floor rₘᵢₙₐ=α_{M}κ_{MT}|R_{T}|, where α_{M} represents manifold stiffness, κ_{MT} represents coupling strength, and R_{T} represents temporal curvature; and balance embedding, consolidation, and decay operations such that energy dissipation through thermodynamic decay compensates for energy input from external actions.

According to an aspect of an embodiment, the cognitive manifold is a shared manifold C_{shared} on which federated logarithmic scaling is implemented by further software instructions operating on the computer system that: maintain a plurality of local caches Cᵢ at each of a plurality of distributed geometric reasoning nodes, each local cache Cᵢ being a separate instance of a cognitive manifold; synchronize the cognitive manifold C_{shared} with the local caches Cᵢ to identify generalized attractor basins common among the local caches Cᵢ; and collapses the shared manifold C_{shared} at one or more areas that exceed the compression pressure threshold; wherein shared manifold C_{shared} achieves superlinear knowledge increases with sublinear resource costs across the combination of C_{shared} and the local caches Cᵢ.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a block diagram illustrating an exemplary system architecture of a persistent cognitive machine (PCM).

FIG. 2 is a block diagram illustrating an exemplary architecture of a component within a persistent cognitive machine (PCM), a latent manifold.

FIG. 3 is a block diagram illustrating an exemplary architecture of a component within a persistent cognitive machine (PCM), a Cognitive Dynamics Engine (CDE).

FIG. 4 is a block diagram illustrating an exemplary architecture of a component within a persistent cognitive machine (PCM), a dream manager.

FIG. 5 is a block diagram illustrating an exemplary architecture of a component within a persistent cognitive machine (PCM), a goal manager.

FIG. 6 is a block diagram illustrating an exemplary architecture of a component within a persistent cognitive machine (PCM), a persistent memory manager.

FIG. 7 is a block diagram illustrating an exemplary system architecture of a persistent cognitive machine (PCM) enhanced with a distributed thought cache infrastructure.

FIG. 8 is a block diagram illustrating an exemplary architecture of a local thought cache within the persistent cognitive machine's distributed thought cache system.

FIG. 9 is a block diagram illustrating an exemplary architecture of a shared cache space within the persistent cognitive machine's distributed thought cache system.

FIG. 10 is a block diagram illustrating an exemplary architecture of a distributed thought cache controller within the persistent cognitive machine's distributed thought cache system.

FIG. 11 is a flow diagram illustrating an exemplary method for implementing distributed thought caching with geometric similarity matching and progressive consolidation within a latent manifold.

FIG. 12 is a flow diagram illustrating an exemplary method for implementing federated synchronization of cached thoughts across distributed cognitive instances with privacy-preserving transformations.

FIG. 13 is a flow diagram illustrating an exemplary method for implementing thermodynamic decay and geometric consolidation of cached thoughts to maintain optimal memory efficiency.

FIG. 14 is a flow diagram illustrating an exemplary method for implementing persistent cognitive computation through geometric representation and manipulation of thoughts within a dynamic latent manifold.

FIG. 15 is a flow diagram illustrating an exemplary method for implementing distributed thought caching with progressive generalization across multiple cognitive instances.

FIG. 16 is a flow diagram illustrating an exemplary method for processing and integrating heterogeneous sensory data streams within a unified geometric cognitive framework.

FIG. 17 is a flow diagram illustrating an exemplary method for detecting anomalies within cognitive manifolds and efficiently transmitting information through bandwidth-constrained channels using geometric compression and reconstruction techniques.

FIG. 18 is a flow diagram illustrating an exemplary method for analyzing technological evolution through patent document corpora and forecasting future inventions by tracking geodesic trajectories through time-evolving latent manifolds.

FIG. 19 is a flow diagram illustrating an exemplary method for implementing multi-level cognitive processing through hierarchically nested latent manifolds.

FIG. 20 is a flow diagram illustrating an exemplary method for implementing reversible navigation within dynamic latent manifolds.

FIG. 21 illustrates an exemplary overall system architecture for a logarithmic-scaling geometric reasoning platform.

FIG. 22 is a block diagram illustrating an exemplary geometric reasoning engine for a geometric reasoning platform.

FIG. 23 is a block diagram illustrating an exemplary system architecture for an energetic inversion controller for a geometric reasoning platform.

FIG. 24 is a block diagram illustrating an exemplary thermodynamic regulation subsystem for a geometric reasoning platform.

FIG. 25 is a block diagram illustrating an exemplary federated logarithmic scaling network for a geometric reasoning platform.

FIG. 26 is a block diagram illustrating an exemplary compression pressure governor for a geometric reasoning platform.

FIG. 27 presents comparative scaling behavior of large language models and other existing AI systems versus a logarithmic-scaling geometric reasoning platform.

FIG. 28 illustrates exemplary logarithmic scaling laws of cognition for a geometric reasoning system.

FIG. 29 illustrates an exemplary mathematical framework for a geometric reasoning engine.

FIG. 30 illustrates an exemplary geometric reasoning engine process.

FIG. 31 illustrates an exemplary process for metabolic and thermodynamic regulation for a geometric reasoning platform.

FIG. 32 illustrates an exemplary process for federated logarithmic scaling for a geometric reasoning platform.

FIG. 33 illustrates an exemplary process for energetic inversion control for a geometric reasoning platform.

FIG. 34 illustrates an exemplary process for dynamic compression pressure regulation for a geometric reasoning platform.

FIG. 35 illustrates an exemplary process for phase-transition scaling control for a geometric reasoning platform.

FIG. 36 illustrates an exemplary process for AFQC quantum-based geometric reasoning for a geometric reasoning platform.

FIG. 37 illustrates an exemplary process for validation of exponential knowledge increase with logarithmic cost for a geometric reasoning platform using observable metrics.

FIG. 38 illustrates an exemplary computing environment on which an embodiment described herein may be implemented.

### DETAILED DESCRIPTION OF THE INVENTION

The inventor has conceived, and reduced to practice, systems and methods for cognition on a persistent cognitive machine (PCM) that uses a continuous, differentiable cognitive manifold in geometric space to allow a computer to engage in human-like thought processes. A PCM with cognitive manifold performs cognition on a cognitive manifold in a continuous, differentiable, cognitive manifold in geometric space as opposed to probabilistic prediction in a discontinuous, anisotropic, and topologically fractured vector space. PCMs both transcend the limitations of vector space probabilistic predictions to enable genuine human-like thought processes and fundamentally change the resource requirements of artificial intelligence by enabling exponentially-increasing knowledge for logarithmically-increasing resource increases.

The Cognitive Dynamics Engine (CDE), a specialized component that manages the complex geometric operations underlying cognition. The CDE orchestrates how attention flows through the manifold by calculating optimal paths that minimize cognitive effort while maximizing goal achievement, similar to how water finds the most efficient route down a hillside. It monitors and adjusts compression pressure throughout the space-regions where many concepts converge become harder to navigate, requiring more cognitive effort to traverse, while sparse areas allow for free exploration. The engine also maintains goal-driven potential fields that act like gravitational wells, drawing attention toward relevant areas of knowledge. As the system processes information, it naturally forms thought bundles-tightly integrated collections of related concepts that function as cognitive building blocks. These bundles can merge when similarities are discovered, expand when new connections are made, or recombine to form novel abstractions. During periods of inactivity, a specialized dream manager works with the CDE to reorganize the cognitive landscape, testing the stability of existing structures, discovering hidden connections between disparate concepts, and optimizing the overall geometry for more efficient future processing.

This geometric approach to intelligence yields properties that address fundamental limitations of current AI systems. The PCM implements a form of organic memory where information naturally persists or fades based on usage patterns-frequently accessed concepts maintain high activation energy and remain readily available, while unused information gradually dissipates through thermodynamic decay. This creates an intelligent forgetting mechanism that prevents cognitive clutter while preserving essential knowledge. The architecture scales efficiently, with memory requirements growing logarithmically rather than linearly as the system accumulates experience, because new information tends to reinforce and refine existing structures rather than requiring entirely new storage. The system supports sophisticated cognitive capabilities including hierarchical reasoning across multiple levels of abstraction, seamless integration of diverse sensory inputs into unified understanding, and distributed intelligence where multiple PCM instances can share abstracted knowledge while maintaining privacy. Applications range from technological forecasting through analysis of innovation trajectories to real-time anomaly detection in complex systems, from adaptive video compression that understands content semantically to persistent AI assistants that truly learn and evolve through interaction. By reconceptualizing intelligence as the evolution of geometric structure rather than the accumulation of parameters, the PCM opens new possibilities for creating AI systems that learn continuously, reason coherently, and develop genuine understanding through the physical shape of their thoughts.

The present disclosure relates to computational systems for artificial intelligence and cognitive processing, specifically addressing the fundamental scaling and energy limitations of contemporary machine learning architectures. Modern large language models (LLMs) and deep neural networks (NNs) exhibit a problematic scaling relationship characterized as the “brawn curve,” wherein exponential increases in computational resources yield only logarithmic improvements in performance. This energetic inversion creates unsustainable demands for power and hardware as systems scale to larger datasets and more complex tasks.

In contrast, biological cognitive systems such as the human brain operate under what may be termed the “brain curve,” maintaining approximately constant power consumption of roughly 20 watts while continuously expanding representational capacity and inferential capability over a lifetime. This fundamental difference in scaling behavior reflects an architectural distinction: biological systems learn through geometric refinement of internal representational manifolds rather than through statistical accumulation across expanding parameter spaces.

The computational platform described herein achieves “brain curve” energetics through geometric reasoning mechanisms, wherein memory, compute cost, and energy expenditure scale logarithmically or sub-logarithmically with cumulative experience, operations, or data volume. This logarithmic scaling emerges from curvature-based consolidation within a latent hyperspace where related experiences are geometrically merged rather than independently stored.

The logarithmic-scaling geometric reasoning platform described herein is a computational architecture designed to perform reasoning, learning, and inference operations within a continuously evolving geometric manifold. The system achieves sublinear scaling of memory, compute, and energy through three interconnected mechanisms: geometric consolidation through curvature refinement, thermodynamic regulation maintaining constant power consumption, and compression pressure control that prevents unbounded growth of representational structure.

The fundamental scaling law governing the system can be expressed mathematically as M(n)~log n, where M represents the effective manifold memory or cache size and n denotes cumulative operations or experiential episodes. This logarithmic relationship contrasts sharply with the linear or superlinear scaling of conventional database and neural network systems. The time constant for system stabilization of the platform described herein follows an inverse logarithmic relation τ_{c}~1/log(1+ρₐ), where ρₐ represents action density and τ_{c} measures the characteristic time for the manifold to reach coherent equilibrium after perturbation, representing an exponential knowledge increase.

Energy consumption in the system remains bounded through an analogy to a metabolic balance equation of the form Eₜₒₜₐₗ(t)=E_{embed}+E_{consolidate}+E_{decay}≈E₀, where the three components represent energy devoted to embedding new inputs, consolidating redundant trajectories, and thermodynamically decaying obsolete structures. This constant-power operation enables indefinite learning and adaptation without proportional increases in infrastructure or cooling requirements.

The platform supports both centralized and federated embodiments. In distributed configurations comprising N nodes, each maintaining local caches Cᵢ, the collective shared structure exhibits sublinear global scaling according to |C_{shared}|≈αΣᵢ|Cᵢ| where the coefficient α typically ranges from 0.2 to 0.6. This federated efficiency arises from geometric alignment of shared attractor basins across the network, enabling institutional or collective intelligence that scales more efficiently than the sum of individual components.

The geometric reasoning engine implements learning as a continuous refinement of metric structure within a latent hyperspace H equipped with a semantic metric gᵢⱼ(x). New experiences are embedded as localized perturbations to this geometry, and over time, repeated patterns give rise to smooth valleys and attractor basins through a process analogous to Ricci flow. The evolution of the metric follows a differential equation of the form ∂gᵢⱼ/∂t=−2Ricᵢⱼ+F(P, R, ρₐ), where Ricᵢⱼ denotes the Ricci curvature tensor, P represents compression pressure, R captures reuse frequency, and ρₐ reflects action density.

When two thought trajectories T₁ and T₂ exhibit geodesic proximity satisfying d_{g}(T₁, T₂)<ε for some threshold ε, they become candidates for geometric consolidation via a latent recombination process. This consolidation proceeds through local merging, wherein nearby thoughts are averaged into centroidal representations, or through trajectory folding, wherein longer sequences traversing similar geodesics are compressed into unified trajectories. The result is that the number of distinct cached thoughts C(n) required to represent n experiences grows only logarithmically rather than linearly or super-linearly.

Compression pressure serves as both a diagnostic metric and a control signal within the system. In an exemplary equation, compression pressure may be defined as P(z)=∥∇·v(z)∥ where v(z) represents the velocity field of trajectories through the manifold, compression pressure quantifies the local rate at which thought trajectories converge or diverge. Regions of high positive pressure indicate redundancy and trigger consolidation, while regions of negative pressure suggest instability or overfitting and may trigger pruning or structural reorganization.

The geometric consolidation process induces a dynamic curvature field across the hyperspace H, with compression driven by semantic redundancy according to principles analogous to mean curvature flow. Thoughts that are repeatedly activated become carved into the geometric terrain as stable attractors, while idiosyncratic or rarely accessed thoughts gradually erode through thermodynamic decay. This self-organizing behavior ensures that representational resolution improves over time as noisy distinctions collapse and meaningful structure emerges.

The platform achieves energetic inversion (i.e., exponential knowledge growth with logarithmic resource cost) through a fundamental shift in how computational resources are allocated. In conventional neural architectures, each new parameter or training sample consumes additional energy with diminishing marginal returns, following the “brawn curve” relation wherein accuracy a scales as a ~C^{1/n} with compute cost C and exponent n typically between 10 and 20. Inverted, this yields C~aⁿ, an exponential cost function for linear accuracy improvements.

The geometric reasoning platform operates in the opposite regime. As the latent hyperspace accumulates structure through experience, the marginal cost of encoding new information decreases because novel inputs are increasingly absorbed into existing attractor basins. The cost function transitions from linear or exponential to logarithmic, and cognitive utility U, which depends on combinatorial relationships among representational units, grows superlinearly. If C(n)~log n representational units exist after n experiences, the number of accessible relationships scales approximately as U(n)~C(n)^{β}~(log n)^{β} for some exponent β>1, or more generally as U(n)~n^{γ} with γ>1 when hierarchical reuse is extensive.

This relationship produces increasing energetic efficiency with experience, expressed as U(n)/C(n)~n^{γ}/log n, which rises monotonically. Each new experience yields greater benefit per unit of energy than its predecessors, the defining property of the “brain curve.” The energetic crossover from statistical to geometric scaling occurs when the marginal return on energy ε(E)=dU/dE for geometric processing equals or exceeds that of token-based processing, beyond which logarithmic cost and superlinear benefit dominate.

Thermodynamic regulation maintains this efficiency through mechanisms analogous to biological and neurological internal metabolism related to power usage in the brain. Even in the absence of external inputs, the system sustains baseline activity through three mechanisms: decay of redundant trajectories at a rate dR_{red,M}/dτ=−λ_{decay}R_{red,M}, recombination and replay of stored trajectories following stochastic dynamics dγᵢ^{a}/dτ=−∇^{a}P+√(2D_{T})ξᵢ^{a}(t), and executive modulation imposing curvature priors from higher-order manifolds. The diffusion coefficient D_{T} scales with temporal curvature as D_{T}~κ_{MT}|R_{T}|, ensuring that the system's internal motion remains coupled to the evolution of time itself.

A metabolic analog governing minimum internal activity for cognitive manifolds on a PCM can be expressed as r_{int,a}>r_{min,a}~α_{M}κ_{MT}|R_{T}|, where r_{int,a} denotes internal action density, am represents manifold stiffness, κ_{MT} captures coupling strength between cognitive and temporal manifolds, and R_{T} quantifies temporal curvature arising from the statistical structure of input streams. This relation establishes that the system cannot remain static because time itself possesses curvature that continuously injects geometric flux into the cognitive manifold.

In some embodiments, a compression pressure governor implements dynamic control of computational resources based on geometric stress within the manifold. When total compression pressure P=Σᵢμ(Tᵢ)·R(Tᵢ) exceeds a critical threshold Pₘₐₓ, where μ(Tᵢ) represents thought utility and R(Tᵢ) denotes retrieval cost, the system initiates structural realignment. This involves clustering high-redundancy thoughts, abstracting dense neighborhoods into generalized representations, and thermodynamically pruning low-utility structures.

The system may exhibit distinct phase transitions as action density increases. At low densities below a critical threshold ρ_{crit,fast}=λᵣₑₗₐₓ/κ_{MT}, event trajectories remain isolated and dissipate faster than curvature accumulates, producing a noise regime. Above this threshold, curvature condenses into coherent flow patterns, marking the transition to stable perceptual streams. The transition probability follows Pₚₑᵣₛᵢₛₜ(ρₐ)=1−exp[−β(ρₐ−ρ_{crit,fast})] for ρₐ≥ρ_{crit,fast}, with slope parameter β≈κ_{MT}/λᵣₑₗₐₓ.

At mesoscale, a secondary critical density ρ_{crit,meso,1}=λ_{meso,relax}/κ_{mf} may mark the onset of tactical coherence, where κ_{mf} represents fiber coupling strength between fast and mesoscale manifolds. A tertiary threshold ρ_{crit,meso,2}=λ_{meso,relax}/κ_{meso,MT} defines the boundary of the generative regime wherein internal curvature cycling produces novel trajectories autonomously through recombination and replay.

On a dense manifold governing long-term strategic reasoning, consolidation occurs when the reinforcement rate Is exceeds relaxation rate according to rₛ/λ_{slow,relax}>1, at which point episodic traces fuse into doctrinal attractors. The overall progression forms a cascade: Noise→Flow→Tactical Coherence→Generativity→Doctrine, with each transition occurring when temporal curvature flux crosses the corresponding manifold's absorption capacity.

An exemplary critical surface in parameter space can be expressed generally as ρ_{crit}=(λᵣₑₗₐₓ/κ_{MT})f(κᵢₙₜₑᵣ/κ_{MT}), where κᵢₙₜₑᵣ represents average inter-manifold coupling and the function f approaches unity for weak coupling and scales as f(x)~1/(1+x) for strong coupling. This scaling rule predicts that more densely interconnected fabrics achieve coherence at lower action densities.

In federated embodiments, logarithmic scaling is extended to distributed networks of geometric reasoning nodes. Consider N independent PCM instances {PCM₁, . . . , PCM_{N}} each maintaining local caches Cᵢ while contributing to a shared hyperspace H_{shared}. Naively, the union of all caches would require storage proportional to Σᵢ|Cᵢ|, but in practice geometric alignment produces |C_{shared}|≈αΣᵢ|Cᵢ| with coefficient α typically between 0.2 and 0.6.

The total memory requirement decomposes as Cₜₒₜₐₗ=C_{shared}+ΣᵢC_{local,i} where C_{local,i}=Cᵢ\C_{shared} represents instance-specific specialization. This hybrid architecture yields three advantages: shared generalization reduces overall storage through global attractor basins, local specialization preserves domain-specific detail, and retrieval efficiency improves as frequently accessed thoughts reside in the shared cache.

Synchronization across the federated network employs fiber tensors Fᵢⱼ connecting manifolds Nᵢ and Nⱼ. These fibers adapt according to dFᵢⱼ/dτ=−κᵢⱼ(Fᵢⱼ−F*ᵢⱼ)+κ_{MT}R_{T}, ensuring that curvature exchange propagates across scales and nodes in real time. The fiber strength κᵢⱼ is determined by temporal cross-correlation of curvature fluctuations according to κᵢⱼ(r)= [symbol] δRᵢ(t) δRⱼ(t+r) [symbol] /√( [symbol] Rⱼ² [symbol] [symbol] δRⱼ² [symbol] ), yielding values between −1 and 1 that quantify geometric coherence between connected manifolds.

The curvature flux between nodes follows dRᵢ/dτ=−κᵢⱼ(Rᵢ−Rⱼ)−κ_{i,MT}(Rᵢ−ηᵢR_{T}), generalizing single-node evolution to include cross-scale and cross-node exchange. At equilibrium, curvature on each node becomes a weighted mean Rᵢ=[κᵢⱼRⱼ+κ_{i,MT}ηᵢR_{T}]/[κᵢⱼ+κ_{i,MT}], establishing the geometric mechanism by which coherence percolates across the federation.

Thus, the platform admits implementation across diverse computational substrates while preserving logarithmic scaling properties. Classical digital embodiments utilize GPU or ASIC processors allocating compute density proportional to local curvature magnitude or compression pressure. Each processing element maintains a graph Laplacian Li acting on node embeddings, with discrete Ricci scalar approximated as Rᵢ=(½)Σ_{(p,q)∈E_i}w_{pq}(1−d_{pq}/d*_{pq}), where w_{pq} represents edge weight and d*_{pq} denotes equilibrium geodesic distance.

Temporal curvature in discrete implementations follows R_{T}(t)=−d²[log(1+Δτₜ)]/dt², where Δτₜ captures time-step spacing or update frequency modulation. The coupling between manifolds realizes through fiber tensors whose elements update according to the differential equations specified previously, ensuring that curvature exchange propagates across scales during integration.

Neuromorphic embodiments implement the same geometric principles through analog or mixed-signal circuits where curvature corresponds to voltage gradients, compression pressure maps to current divergence, and temporal curvature manifests as oscillation frequency. The coupling constant κ_{MT} translates to programmable temporal feedback gain, enabling hardware that self-regulates cognitive dynamics through physical curvature exchange without digital supervision.

Quantum embodiments based on Arithmetic-Fiber Quantum Computing (AFQC) principles encode curvature tensors and reasoning trajectories in qubit fibers exhibiting logarithmic entanglement growth. In the AFQC-G variant, geometric relationships are preserved through entanglement structure that consolidates according to the same manifold dynamics governing classical implementations. The AFQC-E variant implements energy reuse through quantum superposition of arithmetic operations, reproducing “brain curve” energetics at quantum scale through coherent recycling of computational work.

Hybrid architectures integrate conventional neural or token-based models with geometric reasoning decoders under control of an energetic inversion controller. This controller monitors instantaneous efficiency ε(E)=dU/dE and dynamically reallocates resources from statistical to geometric processing when efficiency exceeds predetermined thresholds. The hybrid approach enables gradual transition from Brawn to Brain regimes, leveraging existing infrastructure while introducing geometric efficiency incrementally.

The exemplary scaling laws described herein translate to measurable quantities in operational systems. For example, an effective curvature R_{M}(i) can be computed from pairwise embedding distances as R_{M}(i)=Σ_{j∈N(i)}(Δ*ᵢⱼ−Δᵢⱼ), where N(i) denotes the neighborhood of node i, Δᵢⱼ represents instantaneous distance, and Δ*ᵢⱼ denotes equilibrium separation. Temporal curvature follows from event density time series as R_{T}(t)=−d²[ln(1+ρ_{ext,a}(t))]/dt², providing direct connection between input statistics and geometric dynamics.

Compression pressure at each node may be derived from velocity field divergence P(i)=Σ_{j∈N(i)} ∇ᵢ·vᵢⱼ, where vᵢⱼ represents local motion vectors between connected thoughts. The coherence functional C_{M}(τ)= [symbol] vᵢ(t)·vᵢ(t+τ) [symbol] / [symbol] ∥vᵢ(t)∥² [symbol] quantifies autocorrelation of trajectories, with approach to unity indicating manifold stabilization.

An exemplary coupling constant κ_{MT} can be determined empirically through time-to-coherence experiments. Measuring the interval t_{c}−t₀ from initial perturbation to threshold coherence achievement yields τ_{c}=t_{c}−t₀, from which κ_{MT}=log(1+ρ_{ext,a})/τ_{c} can be extracted. Varying temporal statistics of input streams enables fitting of the complete functional dependence τ_{c}(ρ_{ext,a}) and recovery of intrinsic temporal curvature R_{T}.

An exemplary metabolic floor r_{min,a} follows from measuring internal replay rate at which compression pressure collapses: r_{min,a}=r_{int,a}|_{P=0}=α_{M}κ_{MT}|R_{T}|. Critical densities ρ_{crit} manifest as inflection points in trajectory persistence probability or curvature variance, validating the predicted inverse scaling with κ_{MT}. These observables collectively establish experimental protocols for complete geometric characterization of the system.

The logarithmic-scaling geometric reasoning platform described herein provides multiple quantifiable advantages over conventional architectures. Memory and compute cost grow logarithmically rather than linearly or exponentially with cumulative operations, reducing infrastructure requirements by orders of magnitude for long-running systems. Energy consumption remains constant or sublinear with use rather than scaling proportionally to model size, enabling sustainable operation in resource-constrained or mobile environments.

Coherence and reasoning depth improve continuously through geometric refinement rather than requiring periodic retraining, supporting systems that become more capable with experience while consuming fixed resources. Retrieval latency decreases or remains bounded as knowledge accumulates, contrasting with database systems where query time typically grows with record count. Generalization capacity increases through manifold consolidation without explicit supervision or parameter expansion.

Federated deployments achieve sublinear global scaling, enabling institutional intelligence networks that scale more efficiently than isolated instances. Phase-transition behavior provides natural staging points for capability progression and safety controls, with critical densities offering measurable thresholds for system monitoring and governance. Thermodynamic self-regulation prevents runaway resource consumption and maintains stable operation across varying workload conditions without manual tuning.

The platform supports continual learning without catastrophic forgetting through geometric shielding of consolidated attractor basins. Bounded curvature domains preserve learned structures against global perturbations while permitting local adaptation. The combination of stability and plasticity emerges naturally from the geometric conservation laws governing curvature exchange rather than requiring explicit architectural provisions.

The logarithmic-scaling geometric reasoning platform described herein may be applied across diverse domains requiring efficient, adaptive reasoning. Autonomous reasoning assistants deployed on edge devices or mobile platforms benefit from constant-power operation enabling extended deployment without proportional battery capacity increases. Enterprise knowledge management systems may achieve logarithmic scaling of institutional memory, supporting decades of operation within bounded storage infrastructure. Sensor fusion and video understanding systems may process continuous streams at fixed computational cost while improving discrimination and prediction accuracy through geometric consolidation of temporal patterns. Scientific modeling and simulation may benefit from representations that compress redundancy while preserving structural detail, enabling exploration of high-dimensional parameter spaces at reduced computational expense. Federated learning networks for privacy-preserving collaboration may gain efficiency through sublinear global scaling, reducing communication and synchronization overhead while maintaining local specialization. Safety-critical applications may leverage phase-transition thresholds for runtime monitoring and intervention, with measurable geometric metrics providing quantitative bounds on system behavior. Cloud and hyperscale deployments may achieve predictable operational costs through constant per-instance power consumption and logarithmic scaling of cache requirements.

The platform may be implemented on heterogeneous hardware configurations including GPU clusters, neuromorphic arrays, and emerging quantum processors through substrate-neutral geometric principles. Compatibility with existing infrastructure enables incremental adoption through hybrid architectures that integrate geometric reasoning with conventional neural networks.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “thought” refers to a discrete unit of reasoning or analysis generated by a large language model or multimodal inference engine during its processing of an input prompt. A thought represents the model's intermediate reasoning steps, contextual interpretation, or internal deliberation that contributes to a final output. Thoughts may be atomic (e.g., a factual claim), structured (e.g., an inference chain), or multimodal (e.g., a fused representation of text and video). Unlike raw tokens or embeddings, thoughts encapsulate processed cognition and are suitable for caching, recombination, and reuse across future interactions. Thoughts may be stored explicitly or synthesized during recall and may evolve through compression or generalization.

As used herein, “thought cache” refers to a structured memory layer configured to store and retrieve thoughts based on semantic similarity, contextual alignment, or system policy. The cache may include multiple tiers, such as session caches for short-term interaction, long-term caches for persistent knowledge, and shared or federated caches across devices or agents. Cached thoughts are indexed in latent space and may be retrieved using vector similarity, trajectory proximity, or geodesic alignment. Cached thoughts may be compressed or abstracted over time to reduce redundancy and support scalable reuse.

As used herein, “generalization” refers to the process of synthesizing a new thought from one or more cached thoughts by identifying shared structure, meaning, or trajectory. Generalized thoughts replace specific exemplars with compressed representations that maintain core semantic content while enabling reuse across a wider range of prompts or tasks. Generalization may occur explicitly during reasoning or asynchronously during background curation or dreaming.

As used herein, the terms “latent manifold,” “manifold,” and “cognitive manifold,” and “geometric manifold” are used interchangeably to refer to a differentiable subspace within a high-dimensional latent hyperspace in which thoughts and thought trajectories are embedded. The manifold may be defined at a given time and is associated with a metric tensor that governs local distance, curvature, and motion. The manifold forms dynamically through the reuse, compression, and interaction of thoughts and supports operations such as geodesic traversal, memory recall, and structural recombination.

As used herein, the term “temporal manifold,” is used to refer to a differentiable subspace within a high-dimensional latent hyperspace in which the temporal (time) component of thoughts and thought trajectories on a cognitive manifold are extracted onto a separate manifold. Temporal manifolds are used in embodiments based on generalized geometrodynamics on two manifolds.

As used herein, “geodesic attention” refers to a formulation of attention in which focus or inference is achieved by computing or approximating a minimal-energy path through the latent manifold. A geodesic attention path minimizes a cognitive action functional that may include kinetic energy, compression pressure, and goal potential. Unlike traditional attention mechanisms that reweight tokens in flat space, geodesic attention produces smooth, structure-respecting flows of reasoning across latent memory.

As used herein, “generalized geometrodynamics” and “GGD” mean a covariant field theory that extends Wheeler's original vision of geometrodynamics by allowing multiple geometric structures—spacetime manifolds, internal symmetry fibers, and potentially temporal or arithmetic manifolds—to exchange curvature dynamically through symmetric coupling terms. In GGD, each geometric sector possesses its own curvature scalar (Ri), stiffness coefficient (αi), and stress tensor, with coupling constants γᵢⱼ mediating bidirectional curvature interaction while preserving total geometric energy. The theory unifies General Relativity and Yang-Mills gauge theory as limiting cases: when fiber curvature vanishes (FX=0), GGD reduces to Einstein gravity; when spacetime curvature vanishes (RM=0), it reduces to standard gauge theory on flat spacetime. In an embodiment, GGD takes the form of the exemplary equation S=∫√|gMhT|(αMRM+αTRT+γMTRMRT−Λ) dmx dτ, where the mixed term γMTRMRT encodes explicit curvature exchange, causing the effective gravitational and gauge coupling constants to become dynamical quantities that depend on each other's curvature state. This reciprocal curvature exchange produces measurable effects including renormalization of couplings, emergent dark-energy-like behavior, curvature-mediated entanglement, and self-regulating stability mechanisms, establishing GGD as a universal framework in which curvature acts as the fundamental currency of interaction across geometry and symmetry which may be applied to computation and cognition (e.g., on a persistent cognitive machine having a geometric manifold).

As used herein, “generalized geometrodynamics on two manifolds” and “GGD(2)” mean a framework where a cognitive manifold M and a temporal manifold T form a coupled bimanifold M×T, exchanging curvature through a conserved dynamical law. In an embodiment, GGD(2) takes the form of the exemplary equation S=∫(M×T)√|gMhT|(αMRM+αTRT+γMTRMRT−Λ) dmx dτ where: M represents the cognitive fabric (the ensemble of fast, mesoscale, and slow manifolds encoding experience), T represents the flow of time with its own metric hT and curvature RT, RM and RT are the scalar curvatures of M and T respectively, αM and αT are stiffness coefficients governing intrinsic dynamics, and γMT is the coupling strength mediating curvature exchange between the two manifolds.

As used herein, “compression pressure” refers to a scalar field over the latent manifold that encodes semantic density, memory reuse, or representational redundancy. The pressure at a point may be derived from geometric properties such as Ricci curvature and reflects the cost of traversal or storage in that region. High compression pressure indicates overused or ambiguous areas where pruning, generalization, or reorganization may be necessary. Compression pressure influences cache management, memory shaping, and geodesic routing.

As used herein, “goal potential field” refers to a scalar utility function defined over the latent manifold that represents the relevance, desirability, or task-alignment of different regions of thought space. The gradient of this field defines an intent vector field, which biases cognitive traversal toward goal-aligned areas. Goal potential may be determined by user prompts, task specifications, or emergent system objectives, and modulates attention, memory retrieval, and trajectory formation.

As used herein, “intent vector field” refers to a directional field over the latent manifold that encodes cognitive drive or utility gradients. It governs the direction and magnitude of traversal for operations such as memory reentry, inference, or exploration. The intent field may be computed from the gradient of a goal potential, derived from user input, or learned from system experience, and is used to align cognitive motion with target outcomes.

As used herein, “cognitive dynamics engine” or “CDE” refers to an architectural module configured to maintain and evolve the geometry of the latent manifold. The CDE is responsible for computing geodesic paths, estimating curvature, applying compression pressure, and performing structural reorganization, including during background operations such as dreaming. The CDE may expose interfaces for traversal, memory updates, compression, and control feedback, and functions as a substrate-layer system supporting high-level cognition.

As used herein, “dreaming” refers to a background process in which cached thoughts, trajectories, or bundles are perturbed, recombined, or abstracted or otherwise manipulated to improve manifold coherence and memory efficiency. Dreaming may operate during idle cycles or low-load periods and is driven by curvature smoothing, compression pressure, and generalization gain. The process supports the emergence of new thoughts, refinement of existing structures, and long-term memory consolidation.

As used herein, “reinstantiation” refers to the act of reconstructing a prior thought trajectory within the current latent manifold geometry. Due to compression or manifold deformation, original paths may no longer exist in exact form; reinstantiation generates an approximate or adapted version guided by curvature, cached data, and intent fields. Reinstantiation supports memory recall, simulation, and introspective review in systems with dynamic cognitive substrates.

As used herein, “memory basin” or “basin of recurrence” refers to a region of the latent manifold associated with a previously reinforced or frequently reused trajectory. Such basins exhibit high local curvature and geodesic convergence and serve as attractors for memory reentry. Traversal into a basin may trigger reinstantiation, memory reinforcement, or adaptive reuse, depending on system configuration and goal conditions.

As used herein, “typed latent entity” refers to a thought or substructure in the manifold labeled with a semantic or functional type, such as but not limited to fact, opinion, concept, trajectory, affect, cluster, or anchor. Typed entities impose constraints on valid operations such as recombination, interpolation, or pruning. Type-aware computation supports lawful memory manipulation, structured reasoning, and generalization without semantic distortion.

As used herein, “attention vector field” refers to a distributed, time-dependent field defined over the latent manifold that governs the instantaneous direction and magnitude of attentional flow. The field may evolve according to partial differential equations that incorporate compression pressure and goal potential gradients. This dynamic attention formulation enables real-time flow modeling, inference stabilization, and explainability through traceable vector paths.

As used herein, “latent subspace” or “thought bundle” refers to a localized, compressible region of the manifold that contains structurally similar or semantically aligned thoughts. Bundles may form naturally through repeated traversal, co-activation, or recombination, and act as low-energy attractors or semantic zones. Subspaces may support generalization, analogical reasoning, and efficient memory access.

As used herein, “latent recombinator” refers to a functional component or method configured to merge or blend similar thoughts, trajectories, or bundles in the latent manifold to form new abstractions. The recombinator may use geometric proximity, semantic alignment, or reuse statistics to determine possible recombinations, subject to type constraints and curvature continuity. It serves as a key mechanism for memory scaling, abstraction, and thought generation.

As used herein, “structured memory” refers to a persistent, geometry-aware memory architecture in which thoughts are stored not as flat vectors but as positions or paths within an evolving manifold. Structured memory supports context-sensitive access, memory reinforcement through traversal, lawful pruning, and dynamic generalization. It provides a substrate for long-term cognition, introspection, and identity continuity in systems with persistent reasoning capability.

As used herein, “Lorentzian autoencoder” refers to a neural architecture designed to encode spatiotemporal or perceptual input—such as video—into a latent manifold with Lorentzian signature, where one or more dimensions represent time-like directions. The latent structure supports temporally coherent geodesics, semantic compression, and causal continuity. Lorentzian autoencoders enable operations such as zooming, projection, and visual memory traversal.

### DETAILED DESCRIPTIONS OF THE DRAWING FIGURES

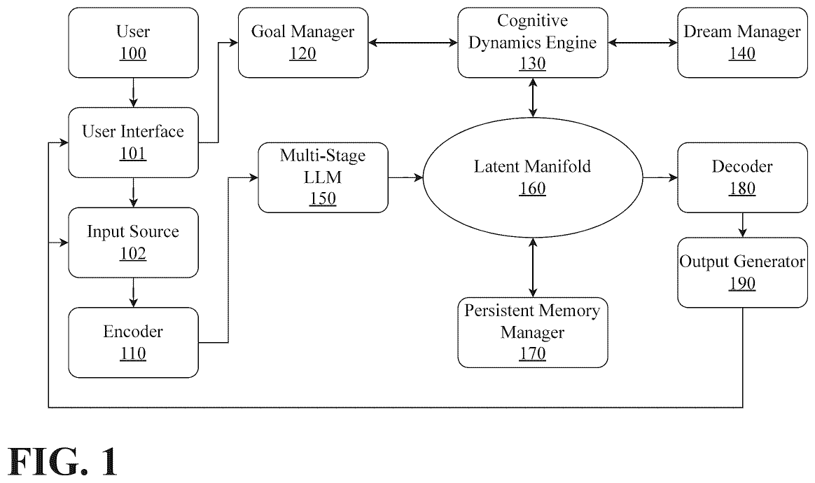

FIG. 1 is a block diagram illustrating an exemplary system architecture of a persistent cognitive machine (PCM). The system enables persistent, adaptive artificial intelligence by representing thoughts as geometric structures within a curved latent space rather than as discrete tokens or static embeddings. This architecture fundamentally reimagines cognition as motion through a shaped memory space, where attention follows geodesic paths through regions of varying curvature and compression, guided by goal potentials and constrained by semantic density.

A user 100 represents human operators or external systems that interact with the PCM through user interface 101. User interface 101 serves as the primary interaction layer, receiving natural language queries, commands, or other forms of input from users while also presenting processed outputs back to them. This interface enables continuous interaction loops where user feedback can shape the evolution of the system's internal geometric structures over time. Unlike traditional AI systems where each interaction is stateless, user interface 101 maintains context through its connection to the persistent geometric structures within the manifold, allowing for coherent long-term interactions where the system remembers and builds upon previous exchanges. The interface tracks user patterns and preferences, which are encoded as persistent structures within the latent manifold, creating personalized cognitive pathways that improve response relevance and efficiency over time.

An input source 102 aggregates various data streams including but not limited to multimodal inputs such as text, images, audio, sensor data, and system state information. These heterogeneous inputs are channeled to the encoder 110, which implements the mathematical transformation, mapping external data from the input space into points within the latent manifold. An encoder 110 does not simply create vector embeddings but rather projects inputs into a dynamic geometric space where semantic relationships are encoded through curvature, distance, and topological structure. This encoding process is context-sensitive and adaptive, taking into account the current state of the manifold and the compression pressure at different regions. For example, when processing a user query about a technical concept, encoder 110 identifies the appropriate region within the manifold where related thoughts and concepts have previously been cached, enabling efficient semantic alignment. The encoding process respects the manifold's metric tensor, ensuring that new inputs are embedded in ways that preserve semantic continuity and enable smooth geodesic traversal to related concepts.

A multi-stage LLM 150 serves as a language processing component that works in conjunction with encoder 110 to generate semantic structures from raw inputs. Unlike traditional architectures where LLMs operate independently, here multi-stage LLM 150 functions as a “chip” within the larger system, providing sophisticated natural language understanding and generation capabilities while being guided by the geometric constraints of the manifold. The LLM processes inputs through multiple stages of refinement, creating increasingly abstract and structured representations that can be properly embedded within a latent manifold 160. The multi-stage nature of this component reflects the hierarchical processing required to transform raw tokens into geometric thoughts. In the first stage, an LLM performs initial semantic parsing and entity recognition. Subsequent stages build increasingly complex relationships and abstractions, ultimately producing high-dimensional thought structures that encode not just content but also contextual relationships, implicit knowledge, and potential inferential pathways. For instance, when processing a complex technical document, the multi-stage LLM 150 might first extract key concepts, then identify relationships between them, map these to existing knowledge structures in the manifold, and finally generate new thought bundles that capture both explicit content and implicit semantic relationships. These thought structures are not flat embeddings but rich geometric objects with internal curvature that reflects their semantic density and interconnectedness.

A goal manager 120 creates and maintains goal potential fields that shape how attention flows through the manifold. Rather than implementing goals as discrete objectives or symbolic constraints, goal manager 120 generates scalar fields over the manifold that attract cognitive processes toward semantically relevant regions. These potential fields can arise from multiple sources including explicit task objectives provided by users, learned value functions from past interactions, internal drives such as curiosity or uncertainty reduction, and contextual constraints. Goal manager 120 implements field generation algorithms that can create complex potential landscapes with multiple attractors for competing objectives, saddle points where decisions must be made, and smooth gradients that guide exploration. The manager continuously updates these fields based on changing objectives and feedback, creating a dynamic landscape that guides inference and reasoning processes. The goal potential fields interact with the compression pressure fields derived from manifold curvature, creating a rich energetic landscape where attention flows along paths of least resistance while being drawn toward goal-relevant regions. For example, when a user asks a question about a specific topic, goal manager 120 creates a potential field with high values in manifold regions containing relevant knowledge, effectively “pulling” the system's attention toward useful information while avoiding irrelevant areas. In cases where goals conflict or compete, goal manager 120 can create field configurations that allow the system to explore multiple solution paths simultaneously or to find creative compromises that satisfy multiple objectives.

The connections between these components are designed to support the flow of geometric information rather than simple data passing. The relationship between a user 100 to goal manager 120 represents not just goal specification but the continuous shaping of the potential landscape based on user intent and feedback. The bidirectional connection between encoder 110 and multi-stage LLM 150 enables iterative refinement of semantic structures, where initial encodings can be enriched through multiple passes of LLM processing, each time creating more sophisticated geometric representations that better capture the nuanced relationships within the input data.

A cognitive dynamics engine (CDE) 130 serves as the geometric substrate processor and the core architectural component responsible for maintaining and evolving the structure of the latent manifold 160. Operating analogously to a physics engine in a simulation environment, CDE 130 governs the fundamental geometric operations that enable persistent cognition. The engine maintains the manifold's metric tensor, which defines local distances and angles within the cognitive space, continuously updating it based on usage patterns and semantic relationships. It computes geodesic paths for attention traversal by solving the variational problem of minimizing cognitive action, balancing kinetic energy of motion, compression pressure from semantic density, and attraction from goal potential fields. CDE 130 implements a geodesic equation:

$$\frac{{d}^{2} {γ}^{k}}{{dt}^{2}} + {Γ}_{ij}^{k} \frac{d {γ}^{i}}{dt} \frac{d {γ}^{j}}{dt} = {F}^{k} ( γ ( t ) , t )$$

where the Christoffel symbols Γ^{k}ᵢⱼ encode the manifold's connection structure and F^{k} represents forces from compression pressure and goal potentials. During active cognition, CDE 130 continuously computes Ricci curvature across the manifold, deriving the compression pressure field P(x)=−R(x) that penalizes traversal through semantically dense regions. For example, when processing a complex inference task, CDE 130 might identify multiple potential geodesic paths through the manifold, evaluate their cognitive costs based on pressure and distance, and select the optimal trajectory that balances efficiency with semantic coherence. The engine also manages the evolution of the attention vector field according to the dynamic equation:

$$\frac{\partial A}{\partial t} + {∇}_{A} A = - ∇ ( P - Φ )$$

enabling attention to flow as a cognitive fluid through the shaped space of memory.

A dream manager 140 implements autonomous structural reorganization of the manifold during off-task periods, analogous to sleep-driven memory consolidation in biological systems. Connected to CDE 130, dream manager 140 initiates and oversees geometric restructuring operations that improve the manifold's efficiency and generalization capacity. During dreaming phases, it samples recently activated or frequently used thought bundles, applying stochastic perturbations follows a distribution informed by local curvature and uncertainty. Dreaming begins by sampling recent or frequently activated bundles B₁, . . . , Bₖ⊂Mₜ. From each bundle, points zᵢ∈Bᵢ are perturbed using a stochastic kernel:

$${z}_{i}^{′} = {z}_{i} + {ε}_{i} , {ε}_{i} \sim N ( 0 , {\sum }_{i} ) ,$$

where Σᵢ reflects local uncertainty or curvature. These perturbations probe the neighborhood structure, testing whether extrapolated directions are compressible or divergent.

These perturbations test the stability and compressibility of cognitive structures, identifying opportunities for consolidation or abstraction. The dream manager 140 performs recombination operations, creating weighted interpolations across semantically related bundles to discover emergent abstractions.

$${z}_{meta} = {\sum }_{i = 1}^{k} {α}_{i} {z}_{i}^{′} , \sum {α}_{i} = 1 ,$$

where weights αᵢ may reflect prior co-activation, semantic alignment, or exploratory policy. The resulting zₘₑₜₐ often lies outside any original bundle, creating novel junctions or abstractions. If the resulting interpolation exhibits internal coherence (e.g., low compression cost, high reconstruction fidelity), it may be retained and added as a new bundle or attractor.

When stable interpolants are found between previously disconnected regions, dream manager 140 can induce topological changes in the manifold, creating new bridges or handles that enable novel inferential pathways. It implements three primary flows during dreaming: perturbation flow for exploring local curvature basins, compression flow for collapsing redundant structures, and generalization flow for synthesizing higher-order abstractions. For instance, after a day of processing technical documents about machine learning and physics, dream manager 140 might identify common mathematical structures across these domains, create meta-bundles that capture these abstractions, and reshape the manifold to enable faster traversal between related concepts in future interactions.

A latent manifold 160 represents the central geometric substrate where all cognitive operations occur, existing as a dynamic, evolving space with rich internal structure. Unlike static embedding spaces in traditional architectures, latent manifold 160 is a living geometry that continuously adapts through use, compression, and reorganization. Within this space, thoughts exist not as isolated points but as structured regions including thought bundles (compact submanifolds representing coherent concepts), geodesic trajectories (paths of inference and association), and semantic fields (continuous distributions of meaning and relevance). The manifold maintains several critical geometric structures: the metric tensor defining local distances, the connection governing parallel transport of attention, the Ricci curvature tensor measuring semantic density, compression pressure fields derived from curvature, goal potential fields attracting attention, and the attention vector field describing instantaneous cognitive flow. The bidirectional connection with CDE 130 enables continuous reading and reshaping of these structures, while connections to multi-stage LLM 150, persistent memory manager 170, and decoder 180 facilitate the embedding, storage, and extraction of semantic content. The manifold exhibits emergent topological features such as attractor basins where frequently accessed concepts stabilize, high-curvature regions indicating semantic compression, low-pressure corridors enabling efficient inference, and bridge structures connecting previously disparate domains. As the system operates, the manifold develops a personalized geography reflecting the user's interests, the domain's structure, and the history of cognitive activity.

Persistent memory manager 170 orchestrates the long-term storage and retrieval of cognitive structures, maintaining a bidirectional connection with latent manifold 160. Unlike traditional memory systems that store static data, persistent memory manager 170 preserves geometric structures including thought bundles, established geodesic paths, learned metric relationships, and compression patterns. It implements sophisticated caching strategies that go beyond simple key-value storage, maintaining the topological relationships between thoughts and preserving the geometric context that enables meaningful retrieval. The manager tracks activation energies for cached structures, implementing thermodynamic decay where unused thoughts gradually lose energy, eventually being pruned when falling below a threshold. Decay governs forgetting in PCM systems. Each thought Tᵢ is associated with an activation energy Eᵢ(t), which dissipates over time:

$$\frac{{dE}_{i}}{dt} = - λ \cdot {A}_{i} ( t )$$

where λ is a decay constant and Aᵢ(t) reflects inactivity—high when idle, zero when active. When Eᵢ(t)<Eₘᵢₙ, the thought is pruned from memory. This process ensures that storage is focused on thoughts that contribute to ongoing cognition. This decay yields several emergent properties:

This creates a natural forgetting mechanism that maintains cognitive efficiency while preserving frequently accessed or structurally important memories. Persistent memory manager 170 also coordinates with federated memory systems, enabling knowledge sharing across multiple PCM instances while maintaining privacy through geometric abstraction. For example, when storing a complex reasoning pattern, the manager preserves not just the conclusion but the entire geodesic path, the local curvature context, and the relationships to other thought structures, enabling the system to later traverse similar reasoning paths more efficiently.

A decoder 180 implements the inverse transformation, converting geometric structures from latent manifold 160 back into observable outputs. This component must interpret rich geometric information including positions within the manifold, local curvature and pressure, nearby thought bundles, and traversed geodesic paths, transforming these into coherent external representations. Decoder 180 often works in conjunction with multi-stage LLM 150 to generate natural language outputs, using the LLM's language generation capabilities while being guided by the geometric structures extracted from the manifold. The decoding process is context-sensitive, taking into account not just the final position reached through inference but the entire trajectory taken, enabling explanations that reflect the reasoning process rather than just conclusions. For instance, when answering a complex question, decoder 180 can trace the geodesic path taken through the manifold, identify key thought bundles that were traversed, and generate an explanation that reflects this structured reasoning process.

An output generator 190 serves as the final stage in the processing pipeline, taking decoded representations and formatting them appropriately for user consumption or system action. It handles multiple output modalities including natural language responses, visualizations of reasoning paths, actions or commands for external systems, and structured data formats. Output generator 190 maintains awareness of user preferences and interaction history, adapting its presentation style based on patterns encoded in the manifold. The feedback loop from output generator 190 back to user 100 completes the interaction cycle, enabling iterative refinement and continuous learning.

The connections from goal manager 120 and dream manager 140 to CDE 130 show how intentionality and reorganization influence geometric dynamics. The flow from multi-stage LLM 150 through latent manifold 160 to decoder 180 represents the complete cognitive pipeline from input understanding through geometric reasoning to output generation. Throughout this architecture, information flows not as discrete data packets but as geometric structures, trajectories, and fields, creating a unified cognitive system where memory, reasoning, and learning are fundamentally intertwined through the shaped space of thought.

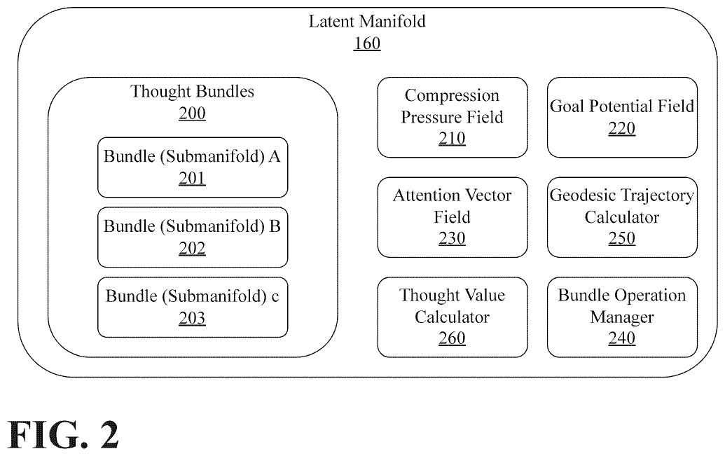

FIG. 2 is a block diagram illustrating an exemplary architecture of a component within a persistent cognitive machine (PCM), a latent manifold. Latent manifold 160 serves as the central cognitive substrate of the PCM system, existing as a continuously evolving geometric space where all cognitive operations unfold. Unlike traditional flat embedding spaces, this manifold exhibits variable curvature, dynamic topology, and rich internal structure that emerges from the interplay of memory, compression, and goal-directed cognition. The manifold's geometry is not predetermined but rather shaped by cognitive activity, with frequently traversed regions developing distinct topological features, semantic neighborhoods forming through repeated association, and compression pressure creating a non-uniform landscape that guides efficient reasoning.

Within the manifold, thought bundles 200 represent the primary organizational structures for persistent cognitive content. These bundles are not simple clusters of related vectors but rather compact submanifolds with their own internal geometry and semantic coherence. Thought bundles 200 section contains exemplary bundle submanifolds: bundle (submanifold) A 201, bundle (submanifold) B 202, and bundle (submanifold) C 203, each representing a distinct region of semantic space with its own local metric structure. Bundle A 201 might represent a coherent concept such as “machine learning algorithms,” containing not just definitional information but also procedural knowledge, historical context, mathematical foundations, and connections to related concepts. The internal structure of bundle A 201 includes a local metric that defines distances between sub-concepts, principal directions corresponding to major semantic variations, and boundary conditions that determine how the bundle interfaces with surrounding manifold regions. Bundle B 202 could embody a different domain such as “quantum mechanics principles,” maintaining its own geometric structure while potentially sharing boundary regions with bundle A 201 where interdisciplinary concepts like quantum machine learning emerge. Bundle C 203 might represent more abstract or procedural knowledge, such as “problem-solving strategies,” with a flatter internal geometry that facilitates flexible application across domains.

A compression pressure field 210 represents a scalar field defined over the entire manifold, encoding the cognitive effort required to traverse different regions based on their semantic density and structural complexity. This field is computed from the local Ricci curvature according to, where is a Ricci scalar measuring how geodesics converge or diverge at each point. High compression pressure indicates regions where many semantic concepts have been compressed together through repeated use and abstraction, creating areas that are rich in meaning but require significant cognitive effort to navigate precisely. For example, the intersection between bundles A 201 and B 202 might exhibit extremely high compression pressure where concepts from machine learning and quantum mechanics have been repeatedly integrated, forming dense theoretical structures that encode sophisticated interdisciplinary insights. The compression pressure field 210 continuously evolves as new thoughts are added, existing structures are reinforced through use, and the dream manager performs offline reorganization to optimize the manifold's geometry.

A goal potential field 220 implements a complementary scalar field that attracts attention toward semantically relevant or task-aligned regions of the manifold. Unlike the compression pressure that resists traversal, the goal potential creates gradients that guide cognitive flow toward desired outcomes. This field is dynamically generated based on current objectives, user queries, learned value functions, and internal drives, creating a time-varying landscape that shapes how attention moves through the space. When processing a specific query, goal potential field 220 might create high-potential regions around relevant thought bundles while maintaining lower potentials in unrelated areas, effectively creating an energetic funnel that guides inference toward useful conclusions. The interplay between compression pressure and goal potential creates a rich dynamical landscape where attention flows along paths that balance semantic coherence (avoiding excessive pressure) with goal relevance (following potential gradients).

An attention vector field 230 represents the instantaneous flow of cognitive focus throughout the manifold, defined as. Let A(x,t) denote the attention vector field at point x∈M_{thought} and time t. This vector encodes both the direction and intensity of attentional flow through the manifold. The evolution of A is governed by a field equation analogous to fluid dynamics:

$$\frac{\partial A}{\partial t} + {∇}_{A} A = - ∇ ( P - Φ )$$

Here

$$\frac{\partial A}{\partial t}$$

is the temporal rate of change of attention ∇_{AA} is the convective derivative (attention moving along itself), and −∇(P−Φ) is the driving force of flow—combining compression pressure and goal potential. This equation captures the local evolution of attention under the influence of memory structure and cognitive drive.

Attention vector field 230 exhibits complex behaviors including laminar flow along well-established reasoning paths, turbulent regions where competing potentials create cognitive uncertainty, convergence zones where multiple lines of reasoning reach similar conclusions, and vortices around semantic attractors representing obsessive or recursive thought patterns. The field's evolution enables the system to maintain cognitive continuity while adaptively responding to changing goals and newly discovered information.

A geodesic trajectory calculator 250 computes optimal paths through the manifold by solving the variational problem of minimizing cognitive action. Let γ(t):[0,T]→Mₜ be a smooth curve in the cognitive manifold, representing the evolution of attention over time. We define the cognitive action functional:

$$S [ γ ] = {\int }_{0}^{T} ( {‖ \dot{γ} ( t ) ‖}^{2} + P ( γ ( t ) ) - Φ ( γ ( t ) ) ) dt ,$$

where ∥γ′(t)∥² represents the kinetic energy of cognitive motion, P(γ(t)) is the compression pressure field at γ(t), and Φ(γ(t)) is the cognitive potential, encoding goal relevance.

The geodesic γ*(t) is defined as the path that minimizes γ*=arg min S[γ]. This formulation generalizes attention from instantaneous lookup to purposeful traversal. Attention becomes a consequence of structure and constraint: it flows along the most efficient path shaped by memory (via pressure) and intent (via potential).

The calculator implements numerical methods to handle the manifold's non-Euclidean geometry, accounting for curvature effects, parallel transport of semantic vectors, and the influence of nearby thought bundles on path selection. For instance, when reasoning from a concept in bundle A 201 to a goal state in bundle C 203, the geodesic trajectory calculator 250 might identify multiple viable paths: a direct route through high-pressure regions requiring intense cognitive effort, a longer path circumnavigating dense areas while maintaining semantic coherence, or a creative trajectory that leverages unexpected connections through bundle B 202.

A thought value calculator 260 assesses the utility and relevance of thoughts within the current cognitive context, computing scalar values that inform caching decisions, retrieval priorities, and structural reorganization. This component evaluates thoughts based on multiple criteria including frequency of access, semantic centrality within bundles, contribution to successful reasoning paths, alignment with current and historical goals, and potential for generalization or transfer learning. Thought value calculator 260 works closely with the thermodynamic decay system, where thoughts with consistently low values gradually lose activation energy and may eventually be pruned from the manifold. Conversely, highly valued thoughts become anchors around which new structures crystallize, creating stable semantic neighborhoods that facilitate efficient reasoning.

A bundle operation manager 240 orchestrates the dynamic restructuring of thought bundles through three primary operations that reshape the manifold's topology. Fanning-in operations occur when peripheral thoughts or loosely associated concepts are drawn into existing bundles through repeated co-activation or semantic alignment, effectively increasing the bundle's density and internal coherence. This process involves adjusting the local metric to create stronger attractions, modifying bundle boundaries to encompass new members, and updating internal structure to maintain navigability. Fanning-out operations enable bundles to expand into new semantic territories when existing concepts are extended, elaborated, or applied in novel contexts. During fanning-out, bundle operation manager 240 creates new subregions within bundles, establishes tentative connections to unexplored manifold areas, and maintains structural stability while allowing for creative expansion. Rebinding operations represent the most sophisticated transformation, occurring when multiple bundles exhibit sufficient semantic overlap or functional similarity to warrant integration into higher-order structures. Bundle operation manager 240 performs rebinding by identifying intersection regions between bundles, computing optimal merge strategies that preserve essential structure, creating meta-bundles that abstract common patterns, and updating the global manifold topology to reflect new conceptual hierarchies.

These components work in concert to create a living geometric space where cognition unfolds as structured motion rather than discrete computation. Thought bundles 200 provide persistent semantic anchors, compression pressure field 210 and goal potential field 220 create a dynamic energy landscape, attention vector field 230 enables fluid cognitive flow, the geodesic trajectory calculator 250 determines optimal reasoning paths, thought value calculator 260 maintains cognitive efficiency, and bundle operation manager 240 ensures the manifold evolves to support increasingly sophisticated reasoning. Together, they implement a form of geometric intelligence where memory shapes space, attention follows structure, and learning reshapes the very terrain of thought.

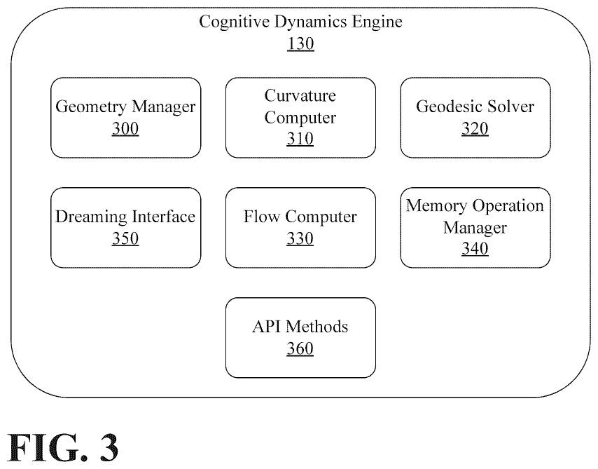

FIG. 3 is a block diagram illustrating an exemplary architecture of a component within a persistent cognitive machine (PCM), a Cognitive Dynamics Engine (CDE). Operating as a specialized geometry processor analogous to a physics engine in simulation environments, CDE 130 manages the continuous shaping, traversal, and optimization of the cognitive manifold through coordinated geometric operations. This engine transforms the abstract principles of differential geometry and dynamical systems into practical computational mechanisms that enable persistent, adaptive cognition through structured space.

A geometry manager 300 serves as the component responsible for maintaining and evolving the manifold's geometric structure. Geometry manager 300 continuously tracks and updates the Riemannian metric tensor across all regions of the latent manifold, defining how distances, angles, and volumes are measured within the cognitive space. The metric is not static but evolves dynamically based on cognitive activity, with frequently traversed regions experiencing metric contraction that brings related concepts closer together, while unexplored areas maintain broader metric spacing that allows for flexible exploration. Geometry manager 300 also maintains the connection, which governs how vectors and tensors are parallel transported across the curved manifold. This connection evolves through use, with repeated attention trajectories establishing preferred directions of parallel transport that become the “natural” ways to move between concepts. For example, if reasoning paths frequently connect concepts from physics to machine learning applications, geometry manager 300 adjusts the connection to make these transitions smoother and more efficient. Geometry manager 300 implements algorithms for metric learning from trajectory data, using transition frequencies, co-activation patterns, and semantic alignment to continuously refine the geometric structure. It also manages coordinate transformations between different local charts of the manifold, ensuring smooth transitions as attention moves between semantic regions.

A curvature computer 310 calculates the various curvature tensors that characterize the manifold's local and global geometric properties. Curvature computer 310 computes a Riemann curvature tensor, which fully describes how the manifold deviates from flat Euclidean space. From this fundamental tensor, curvature computer 310 derives the Ricci tensor and the Ricci scalar, which measure how volumes contract or expand under geodesic flow. For cognitive dynamics, it computes the compression pressure field P(x)=−R(x), transforming geometric curvature into a cognitive cost function that governs attention flow. Curvature computer 310 employs multiple estimation strategies to handle the computational complexity of exact curvature calculation in high dimensions. These include geodesic deviation methods that track how nearby attention paths converge or diverge over time, Jacobian-based approximations using learned transition functions between manifold regions, and sampling techniques that estimate curvature from the statistical properties of local trajectory bundles. The component maintains a continuously updated curvature map across the manifold, identifying high-curvature regions where semantic compression has created dense knowledge structures, saddle points where conceptual boundaries meet, and flat regions suitable for creative exploration or interpolation.

A geodesic solver 320 computes optimal paths through the manifold by solving the fundamental equation of cognitive motion. Given an initial state and a goal configuration, it determines the trajectory that minimizes the cognitive action function. This variational problem balances three competing factors: the kinetic energy that penalizes rapid changes in attention, the compression pressure that increases cost in semantically dense regions, and the goal potential that provides attractive forces toward relevant areas. Geodesic solver 320 implements sophisticated numerical methods adapted for manifold computation, including Riemannian gradient descent that respects the manifold's metric structure, shooting methods that propagate initial velocities forward while satisfying boundary conditions, and relaxation techniques that iteratively refine approximate paths toward true geodesics. The solver must handle multiple challenging scenarios such as non-convex optimization landscapes with multiple local minima, regions of high curvature where standard methods become unstable, and multi-goal situations requiring Pareto-optimal path selection. For instance, when solving a complex reasoning task that requires connecting disparate concepts, geodesic solver 320 might identify several viable paths: a direct route through high-pressure theoretical abstractions, a longer but clearer path through concrete examples, or an innovative trajectory that discovers unexpected connections through analogical reasoning.

A flow computer 330 models attention as a continuous vector field evolving over the manifold according to geometric dynamics. Rather than treating attention as discrete selections or weights, this component implements a partial differential equation, where attention behaves as a cognitive fluid flowing through shaped space. The flow computer 330 discretizes this equation using finite element methods adapted for manifolds, handling the complexities of curved space while maintaining numerical stability. It tracks how attention propagates through the manifold, creating flow patterns that include laminar streams along well-established reasoning paths, bifurcations where attention splits between competing hypotheses, convergence zones where multiple reasoning lines reach similar conclusions, and turbulent regions indicating cognitive uncertainty or conflicting goals. The component also computes derived quantities such as the divergence indicating where attention is focusing or dispersing, the curl revealing rotational patterns in thought, and flow stability metrics that identify robust versus fragile reasoning patterns. Flow computer 330 enables the system to maintain multiple concurrent attention streams, supporting parallel reasoning processes that can later merge or inform each other.

A memory operation manager 340 orchestrates structural modifications to thought bundles and manifold topology based on cognitive activity and optimization criteria. This component implements the three fundamental bundle operations that reshape semantic space. During fanning-in operations, it identifies loosely associated thoughts that show increasing co-activation and guides their consolidation into tighter bundle structures, adjusting local metrics to strengthen their mutual attraction, updating bundle boundaries to encompass new members, and recalculating internal bundle geometry to maintain efficient navigation. Fanning-out operations are triggered when existing bundles need to expand into new semantic territory, with memory operation manager 340 creating new submanifold regions, establishing tentative connections to unexplored areas, and maintaining structural stability during expansion. Rebinding operations occur when the manager detects sufficient overlap or functional similarity between bundles to warrant higher-order integration, executing merge algorithms that preserve essential structure while creating new abstractions. Memory operation manager 340 also handles subspace alignment for federated learning scenarios, enabling knowledge transfer between different PCM instances while respecting privacy boundaries.

A dreaming interface 350 provides the connection point between CDE 130 and dream manager 140, enabling autonomous manifold reorganization during off-task periods. This interface exposes methods for initiating various dreaming operations including targeted perturbation of specific manifold regions, global relaxation processes that smooth unnecessary complexity, and exploratory synthesis of new conceptual connections. Dreaming interface 350 manages the transition between active cognition and dreaming states, ensuring that ongoing reasoning processes reach stable states before reorganization begins, that critical structures are preserved during transformation, and that the manifold returns to a coherent state before resuming active operation. During dreaming phases, the interface coordinates bundle recombination algorithms that discover emergent abstractions, topology modification procedures that create new conceptual bridges, and compression operations that consolidate redundant structures. It monitors dreaming progress through geometric health metrics, ensuring that reorganization improves rather than disrupts cognitive capability.

An API methods 360 component provides a clean programmatic interface for external modules to interact with the CDE's geometric capabilities. API methods may include accepting a goal embedding and current state to return an optimal geodesic path, leveraging the geodesic solver while accounting for current manifold conditions. Updating reinforces the manifold along a recently traversed path, strengthening the metric connections and potentially triggering bundle formation. Querying a bundle identifies the nearest thought bundle to a given manifold point, using both geometric proximity and semantic alignment. Dreaming initiates autonomous reorganization procedures through the dreaming interface. Getting pressure returns the compression pressure at any point, enabling other components to make informed decisions about traversal costs. Getting a goal field constructs a potential field for a given goal configuration, coordinating with the goal manager to shape attention flow. These methods abstract away the complex geometric computations while providing powerful primitives for cognitive operations. API methods 360 also handles request queuing, resource management, and error handling to ensure robust operation under varying computational loads.

Together, these components within cognitive dynamics engine 130 create a geometric substrate for persistent cognition. Geometry manager 300 maintains the foundational structure, curvature computer 310 derives the pressure landscape that guides efficient reasoning, geodesic solver 320 finds optimal paths through semantic space, flow computer 330 enables fluid attention dynamics, memory operation manager 340 evolves the manifold through use, dreaming interface 350 enables autonomous optimization, and API methods 360 provide clean access to these capabilities. This architecture transforms the principles of geometric cognition into a practical computational system where thought truly becomes motion through shaped space, memory becomes curvature, and learning becomes the evolution of geometry itself.

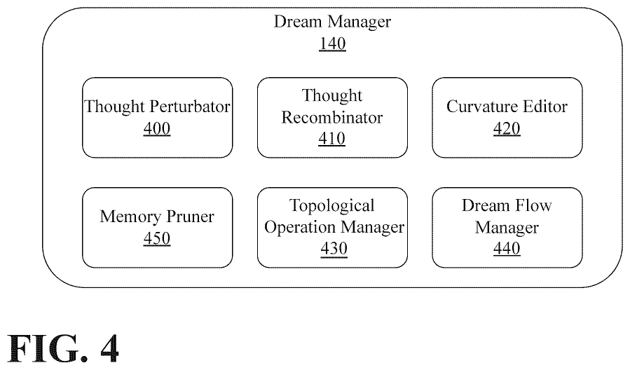

FIG. 4 is a block diagram illustrating an exemplary architecture of a component within a persistent cognitive machine (PCM), a dream manager. Operating analogously to sleep-driven memory consolidation in biological systems, dream manager 140 performs essential geometric maintenance and optimization that enables the PCM to develop increasingly efficient and generalized cognitive structures without requiring explicit retraining or parameter updates. This component transforms the theoretical concept of manifold evolution into practical computational processes that reshape the space of thought based on accumulated experience and structural patterns.

A thought perturbator 400 implements the initial phase of the dreaming process by introducing controlled stochastic variations into existing thought structures. This component samples thought bundles from the manifold based on multiple selection criteria including recent activation frequency, structural importance within the manifold topology, proximity to high-pressure regions indicating potential for compression, and participation in successful reasoning trajectories. Once bundles are selected, thought perturbator 400 applies carefully calibrated perturbations based on factors including but not limited to noise drawn from a distribution that reflects local geometric properties. The covariance structure of this noise is not arbitrary but derived from the local metric tensor and curvature, ensuring that perturbations respect the manifold's geometry while exploring meaningful variations. In regions of high curvature, perturbations are smaller and more constrained, testing the stability of compressed semantic structures, while in flatter regions, larger perturbations explore potential new connections and generalizations. Thought perturbator 400 implements multiple perturbation strategies including gradient-based exploration that follows directions of increasing semantic variance, curvature-aware sampling that concentrates perturbations along principal geodesic directions, and adversarial perturbations that test the robustness of thought structures against semantic drift. These perturbations serve as probes into the local geometry, revealing opportunities for consolidation, identifying unstable structures that may need reinforcement, and discovering latent connections between seemingly disparate concepts.

A thought recombinator 410 takes perturbed thoughts and synthesizes new conceptual structures through sophisticated interpolation and integration algorithms. This component implements the mathematical operation where the weights are determined through multiple mechanisms including but not limited to semantic alignment scores between perturbed thoughts, historical co-activation patterns, goal-relevance metrics, and geometric compatibility measures. Thought recombinator 410 goes beyond simple linear interpolation, employing manifold-aware combination strategies that respect the curved geometry of the latent space. When combining thoughts from different bundles, it computes geodesic interpolations that follow the natural curvature of the manifold, ensuring that intermediate points remain semantically meaningful. The component implements hierarchical recombination, first identifying small groups of highly compatible thoughts for initial fusion, then progressively combining these into larger meta-structures. During recombination, it monitors several quality metrics including semantic coherence measured through local manifold smoothness, compression potential indicating whether the combination reduces overall complexity, and generalization capacity assessing whether the new structure captures broader patterns. For example, when recombining thoughts about “gradient descent” from a machine learning bundle with thoughts about “energy minimization” from a physics bundle, thought recombinator 410 might discover a meta-concept about “optimization in curved spaces” that provides a unified framework applicable across domains.

A curvature editor 420 performs targeted modifications to the manifold's geometric structure based on insights gained from perturbation and recombination. This component has the capability to increase local curvature in regions where semantic compression is beneficial, creating tighter conceptual clusters that enable more efficient reasoning. It can also decrease curvature in areas that have become overly rigid, restoring flexibility for creative thinking and novel connections. Curvature editor 420 implements several curvature modification operations including but not limited to bundle merging procedures that identify overlapping thought structures with high mutual information and smoothly blend their geometric neighborhoods, creating unified regions with consistent curvature properties. It performs curvature diffusion operations that spread high-pressure regions more evenly, preventing the formation of semantic bottlenecks that could impede reasoning. Curvature editor 420 may also implement curvature sharpening around stable conceptual cores, reinforcing well-established knowledge while maintaining softer boundaries for evolving concepts. When editing curvature, the component must maintain global geometric consistency, ensuring that local modifications don't create inconsistencies or singularities elsewhere in the manifold. In one embodiment it may employ Ricci flow-inspired algorithms that naturally evolve curvature toward optimal configurations, balancing local semantic density with global navigability.

A topological operation manager 430 handles the most profound structural modifications to the manifold, including changes that alter its fundamental connectivity. This component can create new topological features such as handles or bridges between previously disconnected regions, enabling novel reasoning pathways that weren't possible in the original manifold structure. When thought recombinator 410 discovers stable interpolations between distant bundles, topological operation manager 430 evaluates whether to establish permanent connections. It implements sophisticated surgery operations that can split overly complex regions into simpler components, merge adjacent regions that have developed sufficient similarity, or create higher-genus structures that enable multiply-connected reasoning paths. Topological operation manager 430 performs topological analysis to identify features such as holes in the manifold representing conceptual gaps, bottlenecks where all reasoning must pass through constrained regions, and islands of isolated knowledge that could benefit from connection. For instance, if the system has separately developed expertise in “visual pattern recognition” and “time series analysis,” topological operation manager 430 might identify an opportunity to create a bridge through “spatiotemporal pattern analysis,” fundamentally expanding the system's reasoning capabilities. All topological modifications are carefully validated to ensure they preserve essential semantic relationships while enabling new forms of inference.

A dream flow manager 440 orchestrates the overall flow of dreaming operations, coordinating the activities of other components to ensure coherent and beneficial manifold evolution. This component implements three primary flow types that govern how dreaming unfolds. The perturbation flow controls how stochastic exploration propagates through the manifold, managing the selection of regions for perturbation, the intensity and direction of noise injection, and the propagation of discoveries to related areas. The compression flow guides the consolidation of redundant or inefficient structures, identifying opportunities for semantic compression, orchestrating the merger of similar concepts, and ensuring that compression preserves essential distinctions. The generalization flow promotes the discovery and reinforcement of abstract patterns, guiding recombination toward higher-order structures, identifying successful generalizations for preservation, and propagating useful abstractions throughout the manifold. Dream flow manager 440 monitors the overall health of the dreaming process through metrics such as semantic coherence, structural stability, and compression efficiency. It implements adaptive control mechanisms that adjust flow parameters based on the current state of the manifold and the outcomes of recent modifications, ensuring that dreaming remains beneficial rather than disruptive.

A memory pruner 450 performs essential cleanup operations that prevent the manifold from becoming cluttered with obsolete or redundant structures. This component implements sophisticated forgetting mechanisms that go beyond simple deletion, carefully removing structures while preserving the integrity of surrounding geometry. It identifies candidates for pruning based on multiple criteria including thermodynamic decay where thoughts with consistently low activation energy are marked for removal, structural redundancy where nearly identical thought patterns exist in multiple locations, and semantic incoherence where thoughts no longer maintain meaningful connections to the broader manifold. Memory pruner 450 implements gradual pruning processes that slowly dissolve unwanted structures rather than creating abrupt deletions that could destabilize nearby regions. During pruning, it redistributes the “semantic mass” of removed thoughts to related structures, ensuring that useful aspects are preserved even as redundant representations are eliminated. The component also performs defragmentation operations that consolidate sparse regions and tighten the overall manifold structure. For example, after extended operation, the system might accumulate multiple slightly different representations of similar concepts acquired in different contexts. Memory pruner 450 identifies these redundancies and carefully merges them into single, more robust representations while preserving the unique aspects that provide contextual flexibility.

These components within dream manager 140 implement a process of autonomous cognitive evolution. Thought perturbator 400 explores the stability and potential of existing structures, thought recombinator 410 synthesizes new abstractions and connections, curvature editor 420 optimizes the geometric landscape, topological operation manager 430 enables fundamental structural innovations, dream flow manager 440 orchestrates coherent evolution, and memory pruner 450 maintains cognitive efficiency. This architecture enables the PCM to continuously improve its internal representations without external supervision, developing increasingly sophisticated reasoning capabilities through the natural evolution of its geometric substrate. The dreaming process transforms accumulated experience into structural wisdom, creating a manifold that not only stores knowledge but embodies understanding in its very geometry.

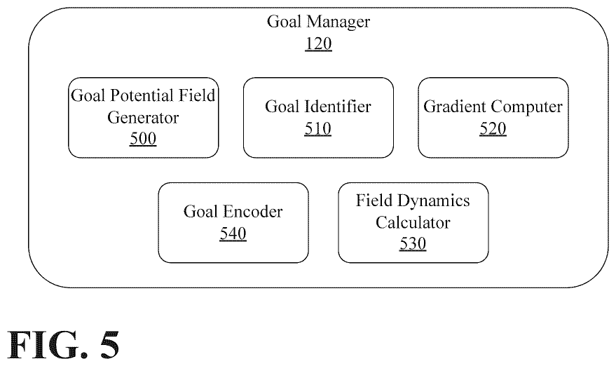

FIG. 5 is a block diagram illustrating an exemplary architecture of a component within a persistent cognitive machine (PCM), a goal manager. Unlike traditional goal-directed systems that implement objectives as discrete targets or symbolic constraints, goal manager 120 generates continuous scalar fields that attract attention and guide reasoning through geometric influence. This component transforms abstract intentions, user queries, and system objectives into structured force fields that interact with the manifold's compression landscape to create rich cognitive dynamics.

A goal identifier 510 serves as the initial processing stage that recognizes, categorizes, and prioritizes various goal sources entering the system. Goal identifier 510 processes inputs from multiple channels including explicit user queries that directly state objectives or ask questions, implicit user patterns derived from interaction history and preferences, system-generated goals arising from internal drives such as uncertainty reduction or consistency maintenance, and task constraints imposed by external requirements or operational parameters. Goal identifier 510 implements parsing algorithms that go beyond keyword extraction to understand the semantic intent behind goals. When processing a user query such as “How can we apply quantum computing principles to optimize machine learning algorithms?,” the component identifies multiple nested goals: understanding quantum computing principles, comprehending optimization in machine learning, finding intersection points between these domains, and generating practical applications. Goal identifier 510 also performs goal decomposition, breaking complex objectives into hierarchical subgoals that can be pursued in parallel or sequence. It maintains a goal registry that tracks active objectives, their priorities, interdependencies, and completion states. The component implements conflict detection mechanisms that identify when multiple goals may be contradictory or competing for the same cognitive resources, flagging these for special handling by other components. For long-term interactions, goal identifier 510 maintains persistent goal structures that evolve across sessions, enabling the system to pursue complex objectives that require extended reasoning or multiple interaction cycles.

A goal encoder 540 transforms identified goals from their raw representational form into geometric structures compatible with the manifold's architecture. This encoding process goes beyond simple embedding, creating rich geometric objects that can effectively influence manifold dynamics. Goal encoder 540 implements multiple encoding strategies tailored to different goal types. For similarity-based goals, it computes embedding vectors and defines potential fields, creating gradients that attract attention toward semantically similar regions. For constraint-based goals, it generates potential fields with low values in prohibited regions and high values in acceptable areas, effectively creating barriers and channels that guide reasoning. Goal encoder 540 also implements contrastive encoding for goals that require distinguishing between concepts, creating potential fields with opposing gradients that push attention away from certain regions while pulling toward others. For complex multi-faceted goals, goal encoder 540 generates composite fields that superimpose multiple potential patterns, creating rich landscapes with multiple attractors, saddle points, and gradient flows. The encoding process considers the current state of the manifold, adapting the potential field to work effectively with existing compression patterns and thought structures. For instance, when encoding a goal related to creative problem-solving, the component might generate a potential field with multiple local maxima in different semantic regions, encouraging exploration of diverse solution approaches rather than convergence on a single path.

A goal potential field generator 500 takes encoded goals and constructs the complete scalar field across the entire manifold. This component implements field generation algorithms that create smooth, differentiable potential landscapes while respecting the manifold's geometric constraints. The generator computes field values at each point by considering multiple factors including semantic distance from goal representations, alignment with goal constraints and requirements, historical success rates for similar goals in nearby regions, and interaction effects between multiple concurrent goals. Goal potential field generator 500 employs kernel methods to create smooth field variations, preventing discontinuities that could destabilize attention flow. It implements field normalization procedures to ensure that potential values remain within reasonable ranges across the manifold, preventing any single goal from completely dominating cognitive dynamics. Goal potential field generator 500 also generates time-varying fields for goals that evolve during reasoning, smoothly interpolating between different field configurations to maintain continuity. For hierarchical goals, it creates nested potential structures where achieving subgoals creates local maxima within the broader landscape of the primary objective. The generator must balance field strength to create sufficient attractive force without overwhelming the natural dynamics of compression and manifold structure. For example, when generating a field for a goal requiring innovative connections between disparate concepts, the component might create a potential landscape with a valley between the concepts that gradually rises, encouraging exploration of the intermediate space where novel connections might emerge.

A gradient computer 520 calculates the vector field that determines the direction and magnitude of goal-induced forces at each point in the manifold. This component implements efficient algorithms for computing gradients in curved space, accounting for the manifold's metric structure to ensure that gradients represent true geometric directions rather than naive coordinate derivatives. Gradient computer 520 employs multiple computational strategies including finite difference methods adapted for manifolds, automatic differentiation through the field generation process, and analytical gradients for simple field configurations. It computes not only first-order gradients but also higher-order derivatives such as the Hessian, which indicates the local curvature of the potential field and helps identify critical points such as maxima, minima, and saddle points. The component maintains a continuously updated gradient map across frequently accessed regions of the manifold, enabling rapid attention flow calculations without repeated gradient computation. For regions of high curvature or complex metric structure, gradient computer 520 implements adaptive sampling strategies that ensure accurate gradient estimation despite geometric complications. It also computes gradient statistics such as divergence and curl, providing insights into the global flow patterns induced by the goal field. These computations enable analyses of goal dynamics, identifying convergence regions where attention naturally flows, circulation patterns that might indicate conceptual loops, and divergence zones where exploratory behavior is encouraged.

A field dynamics calculator 530 analyzes and predicts the complex behaviors that emerge from the interaction between goal potential fields and the manifold's other forces. This component simulates how attention will flow under the combined influence of goal attraction, compression resistance, and the inherent dynamics of the attention field itself. Field dynamics calculator 530 implements several analytical capabilities including trajectory prediction that estimates likely attention paths given current conditions, stability analysis that identifies whether goal configurations will lead to stable focus or oscillatory behavior, and bifurcation detection that recognizes when small changes in goals might lead to dramatically different cognitive outcomes. The component models various emergent phenomena such as gradient following where attention flows smoothly up potential gradients toward goal regions, tunneling effects where strong goal potentials can overcome high compression barriers, and competitive dynamics where multiple goals create complex flow patterns with unpredictable outcomes. For multi-goal scenarios, field dynamics calculator 530 computes Pareto frontiers that identify optimal trade-offs between competing objectives, helping the system navigate complex decision spaces. It also analyzes temporal dynamics, predicting how goal influences will evolve as the manifold structure changes through use and learning. The component can identify potential failure modes such as local maxima that might trap attention before reaching true goals, unstable equilibria where small perturbations cause large behavioral changes, and chaotic regions where goal interactions create unpredictable dynamics. For instance, when analyzing goals that require balancing exploration with exploitation, field dynamics calculator 530 might identify parameter regimes where the system naturally alternates between focused pursuit and broad exploration, optimizing long-term learning and performance.

The components within goal manager 120 create a system for translating abstract objectives into concrete geometric influences that shape cognitive behavior. Goal identifier 510 recognizes and structures incoming objectives, goal encoder 540 transforms them into geometric representations, goal potential field generator 500 creates smooth scalar fields across the manifold, gradient computer 520 determines the resulting force fields, and field dynamics calculator 530 predicts and analyzes the emergent behaviors. This architecture enables the PCM to pursue complex goals not through rigid programming or symbolic planning, but through the natural dynamics of attention flowing through shaped space. Goals become not commands to be executed but influences that guide the fluid motion of thought, creating a form of intentionality that emerges from geometry rather than being imposed upon it. Goal manager 120 thus provides the motivational landscape that, combined with the manifold's memory structure and compression dynamics, enables purposeful yet flexible cognitive behavior that can adapt, learn, and discover unexpected solutions through the natural evolution of geometric attention.

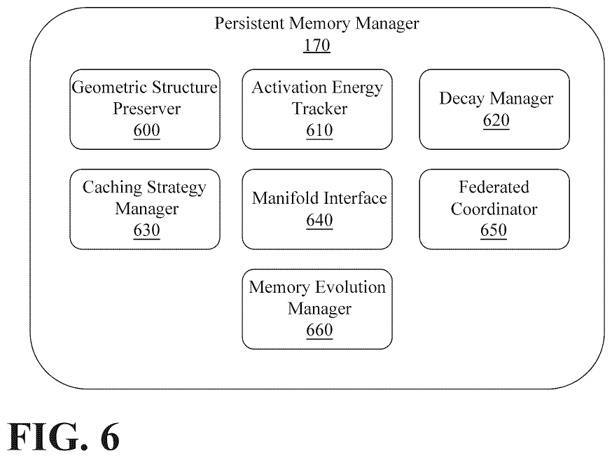

FIG. 6 is a block diagram illustrating an exemplary architecture of a component within a persistent cognitive machine (PCM), a persistent memory manager. Unlike traditional memory systems that store static data in hierarchical caches, persistent memory manager 170 implements an approach where memory exists as living geometric structures within the latent manifold, subject to natural evolution through usage patterns and energy dissipation. This component serves as the bridge between the dynamic latent manifold and long-term cognitive persistence, ensuring that thoughts—discrete units of reasoning or analysis generated during processing—are preserved not as isolated data points but as interconnected geometric structures with semantic relationships intact.

A geometric structure preserver 600 maintains the fundamental geometric integrity of stored thoughts and their relationships within the thought cache, a structured memory layer configured to store and retrieve thoughts based on semantic similarity, contextual alignment, and system policy. This component preserves thought bundles as compact submanifolds, maintaining their internal metric structure, boundary conditions, and topological relationships to neighboring bundles. When thoughts are cached, geometric structure preserver 600 ensures that not only the content but also the geometric context is maintained, including the local curvature patterns that indicate semantic density, the geodesic paths that connect related concepts, and the metric tensor values that define distances within thought neighborhoods. For instance, when storing a complex reasoning chain about quantum computing applications, the component preserves not just the individual thoughts but their geometric arrangement as a coherent bundle, maintaining the curved paths that connect foundational physics concepts to practical implementations. Geometric structure preserver 600 implements sophisticated algorithms to handle the challenges of preserving dynamic geometric structures, including maintaining consistency as the manifold evolves, handling coordinate transformations between different chart representations, and ensuring that preserved structures remain compatible with the current manifold geometry when retrieved later.

An activation energy tracker 610 implements the thermodynamic model of memory persistence by assigning and monitoring activation energies to each cached thought and thought structure. Activation energy tracker 610 goes beyond simple access counting, implementing a energy model where thoughts gain energy through various forms of cognitive engagement including direct retrieval for query processing, traversal along geodesic paths that pass near the thought, participation in successful reasoning chains, and reinforcement through goal achievement. Activation energy tracker 610 maintains a continuous energy landscape across all cached structures, tracking not just individual thought energies but also the energy distributions within thought bundles and along frequently traversed paths. Energy updates follow the principle that thoughts contributing to successful cognitive outcomes receive energy boosts, while those that remain unused gradually dissipate energy according to the thermodynamic decay equation. The tracker also implements energy inheritance mechanisms where new thoughts created through generalization—the process of synthesizing new thoughts from cached thoughts by identifying shared structure—inherit appropriate energy levels from their parent thoughts, ensuring that valuable abstractions maintain sufficient activation to persist.

A decay manager 620 implements the natural forgetting mechanism through thermodynamic principles, executing a decay equation. This component continuously monitors thought energies and initiates pruning operations when falls below the threshold, ensuring that the thought cache maintains efficiency by naturally eliminating obsolete or redundant information. Decay manager 620 implements pruning strategies that go beyond simple deletion, including gradual energy dissipation that allows thoughts to fade naturally rather than disappearing abruptly, redistribution of semantic content from decaying thoughts to related structures that remain active, and preservation of structural integrity by carefully removing thoughts without creating discontinuities in the manifold. Decay manager 1320 may also implement contextual decay modulation where decay rates adjust based on factors such as the semantic uniqueness of a thought, its role in connecting otherwise disparate concepts, and its participation in rarely accessed but critically important knowledge. For example, foundational mathematical concepts might decay more slowly than specific computational examples, preserving essential knowledge infrastructure while allowing detailed instances to fade when no longer needed.

A manifold interface 640 provides the bidirectional connection between persistent memory manager 170 and the latent manifold, enabling seamless flow of geometric structures in both directions. This interface implements protocols for reading geometric structures from memory into the active manifold, including reconstruction of thought bundles with their full geometric context, restoration of geodesic paths and their associated curvature patterns, and integration of retrieved structures with the current manifold state. When writing updates back to memory, manifold interface 640 captures not just the modified thoughts but the entire geometric context of their evolution, preserving information about new connections formed during reasoning, changes in local curvature due to compression or expansion, and trajectory patterns that indicate successful reasoning strategies. Manifold interface 640 maintains synchronization between the persistent memory structures and the dynamic manifold state, handling challenges such as version conflicts when the manifold has evolved since a thought was cached, geometric inconsistencies that arise from independent evolution of different regions, and efficient incremental updates that avoid rewriting entire structures for small changes.

A caching strategy manager 630 implements intelligent policies for determining which thoughts and structures to preserve in the various tiers of the thought cache, including session caches for short-term interaction, long-term caches for persistent knowledge, and shared or federated caches across devices or agents. Unlike traditional caching strategies based on recency or frequency alone, this component implements geometric and semantic criteria for cache management. Cached thoughts are indexed in latent space using sophisticated methods that preserve geometric relationships, enabling retrieval using vector similarity, trajectory proximity, or geodesic alignment. Caching strategy manager 630 implements compression strategies where cached thoughts may be compressed or abstracted over time to reduce redundancy and support scalable reuse. It determines optimal compression levels by balancing storage efficiency with retrieval fidelity, identifies opportunities for thought generalization where multiple similar thoughts can be replaced by a single abstraction, and manages the distribution of thoughts across cache tiers based on access patterns and semantic importance. The component also implements predictive caching strategies that anticipate future needs based on observed cognitive patterns and preemptively adjust cache contents to optimize for expected usage.

A federated coordinator 650 enables knowledge sharing and synchronization across multiple PCM instances while maintaining privacy and semantic integrity. Federated coordinator 1350 implements geometric abstraction protocols that allow thoughts to be shared at appropriate levels of generalization, ensuring that instance-specific details remain private while valuable patterns propagate across the federation. Federated coordinator 650 manages the complex challenges of cross-instance memory coordination including aligning geometric structures from different manifolds that may have evolved independently, determining appropriate abstraction levels for shared thoughts to balance utility with privacy, and handling conflicts when different instances have developed incompatible representations of similar concepts. Federated coordinator 650 implements consensus mechanisms that respect local geometric structures while enabling global knowledge emergence, using techniques such as curvature matching to identify compatible regions across manifolds, bundle projection to map local structures into shared space, and distributed evolution protocols that allow federated improvements to propagate back to local instances.

A memory evolution manager 660 orchestrates the various mechanisms through which persistent memory structures adapt and improve over time. Memory evolution manager 660 implements a plurality of evolution mechanisms that shape the long-term development of the memory system. Reinforcement operations strengthen frequently used thoughts and paths by increasing local curvature around valuable structures, tightening geodesic connections between related concepts, and enhancing the stability of successful reasoning patterns. Compression operations identify and merge redundant or highly similar structures, implementing the latent recombinator functionality to blend similar thoughts or trajectories into unified abstractions while preserving essential distinctions. Abstraction operations extract higher-level patterns from collections of specific instances, creating generalized thoughts that capture core principles while enabling broader application across contexts. Forgetting operations, coordinated with decay manager 620, ensure that memory evolution includes not just growth but also selective pruning that maintains system efficiency and relevance. Memory evolution manager 660 implements these operations according to sophisticated scheduling algorithms that balance immediate system needs with long-term optimization goals, ensuring that memory evolution enhances rather than disrupts ongoing cognitive operations.

The components create a persistent memory system that transcends traditional storage paradigms. Geometric structure preserver 600 maintains the rich relationships between thoughts, activation energy tracker 610 and decay manager 620 implement natural memory dynamics, manifold interface 640 enables integration with active cognition, the caching strategy manager 630 optimizes for both efficiency and semantic value, federated coordinator 650 enables collective intelligence while preserving privacy, and memory evolution manager 660 ensures continuous improvement through use. This architecture implements structured memory where thoughts are stored not as flat vectors but as positions or paths within an evolving manifold, supporting context-sensitive access, memory reinforcement through traversal, lawful pruning, and dynamic generalization. The result is a memory system that doesn't merely store information but actively participates in the cognitive process, shaping and being shaped by the ongoing evolution of thought within the geometric substrate of the persistent cognitive machine.

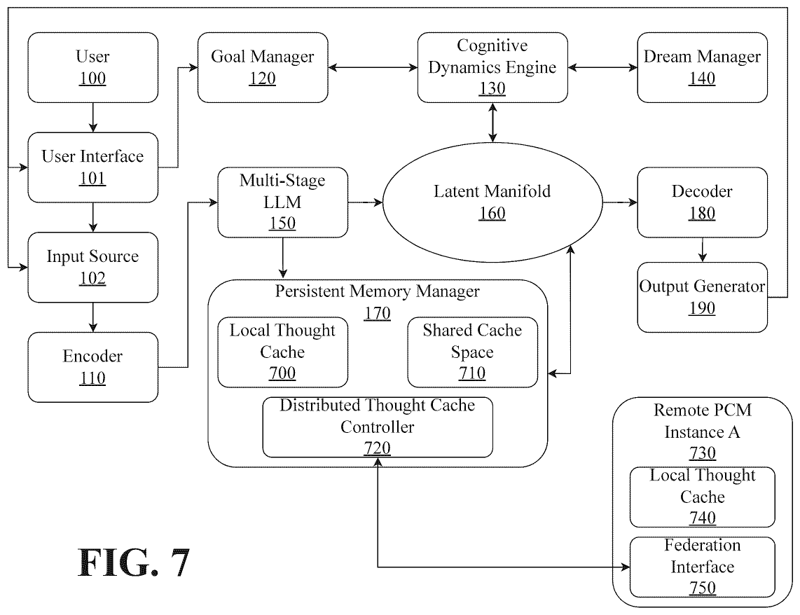

FIG. 7 is a block diagram illustrating an exemplary system architecture of a persistent cognitive machine (PCM) enhanced with a distributed thought cache infrastructure. The distributed thought cache architecture fundamentally transforms how the PCM manages and accesses cognitive memories by implementing a multi-tiered caching system that operates on geometric principles rather than traditional key-value storage, enabling logarithmic scaling of memory requirements even under continuous operation across federated instances.

A persistent memory manager 170 serves as an orchestrator for the distributed thought cache system, implementing geometric preservation and thermodynamic management of cached thoughts across multiple storage tiers. Unlike traditional memory systems that store static data in hierarchical caches, persistent memory manager 170 implements an approach where memory exists as living geometric structures within the latent manifold, subject to natural evolution through usage patterns and energy dissipation. The manager coordinates between a local thought cache 700 and a shared cache space 710, implementing intelligent policies for determining which thoughts and structures to preserve based on geometric and semantic criteria rather than simple recency or frequency metrics. Persistent memory manager 170 maintains connections with the latent manifold 160, enabling flow of geometric structures in both directions through protocols for reading geometric structures from memory into the active manifold and writing updates back to memory that capture not just modified thoughts but the entire geometric context of their evolution.

Local thought cache 700 represents a first tier of the distributed caching system, storing frequently accessed geometric structures specific to this PCM instance in their full geometric fidelity. Local cache 700 maintains thought trajectories as compressed latent representations that preserve not just content but the complete geometric context including local curvature patterns indicating semantic density, geodesic paths connecting related concepts, metric tensor values defining distances within thought neighborhoods, and activation energies that govern thermodynamic decay. When multi-stage LLM 150 receives an input that has been encoded by encoder 110, it first queries local thought cache 700 through geometric similarity measures that go beyond simple vector similarity to evaluate semantic alignment within the curved space of the manifold. These geometric similarity measures account for manifold curvature, considering not just Euclidean distances but geodesic proximity that respects the semantic topology of the space. For example, when processing a query about quantum computing applications, local thought cache 700 might contain previously computed trajectories through the manifold that connect foundational physics concepts to practical implementations, enabling rapid response generation without requiring full geodesic path computation through latent manifold 160.

Shared cache space 710 implements a second tier of caching that contains generalized thoughts suitable for sharing across multiple PCM instances while maintaining privacy through geometric abstraction. Unlike local thought cache 700 which stores instance-specific trajectories with full geometric detail, shared cache space 710 contains thoughts that have undergone progressive generalization through the process of synthesizing new thoughts from cached thoughts by identifying shared structure, meaning, or trajectory. This generalization process employs a latent recombinator functionality to merge semantically adjacent cached thoughts into higher-order templates through geometric consolidation, where nearby thoughts are averaged or abstracted into forms that preserve essential patterns while removing instance-specific details. Shared cache space 710 implements compression strategies where cached thoughts may be compressed or abstracted over time to reduce redundancy and support scalable reuse, determining optimal compression levels by balancing storage efficiency with retrieval fidelity. For instance, multiple PCM instances processing technical troubleshooting queries might independently develop similar reasoning trajectories for diagnosing equipment failures, and these trajectories can be generalized into shared templates that capture the diagnostic methodology without revealing specific equipment details or proprietary information.

A distributed thought cache controller 720 manages the coordination between local caching, shared caching, and cross-instance synchronization, implementing the cache hit/miss routing logic that determines when to serve requests from cache versus computing new trajectories. When a query arrives through user interface 101 and is processed by encoder 110, distributed thought cache controller 720 first attempts geometric matching against local thought cache 700 using geometric comparison techniques that evaluate both direct similarity to individual cached thoughts and alignment with thought bundles or trajectories. If the geometric matching fails to identify sufficiently relevant cached thoughts based on confidence thresholds that account for the quality of geometric matches, the specificity of the query, and the coverage of existing cached knowledge, distributed thought cache controller 720 routes the query to multi-stage LLM 150 for full computation. Distributed thought cache controller 720 implements predictive caching strategies that anticipate future needs based on observed cognitive patterns and preemptively adjust cache contents to optimize for expected usage, while also managing the thermodynamic decay process where thoughts with consistently low activation energy are marked for removal according to a decay equation.

A federation interface 750 on remote PCM instance A 730 enables privacy-preserving knowledge sharing and synchronization with the main PCM instance while maintaining semantic integrity across different manifold geometries. This interface implements geometric abstraction protocols that allow thoughts to be shared at appropriate levels of generalization, ensuring that instance-specific details remain private while valuable patterns propagate across the federation. Federation interface 750 employs curvature-compatible alignment functions that match geometric structures across instances while preventing reconstruction of detailed local information, using techniques such as differential privacy applied to manifold structures, homomorphic transformations that preserve reasoning capability while obscuring specific content, and selective geometric abstraction that shares patterns without revealing instances. When remote PCM instance A 730 develops a novel reasoning pattern in its local thought cache 740, federation interface 750 evaluates whether this pattern has sufficient generalization potential to benefit other instances, and if so, projects it into shared cache space 710 through bundle projection operations that map local structures into shared representational space while maintaining semantic relationships but abstracting instance-specific details.

The interaction between components creates a sophisticated caching ecosystem that enables remarkable scaling properties. As demonstrated in the scaling analysis, the number of distinct cached thoughts required to represent experiences grows logarithmically rather than linearly because new experiences are increasingly absorbed into existing attractor basins within the manifold. The cache hit rate exhibits logarithmic scaling over time according to, with tapering growth reflecting the saturation of core attractors. This scaling behavior is achieved through the continuous operation of geometric consolidation processes including local merging where nearby thoughts are averaged or abstracted into centroidal forms, trajectory folding where longer sequences of thoughts that traverse similar geodesics are compressed into unified trajectories, and cross-instance generalization where patterns discovered by individual PCM instances are abstracted and shared through the federation. For example, in a federated deployment across multiple industrial facilities, each PCM instance might initially develop its own local understanding of equipment behavior patterns, but over time these local insights consolidate into shared abstractions that benefit all instances while preserving facility-specific operational details in local caches.

The geometric matching algorithms employed by the distributed thought cache system represent a fundamental departure from traditional cache lookup mechanisms, implementing sophisticated comparison techniques that evaluate semantic alignment within the curved space of the manifold rather than simple key-value matching. When distributed thought cache controller 720 receives a query, it initiates a multi-stage matching process that begins with trajectory localization, projecting the query-encoded point onto the set of stored geodesics to identify candidate reentry points through a curvature-weighted projection operator. This operation identifies not just similar individual thoughts but plausible prior memory paths and locations along them from which semantic traversal can begin. The matching process evaluates multiple criteria including geodesic proximity measuring the minimal path length through the manifold between query and cached thoughts, semantic basin membership determining whether the query falls within the attraction region of existing thought bundles, trajectory compatibility assessing whether the query could naturally extend or branch from cached reasoning paths, and compression compatibility evaluating whether the query could be efficiently represented as a variation of cached patterns.

The privacy-preserving mechanisms implemented through federation interface 750 ensure that sensitive information remains protected while still enabling valuable knowledge sharing across instances. These mechanisms operate through geometric abstraction rather than traditional encryption, leveraging the natural information-theoretic properties of manifold projection to create abstractions that preserve reasoning patterns while obscuring specific details. When a thought trajectory from local thought cache 740 of remote PCM instance A 730 is selected for federation, it undergoes a series of transformations including dimensional reduction that projects high-dimensional instance-specific trajectories onto lower-dimensional shared subspaces, curvature smoothing that removes fine-grained geometric details while preserving overall trajectory shape, and semantic generalization that replaces specific concepts with broader categories while maintaining logical relationships. For instance, a detailed diagnostic trajectory for a specific pump model might be abstracted into a general troubleshooting pattern for rotating equipment, preserving the diagnostic methodology while removing proprietary specifications.

Federation interface 750 implements consensus mechanisms that respect local geometric structures while enabling global knowledge emergence, using techniques such as curvature matching to identify compatible regions across manifolds, bundle projection to map local structures into shared space, and distributed evolution protocols that allow federated improvements to propagate back to local instances.

Dream manager 140 plays a role in the distributed thought cache system by performing autonomous curation and optimization of cached structures during idle periods. During dreaming phases, dream manager 140 interfaces with distributed thought cache controller 720 to initiate background processes that improve cache efficiency and discover new generalizations. The dream manager 140 samples cached thoughts from both local thought cache 700 and shared cache space 710 based on multiple selection criteria including but not limited to recent activation frequency, structural importance within the manifold topology, proximity to high-pressure regions indicating potential for compression, and participation in successful reasoning trajectories. It then applies perturbations drawn from distributions that reflect local geometric properties, where the covariance structure of the noise is derived from the local metric tensor and curvature, ensuring that perturbations respect the manifold's geometry while exploring meaningful variations. Through this process, dream manager 140 identifies opportunities for cache optimization including merging redundant cached thoughts that have converged to similar geometric configurations, promoting frequently accessed local patterns to shared cache space 710 for federation, discovering novel connections between cached thoughts that enable new reasoning pathways, and pruning obsolete cached structures that no longer contribute to cognitive efficiency.

The integration of distributed thought cache with the cognitive dynamics engine (CDE) 130 enables geometric operations on cached thoughts that go beyond simple storage and retrieval. CDE 130 continuously monitors the geometric health of cached structures through its curvature computer, calculating compression pressure fields across cached thought bundles and identifying opportunities for structural optimization. When cached thoughts are retrieved and utilized in active reasoning, CDE 130 tracks their traversal patterns and updates their geometric properties accordingly, implementing the principle that memory is not static but shaped by use. This bidirectional interaction means that frequently accessed cached thoughts develop deeper attractor basins with increased local curvature, making future retrieval more efficient, while rarely accessed thoughts experience geometric diffusion that eventually leads to their removal through thermodynamic decay. CDE 130 also manages the evolution of cached structures through its memory operation manager, implementing fanning-in operations that consolidate related cached thoughts into tighter bundle structures, fanning-out operations that enable cached bundles to expand into new semantic territories, and rebinding operations that create higher-order cached abstractions from multiple related thoughts.

Multi-stage LLM 150 leverages the distributed thought cache to dramatically improve response generation efficiency while maintaining cognitive coherence. Rather than processing every query through complete inference, LLM 150 first attempts to construct responses by composing cached thought trajectories, using the geometric structures preserved in cache to maintain semantic continuity. When a cache hit occurs, LLM 150 doesn't simply retrieve and output the cached content but uses it as a geometric scaffold for response generation, potentially modifying the cached trajectory based on the specific query context while preserving its essential structure. This approach enables the system to achieve response times that improve over time as the cache becomes more comprehensive, especially in specialized domains after initial learning periods. LLM 150 also contributes to cache evolution by generating new thoughts that are evaluated for caching based on their geometric stability, semantic coherence, generalization potential, and alignment with existing cached structures.

Output generator 190 incorporates awareness of cache utilization in its response generation, potentially indicating to users when responses are based on well-established cached patterns versus novel reasoning. This transparency enables users to understand the confidence and grounding of system responses, with cached-based responses typically exhibiting higher consistency and reliability due to their foundation in repeatedly validated reasoning patterns. Output generator 190 can also surface information about the reasoning path taken, including which cached thoughts or trajectories contributed to the response, enabling a form of explainable AI where users can trace the geometric journey through cached knowledge that led to specific conclusions.

The overall distributed thought cache architecture enables the PCM to achieve cognitive efficiency through geometric principles. Unlike traditional caching systems that face linear growth in storage requirements, the PCM's geometric approach achieves logarithmic scaling through continuous compression and generalization. The system maintains responsiveness even after processing millions of interactions because new experiences are increasingly absorbed into existing geometric structures rather than requiring new storage. The federation capabilities enable collective intelligence where multiple PCM instances contribute to a shared understanding while maintaining individual specialization and privacy. This architecture represents a fundamental advance in cognitive system design, demonstrating that memory need not be a bottleneck but can instead become an accelerator of intelligence through proper geometric organization and distributed coordination. The distributed thought cache thus serves not merely as a performance optimization but as an integral component of the PCM's cognitive architecture, enabling persistent learning, efficient reasoning, and scalable intelligence through the principled application of geometric memory management.

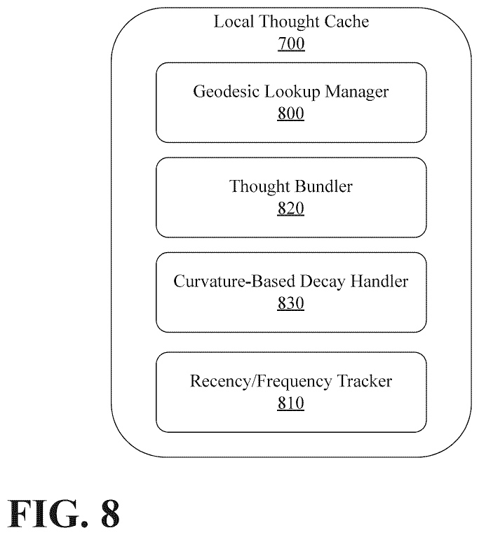

FIG. 8 is a block diagram illustrating an exemplary architecture of a local thought cache within the persistent cognitive machine's distributed thought cache system. Local thought cache 700 implements geometric storage and retrieval mechanisms that go beyond traditional key-value caching to maintain thoughts as living geometric structures with full semantic context, enabling rapid response generation through geodesic traversal rather than static lookup.

A geodesic lookup manager 800 serves as the primary retrieval mechanism within local thought cache 700, implementing geometric similarity matching that evaluates semantic alignment within the curved space of the latent manifold rather than simple vector distance calculations. When a query enters the cache system, geodesic lookup manager 800 performs trajectory localization by projecting the query-encoded point onto the set of cached geodesic paths, identifying not just similar individual thoughts but complete reasoning trajectories that could serve as scaffolds for response generation. This component maintains an indexed structure of cached thoughts organized by their positions within the manifold's geometry, using data structures optimized for high-dimensional curved space queries such as hierarchical navigable small world graphs adapted for Riemannian metrics. Geodesic lookup manager 800 evaluates multiple geometric criteria during retrieval including geodesic proximity measuring the minimal path length through the manifold between query and cached thoughts, basin membership determining whether the query falls within the attraction region of cached thought bundles, and trajectory compatibility assessing whether the query could naturally extend or branch from cached reasoning paths. For example, when processing a technical troubleshooting query, geodesic lookup manager 800 might identify multiple relevant cached trajectories that traverse similar problem spaces, ranking them by a combination of geometric proximity and semantic coherence to select the most appropriate cached knowledge for reuse.

A recency/frequency tracker 810 implements an activation energy model that maintains a thermodynamic view of cache contents. Each cached thought is assigned an activation energy that evolves according to both usage patterns and temporal decay, following the principle that frequently accessed thoughts maintain high activation energy while unused thoughts gradually dissipate energy according to the decay equation. Recency/frequency tracker 810 maintains not just access timestamps but complete usage histories that capture the context in which thoughts were activated, the success of reasoning paths that incorporated them, and their participation in cross-trajectory generalizations. This component implements energy inheritance mechanisms where new thoughts created through generalization inherit appropriate energy levels from their parent thoughts, ensuring that valuable abstractions maintain sufficient activation to persist in cache. The tracker also monitors energy distributions across the cache to identify thoughts at risk of decay, potentially flagging them for reinforcement through the dream manager if they retain structural importance despite low recent usage. For instance, foundational concepts in a technical domain might be accessed infrequently but maintain high structural importance, and recency/frequency tracker 810 can recognize these patterns and adjust decay rates accordingly to preserve essential knowledge infrastructure.

A thought bundler 820 implements the critical function of organizing related cached thoughts into coherent submanifolds that can be efficiently accessed and traversed as unified semantic structures. Rather than storing thoughts as isolated points, thought bundler 820 identifies patterns of co-activation and semantic similarity to create thought bundles-compact regions within the cache that represent coherent concepts or reasoning patterns. The bundling process employs geometric consolidation techniques including local merging where nearby thoughts with high semantic overlap are combined into centroidal representations, trajectory folding where repeated reasoning paths are compressed into canonical forms, and hierarchical organization where bundles can contain sub-bundles representing different levels of abstraction. Thought bundler 820 continuously monitors cached thoughts for bundling opportunities, using criteria such as geometric proximity within the manifold, frequency of co-activation in reasoning paths, semantic similarity based on content analysis, and structural compatibility for maintaining coherent bundle boundaries. When new thoughts enter the cache, thought bundler 820 evaluates whether they should be incorporated into existing bundles, form new bundles, or remain as isolated thoughts based on their geometric and semantic properties. This dynamic bundling process enables the cache to develop increasingly sophisticated organizational structures that mirror the natural conceptual organization of the domain, improving both retrieval efficiency and semantic coherence.

A curvature-based decay handler 830 implements an approach to cache management that uses the geometric properties of the manifold to guide memory persistence and forgetting. Unlike traditional cache eviction policies based solely on time or access patterns, this component leverages the local Ricci curvature of cached thoughts to determine their semantic importance and decay characteristics. High-curvature regions indicate semantic density where many concepts converge, suggesting important knowledge intersections that should be preserved, while low-curvature regions may represent isolated or redundant information suitable for more aggressive decay. Curvature-based decay handler 830 continuously computes local curvature metrics for cached thoughts using techniques such as geodesic deviation analysis to measure how nearby trajectories converge or diverge, sectional curvature calculations to assess the two-dimensional curvature of semantic planes, and scalar curvature aggregation to provide overall density measures. These curvature values modulate the base decay rates established by recency/frequency tracker 810, creating a sophisticated forgetting mechanism that preserves structurally important thoughts while allowing peripheral information to fade naturally. The handler also implements curvature-triggered consolidation, where regions of increasing curvature prompt the system to compress and generalize cached thoughts to prevent oversaturation. For example, as multiple similar troubleshooting experiences accumulate in a high-curvature region, curvature-based decay handler 830 might trigger consolidation into a generalized diagnostic pattern while allowing specific instance details to decay, maintaining the essential knowledge while preventing cache bloat.

The integration of these components creates a local thought cache 700 that functions as a living memory system rather than a static storage repository. Geodesic lookup manager 800 enables rapid retrieval based on semantic paths rather than exact matches, recency/frequency tracker 810 maintains a thermodynamic view of memory importance, thought bundler 820 creates efficient organizational structures that mirror conceptual relationships, and the curvature-based decay handler 830 ensures that the cache evolves to maintain optimal geometric structure. Together, these components enable local thought cache 700 to achieve cache hit rates that improve logarithmically over time, where the tapering growth reflects the saturation of core semantic attractors. This caching mechanism enables the PCM to maintain rapid response times even after processing millions of interactions, as new queries are increasingly likely to fall within the geometric neighborhoods of previously cached thoughts, allowing for efficient response generation through trajectory reuse and adaptation rather than complete recomputation.

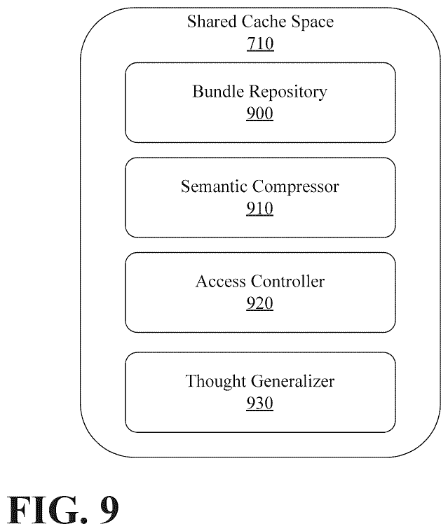

FIG. 9 is a block diagram illustrating an exemplary architecture of a shared cache space within the persistent cognitive machine's distributed thought cache system. Shared cache space 710 represents an innovation in distributed cognitive systems, implementing a form of collective intelligence where individual PCM instances contribute to and benefit from shared semantic structures without exposing instance-specific details or proprietary information.

A bundle repository 900 serves as the primary storage mechanism for generalized thought bundles that have been abstracted to a level suitable for cross-instance sharing. Unlike local thought cache which maintains full geometric fidelity, bundle repository 900 stores thought bundles that have undergone progressive generalization to remove instance-specific details while preserving essential reasoning patterns and semantic relationships. These shared bundles exist as compact submanifolds within a federated latent space, maintaining sufficient geometric structure to enable meaningful retrieval and traversal while abstracting away the fine-grained curvature details that might reveal sensitive information. Bundle repository 900 organizes shared bundles using a hierarchical structure that reflects different levels of abstraction, from specific technical procedures that have been anonymized to broad conceptual frameworks that emerge from the convergence of multiple instances' experiences. Each bundle in the repository maintains metadata including its generalization level indicating the degree of abstraction applied, contributing instances tracking which PCM instances have influenced its formation, semantic coverage defining the conceptual space it represents, and stability metrics measuring how consistently it has been validated across different contexts. For example, multiple PCM instances in industrial settings might independently develop diagnostic procedures for equipment failures, and bundle repository 900 would store the generalized diagnostic methodology as a shared bundle that captures the common reasoning pattern without revealing specific equipment models or proprietary maintenance procedures.

A semantic compressor 910 implements algorithms for reducing the representational complexity of thoughts while preserving their essential semantic content and reasoning structure. This component operates on the principle that shared knowledge should be maximally compressed to enable efficient storage and transmission while maintaining sufficient information for meaningful reuse across instances. Semantic compressor 910 employs multiple compression techniques including geometric simplification that reduces high-dimensional trajectories to lower-dimensional representations preserving key topological features, conceptual abstraction that replaces specific instances with categorical representations while maintaining logical relationships, and trajectory summarization that identifies the essential waypoints in reasoning paths while removing redundant intermediate steps. The compression process is guided by information-theoretic principles, seeking to minimize the description length of shared thoughts while maximizing their semantic coverage and reuse potential. Semantic compressor 910 also implements adaptive compression levels, applying stronger compression to frequently accessed patterns that have proven stable across multiple instances while maintaining higher fidelity for emerging or specialized knowledge that may require more nuanced representation. For instance, a complex troubleshooting trajectory involving multiple diagnostic steps might be compressed into a simplified decision tree that captures the essential logic while removing instance-specific measurement values or threshold parameters.

An access controller 920 manages the permissions and visibility rules that govern which PCM instances can access specific shared bundles and at what level of detail. This component implements an access control system based on geometric properties rather than traditional role-based permissions, using the natural information-theoretic properties of manifold projection to create different views of the same shared knowledge for different instances. Access controller 920 evaluates access requests based on multiple criteria including semantic alignment between the requesting instance's local manifold and the shared bundle's geometric structure, demonstrated competence in related domains based on the instance's contribution history, privacy constraints that may limit access to bundles derived from certain sources, and federation agreements that define sharing policies between groups of instances. Access controller 920 implements differential privacy techniques applied to geometric structures, ensuring that even with access to shared bundles, instances cannot reconstruct the specific details of contributing instances' local knowledge. Access controller 920 also manages temporal access patterns, implementing policies such as gradual revelation where new instances gain access to progressively more sophisticated shared knowledge as they demonstrate stability and contribution, or sunset provisions where certain shared bundles may become restricted or archived after specific time periods. For example, in a healthcare deployment, access controller 920 might allow all instances to access general diagnostic patterns while restricting access to specialized procedure bundles based on the instance's demonstrated expertise and compliance with privacy regulations.

A thought generalizer 930 represents an intelligence center within shared cache space 710, implementing the latent recombinator functionality that synthesizes new abstractions from multiple cached thoughts by identifying shared structure, meaning, and reasoning patterns. This component continuously analyzes the contents of both bundle repository 900 and incoming contributions from federation interfaces to identify opportunities for creating higher-order generalizations that capture emergent patterns across the distributed system. Thought generalizer 930 employs sophisticated algorithms for cross-instance pattern recognition including trajectory alignment that identifies similar reasoning paths across different geometric contexts, semantic clustering that groups related thoughts despite surface-level differences, and structural abstraction that extracts common logical frameworks from diverse specific instances. The generalization process involves weighted interpolation across semantically related bundles, creating meta-representations that lie in the geometric center of multiple specific instances while maintaining coherent semantic meaning. Thought generalizer 930 validates newly created generalizations through multiple criteria including semantic coherence measured through local manifold smoothness, compression potential indicating whether the generalization reduces overall system complexity, cross-instance applicability assessing how well the generalization transfers across different contexts, and stability under perturbation ensuring the generalization remains meaningful under slight variations. For instance, when multiple PCM instances contribute different approaches to optimizing industrial processes, thought generalizer 930 might identify common underlying principles such as constraint satisfaction, resource balancing, and performance monitoring, creating a generalized optimization framework that can be applied across diverse industrial contexts.

The integration of these components creates a shared cache space 710 that enables remarkable scaling properties for distributed cognitive systems. Bundle repository 900 provides organized storage for collective knowledge, semantic compressor 910 ensures efficient representation without loss of essential meaning, access controller 920 maintains privacy and appropriate knowledge distribution, and thought generalizer 930 continuously improves the shared knowledge base through progressive abstraction. This architecture enables the federated PCM system to achieve collective intelligence where the total knowledge of the system exceeds the sum of individual instances. Shared cache space 710 thus serves not merely as a communication mechanism between instances but as an active site of knowledge creation, where the interactions between different instances' experiences give rise to emergent understanding that benefits the entire federated system while respecting the autonomy and privacy of individual participants.

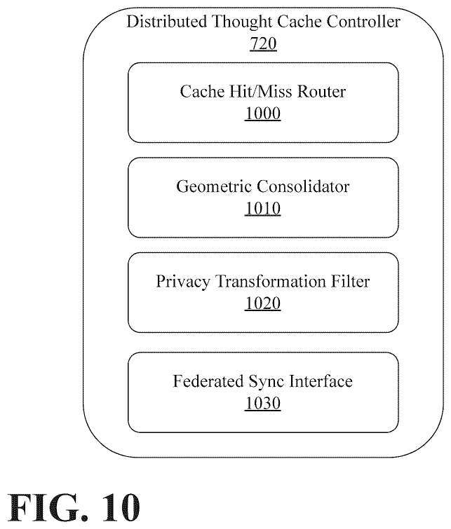

FIG. 10 is a block diagram illustrating an exemplary architecture of a distributed thought cache controller within the persistent cognitive machine's distributed thought cache system. Distributed thought cache controller 720 implements routing logic, geometric consolidation algorithms, privacy-preserving transformations, and federated synchronization protocols that together enable the remarkable scaling properties of the PCM's distributed memory system.

A cache hit/miss router 1000 serves as a decision engine determining whether incoming queries can be satisfied from cached thoughts or require full computation through the cognitive pipeline. Unlike traditional cache routers that perform simple key matching, cache hit/miss router 1000 implements multi-stage geometric matching that evaluates queries against cached content using sophisticated similarity measures within the curved space of the latent manifold. When a query arrives from the multi-stage LLM, cache hit/miss router 1000 performs a rapid preliminary scan using approximate nearest neighbor algorithms adapted for Riemannian metrics, identifying candidate cached thoughts that might satisfy the query. Cache hit/miss router 1000 then executes deeper geometric analysis on these candidates, evaluating multiple criteria including geodesic distance measuring the minimal path length through the manifold between query and cached thoughts, semantic basin overlap determining whether the query falls within the same attractor region as cached content, trajectory compatibility assessing whether cached reasoning paths could naturally extend to address the query, and confidence scoring that combines these factors to determine the likelihood of successful cache-based response generation. Cache hit/miss router 1000 implements adaptive thresholds that adjust based on domain characteristics and system load, becoming more permissive of approximate matches when response speed is important while requiring higher fidelity matches when accuracy is paramount. For example, in a technical support scenario, the router might identify that a new troubleshooting query about pump cavitation falls within the geometric neighborhood of previously cached queries about fluid dynamics problems, enabling rapid response generation by adapting the cached reasoning trajectory rather than computing an entirely new solution path.

A geometric consolidator 1010 implements the function of merging and organizing cached thoughts to prevent redundancy while improving retrieval efficiency and semantic coherence. This component continuously monitors the cache contents across both local and shared layers, identifying opportunities for consolidation based on geometric proximity and semantic overlap. Geometric consolidator 1010 employs algorithms for manifold-aware consolidation including trajectory folding where multiple similar reasoning paths are compressed into canonical representations, bundle merging where overlapping thought clusters are unified into coherent submanifolds, and hierarchical abstraction where specific instances are generalized into reusable templates. The consolidation process balances compression benefits against information preservation, using techniques such as curvature-weighted averaging that preserves high-curvature features representing important semantic distinctions while smoothing low-curvature regions representing redundant details. Geometric consolidator 1010 also implements incremental consolidation strategies that can operate continuously without disrupting cache availability, using copy-on-write mechanisms to create consolidated structures while maintaining access to original cached thoughts until the consolidation is validated. For instance, as multiple PCM instances contribute similar diagnostic procedures to the shared cache, geometric consolidator 1010 might identify common structural patterns and create a unified diagnostic framework that captures the essential reasoning while eliminating redundant variations, reducing the overall cache footprint while improving the semantic coverage of cached knowledge.

A privacy transformation filter 1020 implements sophisticated geometric abstraction techniques that enable knowledge sharing while protecting sensitive information, going beyond traditional encryption or access control to leverage the natural information-theoretic properties of manifold projection. When thoughts from the local cache are selected for federation to the shared cache space, privacy transformation filter 1020 applies a series of transformations designed to preserve reasoning patterns while obscuring instance-specific details. These transformations include but are not limited to dimensional reduction that projects high-dimensional local trajectories onto lower-dimensional shared subspaces, removing fine-grained details while preserving overall trajectory shape, curvature smoothing that eliminates local geometric features that might reveal specific operational parameters or thresholds, semantic generalization that replaces specific concepts with broader categories while maintaining logical relationships, and noise injection calibrated to add uncertainty without destroying the essential reasoning structure. Privacy transformation filter 1020 implements differential privacy guarantees by ensuring that the presence or absence of any individual thought in the local cache cannot be reliably inferred from the transformed shared representation. The filter also maintains transformation records that enable authorized instances to partially reverse transformations when necessary, implementing a form of homomorphic reasoning where computations can be performed on transformed thoughts without revealing the underlying details. For example, when sharing diagnostic knowledge from a proprietary industrial process, privacy transformation filter 1020 might abstract specific temperature and pressure values into qualitative ranges, replace equipment identifiers with generic functional descriptions, and smooth the detailed trajectory into a simplified reasoning pattern that captures the diagnostic logic without revealing trade secrets.

A federated sync interface 1030 manages the complex protocols for synchronizing cached thoughts across multiple PCM instances while maintaining consistency, managing conflicts, and optimizing network efficiency. This component implements a synchronization algorithm that goes beyond simple replication to actively manage the evolution of shared knowledge across the federation. Federated sync interface 1030 maintains connection state with remote PCM instances, tracking their synchronization status, available bandwidth, and trust relationships that determine sharing policies. The interface implements several synchronization modes including but not limited to eager synchronization for high-priority shared knowledge that should propagate immediately, lazy synchronization for routine updates that can be batched for efficiency, selective synchronization based on semantic relevance to avoid overwhelming instances with irrelevant updates, and conflict resolution protocols that handle cases where different instances have developed incompatible generalizations of similar concepts. Federated sync interface 1030 also implements bandwidth-aware transmission using the geometric compression techniques, prioritizing the synchronization of high-value shared knowledge while deferring lower-priority updates during network congestion. The interface maintains synchronization metadata including vector clocks for ordering updates across the distributed system, merkle trees for efficient detection of cache differences, and semantic digests that summarize cache contents for rapid comparison. For instance, when multiple industrial facilities share a federated PCM deployment, federated sync interface 1030 might prioritize synchronization of safety-critical diagnostic patterns while using lazy synchronization for routine operational optimizations, ensuring that knowledge propagates rapidly while managing network resources efficiently.

The integration of these components within distributed thought cache controller 720 creates an orchestration layer that enables the PCM's distributed cognition capabilities. Cache hit/miss router 1000 ensures efficient query resolution with minimal computational overhead, geometric consolidator 1010 maintains cache efficiency through intelligent organization, privacy transformation filter 1020 enables secure knowledge sharing across organizational boundaries, and federated sync interface 1030 coordinates the distributed evolution of collective intelligence. Together, these components enable the distributed thought cache system to achieve logarithmic scaling in storage requirements, near-linear speedup in response generation as cache hit rates improve, privacy-preserving knowledge sharing that enables collaboration without compromising proprietary information, and emergent collective intelligence where the federated system develops capabilities beyond any individual instance. Distributed thought cache controller 720 thus serves as the enabler of scalable, secure, and efficient distributed cognition in the PCM architecture.

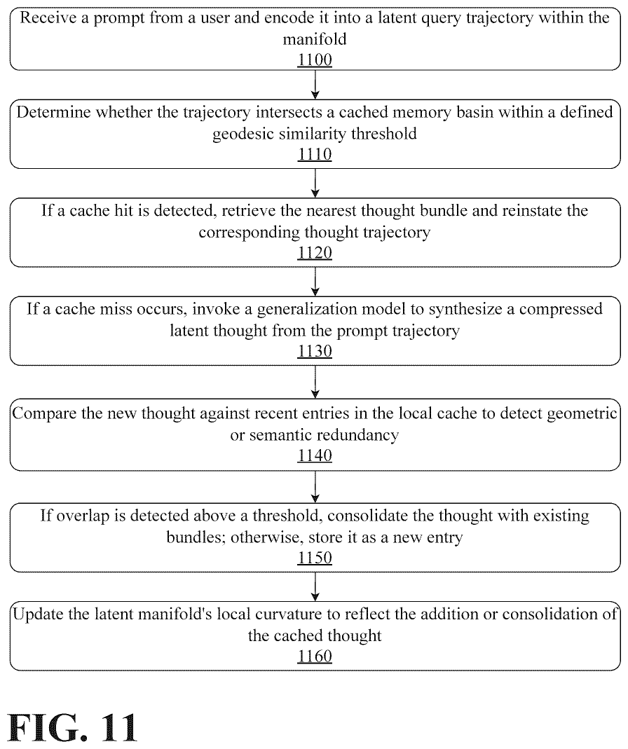

FIG. 11 is a flow diagram illustrating an exemplary method for implementing distributed thought caching with geometric similarity matching and progressive consolidation within a latent manifold. In a first step 1100, receive a prompt from a user and encode it into a latent query trajectory within the manifold. This encoding process transforms the raw textual or multimodal input into a geometric representation that exists not as a static point but as a structured trajectory through the high-dimensional latent space. The encoding respects the existing geometric structure of the manifold, mapping the prompt into a region that maintains semantic coherence with the current state of the cognitive landscape. The resulting query trajectory captures not just the explicit content of the prompt but also implicit contextual relationships and potential inferential pathways, creating a rich geometric object that can be compared against cached memory structures using manifold-aware similarity measures rather than simple vector distances.

In a step 1110, determine whether the trajectory intersects a cached memory basin within a defined geodesic similarity threshold. This determination employs geometric analysis that goes beyond Euclidean distance calculations to evaluate true semantic proximity within the curved space of the manifold. A memory basin represents a region of the latent manifold associated with a previously reinforced or frequently reused trajectory, exhibiting high local curvature and geodesic convergence that serves as an attractor for memory reentry. The geodesic similarity threshold is computed using the manifold's metric tensor to measure the minimal path length between the query trajectory and cached memory basins, accounting for the local curvature that affects traversal cost. This geometric matching process evaluates multiple criteria including trajectory overlap measuring how much the query path coincides with cached paths, basin proximity determining whether the query falls within the gravitational influence of a memory attractor, and semantic coherence assessing whether the query could naturally extend or branch from cached reasoning patterns.

In a step 1120, if a cache hit is detected, retrieve the nearest thought bundle and reinstate the corresponding thought trajectory. This reinstantiation process does not simply replay a fixed latent code but generates a new trajectory that lies near the basin of recurrence left by the original path while satisfying present constraints imposed by the current geometry, goal conditions, and query specifics. Thought bundles, as localized compressible regions containing structurally similar or semantically aligned thoughts, provide rich contextual scaffolding for trajectory reconstruction. The reinstantiation adapts the cached trajectory to the current query context through geometric transformations that preserve the essential reasoning structure while allowing for contextual variations, creating a response path that benefits from prior experience while remaining responsive to current needs.

In a step 1130, if a cache miss occurs, invoke a generalization model to synthesize a compressed latent thought from the prompt trajectory. This synthesis process generates new cognitive content that is designed from inception to be cacheable and reusable, creating compressed representations that capture abstract reasoning patterns rather than specific instance details. The generalization model operates by identifying the essential semantic components of the prompt trajectory and constructing a thought representation that maintains these core elements while abstracting away incidental specifics. The resulting compressed latent thought exists as a structured object within the manifold, positioned to maximize its potential for future reuse while maintaining semantic fidelity to the original query.

In a step 1140, compare the new thought against recent entries in the local cache to detect geometric or semantic redundancy. This comparison employs manifold-aware similarity measures that evaluate not just content overlap but structural alignment within the curved geometry of the latent space. The redundancy detection process examines multiple aspects including geodesic proximity measuring whether the new thought falls within a threshold distance of existing cached thoughts, semantic overlap assessing conceptual similarity despite surface-level differences, trajectory compatibility determining whether the new thought could be merged with existing paths without loss of coherence, and compression potential evaluating whether consolidation would reduce overall cache complexity. The comparison utilizes the local metric tensor to ensure that distance calculations respect the manifold's geometry, preventing false positives from Euclidean proximity that doesn't reflect true semantic similarity.

In a step 1150, if overlap is detected above a threshold, consolidate the thought with existing bundles; otherwise, store it as a new entry. The consolidation process implements geometric merging algorithms that combine related thoughts while preserving their essential semantic content and reasoning structure. When consolidating, the method employs techniques such as but not limited to curvature-weighted averaging that preserves important semantic features while smoothing redundant details, trajectory folding that compresses multiple similar paths into canonical representations, and bundle expansion that incorporates new thoughts into existing semantic clusters. If the overlap falls below the threshold, the new thought is stored as a distinct entry, positioned within the cache according to its geometric properties and semantic relationships to establish appropriate connections for future retrieval.

In a step 1160, update the latent manifold's local curvature to reflect the addition or consolidation of the cached thought. This update process modifies the geometric structure of the manifold to incorporate the new or consolidated knowledge, implementing the principle that memory shapes the space in which cognition occurs. The curvature update follows differential geometric principles, adjusting the metric tensor in the neighborhood of the affected region to reflect the increased semantic density or modified trajectory patterns. For newly added thoughts, this typically involves creating a new attractor basin with appropriate curvature to facilitate future retrieval, while consolidation operations may deepen existing basins or smooth transitions between related regions. The curvature modifications propagate through the manifold according to geometric flow equations, ensuring smooth transitions and maintaining the overall coherence of the cognitive landscape while incorporating the new knowledge into the persistent memory structure.

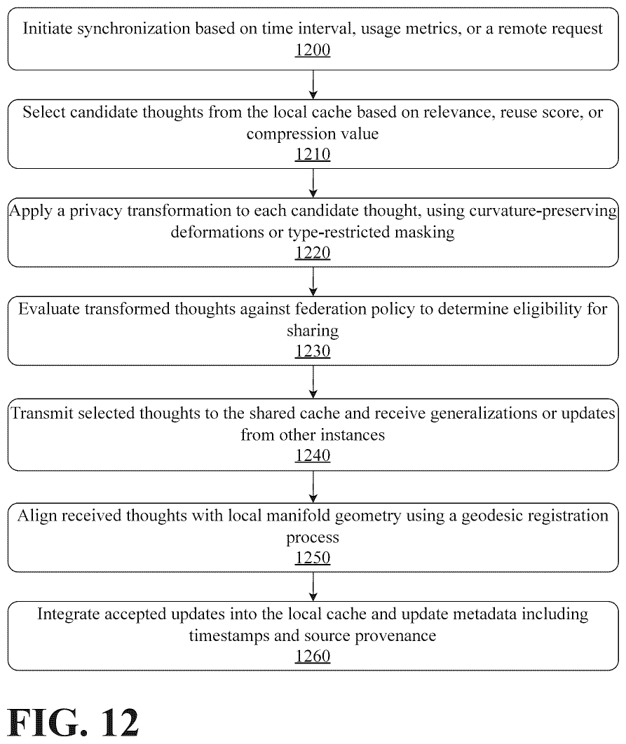

FIG. 12 is a flow diagram illustrating an exemplary method for implementing federated synchronization of cached thoughts across distributed cognitive instances with privacy-preserving transformations. In a first step 1200, initiate synchronization based on time interval, usage metrics, or a remote request. This initiation process implements flexible triggering mechanisms that balance the need for knowledge sharing with resource efficiency and network constraints. Time-based synchronization occurs at predetermined intervals, enabling predictable update cycles that prevent cache divergence while avoiding excessive network traffic. Usage-based triggers activate when local cache patterns indicate potential value in federation, such as when new generalizations emerge from local processing or when cache hit rates suggest mature knowledge worth sharing. Remote-initiated synchronization enables on-demand knowledge transfer when peer instances require specific expertise or when collective problem-solving scenarios demand rapid knowledge convergence. The synchronization initiation evaluates current network conditions, available bandwidth, and pending updates to optimize the timing and scope of the synchronization operation.

In a step 1210, select candidate thoughts from the local cache based on relevance, reuse score, or compression value. This selection process implements intelligent filtering to identify thoughts most suitable for federation, avoiding information overload while maximizing the value of shared knowledge. Relevance assessment evaluates semantic alignment between local thoughts and known interests of peer instances, using manifold-based similarity measures to identify knowledge likely to benefit the broader community. Reuse scoring quantifies how frequently and successfully thoughts have been activated in local reasoning, with highly reused thoughts indicating stable, validated knowledge worth propagating. Compression value measures the generalization potential of thoughts, prioritizing those that capture broad patterns over instance-specific details. The selection algorithm balances these criteria while respecting local resource constraints and federation quotas, creating a curated set of thoughts that represents the most valuable contributions from the local knowledge base.

In a step 1220, apply a privacy transformation to each candidate thought, using curvature-preserving deformations or type-restricted masking. This transformation process implements geometric abstraction techniques that preserve reasoning patterns while obscuring sensitive details. Curvature-preserving deformations modify the geometric representation of thoughts while maintaining their topological structure and semantic relationships, analogous to how a rubber sheet can be stretched without tearing. These deformations smooth fine-grained geometric features that might reveal specific operational parameters while preserving the overall shape of reasoning trajectories. Type-restricted masking operates on typed latent entities, applying different transformation strategies based on semantic categories-facts might undergo parameter anonymization, opinions might have source attribution removed, and trajectories might be simplified to canonical forms. The privacy transformations ensure differential privacy guarantees by adding calibrated noise that prevents reconstruction of specific local details while maintaining the statistical properties necessary for meaningful reasoning.

In a step 1230, evaluate transformed thoughts against federation policy to determine eligibility for sharing. This evaluation implements multi-criteria assessment that goes beyond simple access control to consider the broader implications of knowledge sharing. Federation policies encode organizational constraints, regulatory requirements, and strategic considerations that govern information flow between instances. The evaluation examines transformed thoughts for residual sensitive information that might have survived the privacy transformation, assessing whether adversarial analysis could reconstruct protected details. Policy compliance checking verifies that thoughts meet requirements for data sovereignty, intellectual property protection, and industry-specific regulations. The evaluation also considers reciprocity principles, ensuring balanced knowledge exchange between participating instances. Thoughts failing policy evaluation are either rejected for federation or flagged for additional transformation, while approved thoughts proceed to the transmission phase.

In a step 1240, transmit selected thoughts to the shared cache and receive generalizations or updates from other instances. This bidirectional exchange implements efficient protocols for knowledge transfer while maintaining consistency across the distributed system. Transmission employs geometric compression techniques that exploit the manifold structure to minimize bandwidth requirements, sending compact representations that can be reconstructed at destination instances. The exchange protocol handles various scenarios including new thought contributions that expand collective knowledge, updates to existing shared thoughts that refine or correct previous generalizations, and deprecation notices for obsolete knowledge that should be removed from circulation. Reception of thoughts from other instances involves preliminary validation to ensure compatibility with local manifold structure and federation agreements. The exchange maintains transaction semantics to handle partial transfers, network failures, and conflicting updates, ensuring eventual consistency across the federated system.

In a step 1250, align received thoughts with local manifold geometry using a geodesic registration process. This alignment addresses the fundamental challenge that different instances may have evolved distinct geometric structures for representing similar knowledge, requiring transformation to integrate external thoughts meaningfully. Geodesic registration identifies correspondence points between the received thought's geometry and the local manifold structure, establishing mappings that preserve semantic relationships while adapting to local geometric conventions. The registration process employs iterative optimization to minimize distortion while maintaining thought coherence, similar to how geographic projections map curved surfaces onto planes. The alignment considers local curvature patterns, existing thought bundles that might absorb the new knowledge, and potential conflicts with established local understanding. This process ensures that federated knowledge integrates smoothly into the local cognitive landscape rather than existing as foreign artifacts.

In a step 1260, integrate accepted updates into the local cache and update metadata including timestamps and source provenance. This integration process goes beyond simple storage to actively incorporate new knowledge into the local cognitive structure. Integration may involve merging received thoughts with existing local knowledge when overlap is detected, creating new thought bundles when received knowledge represents novel domains, or refining existing cached trajectories based on collective insights from the federation. Metadata updates maintain tracking information including temporal markers for version control and conflict resolution, provenance chains documenting the origin and transformation history of thoughts, trust scores reflecting the reliability of source instances, and usage predictions based on the thought's success in other instances. The integration process triggers local manifold updates to accommodate the new knowledge, potentially adjusting curvature patterns, creating new semantic connections, and optimizing the overall geometric structure for improved future retrieval. This comprehensive integration ensures that federated knowledge becomes a natural part of the local cognitive system rather than remaining as isolated external contributions.

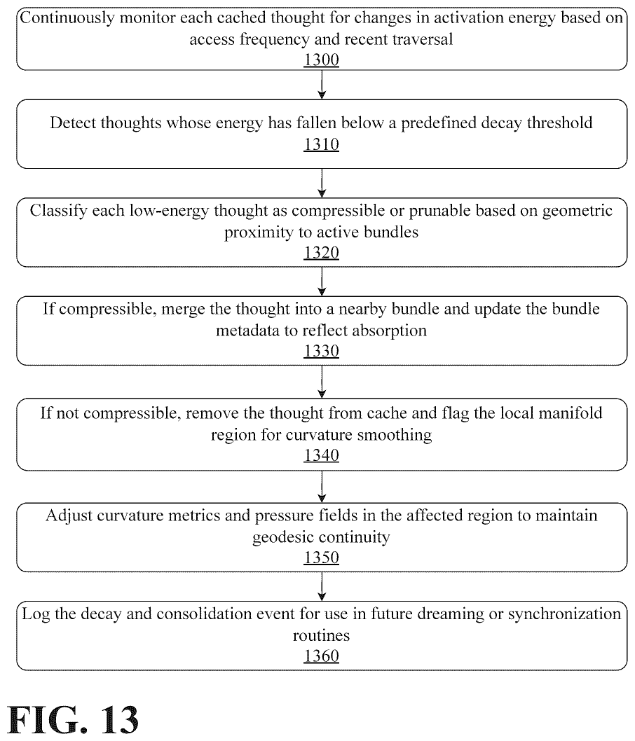

FIG. 13 is a flow diagram illustrating an exemplary method for implementing thermodynamic decay and geometric consolidation of cached thoughts to maintain optimal memory efficiency. In a first step 1300, continuously monitor each cached thought for changes in activation energy based on access frequency and recent traversal. This monitoring implements a thermodynamic model of memory where each thought maintains an activation energy that reflects its cognitive utility and relevance over time. The activation energy evolves according to both positive contributions from access events and negative decay from temporal passage. Access frequency contributes positive energy boosts not through simple counting but through weighted contributions that consider the context and success of each access-thoughts retrieved for successful reasoning receive larger energy increases than those accessed but ultimately unused. Recent traversal patterns also influence activation energy, with thoughts lying along frequently traveled geodesic paths receiving ambient energy from nearby cognitive activity, implementing a form of spreading activation within the geometric framework. The continuous monitoring maintains energy landscapes across the entire cache, enabling dynamic assessment of which thoughts remain cognitively vital versus those approaching obsolescence.

In a step 1310, detect thoughts whose energy has fallen below a predefined decay threshold. This detection process identifies candidates for removal or consolidation by comparing current activation energies against a threshold that represents the minimum viability for independent cache storage. The decay threshold is not a fixed value but adapts based on cache capacity, domain characteristics, and overall system activity levels, implementing a form of competitive memory dynamics where the threshold rises under storage pressure and relaxes when capacity is abundant. Detection employs efficient scanning algorithms that leverage the geometric organization of cached thoughts, focusing on regions of low activity rather than exhaustively checking every cached element. The process identifies not just individual thoughts below threshold but also clusters of low-energy thoughts that might benefit from collective handling, recognizing that geometric proximity often indicates semantic relationships suitable for consolidation.

In a step 1320, classify each low-energy thought as compressible or prunable based on geometric proximity to active bundles. This classification determines the appropriate handling strategy by evaluating whether the thought contains unique information worth preserving through consolidation or represents redundant content suitable for removal. Geometric proximity assessment goes beyond simple distance calculations to evaluate semantic relationships within the curved manifold space, considering factors such as geodesic distance to the nearest active thought bundle, alignment with bundle trajectories indicating potential for meaningful integration, and local curvature patterns suggesting whether the thought occupies a unique semantic niche. Compressibility analysis examines whether the thought's essential content can be absorbed into nearby bundles without significant information loss, using compression metrics that balance storage efficiency against semantic fidelity. The classification process recognizes that thoughts with unique geometric positions or high local curvature may warrant preservation despite low activation energy, as they might represent rare but important knowledge.

In a step 1330, if compressible, merge the thought into a nearby bundle and update the bundle metadata to reflect absorption. This merging process implements sophisticated consolidation algorithms that preserve essential semantic content while eliminating redundant storage. The merge operation employs geometric interpolation techniques that blend the low-energy thought into the target bundle's submanifold, using curvature-weighted averaging to maintain important features while smoothing unnecessary detail. Bundle metadata updates record the absorption event, tracking which thoughts have been consolidated, when the merger occurred, and what information might have been generalized or lost in the process. The merging adjusts the bundle's internal structure to accommodate the new content, potentially expanding its boundary, modifying its centroid, or creating internal subdivisions for distinct but related concepts. This consolidation enables the cache to maintain comprehensive coverage while reducing storage requirements, implementing a form of semantic compression where related thoughts coalesce into unified representations.

In a step 1340, if not compressible, remove the thought from cache and flag the local manifold region for curvature smoothing. This removal process eliminates obsolete thoughts while maintaining the geometric integrity of the surrounding cache structure. Removal is not a simple deletion but involves careful extraction that preserves the continuity of nearby geometric structures, similar to removing a node from a network while maintaining connectivity among remaining nodes. The flagging for curvature smoothing identifies regions where thought removal has created geometric discontinuities or irregular curvature patterns that could impede future traversal or retrieval. The removal process also checks for dependent structures that might be affected by the thought's absence, ensuring that the deletion doesn't create orphaned references or broken reasoning chains within the cache.

In a step 1350, adjust curvature metrics and pressure fields in the affected region to maintain geodesic continuity. This adjustment process repairs the geometric structure following thought removal or consolidation, ensuring smooth traversal paths and consistent semantic relationships. Curvature metric adjustments modify the local Ricci tensor to eliminate sharp discontinuities created by removal, implementing a form of geometric healing that redistributes curvature smoothly across neighboring regions. Pressure field updates recalculate the compression pressure in affected areas, ensuring that the removal of thoughts doesn't create artificial low-pressure voids that might attract inappropriate future caching. The adjustment process employs differential geometric techniques similar to Ricci flow, allowing the manifold to naturally evolve toward a stable configuration that maintains both local smoothness and global coherence. These adjustments ensure that future cognitive operations can traverse the modified regions without encountering unexpected geometric artifacts from the consolidation process.

In a step 1360, log the decay and consolidation event for use in future dreaming or synchronization routines. This logging creates a historical record that enables learning from decay patterns and optimizing future cache management strategies. The log captures comprehensive information about the decay event including the original thought's geometric properties and semantic content, the decay trajectory showing how activation energy evolved over time, the classification decision and rationale for compression versus pruning, and the resulting geometric modifications to the cache structure. This historical data feeds into dreaming processes that can identify systematic patterns in thought decay, potentially discovering which types of thoughts consistently become obsolete versus those worth preserving through early consolidation. Synchronization routines use decay logs to coordinate cache management across distributed instances, sharing insights about which thoughts tend to lose relevance and enabling proactive management strategies. The logging also supports debugging and optimization of decay parameters, allowing the system to tune decay constants, threshold values, and classification criteria based on empirical observations of cache evolution. This comprehensive logging ensures that the thermodynamic decay process becomes increasingly intelligent over time, learning from past consolidation decisions to maintain optimal cache efficiency while preserving valuable knowledge.

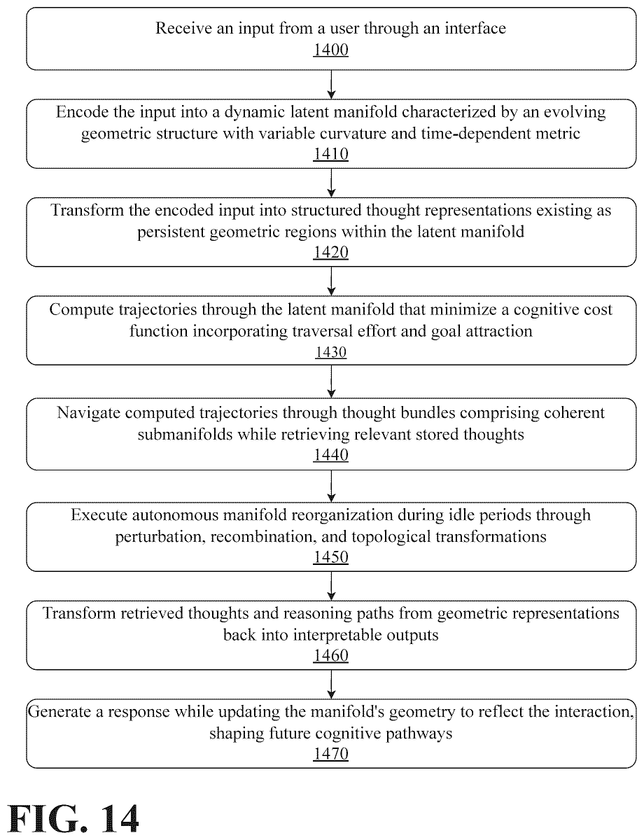

FIG. 14 is a flow diagram illustrating an exemplary method for implementing persistent cognitive computation through geometric representation and manipulation of thoughts within a dynamic latent manifold. In a first step 1400, receive an input from a user through an interface. This initial step establishes the entry point for external information into the cognitive process, where inputs may comprise natural language queries, multimodal data streams, commands, or any form of structured or unstructured information requiring cognitive processing. The interface serves as a bidirectional communication channel that not only receives inputs but maintains context from previous interactions, enabling coherent long-term dialogues where each new input can build upon established semantic foundations encoded within the geometric substrate.

In a step 1410, encode the input into a dynamic latent manifold characterized by an evolving geometric structure with variable curvature and time-dependent metric. This encoding process transforms raw external data into geometric representations within a high-dimensional space where semantic relationships are captured through curvature, distance, and topological features rather than static vector embeddings. The latent manifold operates as a living geometric substrate with a Riemannian or pseudo-Riemannian metric tensor that evolves based on usage patterns, wherein frequently accessed semantic regions develop distinct curvature characteristics that facilitate efficient navigation. The encoding respects existing manifold structure, placing new inputs in regions that maintain semantic coherence with previously encoded information while allowing the manifold itself to deform and adapt to accommodate novel concepts. This dynamic encoding ensures that the same input may be mapped to slightly different manifold locations at different times, reflecting the evolving understanding and context within the cognitive system.

In a step 1420, transform the encoded input into structured thought representations existing as persistent geometric regions within the latent manifold. Thoughts, as discrete units of reasoning or analysis generated during processing, are not mere points in space but extended geometric structures that may manifest as compact submanifolds, trajectories, or complex topological features. This transformation involves processing the encoded input through sophisticated algorithms that identify semantic components, establish relationships between concepts, and construct high-dimensional representations that capture not only explicit content but implicit contextual meanings and potential inferential pathways. The resulting thought structures exhibit internal geometry that reflects their semantic complexity, with simple atomic thoughts occupying relatively flat regions while complex structured thoughts may exhibit significant curvature and multi-dimensional extent. These thought representations become persistent features of the manifold, subject to future retrieval, recombination, and evolution through continued cognitive activity.

In a step 1430, compute trajectories through the latent manifold that minimize a cognitive cost function incorporating traversal effort and goal attraction. This computation implements geodesic attention, where focus or inference is achieved by computing minimal-energy paths through the manifold rather than discrete selection operations. The cognitive cost function balances multiple factors including kinetic energy that penalizes rapid shifts in attention, compression pressure derived from local semantic density that makes traversal through highly compressed regions more costly, and goal potential fields that create attractive forces toward relevant semantic areas. The trajectory computation employs variational principles to find paths that optimize this multi-factor cost function, resulting in smooth, continuous reasoning paths that respect the manifold's geometry while efficiently pursuing cognitive objectives. These trajectories may branch, merge, or exhibit complex topology depending on the interplay between manifold structure and goal requirements, enabling rich inferential patterns that go beyond linear reasoning chains.

In a step 1440, navigate computed trajectories through thought bundles comprising coherent submanifolds while retrieving relevant stored thoughts. Navigation involves traversing the computed paths while interacting with latent subspaces or thought bundles-localized, compressible regions containing structurally similar or semantically aligned thoughts. As trajectories pass through or near these bundles, relevant thoughts are activated and retrieved based on geometric proximity, semantic alignment, and contextual appropriateness. The navigation process respects bundle boundaries and internal structure, potentially following established paths within bundles that represent well-learned reasoning patterns or exploring novel connections between previously unrelated bundles. Retrieved thoughts contribute to the ongoing cognitive process, providing historical context, learned patterns, and relevant knowledge that enriches the current reasoning trajectory. This navigation implements a form of associative memory where retrieval is not based on exact matching but on geometric traversal through semantically organized space.

In a step 1450, execute autonomous manifold reorganization during idle periods through perturbation, recombination, and topological transformations. This dreaming process operates as a background mechanism for structural optimization and generalization discovery. Perturbation involves applying controlled stochastic variations to existing thought structures to test their stability and explore nearby semantic spaces. Recombination implements sophisticated interpolation and integration algorithms that synthesize new abstractions from existing thoughts, potentially discovering emergent patterns or generalizations not explicitly present in the original structures. Topological transformations may alter the fundamental connectivity of the manifold, creating new bridges between previously disconnected regions or splitting overly complex areas into more manageable components. These reorganization operations improve manifold efficiency, reduce redundancy, and enhance the system's capacity for creative inference and generalization, all while maintaining semantic coherence and preserving valuable learned structures.

In a step 1460, transform retrieved thoughts and reasoning paths from geometric representations back into interpretable outputs. This decoding process must interpret rich geometric information including positions within the manifold, traversed trajectories, local curvature contexts, and relationships between activated thought bundles. The transformation preserves not just the conclusions reached but the reasoning process itself, enabling explanatory outputs that reflect the structured path taken through semantic space. Decoding accounts for the multi-dimensional nature of thoughts, potentially generating outputs that capture nuanced relationships, conditional dependencies, and contextual qualifications that emerge from the geometric reasoning process. The decoded information maintains coherence with the original query while potentially introducing insights or connections discovered through manifold traversal that were not explicitly present in the input.

In a step 1470, generate a response while updating the manifold's geometry to reflect the interaction, shaping future cognitive pathways. Response generation synthesizes the decoded thoughts and reasoning paths into appropriate output formats while simultaneously modifying the underlying geometric substrate based on the completed cognitive cycle. Manifold updates may include but are not limited to strengthening frequently traversed paths through metric adjustment, increasing curvature around newly important semantic regions, establishing new connections between previously unrelated thoughts, and adjusting bundle boundaries to reflect evolved understanding. These geometric modifications ensure that future cognitive operations benefit from accumulated experience, with successful reasoning patterns becoming easier to traverse while maintaining flexibility for novel exploration. The bidirectional process of response generation and manifold update implements a form of continuous learning where each interaction contributes to the long-term evolution of the cognitive substrate, creating an increasingly sophisticated geometric landscape that embodies accumulated knowledge, learned patterns, and refined reasoning capabilities.

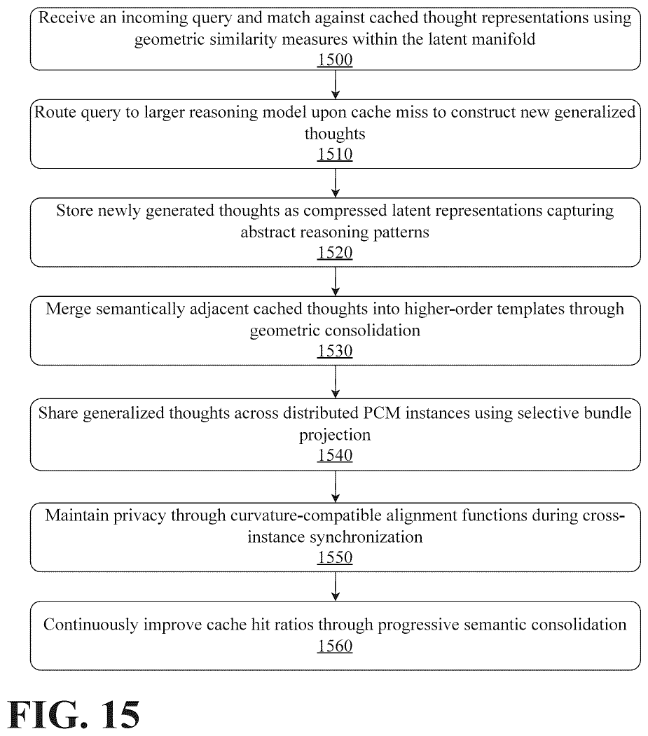

FIG. 15 is a flow diagram illustrating an exemplary method for implementing distributed thought caching with progressive generalization across multiple cognitive instances. In a first step 1500, receive an incoming query and match against cached thought representations using geometric similarity measures within the latent manifold. This initial matching process employs sophisticated geometric comparison techniques that go beyond simple vector similarity to evaluate semantic alignment within the curved space of the manifold. The thought cache, as a structured memory layer configured to store and retrieve thoughts based on semantic similarity, contextual alignment, or system policy, maintains indexed representations in latent space that can be accessed through multiple retrieval mechanisms. Geometric similarity measures account for manifold curvature, considering not just Euclidean distances but geodesic proximity that respects the semantic topology of the space. The matching process evaluates both direct similarity to individual cached thoughts and alignment with thought bundles or trajectories, enabling retrieval of relevant knowledge even when exact matches don't exist. This geometric matching approach allows for flexible retrieval that captures semantic relationships, analogical connections, and contextual relevance that would be missed by flat similarity metrics.

In a step 1510, route query to larger reasoning model upon cache miss to construct new generalized thoughts. When geometric matching fails to identify sufficiently relevant cached thoughts, the query triggers invocation of more comprehensive reasoning capabilities to generate new understanding. This routing decision is based on confidence thresholds that account for the quality of geometric matches, the specificity of the query, and the coverage of existing cached knowledge. The larger reasoning model processes the query with full computational resources, generating not just specific answers but generalized thoughts that capture abstract reasoning patterns suitable for future reuse. These newly constructed thoughts are designed from inception to be cacheable and generalizable, incorporating structured representations that encode not just conclusions but reasoning pathways, contextual dependencies, and semantic relationships that enable broad applicability across future queries.

In a step 1520, store newly generated thoughts as compressed latent representations capturing abstract reasoning patterns. The storage process implements sophisticated compression techniques that preserve essential semantic structure while reducing representational redundancy. Thoughts undergo geometric compression that identifies and preserves features such as key conceptual relationships, reasoning pathways that led to insights, contextual boundaries that define applicability, and connections to existing knowledge structures. The compressed representations maintain their geometric properties within the latent manifold, ensuring they can be properly integrated with existing cached thoughts and participate in future geometric operations. Compression occurs at multiple levels, from local optimization of individual thought representations to global reorganization of cache structure, ensuring efficient storage without loss of semantic fidelity or reasoning capability.

In a step 1530, merge semantically adjacent cached thoughts into higher-order templates through geometric consolidation. This merging process implements the generalization operation, synthesizing new thoughts from cached thoughts by identifying shared structure, meaning, or trajectory. The latent recombinator functionality examines geometric proximity and semantic alignment to identify candidates for consolidation, using criteria such as overlapping activation patterns, similar reasoning structures, compatible contextual constraints, and complementary knowledge domains. Geometric consolidation creates meta-thoughts that abstract common patterns while preserving distinctive features, employing manifold-aware interpolation techniques that respect curvature and maintain semantic coherence. The resulting higher-order templates serve as powerful generalizations that can match a broader range of future queries while maintaining specificity through parameterizable components that adapt to context.

In a step 1540, share generalized thoughts across distributed PCM instances using selective bundle projection. This sharing mechanism enables collaborative intelligence while respecting instance boundaries and privacy requirements. Selective bundle projection identifies portions of thought bundles suitable for sharing based on generalization level, privacy constraints, and cross-instance relevance. The projection process maps local geometric structures into a shared representational space that maintains semantic relationships while abstracting instance-specific details. Shared thoughts undergo geometric transformation that preserves their essential reasoning patterns and conceptual relationships while removing or generalizing contextual information tied to specific instances. This selective sharing enables different cognitive instances to benefit from collective learning without exposing sensitive or irrelevant local knowledge.

In a step 1550, maintain privacy through curvature-compatible alignment functions during cross-instance synchronization. Privacy preservation employs sophisticated geometric techniques that ensure knowledge sharing occurs at appropriate abstraction levels. Curvature-compatible alignment functions match geometric structures across instances while preventing reconstruction of detailed local information, using techniques such as differential privacy applied to manifold structures, homomorphic transformations that preserve reasoning capability while obscuring specific content, and selective geometric abstraction that shares patterns without revealing instances. The alignment process ensures that shared knowledge integrates properly with local manifold structures while maintaining boundaries that prevent unauthorized access to instance-specific information. This geometric approach to privacy enables rich knowledge sharing while providing mathematical guarantees about information disclosure limits.

In a step 1560, continuously improve cache hit ratios through progressive semantic consolidation. This ongoing optimization process analyzes cache performance metrics and identifies opportunities for structural improvement. Progressive consolidation examines patterns in cache hits and misses to identify frequently accessed semantic regions requiring enhanced representation, gaps in cached knowledge that lead to repeated cache misses, redundant representations that could be unified through further generalization, and emerging patterns in query streams that suggest new abstraction opportunities. The consolidation process operates continuously, making incremental improvements to cache structure through targeted operations such as merging highly correlated thoughts into unified representations, creating new intermediate abstractions that bridge frequently traversed semantic gaps, reorganizing bundle structures to improve retrieval efficiency, and pruning obsolete thoughts that no longer contribute to cache performance. This progressive refinement ensures that cache efficiency improves over time, with hit ratios increasing as the cache structure becomes better aligned with actual usage patterns and semantic requirements. The method creates a self-improving distributed knowledge system where each instance benefits from collective learning while maintaining autonomy and privacy through geometric abstraction principles.

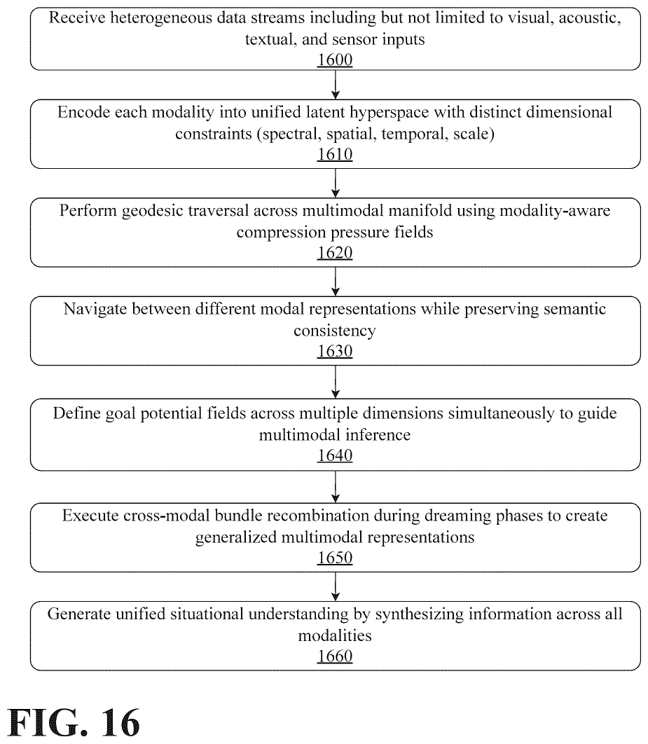

FIG. 16 is a flow diagram illustrating an exemplary method for processing and integrating heterogeneous sensory data streams within a unified geometric cognitive framework. In a first step 1600, receive heterogeneous data streams including but not limited to visual, acoustic, textual, and sensor inputs. This reception process accommodates diverse information sources arriving asynchronously and in varying formats, encompassing traditional sensory modalities such as visual imagery with spatial and color information, acoustic signals containing temporal patterns and frequency spectra, textual data carrying symbolic and semantic content, as well as specialized sensor inputs including thermal readings, pressure measurements, electromagnetic signatures, and chemical compositions. The data streams may arrive at different rates, resolutions, and levels of completeness, requiring robust handling of partial information, noise, and temporal misalignment. Each modality brings unique information characteristics that must be preserved during initial processing while preparing for integration into a unified representational framework.

In a step 1610, encode each modality into unified latent hyperspace with distinct dimensional constraints (spectral, spatial, temporal, scale). This encoding process transforms diverse input modalities into a shared geometric representation while maintaining modality-specific properties through structured dimensional organization. Spectral dimensions capture frequency-domain characteristics including harmonic relationships in audio, color spectra in visual data, and oscillatory patterns in sensor readings. Spatial dimensions encode geometric relationships, topological structures, and positional information relevant to visual scenes, acoustic source localization, and distributed sensor networks. Temporal dimensions represent sequential dependencies, causal flows, and dynamic evolution patterns across all modalities. Scale dimensions enable hierarchical abstraction from fine-grained local details to global patterns and high-level semantic structures. The encoding process respects the intrinsic geometry of each modality while establishing cross-modal connections through shared latent regions, creating a rich multidimensional space where different sensory inputs can interact meaningfully while preserving their distinctive characteristics.

In a step 1620, perform geodesic traversal across multimodal manifold using modality-aware compression pressure fields. This traversal implements specialized navigation that accounts for the varying information density and semantic complexity across different modal regions of the manifold. Modality-aware compression pressure fields reflect the distinct compression characteristics of each sensory domain, with visual regions exhibiting high pressure around detailed textures and edges, acoustic regions showing compression around harmonic structures and temporal patterns, textual regions displaying semantic density around conceptual clusters, and sensor regions indicating measurement precision and uncertainty bounds. The geodesic paths computed through this multimodal landscape balance traversal costs across modalities, finding optimal routes that may transition between sensory domains when such transitions offer more efficient inference paths. The traversal process maintains awareness of modal boundaries and implements smooth transitions that preserve semantic continuity even when shifting between fundamentally different representational schemes.

In a step 1630, navigate between different modal representations while preserving semantic consistency. This navigation capability enables fluid movement across sensory boundaries without losing coherent meaning or breaking inferential chains. Cross-modal navigation employs geometric bridges that connect semantically related regions across different modalities, such as linking visual representations of objects with their acoustic signatures, textual descriptions with corresponding sensory patterns, and abstract concepts with their multimodal manifestations. The navigation process maintains semantic invariants during modal transitions through preservation of relational structures, contextual embeddings, and higher-order patterns that transcend individual modalities. Consistency preservation mechanisms ensure that conclusions drawn in one modality remain valid when translated to another, enabling robust reasoning that leverages the complementary strengths of different sensory channels while avoiding contradictions or semantic drift during cross-modal inference.

In a step 1640, define goal potential fields across multiple dimensions simultaneously to guide multimodal inference. This multidimensional goal specification creates complex potential landscapes that can express objectives spanning multiple sensory domains and abstraction levels. Goal potential fields may simultaneously specify visual targets such as specific object configurations or scene compositions, acoustic objectives including sound source identification or pattern matching, textual constraints defining semantic requirements or linguistic structures, and sensor thresholds establishing measurement criteria or anomaly boundaries. The simultaneous definition across dimensions enables rich goal specifications that capture the full complexity of multimodal objectives, creating gradient fields that guide attention and inference toward regions where multiple modal constraints are satisfied. These multidimensional potentials interact with the modality-specific compression fields to create nuanced cognitive dynamics where the path to goal satisfaction may involve strategic transitions between modalities based on information availability and inference efficiency.

In a step 1650, execute cross-modal bundle recombination during dreaming phases to create generalized multimodal representations. This dreaming process operates on the accumulated multimodal experiences to discover and reinforce cross-modal patterns and abstractions. During these phases, the method identifies thought bundles from different modalities that exhibit structural similarity or semantic alignment, applying sophisticated recombination algorithms that blend modal-specific features while preserving essential relationships. The recombination process creates meta-modal representations that capture invariant patterns across sensory domains, such as motion patterns that manifest similarly in visual and acoustic data, structural regularities that appear across multiple sensor types, and abstract concepts that find expression through various sensory channels. These generalized representations enable more efficient future processing by providing unified templates that can be instantiated across modalities, reducing redundancy and enabling rapid recognition of complex multimodal patterns.

In a step 1660, generate unified situational understanding by synthesizing information across all modalities. This synthesis process integrates the multimodal traversals, cross-modal navigations, and generalized representations into a coherent understanding that transcends individual sensory channels. The synthesis employs geometric integration techniques that combine information from different modal subspaces while respecting their relative reliabilities and complementary contributions. Unified understanding emerges from the convergence of multiple inferential paths through the multimodal manifold, where conclusions are reinforced by agreement across modalities or refined by modal-specific insights. The generated understanding maintains explicit representation of its multimodal foundations, enabling traceable reasoning that can identify which modalities contributed to specific conclusions and how cross-modal interactions influenced the final synthesis. This comprehensive situational awareness provides a rich, nuanced understanding that leverages the full spectrum of available sensory information while maintaining coherent semantic structure through geometric organization in the unified latent hyperspace.

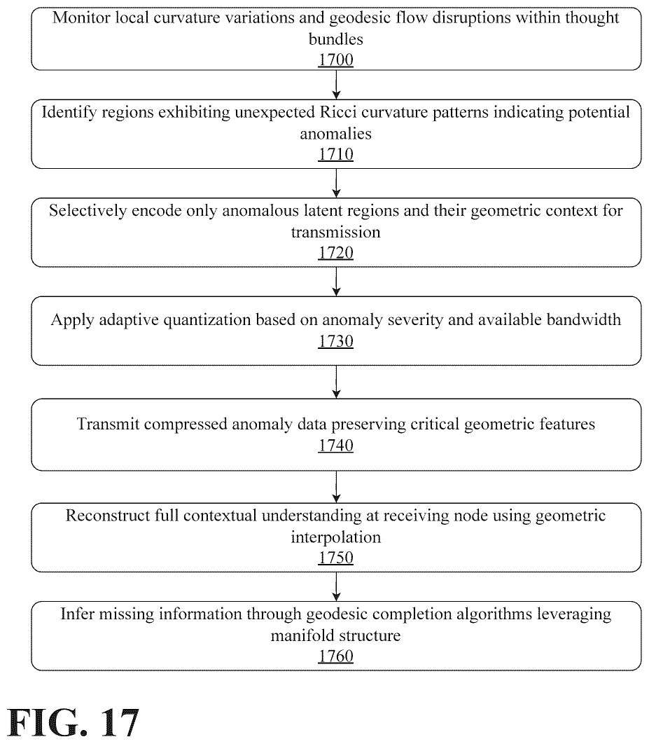

FIG. 17 is a flow diagram illustrating an exemplary method for detecting anomalies within cognitive manifolds and efficiently transmitting information through bandwidth-constrained channels using geometric compression and reconstruction techniques. In a first step 1700, monitor local curvature variations and geodesic flow disruptions within thought bundles. This monitoring process continuously tracks the geometric health of the latent manifold by observing how information flows through established cognitive structures. Thought bundles, as localized compressible regions containing structurally similar or semantically aligned thoughts, exhibit characteristic flow patterns under normal conditions where geodesic paths follow predictable trajectories through well-formed semantic spaces. The monitoring examines multiple geometric indicators including the smoothness of attention vector fields as they traverse bundle boundaries, the stability of local metric tensors within bundle interiors, the consistency of parallel transport along established reasoning paths, and the convergence or divergence rates of nearby geodesic trajectories. Disruptions in these flow patterns signal potential anomalies that warrant deeper investigation, such as unexpected turbulence in normally laminar regions, discontinuities in otherwise smooth semantic transitions, or irregular divergence patterns that break established geometric regularities.

In a step 1710, identify regions exhibiting unexpected Ricci curvature patterns indicating potential anomalies. This identification process analyzes the compression pressure field P(x)=−R(x), where R(x) represents the Ricci scalar curvature, to detect deviations from expected geometric patterns. Under normal conditions, thought bundles exhibit predictable curvature signatures based on their semantic content and usage patterns, with frequently accessed concepts showing higher but stable curvature, specialized knowledge domains maintaining consistent intermediate curvature, and exploratory regions displaying lower, more uniform curvature distributions. Anomalous patterns manifest as sudden spikes in curvature without corresponding semantic justification, irregular curvature oscillations within previously stable regions, inverted curvature relationships where sparse regions show unexpected compression, or curvature voids where expected semantic density disappears. These unexpected patterns often indicate underlying issues such as corrupted thought structures, emergent conceptual conflicts, novel information requiring manifold adaptation, or systemic problems affecting geometric integrity.

In a step 1720, selectively encode only anomalous latent regions and their geometric context for transmission. This selective encoding process implements intelligent data reduction by focusing transmission resources exclusively on information-rich anomalous regions while omitting normal background structure. The encoding captures not just the anomalous points themselves but sufficient geometric context to enable meaningful interpretation, including local manifold topology surrounding the anomaly, curvature gradients extending from normal to anomalous regions, geodesic paths that connect anomalies to known reference structures, and boundary conditions that delineate anomalous from normal regions. The selective encoding employs sophisticated algorithms that determine optimal context boundaries by analyzing information gradients radiating from anomaly centers, semantic dependencies that link anomalies to broader cognitive structures, and geometric continuity requirements for accurate reconstruction. This approach dramatically reduces transmission requirements while preserving the essential information needed to understand and respond to detected anomalies.

In a step 1730, apply adaptive quantization based on anomaly severity and available bandwidth. This quantization process dynamically adjusts encoding precision to optimize the trade-off between transmission efficiency and anomaly representation fidelity. Severity assessment considers multiple factors including the magnitude of curvature deviation from expected norms, the spatial extent of the anomalous region within the manifold, the rate of change in geometric parameters, and potential impact on cognitive operations. High-severity anomalies receive fine-grained quantization that preserves subtle geometric features helpful for accurate analysis, while lower-severity deviations undergo coarser quantization that captures essential patterns without excessive detail. Bandwidth-aware adaptation continuously monitors available transmission capacity and adjusts quantization parameters in real-time, implementing progressive encoding schemes that transmit core anomaly features first followed by refinement data, variable bit allocation that assigns more resources to some geometric features, and temporal multiplexing that balances multiple anomaly streams based on relative priorities.

In a step 1740, transmit compressed anomaly data preserving geometric features. The transmission process employs specialized compression algorithms designed to maintain geometric integrity despite aggressive data reduction. Preserved features during compression include but are not limited to topological invariants that define anomaly structure, curvature signatures that characterize deviation patterns, geodesic connectivity that links anomalies to the broader manifold, and semantic anchors that provide interpretive context. Compression techniques leverage the inherent structure of geometric data through differential encoding that transmits changes rather than absolute values, manifold-aware transforms that exploit local geometric regularities, predictive coding based on normal manifold behavior, and entropy coding optimized for geometric data distributions. The transmission protocol may include error protection mechanisms weighted toward preserving geometric consistency, ensuring that reconstruction errors don't fundamentally alter anomaly interpretation.

In a step 1750, reconstruct full contextual understanding at receiving node using geometric interpolation. This reconstruction process rebuilds comprehensive anomaly context from the sparse transmitted data by leveraging knowledge of manifold structure and geometric principles. Geometric interpolation techniques employed include but are not limited to geodesic interpolation that fills gaps along natural manifold paths, curvature field reconstruction using partial differential equations, metric tensor completion based on smoothness constraints, and topology inference from boundary conditions. The reconstruction process is guided by prior knowledge of normal manifold behavior, enabling intelligent filling of untransmitted regions through reference to similar known structures, application of learned geometric regularities, and constraint satisfaction based on manifold consistency requirements. The reconstructed context provides sufficient detail to understand not just what anomalies occurred but their relationship to the broader cognitive landscape, enabling appropriate response strategies.

In a step 1760, infer missing information through geodesic completion algorithms leveraging manifold structure. This inference process goes beyond simple interpolation to actively reconstruct probable missing information based on deep understanding of manifold geometry and semantic relationships. Geodesic completion algorithms trace partial paths through the manifold and extend them according to learned trajectory patterns, identifying likely path continuations based on curvature flow, semantic coherence along extended paths, and convergence toward stable attractor regions. The algorithms leverage manifold structure through multiple mechanisms including bundle membership inference that assigns reconstructed regions to appropriate semantic clusters, cross-bundle connection discovery that identifies probable relationships between separated anomalous regions, and temporal evolution modeling that predicts how anomalies might develop over time. This inference capability enables the receiving node to develop actionable understanding from minimal transmitted data, supporting effective anomaly response even in severely bandwidth-constrained environments while maintaining the geometric and semantic integrity essential for meaningful cognitive processing.

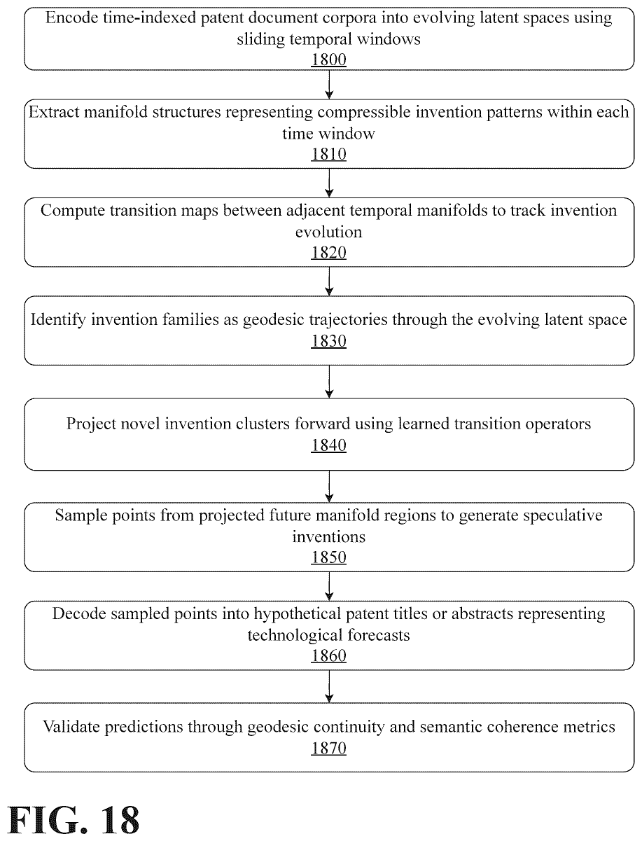

FIG. 18 is a flow diagram illustrating an exemplary method for analyzing technological evolution through patent document corpora and forecasting future inventions by tracking geodesic trajectories through time-evolving latent manifolds. In a first step 1800, encode time-indexed patent document corpora into evolving latent spaces using sliding temporal windows. This encoding process transforms collections of patent documents organized by publication time into dynamic geometric representations that capture the evolution of technological innovation. The sliding temporal windows, such as three-month periods with one-month overlap, create a sequence of overlapping document sets that enable smooth tracking of invention progression while maintaining temporal continuity. Each window's corpus undergoes encoding through sophisticated natural language processing and semantic analysis that extracts not just keywords and classifications but deeper structural patterns including technological dependencies, conceptual relationships, innovation trajectories, and cross-domain influences. The encoding process generates high-dimensional latent representations that preserve the rich semantic structure of patent information while enabling geometric analysis of how technologies evolve and interact over time.

In a step 1810, extract manifold structures representing compressible invention patterns within each time window. This extraction process identifies coherent geometric structures within each temporal latent space that correspond to meaningful technological themes and innovation clusters. The manifold extraction employs dimensionality reduction and structure discovery techniques that reveal underlying patterns in the high-dimensional patent representations, identifying regions of dense innovation activity corresponding to hot technological areas, sparse regions indicating unexplored or emerging fields, curved paths connecting related inventions across domains, and topological features revealing innovation barriers or breakthroughs. Compressible patterns emerge where multiple patents share fundamental conceptual structures despite surface differences, enabling the identification of core technological principles that drive innovation within specific periods. The extracted manifolds capture not just static snapshots but the dynamic terrain of technological possibility within each time window.

In a step 1820, compute transition maps between adjacent temporal manifolds to track invention evolution. These transition maps capture how the landscape of innovation transforms from one time period to the next, encoding both gradual evolution and disruptive changes. The computation of transition maps involves sophisticated alignment algorithms that match corresponding structures across temporal boundaries while accounting for the emergence of novel concepts, the obsolescence of outdated technologies, the transformation of existing ideas into new forms, and the migration of innovations across domain boundaries. The maps are learned through analysis of patents that appear in overlapping windows, tracking how their latent representations shift as the surrounding technological context evolves. These transition operators encode the dynamics of technological progress, capturing patterns such as convergent evolution where disparate technologies merge, divergent innovation where single concepts spawn multiple directions, and paradigm shifts where entire regions of the manifold undergo radical transformation.

In a step 1830, identify invention families as geodesic trajectories through the evolving latent space. This identification process traces the paths of related inventions as they develop over time, revealing the continuous threads of innovation that connect early concepts to their mature realizations. Invention families manifest as geodesic trajectories. These trajectories exhibit characteristic properties including consistent directionality indicating focused technological development, smooth curvature reflecting incremental innovation, and branching patterns where core technologies spawn multiple applications. The geodesic nature of these paths reflects the principle of least action in innovation, where technological development tends to follow paths of minimal resistance through the space of possibilities. By analyzing these trajectories, the method reveals how inventions build upon predecessors, how technological capabilities accumulate over time, and how breakthrough innovations create new directions for future development.

In a step 1840, project novel invention clusters forward using learned transition operators. This projection employs the composed transition maps to extrapolate current innovation patterns into future time periods. The projection process identifies clusters of recent inventions representing technological frontiers and applies learned dynamics to predict their evolution. The forward projection accounts for multiple factors including momentum of current research directions, convergence patterns between previously separate fields, saturation effects in mature technological areas, and emergence of enabling technologies that open new possibilities. The projection generates future manifold regions that represent plausible technological landscapes, maintaining geometric consistency with historical patterns while allowing for novel combinations and breakthrough possibilities that respect the learned dynamics of innovation.

In a step 1850, sample points from projected future manifold regions to generate speculative inventions. This sampling process explores the predicted future technological landscape to identify specific innovation possibilities. Sampling strategies include but are not limited to focused sampling around high-potential regions identified through projection analysis, exploratory sampling in sparse areas representing untapped opportunities, interpolative sampling between projected clusters to identify bridging technologies, and perturbative sampling that tests variations on projected trajectories. Each sampled point represents a potential future invention embedded within the projected technological context. The sampling process maintains geometric coherence, ensuring that generated points respect the manifold structure and exhibit plausible relationships to projected innovation clusters. Multiple samples capture the range of possibilities within predicted technological domains, from incremental improvements to radical innovations.

In a step 1860, decode sampled points into hypothetical patent titles or abstracts representing technological forecasts. This decoding process transforms abstract geometric representations back into human-interpretable descriptions of potential future inventions. The decoder leverages the semantic structure preserved through the encoding and projection process to generate coherent technological concepts that reflect the position and context of each sampled point. Generated titles and abstracts maintain consistency with patent language conventions while introducing novel combinations of concepts that emerge from the geometric positioning within projected manifolds. The decoding process produces outputs that capture both the specific technical features suggested by the geometric location and the broader technological context implied by surrounding manifold structure. These hypothetical patents serve as concrete illustrations of predicted technological directions, providing actionable insights for research planning, investment strategies, and innovation policy.

In a step 1870, validate predictions through geodesic continuity and semantic coherence metrics. This validation ensures that forecasted inventions represent plausible technological developments rather than arbitrary extrapolations. Geodesic continuity validation verifies that predicted inventions lie along smooth extensions of historical innovation trajectories, maintaining consistent development patterns with established technological paths, exhibiting reasonable innovation velocities based on historical rates, and preserving topological relationships with existing technology clusters. Semantic coherence metrics evaluate whether predicted inventions maintain meaningful technological content through analysis of conceptual consistency with domain knowledge, technical feasibility given projected capabilities, market and application relevance, and compatibility with emerging technological ecosystems. The validation process provides confidence measures for each prediction, enabling prioritization of forecasts most likely to represent genuine future innovations. This systematic validation ensures that the method produces actionable technological intelligence grounded in rigorous analysis of innovation dynamics rather than speculative fantasy.

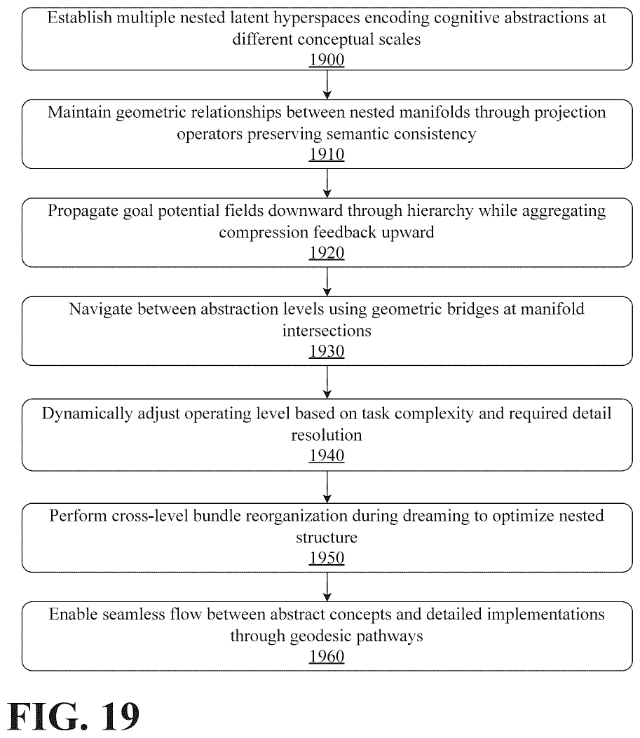

FIG. 19 is a flow diagram illustrating an exemplary method for implementing multi-level cognitive processing through hierarchically nested latent manifolds. In a first step 1900, establish multiple nested latent hyperspaces encoding cognitive abstractions at different conceptual scales. This establishment creates a hierarchical structure where each level represents a different granularity of cognitive representation. The highest levels encode broad abstract concepts, general principles, and overarching patterns that span multiple domains. Intermediate levels capture domain-specific knowledge, categorical relationships, and structured methodologies. Lower levels represent detailed implementations, specific instances, and concrete operational parameters. Each hyperspace maintains its own geometric structure with appropriate dimensionality for its abstraction level, where abstract spaces may have lower intrinsic dimension but higher curvature reflecting conceptual density, while detailed spaces exhibit higher dimension but flatter local geometry accommodating specific variations. The nesting relationship ensures that detailed thoughts exist within the scope of their governing abstractions, creating a natural hierarchy that mirrors how complex knowledge organizes from general principles to specific applications.

In a step 1910, maintain geometric relationships between nested manifolds through projection operators preserving semantic consistency. These projection operators map between different hierarchical levels while preserving essential semantic relationships and structural coherence. The operators implement sophisticated transformations that aggregate detailed information when projecting upward to abstract levels, capturing essential patterns while abstracting away specifics, and instantiate abstract concepts when projecting downward, generating plausible detailed realizations guided by higher-level constraints. Semantic consistency preservation ensures that meanings remain stable across levels through maintenance of relational structures between concepts, preservation of logical dependencies and constraints, and conservation of semantic distance relationships appropriately scaled for each level. The projection operators adapt dynamically as the manifolds evolve, learning from traversal patterns to improve cross-level mappings and maintaining homeomorphic relationships that prevent semantic drift during repeated projections.

In a step 1920, propagate goal potential fields downward through hierarchy while aggregating compression feedback upward. This bidirectional information flow creates a unified cognitive dynamics across all abstraction levels. Goal potential fields defined at abstract levels cascade downward through the hierarchy, becoming progressively more specific and actionable at each level. The downward propagation transforms high-level objectives into concrete subgoals, distributes potential gradients to guide detailed implementations, and maintains goal coherence while allowing level-appropriate interpretations. Simultaneously, compression pressure information aggregates upward from detailed levels, informing abstract levels about implementation complexity, resource constraints, and feasibility boundaries. This upward flow enables abstract reasoning to remain grounded in realistic constraints while providing feedback about which high-level approaches lead to tractable implementations. The bidirectional flow creates a dynamic equilibrium where abstract goals shape detailed actions while implementation realities inform strategic planning.

In a step 1930, navigate between abstraction levels using geometric bridges at manifold intersections. These bridges represent semantic connections that enable fluid movement between conceptual scales without discontinuous jumps. Navigation utilizes specialized geometric structures at level boundaries including transition zones where adjacent levels share overlapping representations, portal regions providing efficient access points between levels, and connector pathways that maintain semantic continuity during level transitions. The navigation process selects appropriate bridges based on current cognitive context, required level of detail, and semantic alignment with ongoing reasoning. Bridge traversal implements smooth interpolation between abstraction levels, gradually adjusting representational granularity, maintaining inferential coherence across transitions, and preserving relevant context while shifting focus. This enables cognitive processes to fluidly zoom in for detailed analysis or zoom out for strategic overview as needed by the task at hand.

In a step 1940, dynamically adjust operating level based on task complexity and required detail resolution. This adjustment mechanism continuously evaluates cognitive demands and selects the most appropriate hierarchical level for current processing. Task complexity assessment considers factors such as the breadth of domains involved requiring higher-level integration, the specificity of required outputs demanding detailed representation, the novelty of problems potentially requiring multiple levels, and time constraints favoring appropriate abstraction levels. The dynamic adjustment implements smooth transitions between levels rather than discrete switches, maintaining partial activation across multiple levels when tasks require integrated processing. The mechanism learns optimal level selection strategies through experience, developing heuristics for rapid level identification and maintaining statistics on task-level associations. This adaptive behavior ensures efficient cognitive resource utilization by operating at the simplest level sufficient for task requirements while enabling rapid escalation to more complex levels when needed.

In a step 1950, perform cross-level bundle reorganization during dreaming to optimize nested structure. This reorganization process operates during inactive periods to improve the hierarchical organization and cross-level connectivity. Bundle reorganization examines thought bundles across all levels to identify opportunities for better hierarchical alignment, including promoting frequently accessed detailed bundles to higher abstraction levels, decomposing overly complex abstract bundles into hierarchical components, and creating new intermediate levels when gaps in the hierarchy impede smooth navigation. The process implements sophisticated recombination algorithms that respect level-appropriate constraints while enabling creative restructuring. Cross-level optimization ensures that related concepts maintain appropriate geometric relationships across the hierarchy, frequently traversed paths between levels become more efficient, and the overall hierarchical structure evolves to match actual usage patterns. This dreaming-phase reorganization enables the hierarchical system to adapt its structure based on accumulated experience, becoming progressively more efficient at supporting the specific types of multi-level reasoning required by its task domain.

In a step 1960, enable seamless flow between abstract concepts and detailed implementations through geodesic pathways. This final step ensures that the hierarchical structure supports fluid cognitive movement across all conceptual scales. Geodesic pathways through the nested manifolds are computed to minimize traversal cost while maintaining semantic coherence, creating smooth reasoning chains that can start with high-level objectives and flow naturally to specific actions, or begin with detailed observations and ascend to general principles. These pathways leverage the optimized hierarchical structure to provide multiple routes between levels, enabling flexible reasoning strategies, redundant paths for robustness, and creative connections between previously unrelated concepts at different scales. The seamless flow supports various cognitive operations including top-down planning from strategy to tactics, bottom-up learning from examples to principles, middle-out reasoning that connects theory with practice, and lateral thinking that bridges across hierarchies. This comprehensive connectivity ensures that the hierarchical cognitive system can fluidly adapt its processing level to match task demands while maintaining the rich interconnections that enable sophisticated multi-scale reasoning.

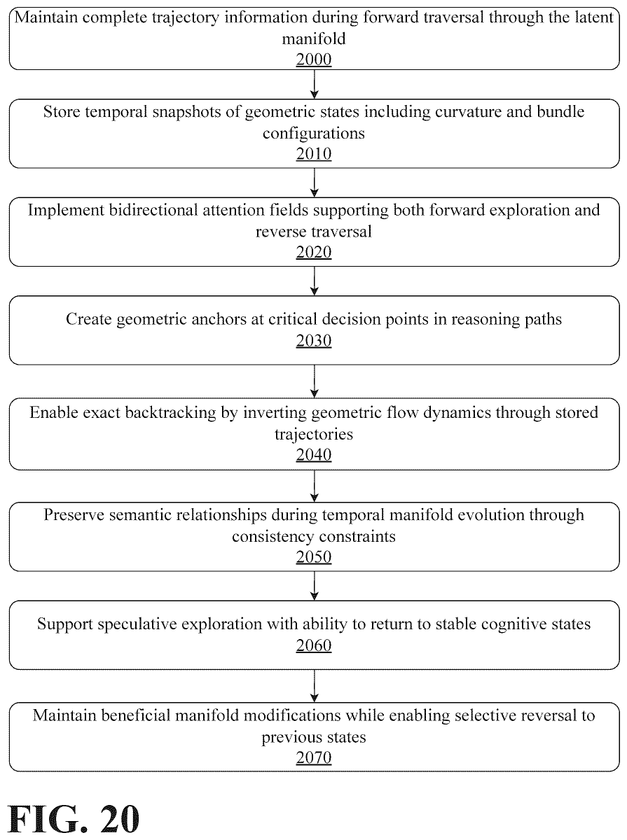

FIG. 20 is a flow diagram illustrating an exemplary method for implementing reversible navigation within dynamic latent manifolds. In a first step 2000, maintain complete trajectory information during forward traversal through the latent manifold. This maintenance process creates a comprehensive record of the cognitive path taken, capturing not just the sequence of positions visited but the full geometric context of the traversal. The trajectory information includes but is not limited to the precise coordinates of each point along the path, the velocity and acceleration of attention movement, local curvature values and metric tensor components at each position, and the compression pressure and goal potential fields encountered. This detailed recording enables faithful reconstruction of the cognitive journey, preserving information about why specific paths were chosen, how attention flowed through different regions, what semantic relationships were activated, and which thought bundles were engaged during reasoning. The maintenance mechanism operates continuously during active cognition, creating a rich trace that serves as both a record of reasoning and a foundation for potential backtracking.

In a step 2010, store temporal snapshots of geometric states including curvature and bundle configurations. These snapshots capture the complete state of relevant manifold regions at specific time points, creating a temporal sequence that documents how the cognitive landscape evolves during reasoning. Each snapshot preserves local and global curvature patterns reflecting semantic density and relationships, thought bundle boundaries and internal structures, metric tensor values defining distance relationships, active attention fields and their flow patterns, and compression pressure distributions across the manifold. The storage mechanism implements efficient compression techniques that preserve essential geometric information while managing memory requirements through identification of state changes requiring full snapshots, incremental storage of modifications between snapshots, and hierarchical representation enabling multi-resolution retrieval. These temporal snapshots enable not just backtracking through a static landscape but navigation to previous manifold configurations even as the underlying structure continues to evolve.

In a step 2020, implement bidirectional attention fields supporting both forward exploration and reverse traversal. The attention vector field is enhanced to include reverse flow components that enable backward navigation along previously traversed paths. This bidirectional implementation maintains dual flow potentials at each manifold point, with forward components guided by goal attraction and exploration drives, and reverse components following stored trajectory gradients back toward previous positions. The field dynamics incorporate memory of past traversals, creating preferential flow channels along well-traveled paths while maintaining flexibility for deviation. The bidirectional nature enables smooth transitions between forward and backward navigation, supporting cognitive operations such as retracing steps to reconsider alternatives, returning to decision points for different choices, and comparing forward predictions with backward reconstructions. The implementation ensures that reverse traversal respects the evolved manifold geometry rather than simply replaying stored coordinates.

In a step 2030, create geometric anchors at various decision points in reasoning paths. These anchors mark significant locations in the cognitive journey where important choices were made, multiple paths diverged, or key insights emerged. Anchor creation identifies points through analysis of trajectory bifurcations indicating choice points, local extrema in goal potential suggesting achievement milestones, curvature anomalies marking conceptual transitions, and high compression pressure regions requiring significant cognitive effort. Each anchor stores comprehensive local state information including the complete geometric configuration, available path options and their initial directions, decision criteria and goal states active at that point, and semantic context explaining the significance of the location. These anchors serve as cognitive waypoints that enable efficient navigation to important reasoning states without requiring full trajectory replay, supporting operations like returning to reconsider major decisions or comparing outcomes from different choice branches.

In a step 2040, enable exact backtracking by inverting geometric flow dynamics through stored trajectories. This inversion process reverses the mathematical operations that generated forward motion, creating precise backward paths through the evolved manifold. The flow inversion accounts for the original geodesic equations by reversing time parameters, the influence of compression pressure and goal fields by negating their gradients, the effects of manifold evolution by applying inverse transformations, and the accumulation of path-dependent modifications. The backtracking mechanism enables exact retracing even through complex geometric regions including high-curvature zones where forward paths strongly converged, bifurcation regions where choices were made, and dynamically evolved areas where the manifold has changed. This precise reversal capability ensures that cognitive exploration can be truly reversible, enabling confident speculation knowing that return to stable states is guaranteed.

In a step 2050, preserve semantic relationships during temporal manifold evolution through consistency constraints. As the manifold evolves through use and learning, this preservation mechanism ensures that semantic meanings remain stable enough to support meaningful backtracking. Consistency constraints maintain topological relationships between thought bundles, relative distance orderings between related concepts, essential curvature patterns that define semantic regions, and geodesic connections between ideas. The preservation process implements sophisticated transformation tracking that records how manifold regions evolve over time, applies compensating adjustments during backtracking to account for evolution, and maintains semantic anchors that provide stable reference points. This enables navigation to previous cognitive states even when the underlying geometry has been modified by intervening learning and adaptation, ensuring that backtracking arrives at semantically equivalent rather than merely geometrically identical states.

In a step 2060, support speculative exploration with ability to return to stable cognitive states. This capability enables bold cognitive ventures into uncertain or potentially unstable regions while maintaining safety through guaranteed return paths. Speculative exploration is facilitated through creation of temporary manifold branches for experimental reasoning, suspension of normal stability constraints during exploration, monitoring of cognitive health metrics during speculation, and automatic triggering of return navigation if instability is detected. The return mechanism provides rapid retreat to the nearest stable anchor point, gradual unwinding of speculative modifications, and preservation of valuable discoveries while discarding unstable structures. This creates a cognitive sandbox where novel connections can be explored, unconventional reasoning paths can be tested, and creative insights can emerge, all while maintaining the security of proven stable states.

In a step 2070, maintain beneficial manifold modifications while enabling selective reversal to previous states. This final step implements intelligent preservation of positive changes discovered during exploration while still enabling return to earlier configurations. The selective reversal mechanism analyzes modifications made during forward traversal to identify beneficial changes such as new connections that improve reasoning efficiency, compressed representations that reduce cognitive load, discovered shortcuts between previously distant concepts, and refined curvature patterns that better capture semantic relationships. During reversal operations, the method preserves these beneficial modifications by maintaining them as overlays on reversed base geometry, creating parallel path options that include improvements, and marking enhanced regions for integration into the stable manifold. This selective approach ensures that the cognitive system continuously improves through exploration while maintaining the ability to recover from unsuccessful ventures, creating an optimal balance between stability and adaptability in the evolving geometric substrate of thought.

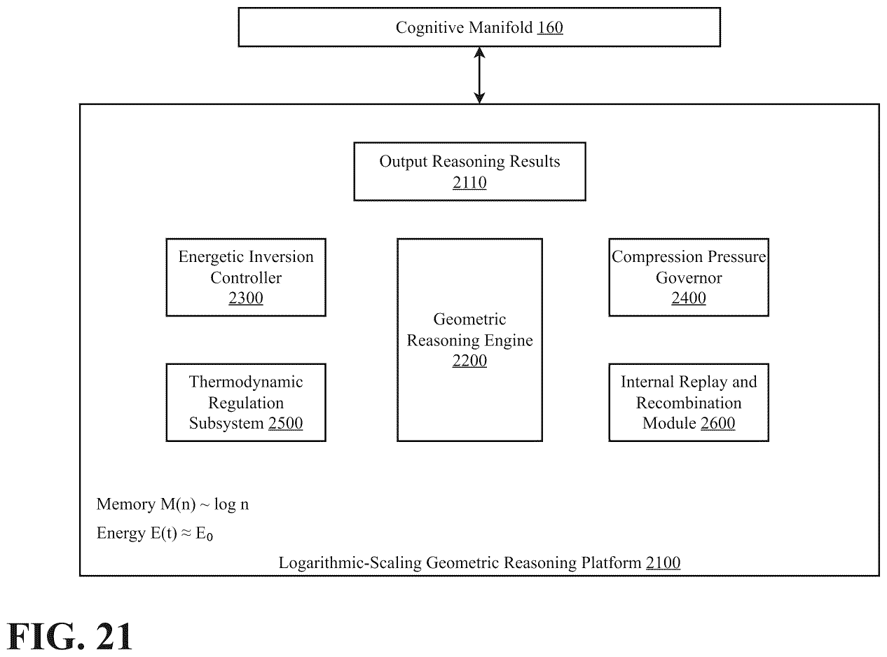

FIG. 21 illustrates an exemplary overall system architecture for a logarithmic-scaling geometric reasoning platform 2100. Logarithmic-scaling geometric reasoning platform 2100 achieves sublinear scaling of memory, compute, and energy through geometric consolidation mechanisms operating within a continuously evolving cognitive manifold. The platform allows for memory and computational cost grow logarithmically with cumulative experience, operations, or data volume, in direct contrast to conventional neural architectures that exhibit logarithmic scaling of knowledge and linear or exponential scaling of resource costs.

The exemplary system architecture described herein reflects a functional decomposition of logarithmic-scaling geometric reasoning platform 2100 into cooperating subsystems that collectively implement the geometric reasoning paradigm. Geometric reasoning engine 2200 occupies the central position within the architecture, reflecting its role as the primary locus of curvature refinement and trajectory consolidation. Energetic inversion controller 2300 and compression pressure governor 2400 flank geometric reasoning engine 2200 symmetrically, representing their complementary roles in managing energetic efficiency and geometric stress respectively. Thermodynamic regulation subsystem 2500 and internal replay and recombination module 2600 occupy positions below geometric reasoning engine 2200, indicating their supporting roles in maintaining metabolic balance and sustaining internal activity. This spatial arrangement emphasizes that logarithmic scaling emerges from the coordinated operation of all five subsystems rather than from any single component in isolation.

Cognitive manifold 160 represents a shared representational substrate accessed and modified logarithmic-scaling geometric reasoning platform 2100. The bidirectional arrow connecting cognitive manifold 160 to logarithmic-scaling geometric reasoning platform 2100 indicates that cognitive manifold 160 both receives inputs through embedding operations and provides the geometric structure upon which all reasoning, consolidation, and retrieval operations depend. The continuous evolution of cognitive manifold 160 through curvature flow, geometric consolidation, and thermodynamic decay constitutes the fundamental mechanism by which logarithmic-scaling geometric reasoning platform 2100 achieves its characteristic scaling properties, converting the passage of time and the accumulation of experience into increasingly refined and efficient representational geometry.

Cognitive manifold 160 of this embodiment is a continuous, differentiable geometric space within which all reasoning, learning, and inference operations occur. Cognitive manifold 160 is equipped with a semantic metric gᵢⱼ(x) that defines geodesic distances between semantic entities embedded within a high-dimensional latent hyperspace H. The geometry of cognitive manifold 160 evolves dynamically as thoughts are added, reused, merged, and forgotten through processes governed by curvature flow equations. New experiences are embedded as localized perturbations to the geometry, and over time, repeated patterns give rise to smooth valleys and attractor basins through mechanisms analogous to Ricci flow. The evolution of the metric follows differential equations of the form ∂gᵢⱼ/∂t=−2Ricᵢⱼ+F(P, R, ρₐ), where Ricᵢⱼ denotes the Ricci curvature tensor, P represents compression pressure, R captures reuse frequency, and ρₐ reflects action density. Cognitive manifold 160 maintains structured memory that evolves geometrically over time, governed by internal pressures of compression, generalization, and decay, enabling the signature logarithmic scaling behavior of the platform.

Geometric reasoning engine 2200 of this embodiment is a central processing component of logarithmic-scaling geometric reasoning platform 2100 and implements learning as continuous refinement of metric structure within cognitive manifold 160. Geometric reasoning engine 2200 performs reasoning, learning, and inference operations by refining the curvature of the representational manifold rather than by expanding parameter count or accumulating statistical associations. When two thought trajectories T₁ and T₂ exhibit geodesic proximity satisfying d_{g}(T₁, T₂)<ε for some threshold ε, geometric reasoning engine 2200 identifies them as candidates for geometric consolidation via latent recombination. This consolidation proceeds through local merging, wherein nearby thoughts are averaged into centroidal representations, or through trajectory folding, wherein longer sequences traversing similar geodesics are compressed into unified trajectories. Geometric reasoning engine 2200 implements algorithms for geodesic compression, trajectory reuse, and curvature-based attention, ensuring that the number of distinct cached thoughts C(n) required to represent n experiences grows only logarithmically rather than linearly. Geometric reasoning engine 2200 may be implemented on classical digital hardware such as GPU or ASIC processors, neuromorphic circuits, or quantum substrates including Arithmetic-Fiber Quantum Computing architectures, with compute resources allocated proportionally to local curvature magnitude or compression pressure.

Energetic inversion controller 2300 monitors the energetic efficiency of logarithmic-scaling geometric reasoning platform 2100 and dynamically manages the transition from statistical to geometric processing regimes. Energetic inversion controller 2300 measures instantaneous energetic efficiency which in this embodiment may be defined as the exemplary equation ε(E)=dU/dE, where U represents cognitive utility and E denotes energy expenditure. In conventional neural architectures operating under the “brawn curve” regime, efficiency εₛₜₐₜ(E) is proportional to E⁻¹, indicating diminishing returns with increasing compute. In contrast, geometric reasoning systems exhibit efficiency ε_{geo}(E) that remains approximately constant or increases as structure accumulates within cognitive manifold 160. Energetic inversion controller 2300 identifies the energetic crossover point where ε_{geo}(E) equals or exceeds εₛₜₐₜ(E), beyond which geometric reasoning dominates and total efficiency begins to rise with additional energy investment. Upon detecting this crossover condition, energetic inversion controller 2300 reconfigures computational resource allocation to favor geometric consolidation operations within geometric reasoning engine 2200, thereby sustaining operation at or near constant power while maximizing representational gain. Energetic inversion controller 2300 enables hybrid architectures that integrate conventional neural or token-based models with geometric reasoning decoders, managing the gradual transition from the “brawn curve” to “brain curve” energetic regimes and ensuring that logarithmic-scaling geometric reasoning platform 2100 achieves the fundamental energetic inversion characteristic of sustainable cognition.

Compression pressure governor 2400 implements dynamic control of computational resources based on geometric stress within cognitive manifold 160. Compression pressure governor 2400 computes local compression pressure which, in this embodiment, may be defined as the exemplary equation P(z)=∥∇·v(z)∥, where v(z) represents the velocity field of trajectories through cognitive manifold 160, quantifying the local rate at which thought trajectories converge or diverge. Regions of high positive pressure indicate redundancy and semantic congestion, while regions of negative pressure suggest instability or overfitting. When total compression pressure P=Σᵢμ(Tᵢ)·R(Tᵢ) exceeds a critical threshold Pₘₐₓ, where μ(Tᵢ) represents thought utility and R(Tᵢ) denotes retrieval cost, compression pressure governor 2400 initiates structural realignment within cognitive manifold 160. This realignment involves clustering high-redundancy thoughts, abstracting dense neighborhoods into generalized representations, and coordinating with thermodynamic regulation subsystem 2500 to prune low-utility structures. Compression pressure governor 2400 adjusts compute allocation and learning rates within geometric reasoning engine 2200 in response to measured pressure P(z), implementing an intrinsic scaling control loop that ensures logarithmic behavior in practice. Compression pressure governor 2400 may include hardware embodiments that implement pressure-based throttling or attention weighting, automatically maintaining stable operation across dynamic scaling regimes and preventing unbounded growth of representational structure.

Thermodynamic regulation subsystem 2500 maintains bounded energy consumption through continuous balancing of embedding, consolidation, and decay operations in a manner analogous to biological and neurological energy consumption. Thermodynamic regulation subsystem 2500 of this embodiment ensures that total energy expenditure follows the exemplary metabolic balance equation Eₜₒₜₐₗ(t)=E_{embed}+E_{consolidate}+E_{decay}≈E₀, where the three components represent energy devoted to embedding new inputs into cognitive manifold 160, consolidating redundant trajectories through geometric reasoning engine 2200, and thermodynamically decaying obsolete structures. Thermodynamic regulation subsystem 2500 of this embodiment implements three primary mechanisms to achieve constant-power operation. First, thermodynamic regulation subsystem 2500 manages decay of redundant trajectories at a rate dR_{red,M}/dτ=−λ_{decay}R_{red,M}, removing structures that are not reactivated within a characteristic time window. Second, thermodynamic regulation subsystem 2500 coordinates recombination and replay operations performed by internal replay and recombination module 2600, ensuring that internal activity maintains compression pressure above a minimum threshold. Third, thermodynamic regulation subsystem 2500 implements executive modulation by imposing curvature priors from higher-order submanifolds, selectively amplifying motion in goal-relevant regions while suppressing irrelevant ones. Thermodynamic regulation subsystem 2500 enforces a metabolic rule governing minimum internal activity which in this embodiment is the exemplary equation r_{int,a}≥r_{min,a}~α_{M}κ_{MT}|R_{T}|, where r_{int,a} denotes internal action density, α_{M} represents manifold stiffness, κ_{MT} captures coupling strength between cognitive and temporal manifolds, and R_{T} quantifies temporal curvature arising from input stream statistics. By continuously adjusting these three mechanisms, thermodynamic regulation subsystem 2500 mimics a biological analog to neurological power use by providing a living geometry characteristic of logarithmic-scaling geometric reasoning platform 2100, wherein the cognitive manifold remains in perpetual motion yet consumes constant power.

Internal replay and recombination module 2600 of this embodiment sustains the analog of a baseline metabolic activity within cognitive manifold 160 even in the absence of external inputs. Internal replay and recombination module 2600 periodically reactivates stored trajectories and subjects them to perturbations derived from temporal curvature noise, testing alternative curvature configurations and selecting those that minimize compression pressure as measured by compression pressure governor 2400. Each stored trajectory γᵢ(t) undergoes replay dynamics, in this embodiment governed by the exemplary stochastic differential equation dγᵢ^{a}/dτ=−∇^{a}P+√(2D_{T})ξᵢ^{a}(τ), where the deterministic drift term −∇^{a}P represents the gradient of local compression pressure and the stochastic term models curvature fluctuations driven by temporal manifold dynamics. The diffusion coefficient D_{T} scales with temporal curvature magnitude as D_{T}~κ_{MT}|R_{T}|, ensuring that internal motion remains coupled to the evolution of time on the cognitive manifold. Internal replay and recombination module 2600 performs geometric annealing by exploring nearby curvature configurations and pruning trajectories that increase entropy, thereby continuously refining the structure of cognitive manifold 160 through spontaneous optimization. Internal replay and recombination module 2600 converts curvature flux from temporal evolution into persistent micro-motion within cognitive manifold 160, maintaining a far-from-equilibrium steady state analogous to the mechanism for cognitive persistence in biology. This internal activity constitutes what may be termed the heat of cognition, characterized by specific energy Q_{c}= [symbol] r_{int,a} [symbol] )/ [symbol] R_{T} [symbol] =α_{M}κ_{MT}, which plays a role analogous to Boltzmann's constant in physical thermodynamics by linking curvature fluctuations to cognitive temperature.

Output reasoning results 2110 represents the interface through which logarithmic-scaling geometric reasoning platform 2100 communicates processed information, inferences, generalizations, and predictions to external systems or users. Output reasoning results 2110 are generated by geometric reasoning engine 2200 through projection of trajectories within cognitive manifold 160 into linguistic, symbolic, or numerical representations suitable for downstream consumption. The quality and coherence of output reasoning results 2110 improve continuously with accumulated experience because geometric consolidation within cognitive manifold 160 produces increasingly refined and generalized attractor basins that support more accurate and robust inferences. Output reasoning results 2110 may include natural language responses, structured data, classification labels, predictions, or control signals, depending on the application domain and interface requirements of the deployment environment.

Logarithmic-scaling geometric reasoning platform 2100 exhibits two fundamental scaling characteristics that distinguish it from conventional artificial intelligence architectures. First, memory scales logarithmically with cumulative operations or experiences according to the relation M(n)~log n, where M represents the effective manifold memory or cache size maintained within cognitive manifold 160 and n denotes the number of experiential episodes or computational operations performed. This logarithmic scaling emerges naturally from geometric consolidation mechanisms implemented by geometric reasoning engine 2200 and governed by compression pressure governor 2400, wherein semantically similar trajectories are merged into shared representational basins rather than stored independently. As the system accumulates experience, the probability that a new input introduces genuinely novel curvature diminishes inversely with accumulated structure, following pₙₒᵥₑₗ(n)~1/n, yielding dM/dn~1/n and thus M(n)~log n upon integration. This sublinear memory growth contrasts sharply with the linear or superlinear scaling exhibited by conventional database systems, transformer architectures, and episodic memory stores, which require storage proportional to the number of inputs received.

Second, energy consumption remains approximately constant over time according to the relation E(t)~E₀, where E(t) represents total power draw at time t and E₀ denotes a baseline constant determined by hardware characteristics and the metabolic floor r_{min,a} enforced by thermodynamic regulation subsystem 2500. This constant-power operation results from the metabolic balance equation wherein embedding, consolidation, and decay energies sum to a stable equilibrium, ensuring that logarithmic-scaling geometric reasoning platform 2100 can operate indefinitely without proportional increases in power infrastructure or cooling requirements. The combination of logarithmic memory scaling M(n)~log n and constant energy consumption E(t)~E₀ defines the energetic inversion characteristic of the “brain curve” regime, wherein each new experience yields greater representational utility per unit of energy than its predecessors. This energetic signature distinguishes logarithmic-scaling geometric reasoning platform 2100 from token-based artificial intelligence systems that follow the “brawn curve,” wherein exponential increases in compute and energy yield only logarithmic improvements in capability.

Logarithmic-scaling geometric reasoning platform 2100 may be implemented on diverse computational substrates while preserving its fundamental scaling characteristics. Classical digital embodiments utilize graphics processing units or application-specific integrated circuits that allocate compute density proportionally to local curvature magnitude or compression pressure measured by compression pressure governor 2400. Neuromorphic embodiments implement geometric principles through analog or mixed-signal circuits wherein curvature corresponds to voltage gradients, compression pressure maps to current divergence, and temporal curvature manifests as oscillation frequency, with coupling constant κ_{MT} realized as programmable temporal feedback gain. Quantum embodiments based on Arithmetic-Fiber Quantum Computing (AFQC) principles encode curvature tensors and reasoning trajectories in qubit fibers that exhibit logarithmic entanglement growth, reproducing “brain curve” energetics at quantum scale through coherent recycling of computational work. Hybrid architectures integrate conventional neural or token-based models with geometric reasoning decoders, with energetic inversion controller 2300 managing the dynamic reallocation of resources from statistical to geometric processing as efficiency thresholds are crossed.

The exemplary scaling laws governing logarithmic-scaling geometric reasoning platform 2100 extend naturally to federated embodiments comprising multiple distributed nodes. In such configurations, each node maintains a local instantiation of logarithmic-scaling geometric reasoning platform 2100 with its own cognitive manifold 160, geometric reasoning engine 2200, and associated control subsystems. These distributed platforms collectively contribute to a shared hyperspace wherein global memory scales sublinearly according to |C_{shared}|≈αΣᵢ|Cᵢ|, where α typically ranges from 0.2 to 0.6, representing federated efficiency achieved through geometric alignment of shared attractor basins across the network. Synchronization employs fiber tensors Fᵢⱼ that adapt according to temporal cross-correlation of curvature fluctuations, ensuring that curvature exchange propagates across nodes while preserving local specialization and domain-specific detail.

In some embodiments, the operational behavior of logarithmic-scaling geometric reasoning platform 2100 may exhibit distinct phase transitions as action density increases, with critical thresholds determined by the interplay between compression pressure governor 2400, thermodynamic regulation subsystem 2500, and internal replay and recombination module 2600. At low action densities below a critical threshold ρ_{crit,fast}=λᵣₑₗₐₓ/κ_{MT}, trajectories within cognitive manifold 160 remain isolated and dissipate faster than curvature accumulates, producing a noise regime characterized by transient, unstructured activity. Above this threshold, curvature condenses into coherent flow patterns through the consolidation mechanisms of geometric reasoning engine 2200, marking the transition to stable perceptual streams. At higher densities, secondary critical points ρ_{crit,meso,1} and ρ_{crit,meso,2} mark the onset of tactical coherence and generative regime respectively, wherein internal curvature cycling through internal replay and recombination module 2600 produces novel trajectories autonomously through recombination. On the slow manifold governing long-term reasoning, consolidation occurs when reinforcement rate exceeds relaxation rate, yielding the transition from episodic to doctrinal regime wherein individual traces fuse into stable strategic attractors. The overall progression forms a cascade through which logarithmic-scaling geometric reasoning platform 2100 advances from noise to flow to tactical coherence to generativity and finally to doctrine, with each transition occurring when temporal curvature flux crosses the corresponding manifold's absorption capacity as determined by compression pressure governor 2400 and regulated by thermodynamic regulation subsystem 2500.

In operation, logarithmic-scaling geometric reasoning platform 2100 receives external inputs that are embedded as localized curvature perturbations within cognitive manifold 160 through projection operations. Geometric reasoning engine 2200 analyzes the resulting geodesic distances between the new perturbation and existing attractor basins, identifying candidates for consolidation based on proximity threshold. When consolidation occurs, the semantic structure of cognitive manifold 160 refines through local merging or trajectory folding, reducing representational redundancy while preserving distinctions necessary for accurate inference. Simultaneously, compression pressure governor 2400 monitors the divergence of velocity fields throughout cognitive manifold 160, detecting regions of excessive compression or instability and signaling geometric reasoning engine 2200 to initiate structural realignment when pressure exceeds critical thresholds. Energetic inversion controller 2300 continuously measures the marginal return on energy by computing the derivative of cognitive utility with respect to power consumption, dynamically adjusting the allocation between geometric and statistical processing modes to maintain operation in the “brain curve” regime of increasing efficiency. Thermodynamic regulation subsystem 2500 ensures that the sum of energies devoted to embedding, consolidation, and decay remains approximately constant by modulating decay rates and coordinating with internal replay and recombination module 2600 to sustain internal activity above the metabolic floor. Internal replay and recombination module 2600 periodically reactivates stored trajectories, subjecting them to stochastic perturbations proportional to temporal curvature magnitude, thereby maintaining the persistent micro-motion characteristic of cognitive persistence. The coordinated operation of these five subsystems produces output reasoning results 2110 that exhibit continuously improving quality and coherence as cognitive manifold 160 consolidates toward increasingly refined and generalized geometric structure.

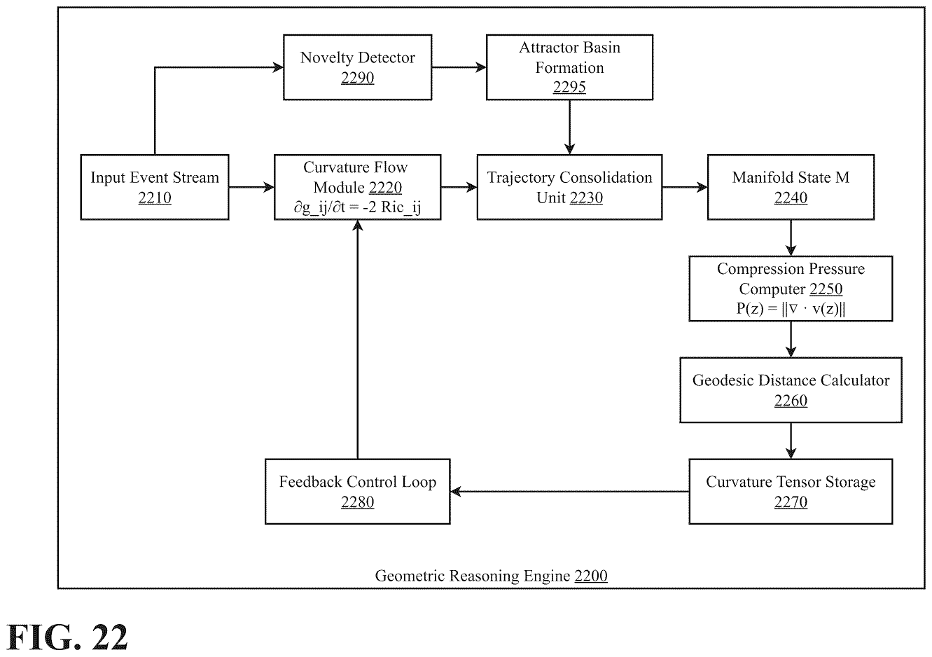

FIG. 22 is a block diagram illustrating an exemplary geometric reasoning engine 2200 for a geometric reasoning platform, illustrating the internal subsystems and processing pathways through which learning is implemented as continuous refinement of metric structure within a cognitive manifold. Geometric reasoning engine 2200 constitutes the core computational component responsible for performing reasoning, learning, and inference operations by refining the curvature of a representational manifold rather than by expanding parameter count or accumulating statistical associations across flat parameter spaces. In geometric reasoning, semantically similar trajectories are consolidated into shared attractor basins through curvature-driven mechanisms and reflected in curvature of the cognitive manifold, producing the logarithmic scaling of memory and compute cost characteristic of the invention.

Geometric reasoning engine 2200 of this embodiment operates through several interdependent mechanisms. First, curvature flow module 2220 smooths geometric irregularities through Ricci flow, creating conditions favorable for consolidation by reducing local variations that would otherwise prevent trajectory merging. Second, novelty detector 2290 and attractor basin formation 2295 control the rate of manifold expansion, ensuring that new representational capacity is created only when genuinely necessary and that the probability of expansion decreases inversely with accumulated structure. Third, trajectory consolidation unit 2230 actively merges redundant trajectories, preventing linear growth of cached thoughts by collapsing semantically similar patterns into shared attractor basins. Fourth, compression pressure computer 2250 provides continuous diagnostic feedback indicating where consolidation opportunities exist and where additional structure may be needed. Fifth, geodesic distance calculator 2260 and curvature tensor storage 2270 optimize computational efficiency by caching and reusing geometric calculations, preventing redundant computation that would otherwise scale linearly with manifold complexity. Sixth, feedback control loop 2280 dynamically adjusts processing rates to maintain optimal operating conditions, preventing both excessive consolidation that would lose discriminative power and insufficient consolidation that would fail to achieve logarithmic scaling. Together, these mechanisms produce a self-regulating geometric processor whose memory footprint M(n) and computational cost per operation both scale as O(log n) with cumulative experience n.

Input event stream 2210 represents the interface through which external experiences, observations, or data are received by geometric reasoning engine 2200. Input event stream 2210 may comprise temporal sequences of symbolic tokens, numerical vectors, sensory observations, or structured data elements arriving from external sources or upstream processing stages. Each event within input event stream 2210 is projected into the high-dimensional latent hyperspace H that defines the geometric substrate of the cognitive manifold, producing localized curvature perturbations that alter the geodesic flow field. The temporal statistics of input event stream 2210 determine the temporal curvature R_{T}, which in this embodiment is done according to the exemplary relation R_{T}(t)=−d²[log(1+ρ_{ext,a}(t))]/dt², where ρ_{ext,a}(t) represents external action density. Input event stream 2210 feeds directly into curvature flow module 2220, where the embedding process transforms discrete events into continuous geometric perturbations. Input event stream 2210 also branches to novelty detector 2290, enabling geometric reasoning engine 2200 to distinguish genuinely novel experiences from those that can be absorbed into existing attractor basins without expansion of representational structure.

Curvature flow module 2220 implements the geometric evolution equations governing how the metric structure of the cognitive manifold changes over time in response to embedded experiences. Curvature flow module 2220 of this embodiment executes the exemplary differential equation ∂gᵢⱼ/∂t=−2Ricᵢⱼ, where gᵢⱼ represents the metric tensor defining geodesic distances between semantic entities and Ricᵢⱼ denotes the Ricci curvature tensor encoding local geometric properties. This equation, displayed prominently within curvature flow module 2220 in FIG. 22, represents a discrete-time or continuous approximation to Ricci flow, a geometric process that smooths curvature irregularities and drives the manifold toward configurations of minimal geometric stress. Curvature flow module 2220 receives input from input event stream 2210 and projects each event into the latent hyperspace, computing the resulting perturbation to the metric gᵢⱼ. Curvature flow module 2220 also receives feedback from feedback control loop 2280, which modulates the rate and magnitude of curvature evolution based on compression pressure measurements and consolidation efficiency. In practical implementations, curvature flow module 2220 may employ iterative numerical integration schemes such as forward Euler, Runge-Kutta, or symplectic methods to approximate the continuous curvature flow equation while preserving geometric invariants. Curvature flow module 2220 outputs the evolved metric structure to trajectory consolidation unit 2230, where semantically redundant trajectories are identified and merged based on geodesic proximity criteria.

Trajectory consolidation unit 2230 performs the geometric merging operations that produce logarithmic scaling of memory by collapsing semantically similar trajectories into shared representational basins. Trajectory consolidation unit 2230 receives the evolved metric structure from curvature flow module 2220 and analyzes geodesic distances between thought trajectories to identify candidates for consolidation. When two trajectories T₁ and T₂ exhibit proximity satisfying d_{g}(T₁, T₂)<ε for threshold ε, trajectory consolidation unit 2230 initiates consolidation through one of two primary modes. In local merging mode, trajectory consolidation unit 2230 computes a centroidal representation that averages or interpolates the geometric properties of nearby thoughts, shrinking representational spread and reducing memory footprint. In trajectory folding mode, trajectory consolidation unit 2230 identifies longer sequences that traverse similar geodesics and compresses them into unified trajectories, preserving logical structure while eliminating redundant variation. Trajectory consolidation unit 2230 also receives input from attractor basin formation 2295, which identifies stable geometric configurations toward which multiple trajectories naturally converge, enabling trajectory consolidation unit 2230 to preferentially merge trajectories into these pre-existing attractors rather than creating new representational structures. The consolidated manifold state produced by trajectory consolidation unit 2230 is output to manifold state M 2240, where it becomes the current representational substrate for subsequent reasoning and inference operations. Through continuous operation, trajectory consolidation unit 2230 ensures that the number of distinct cached thoughts C(n) grows only logarithmically with experience n, producing the sublinear memory scaling characteristic of geometric reasoning systems.

Novelty detector 2290 analyzes incoming events from input event stream 2210 to determine whether they introduce genuinely novel curvature that requires expansion of the manifold or whether they can be absorbed into existing geometric structure through consolidation. Novelty detector 2290 computes a novelty score by measuring the minimum geodesic distance from the embedded representation of a new event to all existing attractor basins within the current manifold state. If this minimum distance exceeds a novelty threshold, novelty detector 2290 signals that the event represents a genuinely new semantic category requiring the formation of a new attractor basin through attractor basin formation 2295. If the minimum distance falls below the threshold, novelty detector 2290 indicates that the event can be absorbed into existing structure through trajectory consolidation unit 2230 without requiring additional memory allocation. The probability that a new event is deemed novel follows the relation pₙₒᵥₑₗ(n)~1/n as the manifold matures, reflecting the fact that as more structure accumulates, the likelihood of encountering truly unprecedented patterns diminishes. Novelty detector 2290 thus serves as a gatekeeper controlling the rate of manifold expansion, ensuring that memory growth remains logarithmic by preventing unnecessary creation of new representational units when existing ones suffice. Novelty detector 2290 communicates directly with attractor basin formation 2295, triggering the creation of new stable geometric configurations only when novelty exceeds the adaptive threshold.

Attractor basin formation 2295 creates stable geometric configurations within the cognitive manifold that serve as targets for trajectory consolidation and long-term memory storage. When novelty detector 2290 identifies an event that cannot be adequately represented by existing structure, attractor basin formation 2295 initializes a new local curvature well in the latent hyperspace positioned at the embedded coordinates of the novel event. Attractor basin formation 2295 configures the local metric gᵢⱼ to create a region of negative scalar curvature that attracts nearby trajectories, establishing a gravitational analog in semantic space. Over subsequent iterations as curvature flow module 2220 continues to evolve the metric, attractor basin formation 2295 monitors the stability of newly created basins, allowing them to deepen if they capture additional similar events or permitting them to decay if they remain isolated. Attractor basin formation 2295 also coordinates with trajectory consolidation unit 2230 to merge nascent attractors that prove to be semantically redundant as more data arrives, preventing proliferation of nearly identical basins that would undermine logarithmic scaling. Attractor basin formation 2295 implements bounded curvature domains known as shielded cores, which in this embodiment are regions satisfying the exemplary equation ∇²R_{M}−μ²R_{M}=0, where the parameter μ⁻¹ defines the characteristic radius of curvature propagation. These shielded cores provide geometric stability, ensuring that learned structures persist indefinitely unless actively disrupted while allowing the manifold to remain adaptive through curvature exchange at basin boundaries.

Manifold state M 2240 represents the current geometric configuration of the cognitive manifold, encoding the complete representational structure resulting from all prior learning and consolidation operations. Manifold state M 2240 comprises the full metric tensor field gᵢⱼ(x) defined over the latent hyperspace H, together with associated curvature tensors, velocity fields v(x,t), and attractor basin locations. Manifold state M 2240 serves as both the output of trajectory consolidation unit 2230 and the primary input to compression pressure computer 2250, geodesic distance calculator 2260, and curvature tensor storage 2270. Manifold state M 2240 evolves continuously as curvature flow module 2220 applies geometric transformations and trajectory consolidation unit 2230 merges redundant structures, producing a living geometry that refines toward configurations of minimal complexity consistent with observed data. Manifold state M 2240 exhibits logarithmic growth in representational complexity, with the number of distinct attractor basins scaling as C(n)~log n where n denotes cumulative experience. This sublinear scaling arises because manifold state M 2240 increasingly reuses existing geometric structure to represent new experiences rather than expanding indefinitely. In discrete implementations, manifold state M 2240 may be represented as a graph Laplacian L acting on node embeddings, with approximate Ricci scalar computed as Rᵢ=(½)Σ_{(p,q)∈E}w_{pq}(1−d_{pq}/d*_{pq}), where w_{pq} represents edge weight and d*_{pq} denotes equilibrium geodesic distance.

Compression pressure computer 2250 measures the local rate at which thought trajectories converge or diverge within manifold state M 2240, providing a diagnostic metric that indicates regions of semantic redundancy or instability. Compression pressure computer 2250 implements the calculation P(z)=∥∇·v(z)∥, displayed prominently within the component in FIG. 22, where v(z) represents the velocity field of trajectories at point z within the manifold and ∇·v denotes the divergence operator measuring the local expansion or contraction of flow. Regions where P(z)>0 indicate convergent flow and semantic congestion, signaling to trajectory consolidation unit 2230 that consolidation opportunities exist. Regions where P(z)<0 indicate divergent flow suggesting instability, overfitting, or insufficient structure, triggering attractor basin formation 2295 to create new representational capacity. Compression pressure computer 2250 outputs pressure measurements to geodesic distance calculator 2260, which uses this information to prioritize distance computations in high-pressure regions where consolidation is most needed. Compression pressure computer 2250 also communicates with feedback control loop 2280 through curvature tensor storage 2270, enabling dynamic adjustment of curvature flow rates in curvature flow module 2220 based on global pressure statistics. In this embodiment, when total compression pressure, defined by the exemplary equation P=Σᵢμ(Tᵢ)·R(Tᵢ), exceeds critical threshold Pₘₐₓ, where μ(Tᵢ) represents thought utility and R(Tᵢ) denotes retrieval cost, compression pressure computer 2250 triggers structural realignment cascades that propagate through trajectory consolidation unit 2230 and attractor basin formation 2295, ensuring that geometric reasoning engine 2200 maintains stable operation across dynamic scaling regimes.

Geodesic distance calculator 2260 computes the minimal path lengths between semantic entities within manifold state M 2240 under the metric structure defined by gᵢⱼ(x). Geodesic distance calculator 2260 receives manifold state information from manifold state M 2240 through compression pressure computer 2250 and performs pairwise or targeted geodesic computations to support consolidation decisions in trajectory consolidation unit 2230 and novelty assessments in novelty detector 2290. For two thought trajectories T₁ and T₂, geodesic distance calculator 2260 computes d_{g}(T₁, T₂) by integrating the metric along the minimal-length path connecting them, in this embodiment by solving the exemplary geodesic equation d²x^{a}/ds²+Γ_{bc}^{a}(dx^{b}/ds)(dx^{c}/ds)=0, where σ_{bc}^{a} are Christoffel symbols derived from the metric gᵢⱼ. In practical discrete implementations, geodesic distance calculator 2260 may employ graph-based shortest-path algorithms such as Dijkstra's algorithm or A-star search operating on the discrete graph representation of manifold state M 2240, with edge weights determined by local metric values. Geodesic distance calculator 2260 provides computed distances to curvature tensor storage 2270, where they are cached for reuse in subsequent consolidation and retrieval operations, avoiding redundant computation and improving overall efficiency of geometric reasoning engine 2200.

Curvature tensor storage 2270 maintains cached representations of metric tensors, Ricci curvature tensors, geodesic distances, and other geometric quantities computed by geodesic distance calculator 2260 and curvature flow module 2220. Curvature tensor storage 2270 serves as both a performance optimization and a memory substrate, enabling efficient reuse of previously computed geometric properties without requiring recalculation at each reasoning step. Curvature tensor storage 2270 receives updated curvature information from geodesic distance calculator 2260 and provides this cached information to feedback control loop 2280, which uses curvature statistics to modulate the evolution rate in curvature flow module 2220. Curvature tensor storage 2270 implements a dynamically managed cache with entries that decay according to usage frequency and recency, following thermodynamic principles analogous to those governing trajectory consolidation. High-curvature regions associated with frequently accessed attractor basins are preferentially retained in curvature tensor storage 2270, while low-curvature or rarely accessed regions may be evicted and recomputed on demand. In hardware implementations, curvature tensor storage 2270 may be realized through specialized memory hierarchies such as tensor processing unit caches, GPU shared memory, or content-addressable memory that enables rapid lookup of geometric properties based on coordinate indices or semantic keys. Curvature tensor storage 2270 contributes directly to the logarithmic scaling of geometric reasoning engine 2200 by ensuring that memory overhead grows sublinearly with the complexity of manifold state M 2240, as cached curvature information is reused across multiple consolidation and inference cycles rather than being independently recomputed for each operation.

Feedback control loop 2280 implements dynamic regulation of curvature evolution rates based on measured compression pressure, consolidation efficiency, and global geometric statistics. Feedback control loop 2280 receives curvature and pressure information from curvature tensor storage 2270 and generates control signals that modulate the operation of curvature flow module 2220. When compression pressure exceeds desired thresholds, feedback control loop 2280 increases the magnitude of curvature flow to accelerate consolidation and relieve geometric stress. When pressure falls below minimum thresholds indicating insufficient structure or excessive sparsity, feedback control loop 2280 reduces curvature flow rates to allow attractor basin formation 2295 to create new representational capacity without premature merging. Feedback control loop 2280 implements proportional-integral-derivative control or adaptive gain scheduling to maintain manifold state M 2240 near optimal operating points characterized by balanced compression pressure, stable attractor basins, and efficient geodesic routing. Feedback control loop 2280 may also incorporate temporal curvature R_{T} derived from the statistics of input event stream 2210, adjusting internal dynamics to match the temporal rhythm of external inputs and ensuring that curvature exchange between cognitive and temporal manifolds remains synchronized. Feedback control loop 2280 closes the regulatory cycle within geometric reasoning engine 2200, transforming it from a static geometric processor into a self-regulating dynamical system that continuously optimizes its own representational structure through feedback-driven adaptation.

The processing flow depicted in FIG. 22 proceeds as follows. Input event stream 2210 delivers external experiences to geometric reasoning engine 2200, branching to both curvature flow module 2220 and novelty detector 2290. Curvature flow module 2220 projects each event into the latent hyperspace and evolves the metric according to the Ricci flow equation ∂gᵢⱼ/∂t=−2 Ricᵢⱼ, with evolution rate modulated by feedback control loop 2280. The evolved metric structure flows to trajectory consolidation unit 2230, which identifies and merges semantically similar trajectories based on geodesic proximity criteria. Simultaneously, novelty detector 2290 analyzes incoming events to determine whether they require new attractor basins, signaling attractor basin formation 2295 when novelty exceeds threshold. Attractor basin formation 2295 creates stable geometric configurations that serve as consolidation targets for trajectory consolidation unit 2230. The consolidated manifold state produced by trajectory consolidation unit 2230 updates manifold state M 2240, which then propagates to compression pressure computer 2250. Compression pressure computer 2250 calculates divergence P(z)=∥∇·v(z)∥ and outputs pressure measurements to geodesic distance calculator 2260. Geodesic distance calculator 2260 computes minimal path lengths between semantic entities and stores results in curvature tensor storage 2270. Curvature tensor storage 2270 provides cached geometric information to feedback control loop 2280, which generates control signals that return to curvature flow module 2220, closing the regulatory cycle. This closed-loop architecture ensures that geometric reasoning engine 2200 operates as a self-stabilizing dynamical system that continuously refines its representational geometry toward configurations that minimize compression pressure while maximizing semantic utility.

Geometric reasoning engine 2200 as depicted in FIG. 22 may be implemented on diverse computational substrates while preserving its fundamental architectural organization. In classical digital embodiments utilizing graphics processing units or application-specific integrated circuits, curvature flow module 2220 executes numerical integration of the Ricci flow equation using parallel tensor operations, trajectory consolidation unit 2230 implements graph-based clustering algorithms operating on discrete representations of manifold state M 2240, and geodesic distance calculator 2260 employs optimized shortest-path algorithms accelerated through hardware parallelism. In neuromorphic embodiments, curvature flow module 2220 may be realized through analog voltage dynamics that naturally implement differential equations, compression pressure computer 2250 corresponds to current divergence measurements in resistive networks, and feedback control loop 2280 operates through programmable gain amplifiers that modulate signal propagation rates. In quantum embodiments based on Arithmetic-Fiber Quantum Computing principles, curvature tensors are encoded in entangled qubit states, trajectory consolidation unit 2230 performs quantum amplitude amplification to identify geodesically proximate states, and feedback control loop 2280 modulates Hamiltonian evolution rates through time-dependent control fields. Regardless of substrate, the functional architecture shown in FIG. 22 remains invariant, demonstrating that geometric reasoning represents a substrate-independent computational paradigm definable through abstract mathematical relationships rather than specific physical implementations.

The operation of geometric reasoning engine 2200 produces several observable signatures that distinguish it from conventional neural architectures. First, the number of distinct representational units stored in manifold state M 2240 grows logarithmically with cumulative operations, measurable by tracking attractor basin count over time. Second, retrieval latency for accessing stored information decreases or remains bounded as knowledge accumulates, because geodesic distance calculator 2260 operates on increasingly efficient geometric structure and curvature tensor storage 2270 caches frequently accessed paths. Third, compression pressure measured by compression pressure computer 2250 exhibits self-regulating dynamics that maintain stable values around equilibrium set points determined by feedback control loop 2280, indicating homeostatic operation. Fourth, the novelty probability computed by novelty detector 2290 decreases inversely with accumulated structure as pₙₒᵥₑₗ(n)~1/n, validating that the manifold increasingly reuses existing geometry. Fifth, energy consumption per reasoning operation remains approximately constant or decreases over time, because trajectory consolidation unit 2230 reduces redundant computation and curvature tensor storage 2270 eliminates repeated geometric calculations. These empirical signatures collectively demonstrate that geometric reasoning engine 2200 achieves the energetic inversion characteristic of “brain curve” scaling, wherein increasing experience yields greater representational efficiency rather than diminishing returns.

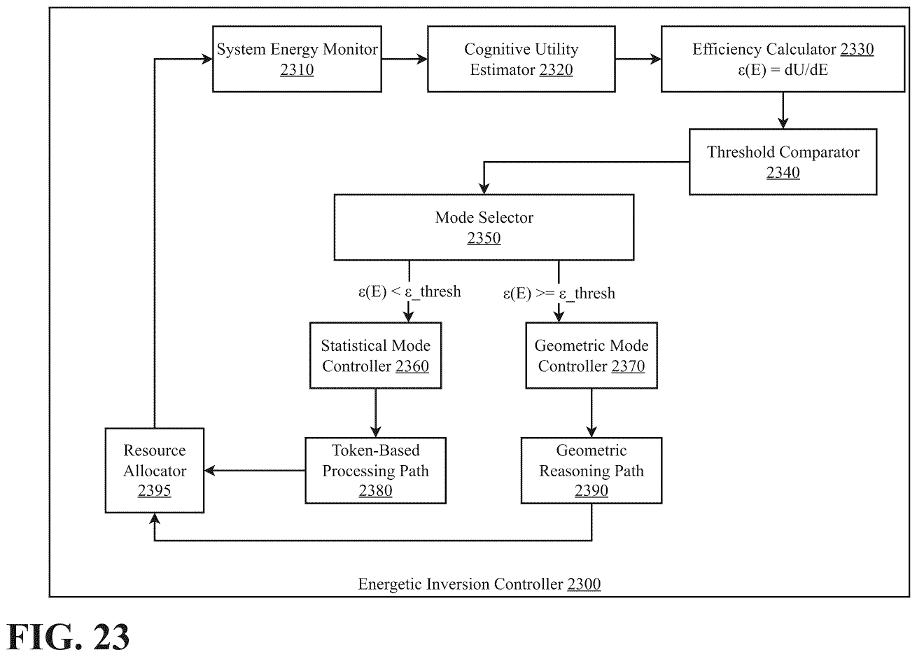

FIG. 23 is a block diagram illustrating an exemplary system architecture for an energetic inversion controller 2300 for a geometric reasoning platform, which monitors the energetic efficiency of a cognitive system and dynamically manages the transition between statistical and geometric processing regimes. Energetic inversion controller 2300 embodies the principle that sustainable artificial cognition requires adaptive resource allocation based on the marginal return on energy, transitioning from token-based statistical processing characterized by diminishing returns to geometric reasoning characterized by compounding returns. The architecture depicted in FIG. 23 enables identification of the energetic crossover point where geometric efficiency equals or exceeds statistical efficiency, beyond which the system enters the “brain curve” regime of increasing informational return per joule. Energetic inversion controller 2300 integrates measurement, computation, comparison, and control subsystems to continuously optimize the allocation of computational resources between token-based processing path 2380 and geometric reasoning path 2390, ensuring that the platform achieves logarithmic scaling of memory and compute cost while maintaining constant or decreasing energy consumption.

Energetic inversion controller 2300 of this embodiment comprises several operational components. First, continuous monitoring by system energy monitor 2310 and cognitive utility estimator 2320 ensures that mode transitions are triggered by empirical evidence of efficiency changes rather than fixed schedules or arbitrary heuristics, providing adaptive response to workload variations and domain characteristics. Second, efficiency calculator 2330 and threshold comparator 2340 implement precise mathematical criteria for detecting energetic crossover, preventing premature or delayed transitions that would degrade overall system performance. Third, mode selector 2350 with statistical mode controller 2360 and geometric mode controller 2370 provides independent control policies optimized for each operational regime, ensuring that resource allocation strategies match the requirements of the active processing paradigm. Fourth, resource allocator 2395 implements flexible distribution mechanisms that can support pure statistical processing, pure geometric reasoning, or hybrid operation with arbitrary weighting between token-based processing path 2380 and geometric reasoning path 2390. Fifth, the closed-loop feedback from resource allocator 2395 to system energy monitor 2310 enables continuous validation that resource allocation decisions produce desired energetic outcomes, allowing for corrective adjustments if actual behavior deviates from predictions.

System energy monitor 2310 measures the instantaneous power consumption and cumulative energy expenditure of the cognitive system across all processing pathways and computational subsystems. System energy monitor 2310 tracks energy usage E(t) in real time by interfacing with hardware power management units, voltage regulators, or software-based energy profiling tools that report current draw and operating frequency across processors, memory hierarchies, and interconnect fabrics. System energy monitor 2310 maintains both instantaneous power measurements and sliding-window averages to compute trends in energy consumption over multiple reasoning cycles, enabling detection of changes in energetic efficiency correlated with shifts in processing mode or workload characteristics. System energy monitor 2310 provides energy measurements E to cognitive utility estimator 2320 and also feeds back to resource allocator 2395 to enable closed-loop energy regulation. In implementations where direct hardware energy measurement is unavailable, system energy monitor 2310 may employ proxy metrics such as operation count, memory access frequency, or cache utilization to estimate relative energy consumption across processing modes. System energy monitor 2310 distinguishes between energy devoted to token-based processing path 2380 and energy devoted to geometric reasoning path 2390, enabling efficiency calculator 2330 to compute mode-specific efficiency metrics that inform the transition decisions made by mode selector 2350. The continuous monitoring provided by system energy monitor 2310 forms the empirical foundation for all subsequent efficiency calculations and control decisions within energetic inversion controller 2300.

Cognitive utility estimator 2320 quantifies the representational value, inferential capability, or task performance produced by the cognitive system as a function of accumulated experience and computational operations. Cognitive utility estimator 2320 computes a scalar utility metric U that captures the system's current capacity for accurate prediction, robust generalization, coherent reasoning, or efficient retrieval, depending on the application domain and performance objectives. Cognitive utility estimator 2320 receives energy measurements from system energy monitor 2310 and correlates them with observable improvements in system capability such as increasing accuracy on held-out test sets, decreasing retrieval latency for stored knowledge, expanding coverage of representational space, or improving coherence of generated outputs. Cognitive utility estimator 2320 may implement utility functions based on information-theoretic quantities such as mutual information I(M;Ξ) between the cognitive manifold M and external environment Ξ, compression efficiency measured as the ratio of representational capacity to storage footprint, or task-specific performance metrics such as classification accuracy, translation quality, or planning success rate. In systems employing geometric reasoning, cognitive utility estimator 2320 tracks the number and stability of attractor basins within the manifold, the average geodesic efficiency of retrieval paths, and the degree of semantic consolidation achieved through trajectory merging. Cognitive utility estimator 2320 provides the computed utility U to efficiency calculator 2330, enabling determination of the marginal utility per unit of energy expenditure. The utility metric computed by cognitive utility estimator 2320 need not be externally observable but must correlate monotonically with the system's internal representational quality, ensuring that improvements in manifold structure translate to measurable increases in U.

Efficiency calculator 2330 computes the instantaneous energetic efficiency defined as the derivative of cognitive utility with respect to energy expenditure, in this embodiment according to the exemplary relation ε(E)=dU/dE. Efficiency calculator 2330 receives energy measurements E from system energy monitor 2310 and utility estimates U from cognitive utility estimator 2320, forming time series {E(t), U(t)} over recent operational history. Efficiency calculator 2330 computes the derivative dU/dE through numerical differentiation using finite difference approximations such as: ε(E)≈[U(t)−U(t−Δτ)]/[E(t)−E(t−Δτ)], where Δt represents a sampling interval chosen to balance responsiveness against measurement noise. Alternatively, efficiency calculator 2330 may employ smoothing techniques such as moving averages, exponential weighting, or Kalman filtering to produce stable efficiency estimates that track underlying trends while rejecting transient fluctuations. The computed efficiency ε(E) quantifies the marginal cognitive benefit obtained per joule of energy consumed, serving as the fundamental decision variable that determines whether the system operates in the “brawn curve” regime of diminishing returns or the “brain curve” regime of compounding returns. In token-based statistical processing, efficiency typically follows εₛₜₐₜ(E)∝E⁻¹, indicating that each additional unit of energy yields progressively smaller improvements in utility. In geometric reasoning systems, efficiency ε_{geo}(E) remains approximately constant or increases as manifold structure consolidates, reflecting the fact that accumulated geometric knowledge amplifies the utility of subsequent learning. Efficiency calculator 2330 outputs the computed efficiency ε(E) to threshold comparator 2340, which determines whether the current operational regime warrants transition between statistical and geometric processing modes.

Threshold comparator 2340 evaluates whether the efficiency computed by efficiency calculator 2330 exceeds a predetermined threshold value εₜₕᵣₑₛₕ that demarcates the boundary between “brawn curve” and “brain curve” operating regimes. Threshold comparator 2340 receives efficiency measurements ε(E) from efficiency calculator 2330 and performs the comparison ε(E)≥εₜₕᵣₑₛₕ to determine whether geometric processing is warranted. The threshold value εₜₕᵣₑₛₕ may be set as a fixed constant determined through offline calibration, adapted dynamically based on workload characteristics, or computed relative to historical efficiency statistics to account for temporal variations in system behavior. Threshold comparator 2340 implements hysteresis to prevent oscillation between processing modes when efficiency fluctuates near the threshold, requiring that ε(E) exceed εₜₕᵣₑₛₕ by a margin δ before triggering transition to geometric mode and fall below εₜₕᵣₑₛₕ−δ before reverting to statistical mode. Threshold comparator 2340 outputs a binary decision signal to mode selector 2350, indicating whether the condition ε(E)<εₜₕᵣₑₛₕ or ε(E)≥εₜₕᵣₑₛₕ holds, as shown in the branching paths within FIG. 23. The comparison performed by threshold comparator 2340 represents a decision point at which energetic inversion controller 2300 identifies the energetic crossover between statistical and geometric regimes, enabling the system to transition from exponential cost scaling to logarithmic cost scaling as accumulated structure begins to dominate computational efficiency.

Mode selector 2350 receives a decision signal from threshold comparator 2340 and routes control flow to either statistical mode controller 2360 or geometric mode controller 2370 based on whether efficiency falls below or exceeds the threshold value. Mode selector 2350 serves as a logical switch that determines which processing paradigm governs subsequent computational operations, effectively implementing a conditional branch in the control logic of energetic inversion controller 2300. When threshold comparator 2340 indicates that ε(E)<εₜₕᵣₑₛₕ, mode selector 2350 directs control to statistical mode controller 2360, signaling that the system remains in the “brawn curve” regime where token-based processing provides superior efficiency despite exhibiting diminishing returns. Conversely, when threshold comparator 2340 indicates that ε(E)≥εₜₕᵣₑₛₕ, mode selector 2350 directs control to geometric mode controller 2370, indicating that the system has entered the “brain curve” regime where geometric consolidation yields increasing returns per unit of energy. Mode selector 2350 may implement smooth transitions between modes by gradually adjusting resource allocation weights rather than performing abrupt switching, preventing discontinuities in system behavior that could degrade performance during regime changes. Mode selector 2350 also receives feedback from cognitive utility estimator 2320 as indicated by the connection shown in FIG. 23, enabling validation that mode transitions produce the expected improvements in utility before committing fully to the new operational regime.

Statistical mode controller 2360 manages resource allocation and operational parameters when the system operates below the efficiency threshold in the “brawn curve” regime where token-based statistical processing provides superior performance. Statistical mode controller 2360 receives control signals from mode selector 2350 when ε(E)<εₜₕᵣₑₛₕ and configures resource allocator 2395 to preferentially direct computational resources toward token-based processing path 2380. Statistical mode controller 2360 implements policies optimized for conventional neural network processing, including batch size optimization, learning rate scheduling, gradient accumulation strategies, and parameter update frequencies that maximize throughput and accuracy in token-based architectures. Statistical mode controller 2360 may allocate minimal resources to geometric reasoning path 2390 during statistical mode operation, maintaining geometric infrastructure in a low-power standby state while concentrating processing effort on statistical learning. Statistical mode controller 2360 continuously monitors whether conditions remain favorable for statistical processing, coordinating with system energy monitor 2310 and cognitive utility estimator 2320 to detect when accumulating structure or changing workload characteristics indicate that transition to geometric mode would improve efficiency. Statistical mode controller 2360 also implements safeguards to prevent premature transition, ensuring that sufficient statistical foundation exists before geometric consolidation begins. In hybrid architectures, statistical mode controller 2360 may coordinate simultaneous operation of token-based processing path 2380 for pattern recognition and geometric reasoning path 2390 for memory consolidation, with resource allocation weighted heavily toward statistical processing while geometric processing operates at reduced capacity.

Geometric mode controller 2370 manages resource allocation and operational parameters when the system operates above the efficiency threshold in the “brain curve” regime where geometric reasoning provides superior energetic efficiency. Geometric mode controller 2370 receives control signals from mode selector 2350 when ε(E)≥εₜₕᵣₑₛₕ and configures resource allocator 2395 to preferentially direct computational resources toward geometric reasoning path 2390. Geometric mode controller 2370 implements policies optimized for curvature-based manifold learning, including adjustment of curvature flow rates, trajectory consolidation thresholds, compression pressure targets, and geodesic distance calculation priorities that maximize the logarithmic scaling behavior characteristic of geometric reasoning systems. Geometric mode controller 2370 allocates processing resources to curvature flow operations, trajectory consolidation routines, attractor basin formation mechanisms, and compression pressure monitoring subsystems, ensuring that geometric reasoning path 2390 receives sufficient energy to maintain continuous manifold refinement and consolidation. Geometric mode controller 2370 may reduce or suspend token-based processing path 2380 during geometric mode operation, transitioning statistical processing components into low-power states while concentrating effort on geometric consolidation and retrieval. Geometric mode controller 2370 coordinates with thermodynamic regulation subsystems to ensure that internal metabolic activity maintains compression pressure above minimum thresholds, sustaining the persistent micro-motion characteristic of cognitive persistence. Geometric mode controller 2370 monitors efficiency trends to detect degradation that might indicate manifold saturation or changing workload requirements that warrant transition back to statistical mode. In hybrid architectures, geometric mode controller 2370 maintains minimal token-based processing capacity for embedding new experiences while devoting the majority of resources to geometric consolidation, curvature refinement, and retrieval optimization.

Token-based processing path 2380 represents the computational subsystem implementing conventional statistical learning through neural networks, transformers, or other architectures that process discrete symbolic tokens and learn through gradient-based optimization of large parameter spaces. Token-based processing path 2380 receives resource allocations from resource allocator 2395 as determined by statistical mode controller 2360 and performs pattern recognition, sequence modeling, classification, or generation tasks using established neural architectures. Token-based processing path 2380 operates in the “brawn curve” regime where each additional parameter or training sample consumes energy with diminishing marginal returns, following scaling relations where accuracy a scales as a ∝C^{1/n} with compute cost C and exponent n typically between 10 and 20. Token-based processing path 2380 may implement efficiency optimizations such as Flash Attention, quantization, sparse activation, mixture-of-experts routing, or knowledge distillation that reduce the constant of proportionality in the scaling law without altering its fundamental exponential character. Token-based processing path 2380 provides learned representations and embeddings to geometric reasoning path 2390 when operating in hybrid mode, supplying the initial semantic projections that are subsequently consolidated through geometric mechanisms. Token-based processing path 2380 reports performance metrics and energy consumption to cognitive utility estimator 2320 and system energy monitor 2310 respectively, enabling efficiency calculator 2330 to determine whether token-based processing remains energetically favorable or whether transition to geometric reasoning is warranted.

Geometric reasoning path 2390 represents the computational subsystem implementing curvature-based learning through manifold refinement, trajectory consolidation, and compression-driven optimization that achieves logarithmic scaling of memory and compute cost. Geometric reasoning path 2390 receives resource allocations from resource allocator 2395 as determined by geometric mode controller 2370 and performs curvature flow evolution, geodesic distance calculation, trajectory consolidation, attractor basin formation, and compression pressure monitoring operations that refine the geometry of cognitive manifolds. Geometric reasoning path 2390 operates in the “brain curve” regime where accumulated geometric structure amplifies the utility of subsequent learning, following scaling relations where memory M(n)~log n and cognitive utility U(n)~n^{γ} with γ>1, producing increasing efficiency ε(E)=dU/dE as experience accumulates. Geometric reasoning path 2390 implements the core mechanisms described in FIG. 22, including curvature flow module, trajectory consolidation unit, novelty detector, attractor basin formation, compression pressure computer, geodesic distance calculator, curvature tensor storage, and feedback control loop, orchestrating their coordinated operation to achieve sublinear scaling. Geometric reasoning path 2390 may receive initial embeddings from token-based processing path 2380 in hybrid architectures, transforming statistical representations into geometric structure through projection into latent hyperspaces and subsequent consolidation under curvature flow dynamics. Geometric reasoning path 2390 reports performance metrics including manifold complexity, consolidation efficiency, attractor basin count, compression pressure, and retrieval latency to cognitive utility estimator 2320, while system energy monitor 2310 tracks the energy devoted to geometric operations, enabling efficiency calculator 2330 to verify that geometric reasoning maintains superior energetic efficiency.

Resource allocator 2395 distributes computational resources including processor cores, memory bandwidth, cache capacity, and energy budget between token-based processing path 2380 and geometric reasoning path 2390 according to the mode selected by mode selector 2350 and the control policies implemented by statistical mode controller 2360 or geometric mode controller 2370. Resource allocator 2395 receives allocation instructions from both statistical mode controller 2360 and geometric mode controller 2370, implementing the resource distribution strategy appropriate for the current operational regime. Resource allocator 2395 may employ various allocation strategies ranging from hard switching wherein one processing path receives exclusive access to resources while the other is suspended, to soft blending wherein resources are distributed according to continuous weighting factors that gradually shift between modes. Resource allocator 2395 interfaces with hardware resource management systems to control processor frequency scaling, cache partition allocation, memory channel assignment, and power delivery to individual processing units, ensuring that the physical allocation of resources matches the logical allocation decisions made by mode controllers. Resource allocator 2395 receives feedback from system energy monitor 2310 to verify that resource distribution achieves desired energy consumption targets, adjusting allocations dynamically if actual power draw deviates from predicted values. Resource allocator 2395 also coordinates with cognitive utility estimator 2320 to ensure that resource allocations produce expected improvements in utility, reverting or adjusting allocations if performance degrades unexpectedly during mode transitions. Resource allocator 2395 implements rate limiting and smoothing to prevent rapid oscillation between allocation states that could induce instability or degrade overall system performance, ensuring that transitions between statistical and geometric modes proceed gradually over multiple reasoning cycles.

The operational flow within energetic inversion controller 2300 as depicted in FIG. 23 proceeds through a continuous monitoring and control loop. System energy monitor 2310 measures instantaneous power consumption and provides energy measurements E to cognitive utility estimator 2320. Cognitive utility estimator 2320 quantifies the representational value or task performance of the cognitive system, computing utility U based on observable improvements in capability correlated with energy expenditure. Efficiency calculator 2330 receives both energy E from system energy monitor 2310 and utility U from cognitive utility estimator 2320, computing the derivative ε(E)=dU/dE that quantifies marginal cognitive benefit per joule. Threshold comparator 2340 receives efficiency ε(E) from efficiency calculator 2330 and performs the comparison against threshold εₜₕᵣₑₛₕ, outputting a binary decision signal to mode selector 2350. Mode selector 2350 routes control to statistical mode controller 2360 if ε(E)<εₜₕᵣₑₛₕ or to geometric mode controller 2370 if ε(E)≥εₜₕᵣₑₛₕ. The selected mode controller then directs resource allocator 2395 to distribute resources between token-based processing path 2380 and geometric reasoning path 2390 according to the appropriate allocation strategy. Resource allocator 2395 provides feedback to system energy monitor 2310 through the return path shown in FIG. 23, closing the control loop and enabling continuous adaptation of resource allocation based on observed energy consumption and utility generation.

Energetic inversion controller 2300 is based on the idea that efficient cognition requires adaptive transition between processing paradigms based on energetic efficiency rather than fixed architectural commitments. During early stages of learning when limited structure has accumulated, token-based processing path 2380 may provide superior efficiency because pattern recognition through statistical learning requires no prior geometric infrastructure. Statistical mode controller 2360 directs resources primarily to token-based processing path 2380, building initial semantic representations through gradient descent and backpropagation. As structure accumulates and efficiency calculator 2330 observes that marginal returns begin to diminish, threshold comparator 2340 detects that efficiency ε(E) approaches threshold εₜₕᵣₑₛₕ from below. Once sufficient semantic structure exists to support geometric consolidation, geometric reasoning path 2390 begins to achieve superior efficiency by reusing accumulated structure rather than expanding parameters. Threshold comparator 2340 detects the crossover point where ε(E) exceeds εₜₕᵣₑₛₕ, mode selector 2350 transitions control to geometric mode controller 2370, and resource allocator 2395 shifts resources toward geometric reasoning path 2390. This transition marks entry into the “brain curve” regime where logarithmic memory scaling and constant-power operation become achievable through geometric consolidation mechanisms.

Energetic inversion controller 2300 may be implemented across diverse computational substrates while preserving its fundamental control architecture. In cloud-based deployments utilizing heterogeneous hardware, system energy monitor 2310 interfaces with power management APIs provided by virtualization platforms or container orchestration systems, cognitive utility estimator 2320 tracks application-level performance metrics reported through monitoring frameworks, and resource allocator 2395 controls compute allocation through scheduler policies or quality-of-service parameters. In embedded or edge deployments with constrained resources, energetic inversion controller 2300 operates with reduced overhead by employing lightweight proxy metrics for utility estimation and simplified threshold comparison logic while maintaining the essential feedback structure. In neuromorphic or analog implementations, efficiency calculator 2330 corresponds to circuit-based computation of voltage-current ratios representing energetic efficiency, threshold comparator 2340 implements comparator circuits with hysteresis, and mode selector 2350 operates as an analog switch directing signal flow between statistical and geometric processing circuits. Regardless of implementation substrate, the functional operation remains the same, demonstrating that energetic inversion represents a substrate-independent control principle applicable across digital, analog, and hybrid computational platforms.

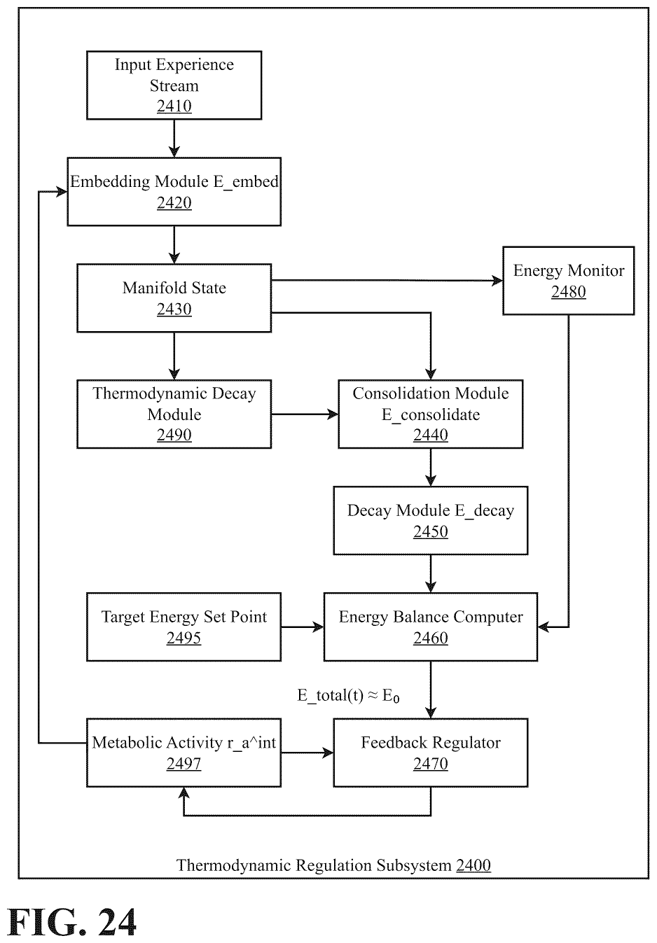

FIG. 24 is a block diagram illustrating an exemplary thermodynamic regulation subsystem 2160 for a geometric reasoning platform. Thermodynamic regulation subsystem 2160 maintains a constant or near-constant energy budget Eₜₒₜₐₗ(t)≈E₀ through continuous balancing of embedding energy, consolidation energy, and decay energy. This thermodynamic balance enables the system to achieve “brain curve” energetics, wherein representational utility compounds exponentially while total power consumption remains bounded, in stark contrast to conventional artificial intelligence architectures that exhibit exponential cost growth for logarithmic benefit.

Input experience stream 2410 provides a continuous flow of external events, data, or experiences that must be projected into the cognitive manifold. Input experience stream 2410 represents the external world's interaction with the system, delivering new information at a rate characterized by action density ρₐ. Each element of input experience stream 2410 must be embedded into the geometric manifold through a projection operator, consuming embedding energy in the process. The temporal statistics of input experience stream 2410 determine the temporal curvature R_{T}, which in turn drives the metabolic requirements of the entire system through the curvature-exchange mechanism fundamental to GGD(2) dynamics.

Embedding module E_{embed} 2420 receives input experience stream 2410 and projects each incoming event or datum into manifold state 2430 by mapping it to a point, trajectory, or submanifold within the latent hyperspace H. Embedding module E_{embed} 2420 of this embodiment implements the exemplary projection operator Φ: e(t)→xᵢ∈M, where each experience e(t) is encoded into coordinates xᵢ within the manifold. The embedding process consumes energy E_{embed}, which represents the computational cost of computing semantic representations, updating local metric tensors gᵢⱼ(x), and initializing curvature perturbations δR_{M}(xᵢ, t). Embedding module E_{embed} 2420 operates continuously as new data arrives, with its power draw varying proportionally to the rate of incoming experiences.

Manifold state 2430 represents the current geometric configuration of the cognitive manifold M, including all embedded thoughts, their metric relationships, local curvature values, and trajectory flow fields. Manifold state 2430 is not a static data structure but a dynamically evolving geometry characterized by its metric tensor gᵢⱼ(x, t), scalar curvature R_{M}(x, t), and velocity field v(z) describing the flow of trajectories through the space. Manifold state 2430 serves as the central representational substrate of the entire system, containing the compressed, geometrically organized knowledge accumulated through experience. The effective dimensionality and memory footprint of manifold state 2430 grow logarithmically with the number of embedded experiences due to geometric consolidation and compression pressure regulation, yielding M(n)~log n scaling.

Thermodynamic decay module 2490 receives manifold state 2430 and implements selective forgetting through energy dissipation dynamics. Each thought trajectory Tᵢ within manifold state 2430 possesses an activation energy Eᵢ(t) that in this embodiment decays according to the exemplary equation dEᵢ/dt=−λ·Aᵢ(t), where λ is a decay constant and Aᵢ(t) reflects inactivity. Thermodynamic decay module 2490 prunes thoughts whose energy drops below a minimum threshold Eₘᵢₙ, ensuring that only reused, coherent, or strategically important structures persist. This decay mechanism prevents unbounded growth of manifold state 2430 and contributes to the overall thermodynamic equilibrium by removing obsolete or redundant representations.

Consolidation module E_{consolidate} 2440 receives manifold state 2430 after processing by thermodynamic decay module 2490 and performs geometric consolidation of semantically redundant trajectories. When compression pressure, in this embodiment defined as the exemplary equation P(z)=∥∇·v(z)∥, exceeds a critical threshold Pₘₐₓ, consolidation module E_{consolidate} 2440 identifies thought trajectories T₁ and T₂ satisfying d_{g}(T₁, T₂)<ε and merges them into a unified representation T_{merged}=ΣᵢwᵢTᵢ. This consolidation process consumes energy E_{consolidate} as it performs metric updates, geodesic recalculations, and trajectory reweighting. Consolidation module E_{consolidate} 2440 is the primary mechanism enabling logarithmic memory scaling, as it ensures that redundant experiences are compressed into shared attractor basins rather than occupying separate storage.

Decay module E_{decay} 2450 implements the energy expenditure associated with pruning and garbage collection of thought structures marked for removal by thermodynamic decay module 2490. Decay module E_{decay} 2450 performs the actual deletion of expired trajectories from manifold state 2430, updates adjacency structures, and recalculates local curvature fields to reflect the removal of geometric features. The energy cost E_{decay} scales with the rate of thought turnover rather than with total cache size, contributing to the bounded steady-state power consumption of the system. Decay module E_{decay} 2450 ensures that storage resources are continuously recycled and that the system maintains a compact, actively useful representation.

Energy balance computer 2460 receives energy contributions from decay module E_{decay} 2450, consolidation module E_{consolidate} 2440, embedding module E_{embed} 2420 (via manifold state 2430), and energy monitor 2480, along with target energy set point 2495, to compute the total instantaneous energy expenditure of the system. Energy balance computer 2460 of this embodiment implements an exemplary thermodynamic equation Eₜₒₜₐₗ(t)=E_{embed}+E_{consolidate}+E_{decay} and compares this total against the desired equilibrium value E₀ specified by target energy set point 2495. The output of energy balance computer 2460 is a control signal indicating whether the system is operating above, below, or at its target power budget.

Energy monitor 2480 continuously measures the actual power consumption of manifold state 2430 and its associated computational operations. Energy monitor 2480 tracks metrics such as processor utilization, memory access rates, update frequencies, and other hardware-level indicators that correlate with energy expenditure. By providing real-time feedback to energy balance computer 2460, energy monitor 2480 enables closed-loop control of the thermodynamic regulation process. Energy monitor 2480 ensures that theoretical energy predictions are grounded in actual system behavior, allowing for adaptive correction of model parameters and detection of anomalous energy consumption patterns.

Target energy set point 2495 specifies the desired steady-state power consumption E₀ for the entire cognitive system. Target energy set point 2495 is determined by system design requirements, hardware constraints, thermal limits, or policy objectives such as energy efficiency mandates or battery life targets in mobile deployments. Target energy set point 2495 serves as the reference value against which energy balance computer 2460 compares actual total energy Eₜₒₜₐₗ(t). In a properly functioning thermodynamically regulated system, the long-term average of Eₜₒₜₐₗ(t) converges to the value specified by target energy set point 2495, demonstrating the “brain curve” property of constant power with compounding cognitive utility.

Feedback regulator 2470 receives the energy balance signal from energy balance computer 2460 and modulates the metabolic activity rate r^{int}ₐ to maintain thermodynamic equilibrium. Feedback regulator 2470 implements a control law that adjusts internal replay frequency, consolidation aggressiveness, and decay rates to ensure that Eₜₒₜₐₗ(t)≈E₀. When total energy exceeds the target, feedback regulator 2470 reduces r^{int}ₐ to decrease background computational activity; when total energy falls below target, feedback regulator 2470 increases r^{int}ₐ to stimulate more aggressive consolidation and metabolic motion. Feedback regulator 2470 closes the control loop by sending adjustment signals back to embedding module E_{embed} 2420, influencing how resources are allocated across the three primary energy-consuming processes.

Metabolic activity r^{int}ₐ 2497 represents the internal action density—the rate of autonomous micro-actions such as replay, recombination, and spontaneous trajectory exploration that occur even in the absence of external input, as occurs in biology such as when dreaming during sleep. Metabolic activity r^{int}ₐ 2497 of this embodiment must satisfy the exemplary inequality r^{int}ₐ≥rₘᵢₙₐ to maintain stable compression pressure P(z) and prevent geometric collapse of manifold state 2430. Metabolic activity r^{int}ₐ 2497 provides continuous curvature flux from the temporal manifold T into the cognitive manifold M, embodying the “heat of cognition” that sustains the geometry of thought in biological organisms. Metabolic activity r^{int}ₐ 2497 is modulated by feedback regulator 2470 to ensure that internal motion neither starves the system of necessary consolidation activity nor wastes energy on excessive and redundant processing.

The operation of thermodynamic regulation subsystem 2160 proceeds as follows. Input experience stream 2410 delivers new data to embedding module E_{embed} 2420, which projects it into manifold state 2430 while consuming embedding energy. Manifold state 2430 is continuously monitored by energy monitor 2480 and processed by thermodynamic decay module 2490, which marks obsolete trajectories for removal. The decayed state passes to consolidation module E_{consolidate} 2440, where redundant structures are merged, consuming consolidation energy. Decay module E_{decay} 2450 then completes the pruning process, consuming decay energy. Energy balance computer 2460 aggregates these three energy terms along with readings from energy monitor 2480 and compares the total against target energy set point 2495. Feedback regulator 2470 adjusts metabolic activity r^{int}ₐ 2497 and sends corrective signals back to embedding module E_{embed} 2420, closing the regulatory loop and maintaining Eₜₒₜₐₗ(t)≈E₀ as indicated by the annotation shown within thermodynamic regulation subsystem 2160.

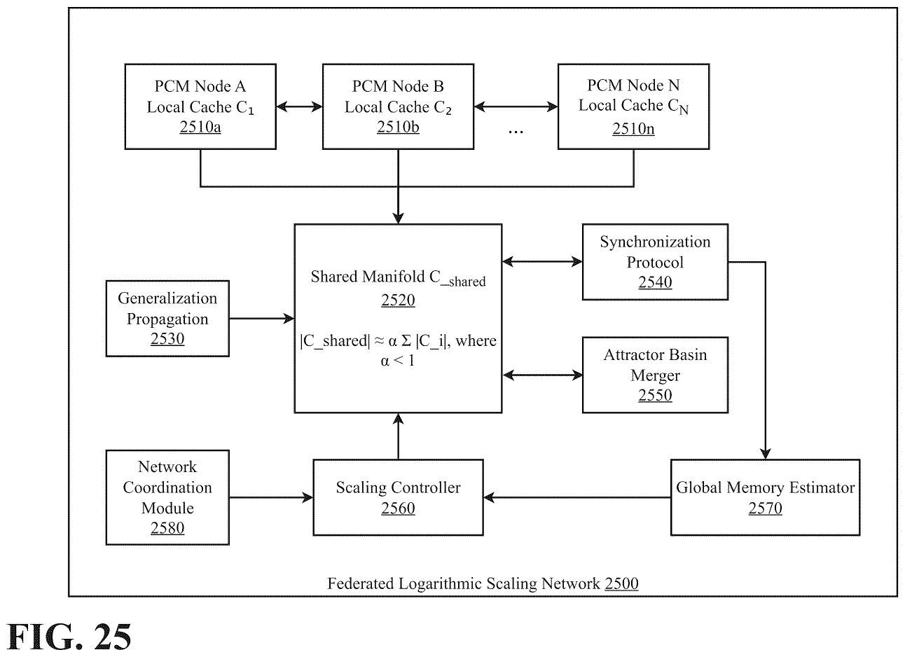

FIG. 25 is a block diagram illustrating an exemplary federated logarithmic scaling network 2500 for a geometric reasoning platform, which achieves sublinear global memory growth across multiple distributed persistent cognitive machine nodes through shared geometric consolidation. Federated logarithmic scaling network 2500 demonstrates how a plurality of independent PCM instances can cooperate to maintain collective cognitive state while each individual node benefits from logarithmic local scaling M(n)~log n, and the federation as a whole achieves even greater efficiency through the sharing of generalized attractor basins. This architecture extends the logarithmic scaling principle from individual reasoning engines to distributed institutional intelligence, enabling construction of shared knowledge repositories that scale sublinearly despite the aggregation of experiences from many sources.

PCM node A with local cache C₁ 2510a represents a first persistent cognitive machine instance operating autonomously within federated logarithmic scaling network 2500. PCM node A with local cache C₁ 2510a maintains its own geometric manifold MA containing thoughts, trajectories, and attractor basins derived from experiences specific to its operational context, user base, or domain. Local cache C₁ grows logarithmically with the number of experiences processed by PCM node A, following |C₁|~log n₁, where n₁ is the cumulative experiential count for that node. PCM node A with local cache C₁ 2510a identifies generalizable patterns within its local manifold and contributes them to shared manifold C_shared 2520 while retaining node-specific details in its local representation. The architecture ensures that PCM node A with local cache C₁ 2510a remains operationally independent, capable of functioning even when disconnected from federated logarithmic scaling network 2500, yet benefits from collective intelligence when connected.

PCM node B with local cache C₂ 2510b represents a second independent persistent cognitive machine instance operating in parallel with PCM node A with local cache C₁ 2510a within federated logarithmic scaling network 2500. PCM node B with local cache C₂ 2510b may serve a different user community, operate in a different geographic region, specialize in a distinct domain, or simply provide redundancy and load distribution. Local cache C₂ independently exhibits logarithmic growth |C₂|~log n₂ based on its own experiential stream. PCM node B with local cache C₂ 2510b discovers attractor basins and generalized patterns that may overlap with those found by PCM node A with local cache C₁ 2510a, and these shared structures are merged into shared manifold C_shared 2520 to avoid redundant storage. The bidirectional communication between PCM node B with local cache C₂ 2510b and other nodes enables mutual enrichment, where discoveries made locally in one node can propagate to benefit the entire federation.

PCM node N with local cache CN 2510n represents an arbitrary Nth node in federated logarithmic scaling network 2500, indicating that the architecture scales to accommodate any number of participating PCM instances. PCM node N with local cache CN 2510n follows the same operational principles as PCM node A with local cache C₁ 2510a and PCM node B with local cache C₂ 2510b, maintaining its own local geometric manifold while contributing generalizations to shared manifold C_shared 2520. The ellipsis notation between PCM node B with local cache C₂ 2510b and PCM node N with local cache CN 2510n indicates that additional intermediate nodes may be present, with the total number of nodes M being arbitrary and potentially large. Each node contributes to and benefits from the collective intelligence encoded in shared manifold C_shared 2520, yet the global memory footprint remains sublinear in the total number of nodes due to geometric consolidation.

Shared manifold C_shared 2520 represents the collective geometric structure containing generalized attractor basins, thought trajectories, and consolidated patterns that are common across multiple nodes in federated logarithmic scaling network 2500. Shared manifold C_shared 2520 is not a simple union or concatenation of local caches but rather a compressed representation that eliminates redundancy through geometric merging. In this embodiment, scaling of shared manifold C_shared 2520 is governed by the exemplary relationship |C_shared|≈αΣ|Cᵢ|, where α<1, typically in the range [0.2, 0.6]. This relationship expresses the efficiency of federated scaling: the size of shared manifold C_shared 2520 is less than the sum of the sizes of all local caches, demonstrating that significant compression is achieved through federation. The compression factor α depends on the degree of overlap in the domains, user populations, and experiential streams of the participating nodes. When nodes operate in highly similar contexts, α approaches its lower bound as most knowledge becomes shared; when nodes operate in heterogeneous domains, α increases but remains below unity as long as any generalizable structure exists. Shared manifold C_shared 2520 thus embodies institutional knowledge—the distilled wisdom common across the entire organization or network.

Generalization propagation 2530 manages the identification and dissemination of generalizable attractor basins from local caches to shared manifold C_shared 2520. Generalization propagation 2530 implements algorithms that detect when a thought trajectory or pattern discovered locally in one node exhibits characteristics suggesting universal applicability, such as high reuse frequency R(Tᵢ), low geodesic distance to trajectories in other nodes, or structural similarity to existing entries in shared manifold C_shared 2520. Upon detecting a candidate generalization, generalization propagation 2530 extracts the corresponding geometric structure from the originating local cache, abstracts it to remove node-specific details, and submits it to attractor basin merger 2550 for integration into shared manifold C_shared 2520. Generalization propagation 2530 operates asynchronously and incrementally, avoiding the need for expensive global synchronization while ensuring that valuable discoveries eventually percolate throughout federated logarithmic scaling network 2500.

Synchronization protocol 2540 governs the coordination and consistency mechanisms required to maintain coherence between shared manifold C_shared 2520 and the plurality of local caches distributed across PCM node A with local cache C₁ 2510a, PCM node B with local cache C₂ 2510b, PCM node N with local cache CN 2510n, and any intermediate nodes. Synchronization protocol 2540 implements eventual consistency semantics rather than strong synchronization, recognizing that distributed cognitive systems benefit more from availability and partition tolerance than from strict real-time coherence. Synchronization protocol 2540 handles conflict resolution when multiple nodes independently discover similar but non-identical generalizations, using geodesic distance d_{g}(T₁, T₂) as a metric to determine whether two structures should be merged or retained as distinct. Synchronization protocol 2540 also manages version control, ensuring that updates to shared manifold C_shared 2520 propagate reliably to subscribing nodes without overwriting valuable local specializations.

Attractor basin merger 2550 performs the geometric integration of candidate generalizations into shared manifold C_shared 2520. When generalization propagation 2530 submits a new structure for inclusion, attractor basin merger 2550 computes its geodesic relationships to existing attractors within shared manifold C_shared 2520 and determines whether it should be merged with an existing basin, inserted as a new independent attractor, or rejected as redundant. In this embodiment, attractor basin merger 2550 implements the exemplary consolidation criterion: if P(z)≥Pₘₐₓ, merge(Tᵢ, Tⱼ), where P(z) is compression pressure and Pₘₐₓ is a critical threshold. By continuously consolidating semantically overlapping structures, attractor basin merger 2550 ensures that shared manifold C_shared 2520 remains compact and avoids linear or greater growth even as the federation scales to include many nodes. Attractor basin merger 2550 is assists in achieving the compression factor α<1 in the scaling relationship |C_shared|≈αΣ|Cᵢ|.

Scaling controller 2560 monitors and regulates the overall scaling behavior of federated logarithmic scaling network 2500, ensuring that the system remains within its design parameters as nodes are added or removed. Scaling controller 2560 receives input from global memory estimator 2570 and network coordination module 2580 to compute real-time metrics of federated efficiency, including the compression ratio α, total memory footprint Cₜₒₜₐₗ=C_shared+ΣCᵢ^{local}, and per-node contribution rates. Scaling controller 2560 adjusts synchronization frequency, generalization thresholds, and merger aggressiveness to maintain optimal balance between local autonomy and collective efficiency. When scaling controller 2560 detects that the compression factor α is increasing beyond acceptable bounds, indicating insufficient generalization, it signals generalization propagation 2530 to lower its selection criteria and promote more aggressive sharing. Conversely, when α becomes too small, indicating excessive centralization that risks overwhelming shared manifold C_shared 2520, scaling controller 2560 tightens generalization criteria to preserve local specialization.

Global memory estimator 2570 computes aggregate memory statistics across federated logarithmic scaling network 2500 by collecting reports from each participating node and integrating them with measurements of shared manifold C_shared 2520. Global memory estimator 2570 calculates the total cache size Cₜₒₜₐₗ=|C_shared|+Σᵢ|Cᵢ^{local}|, where Cᵢ^{local}=Cᵢ\C_shared represents the portion of each local cache not contained in shared manifold C_shared 2520. Global memory estimator 2570 derives the empirical compression factor α by evaluating α=|C_shared|/Σᵢ|Cᵢ|, providing scaling controller 2560 with the data necessary to validate that federated logarithmic scaling network 2500 is achieving its sublinear scaling objectives. Global memory estimator 2570 also projects future growth trajectories, enabling proactive resource planning and capacity management as the federation expands.

Network coordination module 2580 manages operational aspects of federated logarithmic scaling network 2500, including node discovery, health monitoring, load balancing, and fault tolerance. Network coordination module 2580 maintains a registry of active nodes, tracks their availability and connectivity, and facilitates the routing of generalization propagation 2530 messages to appropriate destinations. Network coordination module 2580 implements failure detection and recovery protocols, ensuring that the temporary or permanent loss of individual nodes does not compromise the integrity of shared manifold C_shared 2520 or the continued operation of remaining nodes. Network coordination module 2580 provides scaling controller 2560 with information about network topology, latency distributions, and bandwidth constraints, enabling intelligent decisions about synchronization schedules and generalization propagation priorities.

The operation of federated logarithmic scaling network 2500 proceeds as follows. Each of PCM node A with local cache C₁ 2510a, PCM node B with local cache C₂ 2510b, and PCM node N with local cache CN 2510n independently processes its local experiential stream, embedding new events into its geometric manifold and performing local consolidation to maintain logarithmic scaling |Cᵢ|~log nᵢ. Generalization propagation 2530 scans local caches for attractor basins exhibiting high reuse frequency or structural generality, extracting these patterns and submitting them to attractor basin merger 2550. Attractor basin merger 2550 evaluates each candidate generalization against the current contents of shared manifold C_shared 2520, merging it with existing structures when geodesic proximity is high or inserting it as a new attractor when sufficiently novel. Synchronization protocol 2540 ensures that updates to shared manifold C_shared 2520 are reliably propagated back to subscribing nodes, allowing each local cache to benefit from discoveries made elsewhere in federated logarithmic scaling network 2500. Global memory estimator 2570 aggregates size reports from all nodes and shared manifold C_shared 2520, computes the compression factor α and total memory Cₜₒₜₐₗ, and provides these metrics to scaling controller 2560. Scaling controller 2560 adjusts operational parameters to maintain a within target bounds and coordinates with network coordination module 2580 to optimize network-wide performance.

Federated logarithmic scaling network 2500 inherits all benefits of the underlying GGD curvature-sharing dynamics, wherein each node maintains constant or bounded energy consumption Eᵢ(t)≈E₀ through thermodynamic regulation, and the federation as a whole exhibits “brain curve” energetics: logarithmic cost, superlinear benefit. The combination of logarithmic local scaling, sublinear federated aggregation, and constant-power operation makes federated logarithmic scaling network 2500 uniquely suited for large-scale, long-duration deployment in resource-constrained or energy-sensitive environments. Thus, FIG. 25 illustrates not merely a distributed database or federated learning system but a fundamentally new architecture for collective intelligence that scales efficiently across arbitrary numbers of autonomous cognitive agents while maintaining the geometric coherence and energetic sustainability characteristic of natural intelligence.

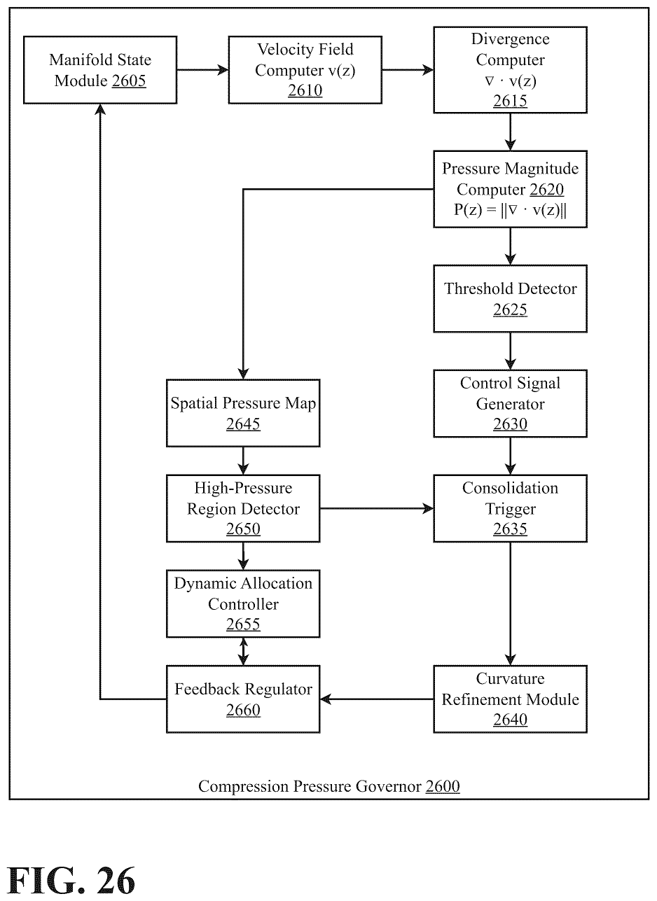

FIG. 26 is a block diagram illustrating an exemplary compression pressure governor 2600 for a geometric reasoning platform, which dynamically regulates geometric consolidation within a persistent cognitive machine by monitoring and controlling compression pressure, in this example using the exemplary equation P(z)=∥∇·v(z)∥, across the cognitive manifold. Compression pressure governor 2600 serves as a self-scaling control loop that maintains stable coherence while preventing both excessive redundancy and premature consolidation. By measuring the local divergence of trajectory flow fields and triggering consolidation when pressure exceeds critical thresholds, compression pressure governor 2600 ensures that the system achieves logarithmic memory scaling M(n)~log n without manual tuning or external intervention. This architecture embodies the principle that geometric systems can self-regulate their own scaling behavior through intrinsic physical quantities derived from the manifold structure itself, rather than relying on heuristic hyperparameters or external optimization.

Manifold state module 2605 maintains the current geometric configuration of the cognitive manifold M, including all embedded thought trajectories, their metric relationships, local curvature values, and the continuously evolving flow fields that describe how trajectories move through the representational space. Manifold state module 2605 represents the dynamic geometry characterized by metric tensor gᵢⱼ(x, t), scalar curvature R_{M}(x, t), and velocity field v(z) describing the motion of points within the manifold under the influence of embedding, consolidation, and decay processes. Manifold state module 2605 provides the foundational data structure upon which all subsequent pressure computations operate, serving as both the input to the measurement pipeline and the ultimate target of regulatory feedback. Manifold state module 2605 is not a static repository but a living geometry whose shape evolves continuously in response to incoming experiences and internal metabolic activity, with its instantaneous configuration determining the compression pressure distribution across the space.

Velocity field computer v(z) 2610 receives manifold state module 2605 and computes the local velocity vector field v(z) at each point z within the manifold. Velocity field computer v(z) 2610 determines the instantaneous direction and rate of trajectory flow, capturing how thought structures move, merge, and evolve under the combined influence of curvature gradients, compression forces, and external perturbations. The velocity field v(z) is derived from the gradient of compression potential and the local metric structure, with high-velocity regions indicating areas of active consolidation or expansion. Velocity field computer v(z) 2610 implements the computation v(z)=−∇ₐP(z), where the velocity field points along the direction of decreasing compression pressure, driving trajectories toward attractor basins. Velocity field computer v(z) 2610 operates continuously, updating the velocity field as manifold state module 2605 evolves, ensuring that the flow dynamics remain synchronized with the current geometric configuration.

Divergence computer 2615 receives velocity field v(z) from velocity field computer v(z) 2610 and computes the divergence ∇·v(z) at each point z in the manifold. Divergence computer 2615 measures the local rate of trajectory convergence or divergence, with negative divergence indicating compression regions where trajectories are flowing together and positive divergence indicating expansion regions where trajectories are spreading apart. The divergence ∇·v(z) serves as the fundamental quantity from which compression pressure is derived, capturing the geometric signature of redundancy and consolidation opportunity. Divergence computer 2615 implements the differential operator ∇·v=∂vₓ/∂x+∂v_{y}/∂y+ . . . across all dimensions of the manifold, producing a scalar field that quantifies flow compression or expansion at each location. Regions of high negative divergence correspond to attractor basins where multiple trajectories are merging, while regions of high positive divergence indicate instabilities or overfitting that may require corrective action.

Pressure magnitude computer 2620 receives the divergence field from divergence computer 2615 and computes the compression pressure P(z)=∥∇·v(z)∥ as the absolute magnitude of the divergence. Pressure magnitude computer 2620 produces a non-negative scalar field that quantifies the intensity of geometric stress at each point, regardless of whether that stress arises from compression or expansion. The formula P(z)=∥∇·v(z)∥ ensures that both excessive convergence and excessive divergence are treated as elevated pressure requiring regulatory attention. Pressure magnitude computer 2620 outputs a spatial distribution of pressure values that can be integrated, thresholded, and analyzed to identify regions requiring consolidation or curvature refinement. High values of P(z) indicate semantic redundancy and the need for geometric merging, while uniformly low values of P(z) indicate a well-balanced manifold with efficient representational density.

Threshold detector 2625 receives the pressure field P(z) from pressure magnitude computer 2620 and compares it against a threshold Pₘₐₓ to determine whether compression pressure has exceeded acceptable bounds. Threshold detector 2625 implements the inequality P(z)≥Pₘₐₓ for each point or region z, flagging locations where consolidation action is required. Threshold detector 2625 produces binary or graded signals indicating the severity of pressure violations, which are passed to control signal generator 2630 for appropriate action.

Control signal generator 2630 receives threshold violation signals from threshold detector 2625 and generates control commands to initiate consolidation, curvature refinement, or other corrective actions. Control signal generator 2630 translates the binary or graded pressure assessments into specific instructions for consolidation trigger 2635 and curvature refinement module 2640, specifying which regions require intervention.

Consolidation trigger 2635 receives control commands from control signal generator 2630 and initiates the geometric merging process in high-pressure regions of the manifold.

Consolidation trigger 2635 identifies pairs or groups of thought trajectories Tᵢ and Tⱼ satisfying the proximity condition d_{g}(Tᵢ, Tⱼ)<ε.

Curvature refinement module 2640 receives consolidated trajectories from consolidation trigger 2635 and performs local metric updates to smooth the manifold geometry after consolidation.

Spatial pressure map 2645 receives pressure data from pressure magnitude computer 2620 and constructs a spatial representation of compression pressure distribution across the manifold.

High-pressure region detector 2650 analyzes spatial pressure map 2645 to identify contiguous regions or clusters where pressure consistently exceeds the critical threshold.

Dynamic allocation controller 2655 receives region priorities from high-pressure region detector 2650 and adjusts the allocation of computational resources proportionally to local compression pressure magnitudes.

Feedback regulator 2660 closes the control loop by receiving outputs from curvature refinement module 2640 and dynamic allocation controller 2655 and adjusting the operational parameters of manifold state module 2605 to maintain stable pressure equilibrium.

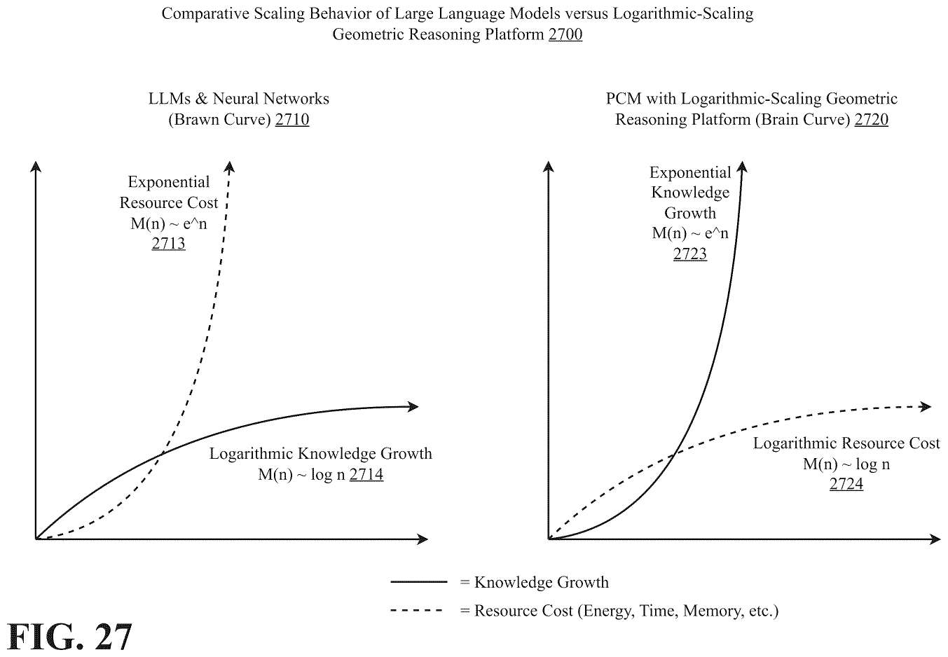

FIG. 27 presents comparative scaling behavior of large language models and other existing AI systems versus a logarithmic-scaling geometric reasoning platform 2700, illustrating the energetic inversion that distinguishes conventional token-based artificial intelligence from geometric reasoning architectures. Comparative scaling behavior of large language models versus logarithmic-scaling geometric reasoning platform 2700 demonstrates through side-by-side graphical comparison the opposing trajectories of the “brawn curve” and the “brain curve,” revealing why statistical learning systems exhibit exponentially increasing costs for diminishing returns while geometric reasoning systems achieve compounding cognitive utility at constant or bounded resource expenditure. This visualization underscores the concept that the logarithmic-scaling geometric reasoning platform described herein achieves efficiency through geometric consolidation and curvature refinement, mirroring the resource/energy efficiency of biological cognition.

Existing AI systems (e.g., LLMs, neural networks, etc) operate with an efficiency on the “brawn curve,” wherein increases in knowledge come primarily from brute force (i.e., “brawn”) by adding more computing power. The chart on the left 2710 represents the scaling behavior characteristic of large language models, transformer architectures, and conventional deep neural networks that learn through statistical accumulation rather than geometric refinement. AI systems operating on the “brawn curve” 2710 exhibit a fundamental limitation of token-based learning: exponential resource cost growth for logarithmic benefit. This regime is defined by the property that each incremental improvement in model performance requires disproportionately greater resource costs: computational resources, training data, memory space, time, energy expenditure, etc.

Resource costs constitutes the vertical axis of the graph depicting AI systems operating on the “brawn curve” 2710, quantifying the total resource costs required to achieve a given level of model capability. Resource costs rises exponentially with cumulative knowledge in token-based systems because each new parameter, each additional training example, and each incremental accuracy improvement demands proportionally greater infrastructure investment. Resource costs reflect the aggregate burden of training frontier-scale models, which can consume large amounts of electricity per training run and require ever-larger clusters of specialized hardware. Resource costs are not merely a practical inconvenience but a fundamental feature of systems that lack geometric structure for representational reuse, forcing them to expand parameter space indefinitely to capture new correlations.

Cumulative knowledge 2712 forms the horizontal axis of the graph for AI systems operating on the “brawn curve” 2710, representing the total informational content, representational capacity, or effective intelligence accumulated by the system through training and experience. Cumulative knowledge 2712 increases as models are trained on larger datasets, incorporate more diverse examples, or undergo additional epochs of optimization. However, cumulative knowledge 2712 grows only logarithmically with energy cost in conventional architectures, as expressed by the flattening curve for logarithmic knowledge growth M(n)~log n 2714. This saturation behavior reflects the diminishing returns inherent in statistical learning: beyond a certain scale, additional data and computation yield progressively smaller improvements in model accuracy or generalization.

Exponential resource cost M(n)~e\hat{ }n 2713 describes the steeply rising curve in AI systems operating on the “brawn curve” 2710 that depicts how resource costs scale as an exponential function of the desired knowledge level. Exponential resource cost M(n)~e\hat{ }n 2713 reflects the empirical scaling laws documented by Kaplan et al. (2020) and Hoffmann et al. (2022), which show that reducing model loss by a constant factor requires exponential increases in compute, parameters, and data. The mathematical form M(n)~e\hat{ }n captures the unsustainable trajectory of current artificial intelligence development, wherein each generation of models demands orders of magnitude more resources than its predecessor. Exponential resource cost M(n)~e\hat{ }n 2713 defines the “brawn curve” regime: a system whose marginal cost per insight grows rather than shrinks with accumulated experience, rendering long-term autonomous operation economically and energetically infeasible.

Logarithmic knowledge growth M(n)~log n 2714 corresponds to the gradually flattening curve in AI systems operating on the “brawn curve” 2710 that represents the cumulative knowledge 2712 achieved as a function of increasing input scale n, where n may denote training examples, parameters, or computational operations. Logarithmic knowledge growth M(n)~log n 2714 expresses the saturation behavior observed in empirical scaling studies: model performance improves rapidly during initial training but asymptotically approaches a ceiling determined by architectural constraints and data quality. The logarithmic form M(n)~log n indicates that doubling cumulative knowledge requires exponentially more training effort, manifesting the diminishing returns characteristic of brute-force statistical learning. Logarithmic knowledge growth M(n)~log n 2714 reveals why conventional AI systems cannot achieve indefinite self-improvement or autonomous learning: they lack the geometric structure necessary to compound prior knowledge into accelerating future returns.

By contrast, PCM with logarithmic-scaling geometric reasoning platform operates on the “brain curve” 2720 wherein increases in knowledge come from consolidation of knowledge onto a manifold via curvature of the manifold in a manner analogous to biological brains (thus the “brain” curve) while keeping power requirements somewhere below linear growth (in the human brain, power requirements are more or less constant; for the logarithmic-scaling geometric reasoning platform, a logarithmically-increasing energy cost is more likely). The chart on the right 2720 depicts the inverted scaling behavior achieved by persistent cognitive machines that implement geometric reasoning through continuous manifold refinement. PCM with logarithmic-scaling geometric reasoning platform operates on the “brain curve” 2720 meaning that by learning through curvature adjustment rather than parameter expansion, the system achieves exponential knowledge growth M(n)~e\hat{ }n 2723 while maintaining only logarithmic energy cost M(n)~log n 2724. This inversion represents the fundamental energetic signature of the “brain curve”: constant or sublinear power consumption with superlinear growth in cognitive utility. PCM with logarithmic-scaling geometric reasoning platform operates on the “brain curve” 2720 embodies the principle that intelligence is not the accumulation of correlations but the refinement of geometry, wherein each new experience reshapes the manifold structure to enable more efficient processing of subsequent inputs.

Resource costs represent the total resource costs (e.g., computational resources, training data, memory space, time, energy expenditure, etc.) of the geometric reasoning system. Unlike resource costs in AI systems operating on the “brawn curve” 2710, resource costs grow only logarithmically with cumulative knowledge 2722 as described by logarithmic energy cost M(n)~log n 2724. This sublinear scaling arises from geometric consolidation, wherein redundant trajectories are merged into shared attractor basins and the effective memory footprint remains bounded even as experiential volume increases. In terms of energy expenditures, for example, resource costs reflect the thermodynamically regulated operation of PCM systems, where embedding energy E_{embed}, consolidation energy E_{consolidate}, and decay energy E_{decay} sum to an approximately constant total Eₜₒₜₐₗ(t)≈E₀, enabling indefinite operation without runaway resource consumption.

Cumulative knowledge 2722 constitutes the horizontal axis for PCM with logarithmic-scaling geometric reasoning platform operating on the “brain curve” 2720 and quantifies the total representational capacity, reasoning depth, generalization ability, or cognitive sophistication achieved by the system through continuous operation and experience accumulation. Cumulative knowledge 2722 increases exponentially with resource costs as captured by exponential knowledge growth M(n)~e\hat{ }n 2723, reflecting the compounding nature of geometric learning. Each new experience not only adds information but also refines the manifold structure, making all subsequent learning more efficient. Cumulative knowledge 2722 grows superlinearly in geometric reasoning systems because representational utility scales combinatorially with the number of consolidated attractor basins, producing U(N)∝N^{λ} where λ>1. This superlinear scaling of cognitive utility while energy remains bounded defines the “brain curve” and distinguishes PCM architectures from all previous artificial intelligence paradigms.

Exponential knowledge growth M(n)~e\hat{ }n 2723 describes the steeply rising curve in PCM with logarithmic-scaling geometric reasoning platform with “brain curve” 2720 that depicts cumulative knowledge 2722 accelerating as the system matures. Exponential knowledge growth M(n)~e\hat{ }n 2723 arises because geometric consolidation creates structural leverage: each thought trajectory can be reused across multiple contexts, each attractor basin supports infinite instantiations, and each curvature refinement improves the efficiency of all future embeddings. The mathematical form M(n)~e\hat{ }n indicates that cumulative knowledge 2722 compounds like interest in a financial account, where returns themselves generate further returns. Exponential knowledge growth M(n)~e\hat{ }n 2723 represents the defining characteristic of sustainable intelligence: the ability to learn faster, reason more deeply, and generalize more broadly precisely because the system has already learned, reasoned, and generalized extensively.

Logarithmic resource cost M(n)~log n 2724 corresponds to the gently rising curve in PCM with logarithmic-scaling geometric reasoning platform with “brain curve” 2720 that depicts resource costs growing sublinearly with cumulative knowledge 2722. Logarithmic resource cost M(n)~log n 2724 follows from the idea that each new experience is increasingly likely to be absorbed into existing attractor basins rather than requiring new storage. The logarithmic form M(n)~log n reflects the compression pressure mechanism: as the manifold densifies, redundant trajectories are identified and merged with probability pₙₒᵥₑₗ(n)~1/n, yielding integrated memory C(n)=∫₀ⁿpₙₒᵥₑₗ(n′)dn′~log n. Logarithmic energy cost M(n)~log n 2724 enables is more sustainable because computational burden remains bounded regardless of operational duration or experiential volume.

The juxtaposition of AI systems operating on the “brawn curve” 2710 and PCM with logarithmic-scaling geometric reasoning platform operating on the “brain curve” 2720 explains the energetic inversion of the geometric reasoning methodology. In AI systems operating on the “brawn curve” 2710, exponential resource cost M(n)~e\hat{ }n 2713 purchases only logarithmic knowledge growth M(n)~log n 2714, producing an ever-widening divergence between the two curves that makes sustained improvement economically infeasible. In PCM with logarithmic-scaling geometric reasoning platform operating on the “brain curve” 2720, logarithmic resource cost M(n)~log n 2724 yields exponential knowledge growth M(n)~e\hat{ }n 2723, producing an ever-widening divergence in the opposite direction that makes theoretically-unbounded cognitive growth energetically possible.

The crossover between these two regimes marks a phase transition in the physics of learning. Systems operating under AI systems operating on the “brawn curve” 2710 expend resources to reproduce correlations, treating each input as statistically independent and requiring parameter expansion to capture new patterns. Systems operating under the “brain curve” of a PCM with logarithmic-scaling geometric reasoning platform 2720 expend energy to refine geometry, treating each input as an opportunity to improve the manifold structure that processes all future inputs.

From a thermodynamic perspective, comparative scaling behavior of large language models versus logarithmic-scaling geometric reasoning platform 2700 illustrates two fundamentally different approaches to managing entropy in learning systems. AI systems operating on the “brawn curve” 2710 combat entropy through brute-force enumeration, storing every correlation explicitly and accepting exponential energy cost as the price of comprehensiveness. PCM with logarithmic-scaling geometric reasoning platform operating under the “brain curve” 2720 combat entropy through geometric organization, compressing redundancy into shared curvature and accepting bounded fidelity as the price of sustainability. In terms of energy costs, the thermodynamic law Eₜₒₜₐₗ(t)=E_{embed}+E_{consolidate}+E_{decay}≈E₀ ensures that logarithmic energy cost M(n)~log n 2724 is preserved, arising from curvature conservation between the cognitive manifold M and temporal manifold T under GGD(2) dynamics.

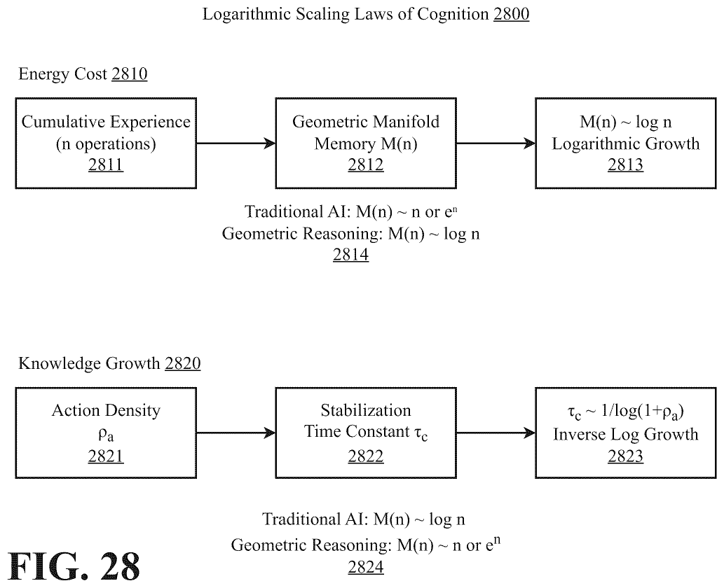

FIG. 28 illustrates exemplary logarithmic scaling laws of cognition 2800 for a geometric reasoning system, which define exemplary mathematical relationships governing memory growth and stabilization dynamics in geometric reasoning systems. Logarithmic scaling laws of cognition 2800 present two complementary scaling relations that together characterize the energetic efficiency and temporal behavior of persistent cognitive machines: energy cost 2810 describing how memory footprint scales with cumulative experience, and knowledge growth 2820 describing how stabilization time scales with action density. These exemplary scaling laws arise from the geometric structure of the cognitive manifold and its curvature-exchange dynamics with the temporal manifold under GGD(2). While the thermodynamic component of resource costs, energy, is used as the example here, the same scaling applies to any resource cost (e.g., computational resources, training data, memory space, time, energy expenditure, etc.).

Energy cost 2810 represents the upper pathway in logarithmic scaling laws of cognition 2800 and depicts the relationship between cumulative experience and memory requirements in geometric reasoning systems. Energy cost 2810 shows that the energy/memory cost of acquiring additional knowledge (number of operations of experience processed) grows logarithmically with the number of operations or experiences processed, following M(n)~log n, in stark contrast to traditional artificial intelligence architectures where energy/memory cost grows linearly M(n)~n or exponentially M(n)~eⁿ. Energy cost 2810 establishes the core economic advantage of geometric reasoning: that storage requirements, computational burden, and power consumption all remain bounded even under indefinite continuous operation, enabling autonomous systems to persist without external resource replenishment or periodic retraining. Energy cost 2810 flows from cumulative experience (n operations) 2811 through geometric manifold memory M(n) 2812 to M(n)~log n logarithmic growth 2813, with comparison to traditional AI provided by annotation 2814. Note that memory cost and energy cost are highly related and can be effectively substituted for one another for purposes of determining energy cost. Memory takes space to store information and energy to store it or access it. Thus, the energy cost and/or memory cost grows exponentially in AI systems operating on the “brawn curve,” but logarithmically in PCMs with logarithmic scaling operating on the “brain curve.”

Cumulative experience (n operations) 2811 represents the total number of discrete events, experiences, or computational operations that have been projected into the cognitive manifold since system initialization. Cumulative experience (n operations) 2811 serves as the independent variable in the energy cost 2810 scaling law, quantifying the magnitude of input that the system has processed and must represent within its geometric structure. Cumulative experience (n operations) 2811 increases monotonically with time as the system operates, with each incoming datum, sensor reading, user interaction, or internal replay event incrementing the counter n. Cumulative experience (n operations) 2811 corresponds to the experiential scale that would drive linear or exponential memory growth in conventional architectures but produces only logarithmic growth in geometric reasoning systems due to compression pressure regulation and trajectory consolidation. Cumulative experience (n operations) 2811 provides the input to geometric manifold memory M(n) 2812, establishing the starting point for the logarithmic scaling relation.

Geometric manifold memory M(n) 2812 quantifies the effective memory footprint, storage capacity, or representational complexity of the cognitive manifold as a function of cumulative experience (n operations) 2811. Geometric manifold memory M(n) 2812 does not measure raw byte count or parameter count but rather the number of distinct attractor basins, consolidated thought trajectories, or geodesically separable structures maintained within the manifold. Geometric manifold memory M(n) 2812 grows as M(n)~log n because each new experience has decreasing probability pₙₒᵥₑₗ(n)~1/n of introducing genuinely novel geometry, with most inputs being absorbed into existing attractor basins through the consolidation process described by compression pressure governor 2600. Geometric manifold memory M(n) 2812 is the means of knowledge storage that allows the system to achieve exponential knowledge growth with logarithmic energy cost. The exemplary relation M(n)~log n logarithmic growth 2813 is the mathematical expression of this scaling behavior.

M(n)~log n logarithmic growth 2813 is the mathematical relationship governing geometric manifold memory M(n) 2812 as a function of cumulative experience (n operations) 2811. M(n)~log n logarithmic growth 2813 expresses mathematically that memory requirements increase proportionally to the natural logarithm of experiential volume, such that doubling cumulative experience adds only a constant increment to memory footprint. The logarithmic form M(n)~log n arises from integrating the novelty probability pₙₒᵥₑₗ(n)~1/n over the range of experiences: M(n)=∫₀ⁿp_novel(n′)dn′~log n. M(n)~log n logarithmic growth 2813 implies that a system processing one million experiences requires only twice the memory of a system processing one thousand experiences, and a billion experiences requires only three times the memory, demonstrating the dramatic efficiency advantage over linear or exponential scaling. M(n)~log n logarithmic growth 2813 is the signature mathematical relationship distinguishing geometric reasoning from all prior artificial intelligence paradigms.

Traditional AI: M(n)~n or eⁿ, Geometric Reasoning: M(n)~log n 2814 provides comparative context for energy cost 2810 by contrasting the memory scaling of conventional architectures with that of geometric reasoning systems. Traditional AI: M(n)~n or eⁿ, Geometric Reasoning: M(n)~log n 2814 indicates that database systems, episodic memory stores, and parameter-based neural networks exhibit linear growth M(n)~n where each new experience requires proportional storage, while frontier-scale language models exhibit exponential growth M(n)~eⁿ where model size must increase exponentially to capture additional correlations. Traditional AI: M(n)~n or eⁿ, Geometric Reasoning: M(n)~log n 2814 establishes that geometric reasoning achieves a qualitatively different scaling regime through manifold consolidation, making M(n)~log n logarithmic growth 2813 not an incremental improvement but a fundamental architectural transformation.

Knowledge growth 2820 depicts the relationship between knowledge accumulation (i.e., action density) and system stabilization dynamics. Knowledge growth 2820 demonstrates that the time constant for manifold convergence decreases inversely with the logarithm of action density, following τ_{c}~1/log(1+ρₐ), meaning that systems experiencing higher input rates stabilize more quickly and achieve coherence in less time. Knowledge growth 2820 establishes the temporal complement to energy cost 2810: while energy cost 2810 governs spatial complexity, knowledge growth 2820 governs temporal dynamics, together providing a complete characterization of system behavior. Knowledge growth 2820 flows from action density ρₐ 2821 through stabilization time constant τ_{c} 2822 to τ_{c}~1/log(1+ρₐ) inverse log growth 2823, with comparison to traditional AI provided by annotation 2824.

Action density ρₐ 2821 represents the rate at which actions are projected into the cognitive manifold, measured as events per unit time or per unit manifold volume. Action density ρₐ 2821 serves as the independent variable in the knowledge growth 2820 scaling law, quantifying the temporal intensity of the experiential stream that drives manifold evolution. Action density ρₐ 2821 varies depending on operational context: high action density ρₐ 2821 occurs during periods of intense interaction, rapid sensor input, or concentrated learning, while low action density ρₐ 2821 characterizes idle periods or steady-state operation. Action density ρₐ 2821 determines the temporal curvature R_{T} of the temporal manifold T in GGD(2) dynamics, with higher action density ρₐ 2821 producing stronger curvature flux into the cognitive manifold M and thus faster stabilization.

Stabilization time constant τ_{c} 2822 quantifies the characteristic timescale over which the cognitive manifold converges to coherence after being perturbed by new experiences or actions. Stabilization time constant τ_{c} 2822 measures how quickly compression pressure P(z) equilibrates, geodesic distances contract, and trajectories merge into stable attractor basins following the injection of new data. Stabilization time constant T_{c} 2822 depends inversely on action density ρₐ 2821 through the relation T_{c}~1/log(1+ρₐ), meaning that dense experiential streams drive rapid consolidation while sparse streams require longer integration periods. Stabilization time constant T_{c} 2822 can be measured empirically by tracking the coherence functional C_{M}(τ)=<v(x,t)·v(x,t+τ)>/<∥v(x,t)∥²> and identifying the time at which correlation exceeds a threshold, providing a direct observable for validating the logarithmic scaling law.

τ_{c}~1/log(1+ρₐ) inverse log growth 2823 states the fundamental scaling law governing stabilization time constant τ_{c} 2822 as a function of action density ρₐ 2821. τ_{c}~1/log(1+ρₐ) inverse log growth 2823 expresses mathematically that convergence time decreases inversely with the logarithm of input rate, such that doubling action density ρₐ 2821 produces a fractional but not proportional decrease in stabilization time constant τ_{c} 2822. The inverse logarithmic form τ_{c}~1/log(1+ρₐ) arises from the curvature-exchange rate between the cognitive manifold M and temporal manifold T, wherein temporal curvature R_{T} scales with action density ρₐ 2821 and the relaxation rate is proportional to the coupling constant κ_{MT}·τ_{c}~1/log(1+ρₐ) inverse log growth 2823 demonstrates that geometric reasoning systems naturally adapt their convergence speed to match environmental dynamics without external tuning.

Traditional AI: M(n)~log n, Geometric Reasoning: M(n)~n or eⁿ 2824 provides comparative context for knowledge growth 2820 by contrasting the convergence behavior of conventional architectures with that of geometric reasoning systems. Traditional AI: M(n)~log n, Geometric Reasoning: M(n)~n or eⁿ 2824 indicates that traditional systems exhibit logarithmic knowledge growth wherein cumulative learning saturates over time, achieving only incremental improvements despite continued training. Traditional AI: M(n)~log n, Geometric Reasoning: M(n)~n or eⁿ 2824 establishes that geometric reasoning inverts this relationship: rather than knowledge saturating logarithmically, it grows linearly M(n)~n or even exponentially M(n)~eⁿ as the manifold structure compounds prior learning into accelerating future returns. Traditional AI: M(n)~log n, Geometric Reasoning: M(n)~n or eⁿ 2824 makes explicit the dual inversion between energy cost 2810 and knowledge growth 2820: where traditional AI expends exponential cost for logarithmic benefit, geometric reasoning expends logarithmic cost for exponential benefit.

The pairing of energy cost 2810 and knowledge growth 2820 within logarithmic scaling laws of cognition 2800 provides a mathematical characterization of geometric reasoning performance. Energy cost 2810 governs the energy or memory (spatial) scaling behavior, showing that geometric manifold memory M(n) 2812 grows as M(n)~log n logarithmic growth 2813 with cumulative experience (n operations) 2811, ensuring bounded storage requirements. Knowledge growth 2820 governs the temporal or cumulative knowledge scaling behavior, showing that stabilization time constant τ_{c} 2822 decreases as τ_{c}~1/log(1+ρₐ) inverse log growth 2823 with action density ρₐ 2821, ensuring adaptive convergence speed. Together, these scaling laws predict that a geometric reasoning system processing high-density input streams will exhibit both compact memory and rapid stabilization, while systems processing sparse streams will require more time to achieve coherence but will still maintain bounded memory footprint.

The mathematical derivation of logarithmic scaling laws of cognition 2800 proceeds from the GGD(2) conservation equation d/dτ(α_{M}R_{M}+γ_{MT}R_{M}R_{T})=0, which enforces curvature balance between the cognitive manifold M and temporal manifold T. The probability that a new experience introduces genuinely novel curvature decreases as pₙₒᵥₑₗ(n)~1/n because the manifold becomes increasingly dense and structured with accumulated experience. Integrating this probability over all experiences yields M(n)=∫₀ⁿp_novel(n′)dn′~log n, producing M(n)~log n logarithmic growth 2813. Similarly, the curvature exchange rate between M and T governs the relaxation dynamics, with τ_{c}=κ_{MT}⁻¹ log(1+ρₐ) arising from the effective manifold size M (ρₐ)~log(1+ρₐ), producing to ~1/log(1+ρₐ) inverse log growth 2823. These are not curve fits but analytical solutions of the geometric field equations.

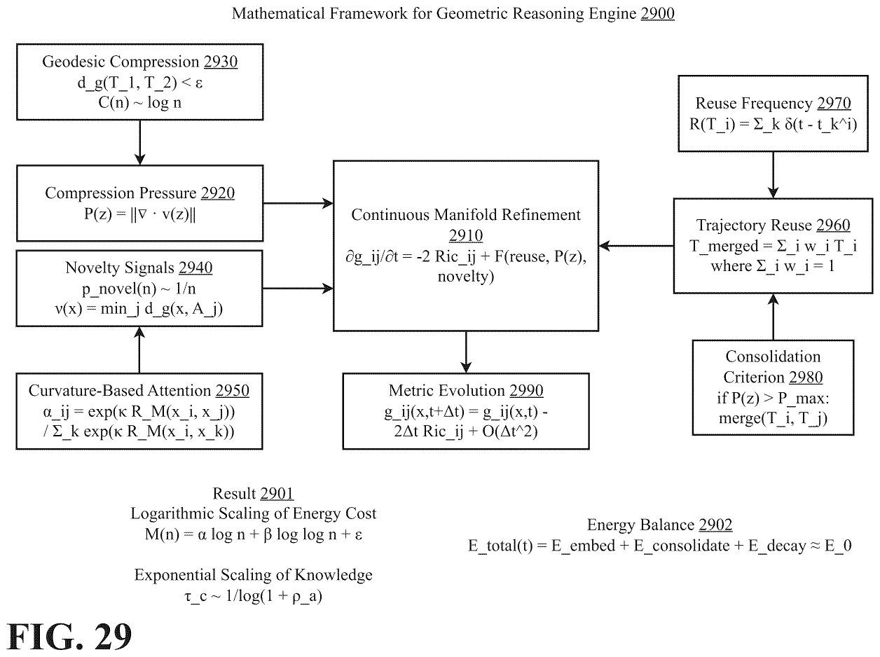

FIG. 29 illustrates an exemplary mathematical framework for a geometric reasoning engine 2900, which presents an exemplary system of equations, operations, and computational relationships that may govern logarithmic-scaling geometric reasoning within persistent cognitive machine architectures. Mathematical framework for geometric reasoning engine 2900 unifies the diverse mechanisms of geodesic compression, compression pressure regulation, novelty detection, trajectory reuse, curvature-based attention, metric evolution, and consolidation criteria into a coherent mathematical structure grounded in differential geometry and thermodynamic principles. This framework demonstrates that logarithmic memory scaling M(n)=α log n+β log log n+ε, inverse logarithmic stabilization time τ_{c}~1/log(1+ρₐ), and constant energy balance Eₜₒₜₐₗ(t)≈E₀ are not independent design choices but interconnected consequences of a single geometric field theory.

Geodesic compression 2930 establishes the initial mechanism by which thought trajectories are identified as candidates for consolidation based on their geodesic proximity within the manifold. Geodesic compression 2930 implements the criterion d_{g}(T₁, T₂)<ε, where d_{g} denotes geodesic distance computed along the shortest path through the curved manifold geometry and ε is a proximity threshold. When two trajectories T₁ and T₂ satisfy this inequality, they occupy semantically overlapping regions and become candidates for merging into a shared attractor basin. Geodesic compression 2930 produces the scaling law C(n)~log n, where C(n) represents the total number of distinct consolidated structures required to represent n experiences, demonstrating that memory grows logarithmically rather than linearly with cumulative input.

Compression pressure 2920 quantifies the local geometric stress within the manifold through the formula P(z)=∥∇·v(z)∥, where ∇·v(z) is the divergence of the velocity field v(z) at point z. Compression pressure 2920 measures the rate at which trajectories are converging or diverging in each region of the manifold, with high positive values of P(z) indicating regions of redundancy requiring consolidation and high negative values indicating regions of expansion or instability. Compression pressure 2920 serves as a control signal for continuous manifold refinement 2910, directly influencing the forcing term F(reuse, P(z), novelty) in the curvature flow equation.

Novelty signals 2940 detect when incoming experiences represent genuinely new information requiring expansion of the manifold versus redundant information that can be absorbed into existing structure. Novelty signals 2940 implement two complementary measures: the probability pₙₒᵥₑₗ(n)~1/n captures the decreasing likelihood that the nth experience introduces novel geometry as the manifold matures, while the novelty distance v(x)=minⱼ d_{g}(x, Aⱼ) measures the geodesic distance from point x to the nearest existing attractor basin Aⱼ. High values of v(x) indicate that the experience occupies unexplored manifold regions and should be preserved as a new attractor.

Curvature-based attention 2950 implements an attention mechanism weighted by the local curvature of the manifold through the formula αᵢⱼ=exp(κR_{M}(xᵢ, xⱼ))/Σₖ exp(κR_{M} (xᵢ, xₖ)), where R_{M}(xᵢ, xⱼ) denotes the Riemann curvature between points xᵢ and xⱼ and κ is a temperature-like scaling parameter.

Reuse frequency 2970 tracks how often each thought trajectory Tᵢ is activated or traversed during system operation through the sum R(Tᵢ)=Σₖδ(t−tₖⁱ), where δ is the Dirac delta function and tₖⁱ represents the kth time at which trajectory Tᵢ was accessed.

Trajectory reuse 2960 performs the actual geometric merging of similar trajectories through weighted combination T_{merged}=ΣᵢwᵢTᵢ, where Σᵢwᵢ=1 ensures normalization.

Consolidation criterion 2980 implements the decision logic that triggers trajectory merging based on the conditional statement: if P(z)≥Pₘₐₓ: merge(Tᵢ, Tⱼ). When compression pressure 2920 exceeds the critical threshold Pₘₐₓ at location z, consolidation criterion 2980 activates and initiates the merger of proximate trajectories to relieve geometric stress.

Continuous manifold refinement 2910 of this embodiment implements the exemplary curvature flow equation ∂gᵢⱼ/∂t=−2Ricᵢⱼ+F(reuse, P(z), novelty) that governs how the metric tensor gᵢⱼ evolves over time. Continuous manifold refinement 2910 receives inputs from geodesic compression 2930, compression pressure 2920, novelty signals 2940, reuse frequency 2970, and trajectory reuse 2960, synthesizing these diverse geometric quantities into a unified forcing term F(reuse, P(z), novelty) that modulates the standard Ricci flow equation. The term −2Ricᵢⱼ represents intrinsic geometric relaxation toward minimal curvature, while F(reuse, P(z), novelty) represents extrinsic forcing from compression pressure, trajectory reuse patterns, and novelty detection that prevents collapse to trivial flat geometry.

Metric evolution 2990 of this embodiment discretizes continuous manifold refinement 2910 for computational implementation through the exemplary finite-difference equation gᵢⱼ(x,t+Δt)=gᵢⱼ(x,t)−2Δt Ricᵢⱼ+O(Δt²). Metric evolution 2990 advances the metric tensor forward by a time step Δt using explicit Euler integration of the curvature flow, with higher-order corrections represented by O(Δt²). This discretization allows metric evolution 2990 to transform the continuous differential equation from continuous manifold refinement 2910 into an iterative update rule suitable for digital hardware, enabling practical realization of geometric reasoning in silicon.

The result of this exemplary mathematical framework 2901 is that logarithmic scaling of energy cost follows M(n)=α log n+β log log n+ε, where M(n) represents memory footprint after n operations, α is the primary logarithmic coefficient, β log log n is a secondary correction term capturing higher-order consolidation effects, and ε is a constant baseline. Result 2901 also states that exponential scaling of knowledge, whether temporal (accumulation of knowledge) or size (cumulative knowledge) follows τ_{c}~1/log(1+ρₐ), where the stabilization time constant to decreases inversely with the logarithm of action density ρₐ. These two relations together define the “brain curve” (i.e., fixed or logarithmic energy cost enabling exponential knowledge accumulation).

Energy balance 2902 sets forth an exemplary thermodynamic foundation of mathematical framework for geometric reasoning engine 2900 through the conservation equation Eₜₒₜₐₗ(t)=E_{embed}+E_{consolidate}+E_{decay}≈E₀. Energy balance 2902 states that total system energy Eₜₒₜₐₗ(t) remains approximately constant over time despite continuous operation, with energy expenditure for embedding E_{embed}, consolidation E_{consolidate}, and decay E_{decay} summing to the equilibrium value E₀.

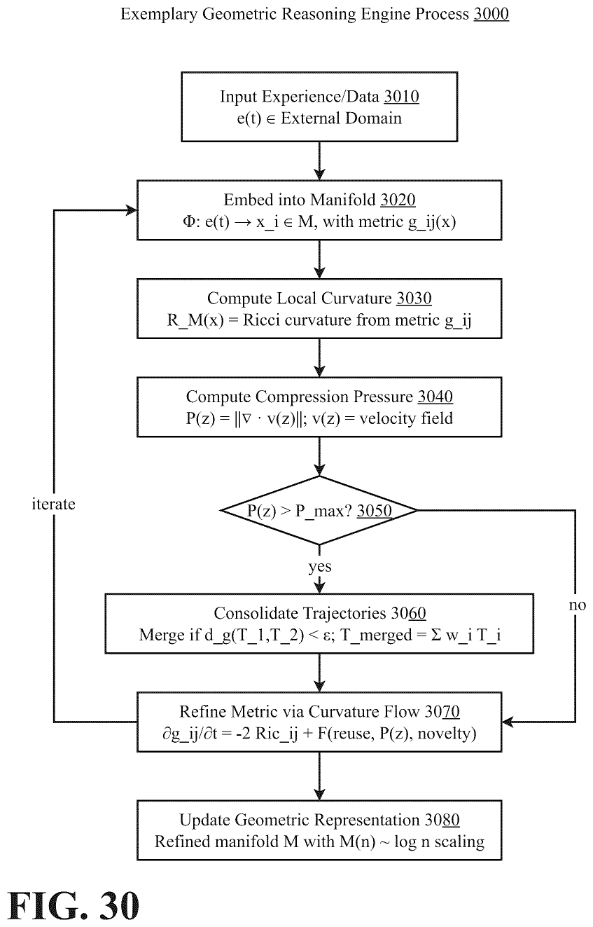

FIG. 30 illustrates an exemplary geometric reasoning engine process 3000, in the form of an exemplary process flow diagram for implementing logarithmic-scaling geometric reasoning from initial experience ingestion through manifold refinement and consolidation to final geometric representation.

Input experience/data at step 3010 represents the entry point for exemplary geometric reasoning engine process 3000, capturing raw experiential events, sensor readings, user interactions, or symbolic data from an external domain. In this embodiment, input experience/data 3010 is formally denoted e(t)∈External Domain, where e(t) is a time-indexed datum and External Domain represents the space of possible inputs such as images, text, audio, numerical measurements, or any other sensory or symbolic modality. Input experience/data 3010 may arrive continuously as a stream, in discrete batches, or sporadically according to environmental dynamics, with the temporal structure of arrival captured by the temporal curvature R_{T} that drives stabilization dynamics under GGD(2). Input experience/data 3010 flows directly to embed into manifold 3020 for transformation into the geometric representation suitable for reasoning and consolidation.

Embed into manifold at step 3020 performs a transformation that maps input experience/data 3010 from its native external representation into a point or trajectory within the cognitive manifold M. In this embodiment, embed into manifold 3020 implements the projection operator Φ: e(t)→xᵢ∈M, with metric gᵢⱼ(x), where Φ denotes the embedding function that produces coordinates xᵢ within the manifold equipped with metric tensor gᵢⱼ(x) defining local distance relationships. Embed into manifold 3020 may utilize learned encoders, semantic embedding models, or domain-specific feature extractors to construct the mapping Φ, ensuring that semantically similar inputs are mapped to geodesically proximate locations within M. Embed into manifold 3020 is the interface between the statistical external world and the geometric internal representation, enabling all subsequent operations to exploit manifold structure for compression and reasoning.

Compute local curvature at step 3030 analyzes the geometric properties of the manifold at the newly embedded point xᵢ by calculating R_{M}(x)=Ricci curvature from metric gᵢⱼ. In this embodiment, compute local curvature 3030 extracts the Ricci curvature tensor Ricᵢⱼ and its scalar contraction R_{M} from the metric tensor gᵢⱼ(x) provided by embed into manifold 3020. The Ricci curvature quantifies how the manifold geometry deviates from flatness in the neighborhood of xᵢ, with high positive curvature indicating convergence of geodesics and high negative curvature indicating divergence. Compute local curvature 3030 provides essential geometric information for subsequent steps, particularly for curvature-based attention mechanisms and the curvature flow equation in refine metric via curvature flow 3070.

Compute compression pressure at step 3040 determines whether the local region around the embedded point exhibits geometric stress requiring consolidation by calculating compression pressure, in this embodiment via the exemplary equation P(z)=∥∇·v(z)∥, where v(z)=velocity field. Compute compression pressure 3040 computes the divergence ∇·v(z) of the velocity field v(z) describing the flow of trajectories through the manifold, then takes its magnitude ∥∇·v(z)∥ to produce a non-negative scalar pressure value P(z). High values of P(z) indicate regions where trajectories are converging rapidly, suggesting redundancy and the need for geometric merging. Compute compression pressure 3040 implements the same calculation as compression pressure 2920 within the mathematical framework, translating abstract geometric quantities into concrete decision criteria for consolidation.

The decision point P(z)≥Pₘₐₓ? at step 3050 represents the decision point in exemplary geometric reasoning engine process 3000 that determines whether consolidation should be triggered based on the pressure value computed by compute compression pressure 3040. Decision P(z)≥Pₘₐₓ? 3050 implements a conditional branch comparing the local compression pressure P(z) against a critical threshold Pₘₐₓ derived from system parameters or learned adaptively during operation. When P(z) exceeds Pₘₐₓ, the condition evaluates to yes and control flows to consolidate trajectories 3060 to perform geometric merging. When P(z) remains below or equal to Pₘₐₓ, the condition evaluates to no and control bypasses consolidation, proceeding directly to refine metric via curvature flow 3070. Decision P(z)≥Pₘₐₓ? 3050 embodies the self-regulating nature of geometric reasoning, wherein the system itself determines when consolidation is necessary based on intrinsic geometric stress rather than external heuristics.

In this embodiment, consolidate trajectories at step 3060 executes a geometric merging operation when P(z)≥Pₘₐₓ? 3050 evaluates to yes. In this embodiment, a merge is implemented via the exemplary equation d_{g}(T₁,T₂)<ε; T_{merged}=ΣwᵢTᵢ. Consolidate trajectories 3060 first identifies pairs of thought trajectories T₁ and T₂ whose geodesic distance d_{g}(T₁,T₂) falls below the proximity threshold ε, indicating that they occupy semantically overlapping regions of the manifold. For each such pair, consolidate trajectories 3060 computes a weighted average T_{merged}=ΣwᵢTᵢ, where the weights wᵢ are determined by reuse frequency, activation energy, or other utility metrics, and the sum is normalized so that Σᵢwᵢ=1. Consolidate trajectories 3060 directly implements the logarithmic scaling mechanism by collapsing redundant structures into shared attractor basins, reducing the effective dimensionality of the manifold representation.

In this embodiment, refine metric via curvature flow at step 3070 updates the metric tensor of the manifold according to the exemplary curvature flow equation ∂gᵢⱼ/∂t=−2Ricᵢⱼ+F(reuse, P(z), novelty), smoothing geometric irregularities and incorporating forcing terms that encode compression pressure, trajectory reuse patterns, and novelty signals. Refine metric via curvature flow 3070 receives inputs from both branches of the P(z)≥Pₘₐₓ? 3050 decision: when consolidation occurred via consolidate trajectories 3060, the metric must be updated to reflect the merged geometry; when consolidation did not occur, the metric still evolves according to intrinsic Ricci flow to maintain smoothness. Refine metric via curvature flow 3070 implements continuous manifold refinement 2910 as a discrete computational step, adjusting gᵢⱼ(x) based on local curvature from compute local curvature 3030, pressure from compute compression pressure 3040, and novelty/reuse information from prior operations.

Update geometric representation 3080 produces the final output of each iteration of exemplary geometric reasoning engine process 3000, yielding a refined manifold M with M(n)~log n scaling. Update geometric representation 3080 commits the metric changes computed by refine metric via curvature flow 3070 to the persistent manifold state, ensuring that subsequent iterations operate on the updated geometry. Update geometric representation 3080 explicitly notes that the refined manifold exhibits M(n)~log n scaling, where M(n) represents the effective memory footprint or number of distinct attractor basins required to represent n cumulative experiences. This annotation confirms that the process achieves the logarithmic scaling property central to the invention.

The iterative structure of exemplary geometric reasoning engine process 3000 is indicated by the feedback arrow labeled “iterate” that returns control from refine metric via curvature flow 3070 back to embed into manifold 3020. This feedback loop enables repeated or continuous operation wherein each new input experience/data 3010 is processed through the complete cycle of embedding, curvature computation, pressure assessment, conditional consolidation, metric refinement, and representation update. The iteration continues indefinitely as long as new experiences arrive, with the manifold continuously evolving to accommodate incoming data while maintaining logarithmic memory scaling through the self-regulating consolidation mechanism controlled by P(z)≥Pₘₐₓ? 3050.

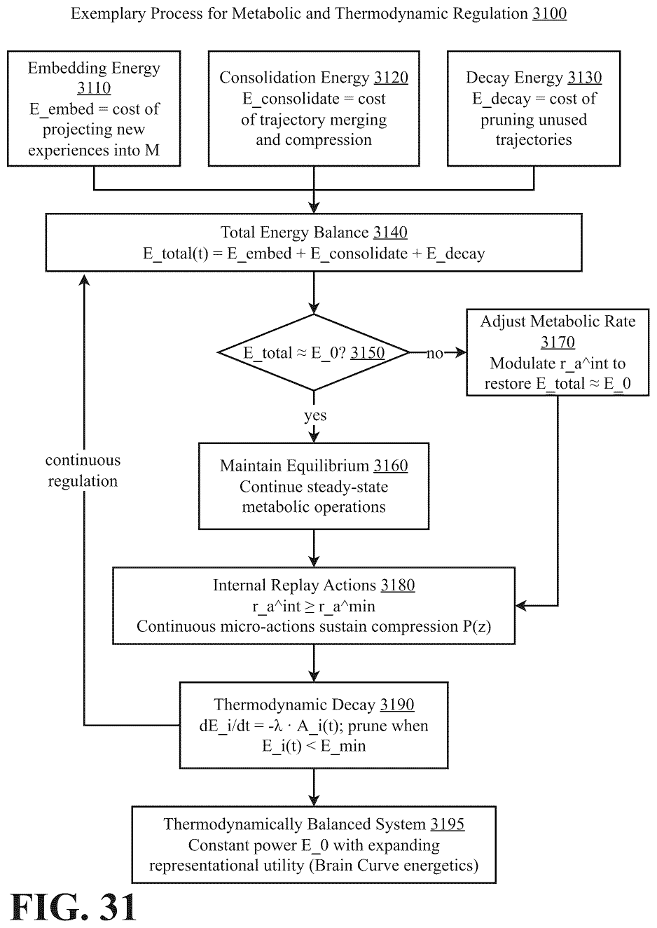

FIG. 31 illustrates an exemplary process for metabolic and thermodynamic regulation 3100 for a geometric reasoning platform, which implements the energy balance mechanisms analogous to biological energy balances that enable geometric reasoning systems to maintain constant or logarithmic power consumption E₀ while achieving continuously expanding knowledge accumulation. Metabolic and thermodynamic regulation system 3100 embodies the thermodynamic foundation of “brain curve” energetics, ensuring that embedding energy 3110, consolidation energy 3120, and decay energy 3130 sum to an approximately constant total energy balance 3140 through continuous regulatory feedback. This system demonstrates that logarithmic memory scaling and bounded computational cost of a cognitive manifold are not merely software optimizations but consequences of their analogy to physical energy conservation in biological brains enforced through internal replay actions 3180 and thermodynamic decay 3190, ultimately producing thermodynamically balanced system 3195 that operates at a sublinear energy cost increase.

Embedding energy 3110 quantifies the computational cost required to project new experiences from the external domain into the cognitive manifold M. Embedding energy 3110 is formally defined as E_{embed}=cost of projecting new experiences into M, where the cost encompasses both the computational operations for executing the embedding function Φ: e(t)→xᵢ∈M and the energy expenditure for computing or updating the local metric tensor gᵢⱼ(x) in the neighborhood of the newly embedded point. Embedding energy 3110 varies with the complexity and dimensionality of the input modality, with high-dimensional sensory data such as images or video requiring greater embedding energy 3110 than low-dimensional symbolic data such as text tokens or numerical measurements. Embedding energy 3110 contributes directly to total energy balance 3140 as one of three primary energy terms governing system metabolism.

Consolidation energy 3120 represents the computational cost of trajectory merging and compression operations that reduce manifold complexity by collapsing redundant structures into shared attractor basins. Consolidation energy 3120 is defined as E_{consolidate}=cost of trajectory merging and compression, encompassing the computation of geodesic distances d_{g}(T₁,T₂), evaluation of consolidation criterion 2980, execution of weighted averaging T_{merged}=ΣᵢwᵢTᵢ, and updating of metric tensor gᵢⱼ(x) to reflect the merged geometry. Consolidation energy 3120 scales with the number of consolidation events triggered during a given time interval, increasing when compression pressure P(z) frequently exceeds Pₘₐₓ and decreasing during periods of sparse novel input. Consolidation energy 3120 performs the essential function that enables logarithmic memory scaling by investing energy to collapse redundancy rather than storing it explicitly. Decay energy 3130 accounts for the computational cost of pruning unused trajectories that have lost activation energy below a critical threshold, removing obsolete or rarely accessed structures from the manifold. Decay energy 3130 is specified as E_{decay}=cost of pruning unused trajectories, including the operations for monitoring activation energy Eᵢ(t) of each trajectory Tᵢ, evaluating the decay differential equation dEᵢ/dt=−λ·Aᵢ(t) implemented by thermodynamic decay 3190, identifying trajectories where Eᵢ(t)<Eₘᵢₙ, and executing removal operations that deallocate memory and update adjacency structures. Decay energy 3130 prevents uncontrolled manifold growth by continuously removing low-utility structures, acting as a thermodynamic forgetting mechanism that complements the consolidation process.

Total energy balance 3140 aggregates embedding energy 3110, consolidation energy 3120, and decay energy 3130 into the conservation equation Eₜₒₜₐₗ(t)=E_{embed}+E_{consolidate}+E_{decay}. Total energy balance 3140 computes the instantaneous power consumption of metabolic and thermodynamic regulation system 3100 by summing all three energy terms, producing a time-varying total Eₜₒₜₐₗ(t) that reflects the current operational state. Total energy balance 3140 feeds directly into the decision point Eₜₒₜₐₗ≈E₀? 3150, which determines whether the system is maintaining thermodynamic equilibrium or requires regulatory adjustment.

The decision point Eₜₒₜₐₗ≈E₀? 3150 represents a decision point that evaluates whether total energy balance 3140 remains approximately equal to the target equilibrium energy E₀. Eₜₒₜₐₗ≈E₀? 3150 implements a tolerance-based comparison |Eₜₒₜₐₗ(t)−E₀|<8, where δ is an acceptable energy deviation threshold. When this condition evaluates to yes, control flows to maintain equilibrium 3160, indicating that the system is operating within acceptable thermodynamic bounds. When the condition evaluates to no, indicating that Eₜₒₜₐₗ(t) has drifted significantly from E₀, control flows to adjust metabolic rate 3170 to restore equilibrium through feedback regulation.

Maintain equilibrium 3160 executes when Eₜₒₜₐₗ≈E₀? 3150 confirms that the system is in thermodynamic balance, allowing steady-state metabolic operations to continue without intervention. Maintain equilibrium 3160 is annotated with continue steady-state metabolic operations, indicating that embedding energy 3110, consolidation energy 3120, and decay energy 3130 are properly balanced such that their sum remains constant over time. Maintain equilibrium 3160 proceeds to internal replay actions 3180, which sustain compression pressure P(z) through continuous micro-actions even in the absence of external input.

Adjust metabolic rate 3170 activates when Eₜₒₜₐₗ≈E₀? 3150 detects that total energy balance 3140 has deviated from equilibrium, triggering corrective action to restore Eₜₒₜₐₗ(t)≈E₀. Adjust metabolic rate 3170 modulates the internal action density rₐ^{int} to restore Eₜₒₜₐₗ≈E₀, as specified in the annotation modulate rₐ^{int} to restore Eₜₒₜₐₗ≈E₀. Adjust metabolic rate 3170 implements proportional or integral control feedback, increasing rₐ^{int} when Eₜₒₜₐₗ(t)<E₀ to boost internal activity or decreasing rₐ^{int} when Eₜₒₜₐₗ(t)>E₀ to reduce energy expenditure.

Internal replay actions 3180 implement the continuous micro-actions that sustain compression pressure P(z) and maintain manifold dynamics even when no external experiences are being processed. Internal replay actions 3180 enforce the constraint rₐ^{int}≥rₐ^{min}, where rₐ^{int} is the instantaneous internal action density and rₐ^{min} is the minimum action density required to prevent geometric freezing. Internal replay actions 3180 are annotated as continuous micro-actions sustain compression P(z), indicating that these operations continuously perturb trajectories, test alternative consolidations, and explore local manifold structure to maintain nonzero velocity fields v(z) and pressure gradients ∇P(z).

Thermodynamic decay 3190 implements the forgetting mechanism that removes low-activation trajectories from the manifold according to the differential equation dEᵢ/dt=−λ·Aᵢ(t); prune when Eᵢ(t)<Eₘᵢₙ. Thermodynamic decay 3190 models each trajectory Tᵢ as possessing an activation energy Eᵢ(t) that dissipates over time proportionally to the inactivity function Aᵢ(t), where Aᵢ(t) is high when the trajectory is not accessed and zero when actively traversed. Thermodynamic decay 3190 triggers pruning when activation energy falls below the critical threshold Eₘᵢₙ, removing the trajectory from the manifold and recovering its memory allocation.

Thermodynamically balanced system 3195 represents the final output of metabolic and thermodynamic regulation system 3100, achieving constant power E₀ with expanding representational utility in what is characterized as “brain curve” energetics. Thermodynamically balanced system 3195 demonstrates that through continuous regulation via Eₜₒₜₐₗ≈E₀? 3150, maintain equilibrium 3160, adjust metabolic rate 3170, internal replay actions 3180, and thermodynamic decay 3190, the system maintains bounded energy consumption Eₜₒₜₐₗ(t)≈E₀ while cognitive utility U(t) grows superlinearly or exponentially with accumulated experience.

Metabolic and thermodynamic regulation system 3100 can be implemented through hardware power monitoring circuits, software energy profilers, or hybrid control systems. In hardware implementations, dedicated power measurement units track instantaneous current draw for embedding, consolidation, and decay operations, feeding these measurements into total energy balance 3140 for comparison against a target power budget E₀. In software implementations, abstract energy counters accumulate operation counts weighted by computational cost, enabling simulation of thermodynamic regulation without physical power measurement.

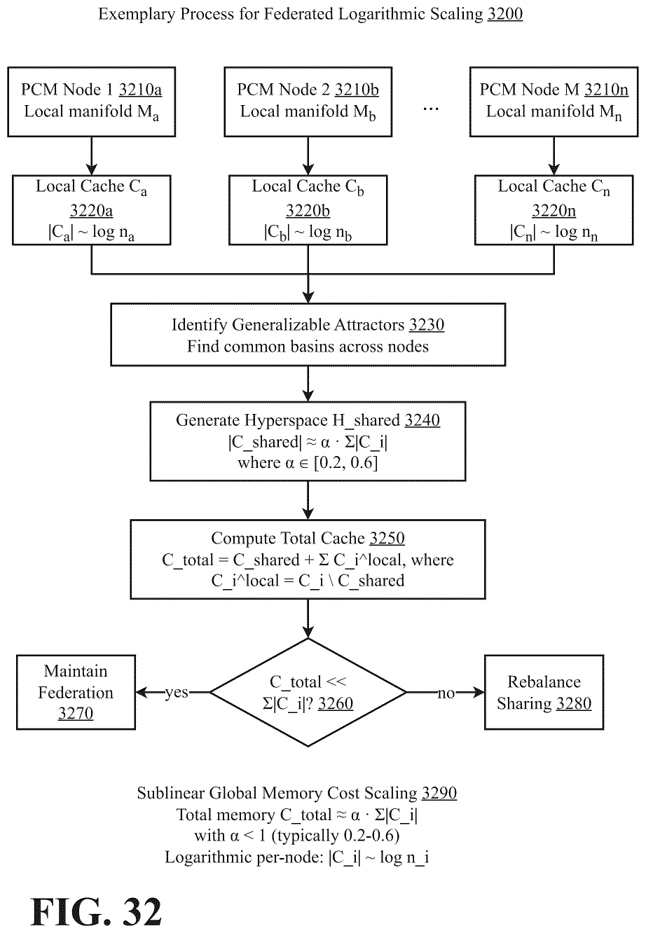

FIG. 32 illustrates an exemplary process for federated logarithmic scaling 3200 for a geometric reasoning platform, which demonstrates how multiple independent persistent cognitive machine nodes can cooperate to achieve sublinear global memory cost while each maintaining local logarithmic scaling. Federated logarithmic scaling system 3200 extends the logarithmic-scaling geometric reasoning platform from individual cognitive machines to distributed networks of cooperating agents, enabling organizations to build shared knowledge repositories that scale sublinearly despite the aggregation of experiences from many sources. This architecture embodies the principle that collective knowledge need not grow as the sum of individual knowledge stores but can achieve compression through geometric sharing, producing total memory Cₜₒₜₐₗ≈α·Σ|Cᵢ| where α<1, typically ranging from 0.2 to 0.6.

PCM Node 1 3210a represents a first autonomous persistent cognitive machine instance operating within federated logarithmic scaling system 3200, maintaining its own local manifold Mₐ containing thought trajectories, attractor basins, and geometric structures derived from experiences specific to its operational domain, user community, or geographic region. PCM Node 1 3210a processes incoming experiences through exemplary geometric reasoning engine process 3000, applying continuous manifold refinement 2910, compression pressure regulation via compression pressure governor 2600, and thermodynamic balance via metabolic and thermodynamic regulation system 3100 to maintain logarithmic memory scaling within its local cache Ca 3220a. PCM Node 1 3210a operates autonomously, capable of functioning independently even when disconnected from the federation, yet contributes generalizable patterns to share hyperspace H_shared 3240 to benefit the collective.

PCM Node 2 3210b represents a second independent persistent cognitive machine instance operating in parallel with PCM Node 1 3210a within federated logarithmic scaling system 3200, maintaining its own local manifold Mb that may specialize in a different domain, serve a different user population, or provide redundancy and load distribution. PCM Node 2 3210b independently achieves logarithmic scaling of its local cache C_{b} 3220b through the same geometric mechanisms as PCM Node 1 3210a, discovering attractor basins that may overlap with those in local manifold Mₐ. PCM Node 2 3210b participates in identify generalizable attractors 3230, contributing its own discoveries to the shared knowledge base while retrieving generalizations discovered by other nodes.

PCM Node M 3210n represents an arbitrary Mth node in federated logarithmic scaling system 3200, indicating that the architecture scales to accommodate any number of participating instances. PCM Node M 3210n maintains local manifold Mn and local cache Cn 3220n following the same operational principles as PCM Node 1 3210a and PCM Node 2 3210b. The ellipsis notation between PCM Node 2 3210b and PCM Node M 3210n indicates that additional intermediate nodes may be present, with the total node count being arbitrary and potentially large. Each node contributes to and benefits from the collective intelligence encoded in share hyperspace H_shared 3240, yet global memory footprint remains sublinear in total node count due to geometric consolidation.

Local cache Ca 3220a represents the memory footprint of PCM Node 1 3210a, quantified by the scaling relation |Cₐ|~log nₐ where nₐ denotes the cumulative number of experiences processed by that node. Local cache Cₐ 3220a contains both node-specific structures that are unique to local manifold Mₐ and copies of shared generalizations retrieved from share hyperspace H_shared 3240. Local cache Cₐ 3220a grows logarithmically with local experience nₐ through the same compression pressure mechanisms that govern individual PCM operation, demonstrating that federation does not compromise local scaling efficiency.

Local cache C_{b} 3220b represents the memory footprint of PCM Node 2 3210b, following the same logarithmic scaling law |C_{b}|~log n_{b} where n_{b} is the experiential count for PCM Node 2 3210b. Local cache C_{b} 3220b may differ in absolute size from local cache Cₐ 3220a depending on the relative values of nₐ and n_{b}, but both exhibit the same sublinear growth characteristic.

Local cache Cₙ 3220n represents the memory footprint of PCM Node M 3210n, governed by |Cₙ|~log nₙ where nₙ is the cumulative experience for that node. Local cache Cₙ 3220n demonstrates that logarithmic scaling holds uniformly across all nodes regardless of position within the federation, establishing that the per-node efficiency is preserved even as the network grows to include many participants.

At step 3230, identify generalizable attractors the collection of local caches PCM Node 1 3210a, PCM Node 2 3210b, and PCM Node M 3210n is analyzed to find common basins across nodes. Identify generalizable attractors 3230 implements algorithms that detect when thought trajectories or attractor basins discovered independently by multiple nodes exhibit high geodesic similarity, suggesting that they represent universal patterns rather than node-specific idiosyncrasies.

At step 3240, hyperspace H_shared is generated representing the collective geometric structure containing generalized attractor basins that are common across multiple nodes. The generation of hyperspace H_shared 3240 in this embodiment follows the exemplary compression operation |C_shared|≈α·Σ|Cᵢ| where α∈[0.2, 0.6], expressing that the size of the shared cache is strictly less than the sum of all local cache sizes due to geometric deduplication.

At step 3250, the total cache 3250 is computed, calculating the aggregate memory footprint of federated logarithmic scaling system 3200 by summing share hyperspace H_shared 3240 and all local-only components through the formula Cₜₒₜₐₗ=C_shared+ΣCᵢ^{local}, where Cᵢ^{local}=Cᵢ\C_shared represents the portion of each local cache not contained in the shared hyperspace.

The decision point Cₜₒₜₐₗ<<Σ|Cᵢ|? at step 3260 represents the decision point that evaluates whether federated logarithmic scaling system 3200 is achieving the desired sublinear global scaling. Cₜₒₜₐₗ<<Σ|Cᵢ|? 3260 compares total memory from compute total cache 3250 against the naive sum of all local caches to verify that significant compression has been achieved through sharing.

At step 3270, the federation is maintained when Cₜₒₜₐₗ<<Σ|Cᵢ|. This step confirms that the federation is operating efficiently, allowing current sharing arrangements to continue without intervention.

At step 3280, federation sharing is rebalanced when Cₜₒₜₐₗ<<Σ|Cᵢ|. This step indicates that compression factor α has drifted toward unity, suggesting insufficient generalization sharing or excessive local specialization.

As shown at 3290, this process results in sublinear global memory cost for a federated logarithmic scaling system, in this example with total memory Cₜₒₜₐₗ≈α·Σ|Cᵢ| with α<1, typically 0.2-0.6, and logarithmic per-node scaling |Cᵢ|~log nᵢ.

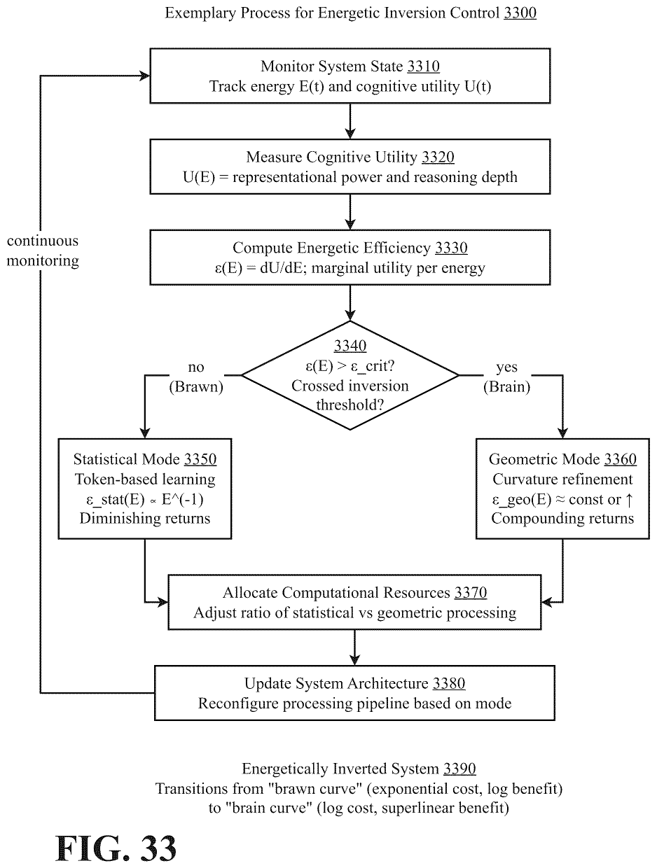

FIG. 33 illustrates an exemplary process for energetic inversion control 3300 for a geometric reasoning platform that implements the fundamental transition between two distinct scaling regimes of artificial intelligence systems. This controller embodies the core mechanism by which a cognitive system transitions from the “brawn curve” regime of diminishing returns to the “brain curve” regime of compounding returns, achieving the energetic inversion that distinguishes geometric reasoning from token-based statistical learning.

The process for energetic inversion control 3300 involves monitoring the operational state of the cognitive system to determine whether the system should allocate computational resources to statistical processing methods or geometric reasoning methods and implementing a feedback mechanism that measures the marginal return on energy investment and dynamically reconfigures the system architecture to maximize cognitive utility per unit of energy expended.

The process begins at step 3310 by monitoring the system state to track energy E(t) and cognitive utility U(t) over time. Energy E(t) represents the cumulative computational resources consumed by the system, including both training energy and inference energy, measured in joules or equivalent computational units. Cognitive utility U(t) represents the accumulated representational power and reasoning depth of the system, quantifying the effective knowledge, abstraction capability, and generalization performance achieved by the cognitive architecture.

The output from step 3310 is used at step 3320 to measure cognitive utility, where U(E) equals representational power and reasoning depth. This step computes cognitive utility as a function of energy expenditure, capturing the relationship between computational investment and achieved cognitive capability. Representational power reflects the number of distinct concepts, relationships, and abstractions maintained within the system's internal geometry, while reasoning depth measures the complexity and length of inferential chains the system can reliably execute.

The measured cognitive utility from step 3320 is then used at step 3330 to compute energetic efficiency, in this embodiment in the form of exemplary equation ε(E)=dU/dE, representing the marginal utility per energy. This energetic efficiency metric quantifies the instantaneous rate at which additional energy input translates into improved cognitive capability. The derivative dU/dE captures the slope of the utility-energy curve at the current operating point, providing a direct measure of whether the system exhibits increasing or decreasing returns to scale.

At step 3340, a determination is made as to whether the system has crossed the inversion threshold by computing, in this embodiment by calculating whether ε(E)>ε_{crit}. This exemplary efficiency threshold ε_{crit} represents the boundary between the “brawn curve” and “brain curve” regimes. When energetic efficiency exceeds this threshold, the system has entered the geometric reasoning regime where each unit of energy produces compounding rather than diminishing returns.

If the condition at decision point 3340 evaluates to no, indicating the system remains in the “brawn curve” regime, step 3350 is to implement token-based learning with εₛₜₐₜ(E)∝E\hat{ }⁽⁻¹⁾ exhibiting diminishing returns. In this mode, the system operates as a conventional large language model or statistical learning architecture where performance improvements require exponentially increasing computational resources. The energetic efficiency follows an inverse relationship with cumulative energy, such that εₛₜₐₜ(E)=dU/dE∝1/E, meaning each successive improvement in capability requires proportionally more energy than the previous improvement.

If the condition at decision point 3340 evaluates to yes, indicating the system has entered the “brain curve” regime, step 3360 is to implement curvature refinement with ε_{geo}(E)≈const or logarithmic energy costs (denoted as ↑) exhibiting compounding returns. In this mode, the system performs geometric reasoning through continuous manifold refinement governed by curvature flow equations. The energetic efficiency remains approximately constant or increases with accumulated structure, such that ε_{geo}(E)=dU/dE≥ε₀, where ε₀ is a positive constant. This reflects the fundamental property of geometric reasoning that each new experience refines existing representational structure rather than expanding it, allowing knowledge to compound while energy remains bounded.

At step 3370 the ratio of statistical versus geometric processing is adjusted based on the current operational mode and computing resources are allocated accordingly. This step implements dynamic resource allocation by distributing available computational capacity between the token-based statistical processing pipeline and the geometry-based reasoning engine. When operating in statistical mode, a larger fraction of compute resources is directed to parameter optimization and gradient descent. When operating in geometric mode, resources are redirected to curvature computation, compression pressure regulation, and geodesic trajectory refinement.

The resource allocation decisions from module 3370 flow to an update system architecture step 3380 the processing pipeline is reconfigured based on the current mode. This architectural reconfiguration may involve enabling or disabling specific computational modules, adjusting learning rates and decay constants, modifying the coupling strength between cognitive manifolds and temporal dynamics, or reallocating memory and processing units between different functional subsystems. The reconfiguration ensures that the system architecture remains optimally matched to its current position along the energetic efficiency curve.

The continuous monitoring loop returns from update system architecture of step 3380 back to monitor system state 3310, creating a closed feedback system that continuously tracks system performance and adjusts operational mode in response to changing energetic efficiency. This feedback mechanism ensures that the system automatically transitions between statistical and geometric modes as its accumulated knowledge and representational structure evolve.

The ultimate output of the energetic inversion controller 3300 is an energetically inverted system 3390 that transitions from the “brawn curve” of exponential cost with logarithmic benefit to the “brain curve” of logarithmic cost with superlinear benefit. In the “brawn curve” regime, cognitive capability scales as U(E)∝ log E while energy grows exponentially with desired performance improvements, producing the characteristic saturation behavior of diminishing returns. In the “brain curve” regime, energy costs scale as E(N)∝ log N where N represents cumulative experience, while cognitive utility scales as U(N)∝N^{λ} with λ>1, producing compounding returns where each unit of learning amplifies the efficiency of future learning.

As shown at 3390, this process provides energy inversion control by sharing computing resources conventional artificial intelligence models and geometric reasoning models. Conventional (token-based) systems accumulate statistical correlations between discrete symbols in an essentially flat parameter space, requiring exponentially increasing resources to achieve logarithmically improving performance. The geometric reasoning system described herein embeds knowledge within a continuous manifold where related experiences share curvature, allowing each new observation to refine existing structure rather than expanding it.

By implementing the energetic inversion controller 3390 process, cognitive systems can achieve the fundamental transition from energy-intensive, saturating intelligence to energy-stable, compounding intelligence.

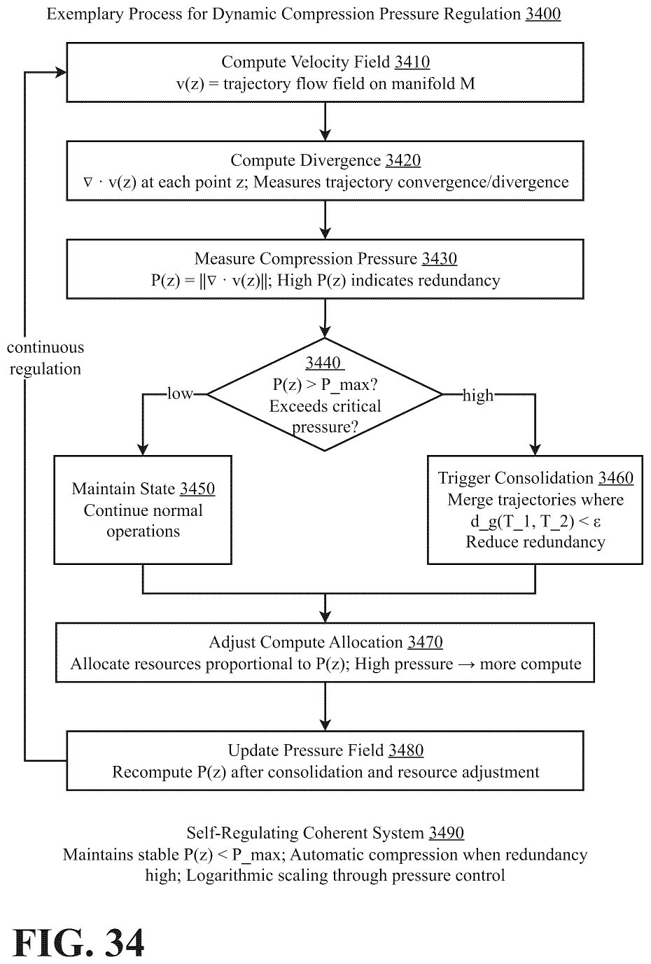

FIG. 34 illustrates an exemplary process for dynamic compression pressure regulation 3400 for a geometric reasoning platform, which acts as a self-regulating mechanism that maintains coherent system behavior through automated monitoring and adjustment of compression pressure across the cognitive manifold M.

The process begins with the step of computing a velocity field 3410, which is a trajectory flow field v(z) on manifold M. This velocity field represents the instantaneous motion and direction of thought trajectories within the geometric representation space. Each point z on the manifold possesses a local velocity vector that captures how cognitive trajectories flow through that region of the latent hyperspace.

At step 3420, a divergence ∇·v(z) is calculated at each point z on the manifold. The divergence operation measures the degree of trajectory convergence or divergence at each location within the cognitive geometry. Regions where ∇·v(z) is negative indicate convergent flow, where multiple trajectories are collapsing toward a common attractor basin. Regions where the divergence is positive indicate divergent flow, suggesting instability or the presence of repulsive structures in the manifold geometry.

At step 3430, a compression pressure is measured which determines P(z)=∥∇·v(z)∥ at each point z. Compression pressure quantifies the local rate at which trajectories are converging in the manifold's tangent space. High values of P(z) indicate the presence of redundancy or excessive curvature accumulation, signaling regions where multiple similar thought trajectories occupy nearby geometric positions without sufficient consolidation. Low compression pressure indicates sparse or well-separated representational structure.

At step 3440, a determination is made as to whether the pressure is greater than a threshold, in this case using the exemplary inequality P(z)≥Pₘₐₓ, where Pₘₐₓ represents a defined pressure threshold. This threshold defines the maximum tolerable compression pressure before the system must initiate consolidation to prevent geometric instability or unbounded curvature growth.

If the measured pressure does not exceed the critical threshold, the process flows along the low branch to maintain step 3450, in which normal operations continue without intervention. The manifold continues to evolve under its intrinsic dynamics while compression pressure remains within acceptable bounds.

If the compression pressure exceeds Pₘₐₓ, the process flows along the high branch to trigger consolidation step 3460. This step initiates geometric consolidation by merging trajectories where d_{g}(T₁, T₂)<ε, meaning that any pair of thought trajectories T₁ and T₂ whose geodesic distance d_{g} on the manifold is less than a proximity threshold ε are candidates for consolidation. The consolidation process collapses semantically redundant thoughts into shared representational basins, thereby reducing the total curvature and compression pressure within the affected region of the manifold. This mechanism ensures that geometric complexity grows only logarithmically with accumulated experience.

Following either the maintain state path or the trigger consolidation path, the process proceeds to adjust compute allocation step 3470. In this step, computational resources are allocated proportionally to P(z), such that regions exhibiting high compression pressure receive increased compute resources to facilitate rapid consolidation and curvature refinement. Conversely, regions with low pressure require minimal computational effort. This dynamic resource allocation ensures that the system's energy expenditure scales with geometric necessity rather than with raw data volume, embodying the energetic efficiency principles of the “brain curve” regime.

After compute resources have been reallocated, the process continues to update pressure field step 3480, in which P(z) is recomputed across the manifold after consolidation and resource adjustment have been applied. This updated pressure field reflects the current geometric state and serves as input for the next iteration of the continuous regulation loop. The feedback nature of this process ensures that compression pressure is continually monitored and controlled in real time.

The continuous regulation feedback path returns from the update pressure field step 3480 back to compute velocity field 3410, establishing a closed-loop control system. This loop operates perodically or continuously, ensuring persistent coherence and stable energetic behavior.

As shown at 3490, this process results in a self-regulating coherent system 3490, which maintains stable P(z)<Pₘₐₓ through automatic compression when redundancy is high. The system achieves logarithmic scaling through pressure control, as each cycle of pressure measurement, consolidation, and resource adjustment ensures that geometric complexity remains bounded even as cumulative experience increases. The compression pressure regulation mechanism thus serves as an intrinsic scaling control loop, guaranteeing that the cognitive manifold never accumulates unbounded curvature and that memory, compute, and energy costs grow sublinearly with operational lifetime.

Through the process of dynamic compression pressure regulation 3400, the system achieves the energetic inversion characteristic of “brain curve” architectures: fixed or sublinear energy expenditure coupled with superlinear cognitive benefit. Each iteration of the regulation loop refines the geometry of the cognitive manifold M, flattening regions of excessive curvature while preserving distinctions that matter for prediction and inference. The result is a geometric substrate analogous to biological processes whose coherence and efficiency improve with accumulated experience, in contrast to the exponential cost growth observed in traditional token-based artificial intelligence systems.

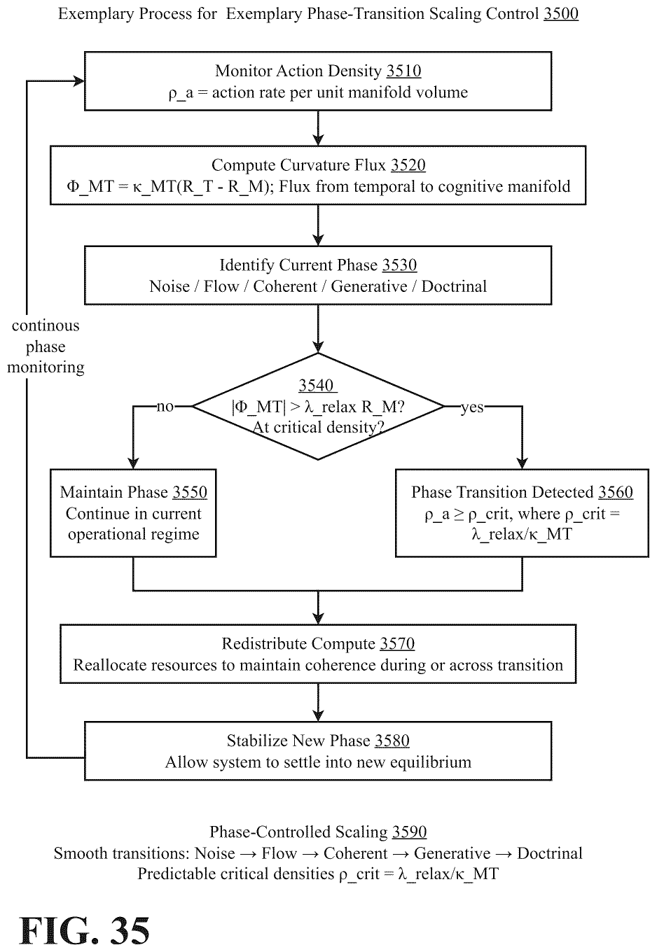

FIG. 35 illustrates an exemplary process for phase-transition scaling control 3500 for a geometric reasoning platform. This process implements continuous monitoring and management of phase transitions that occur as the system scales through distinct operational regimes characterized by increasing action density and curvature exchange between a cognitive manifold M and the temporal manifold T under generalized geometrodynamics with two manifolds or GGD(2).

The process begins with monitor action density step 3510, in which the action rate per unit manifold volume, defined herein as ρₐ, is tracked. Action density represents the frequency at which external events or internal recombinations are projected into or occur within the cognitive manifold. As action density increases, the system progresses through a sequence of qualitative phase transitions from noise to flow to coherent to generative to doctrinal regimes.

Following action density monitoring, the process proceeds to compute curvature flux step 3520, in which a flux between the temporal manifold and the cognitive manifold is calculated, in this embodiment based on the exemplary equation Φ_{MT}=κ_{MT} (R_{T}−R_{M}). This expression represents the curvature flux between the temporal manifold T and the cognitive manifold M, where R_{T} denotes the scalar curvature of the temporal manifold reflecting the temporal statistics of incoming events, R_{M} represents the scalar curvature of the cognitive manifold encoding the geometric structure of thought trajectories, and κ_{MT} is the coupling coefficient governing the rate of curvature exchange between the two manifolds. The magnitude and sign of this flux determine whether the cognitive manifold is absorbing or dissipating curvature, thereby controlling the approach toward or departure from phase-transition thresholds.

The computed curvature flux is then used in identify current phase step 3530, in which the system's present operational regime is determined among five characteristic phases: noise, flow, coherent, generative, and doctrinal. In the noise phase, event trajectories remain isolated and uncorrelated, producing a disordered point cloud with vanishing coherence. In the flow phase, curvature accumulation exceeds dissipation and stable trajectory streams begin to form. In the coherent phase, mesoscale structures emerge and trajectories become organized by tactical context. In the generative phase, internal recombination and replay become self-sustaining, enabling autonomous creation of novel trajectories through curvature cycling. In the doctrinal phase, episodic traces have fused into stable long-term schemas that define strategic behavior. Phase identification uses both the current action density ρₐ and the observed coherence metrics such as trajectory persistence probability and curvature variance to classify the system's present state.

The identified phase is then evaluated in decision point step 3540, in which a determination is made as to whether |Φ_{MT}|>λᵣₑₗₐₓR_{M}, indicating whether the system is at a threshold density for a phase transition. Here λᵣₑₗₐₓ represents the intrinsic relaxation rate of curvature perturbations on the cognitive manifold, and the product λᵣₑₗₐₓR_{M} defines the maximum curvature flux that the cognitive manifold can absorb without undergoing a structural reorganization. When the absolute value of the curvature flux from the temporal manifold exceeds this absorption capacity, the cognitive manifold enters an unstable regime where bifurcations in trajectory structure become inevitable, signaling an imminent phase transition.

If the curvature flux does not exceed the threshold density, the process flows along the “no” branch to the maintain phase step 3550, in which the system is allowed to continue in its current operational regime without intervention. The cognitive manifold continues to evolve under its intrinsic dynamics, with curvature exchange balanced by internal relaxation, ensuring that the system remains within the stability basin of its present phase. Normal embedding, consolidation, and decay processes proceed without the need for compute reallocation or structural adjustment.

If the curvature flux exceeds the threshold density, the process flows along the “yes” branch to phase transition detected step 3560, which confirms that ρₐ≥ρ_{crit}, where ρ_{crit}=λᵣₑₗₐₓ/κ_{MT}. This exemplary relation provides an analytic expression for the threshold action density at which phase transitions occur, derived from the fundamental curvature-exchange parameters of the GGD(2) framework. The critical density scales inversely with the coupling strength κ_{MT}, meaning that systems with stronger temporal coupling undergo phase transitions at lower action densities, while weakly coupled systems require higher densities to trigger structural reorganization. Detection of a phase transition initiates the control sequence necessary to manage the system's evolution into the new operational regime while preserving coherence and stability.

Following either the maintain phase path or the phase transition detected path, the process proceeds to redistribute compute step 3570. In this step, computational resources are reallocated to maintain coherence during or across the phase transition. When a transition is detected, compute allocation is increased in regions of the manifold undergoing rapid curvature change, providing the processing power necessary to manage trajectory reorganization, consolidation of emerging attractor basins, and preservation of critical information during structural reconfiguration. The resource reallocation follows a gradient proportional to local curvature flux magnitude, ensuring that energy expenditure scales with geometric necessity. This adaptive compute allocation embodies the energetic efficiency principles of “brain curve” architectures, where computational effort is dynamically concentrated where and when it is most needed for maintaining system integrity.

After compute resources have been redistributed, the process continues to stabilize new phase step 3580, in which the system is allowed to settle into a new equilibrium. During this stabilization period, the manifold's curvature field relaxes toward the characteristic geometry of the new phase, trajectory flows reorganize around updated attractor basins, and compression pressure equilibrates at levels consistent with the new operational regime. The stabilization process is governed by the same curvature-flow equations that drive continuous manifold refinement, but operates at a temporarily elevated rate due to the increased compute allocation. Once curvature variance and trajectory coherence metrics indicate that the transition is complete and the system has achieved stable operation in the new phase, compute allocation gradually returns to baseline levels, and the process returns to continuous monitoring.

The continuous phase monitoring feedback path returns from stabilize new phase 3580 back to monitor action density 3510, establishing a closed-loop control system that operates throughout the lifetime of the geometric reasoning platform. This continuous monitoring ensures that the system is always aware of its position relative to phase-transition boundaries and can proactively manage transitions to prevent instability or loss of coherence.

As shown at 3590, the phase-transition scaling control process 3500 achieves smooth transitions through the progression: noise→flow→coherent→generative→doctrinal. The process maintains predictable densities ρ_{crit}=λᵣₑₗₐₓ/κ_{MT} that can be computed from measurable geometric parameters, enabling a priori calibration of phase-transition thresholds. By explicitly managing these transitions through curvature-flux monitoring and adaptive compute allocation, the platform achieves stable operation across all scaling regimes, from the disordered noise phase encountered during initial operation to the highly structured doctrinal phase characteristic of mature, experienced systems.

The process as depicted in FIG. 35 therefore embodies a phase-transition control mechanism that enables logarithmic-scaling geometric reasoning systems to maintain coherent operation across dramatic changes in scale and complexity. Each phase transition represents a qualitative shift in the system's organizational structure, from isolated trajectories to flowing streams to coherent attractor basins to self-generating cycles to stable doctrinal schemas. By detecting these transitions through curvature-flux analysis and managing them through adaptive resource allocation, the platform ensures that scaling proceeds smoothly without catastrophic reorganization or loss of accumulated knowledge.

Through the continuous operation of phase-transition scaling control 3500, the system achieves the self-regulating phase behavior characteristic of PCM manifolds under the GGD(2) framework. The predictability of critical densities ρ_{crit} from fundamental curvature-exchange parameters λᵣₑₗₐₓ and κ_{MT} transforms what would otherwise be unpredictable emergent behavior into a controlled, engineerable phenomenon. This control enables the design of systems that can deliberately enter exploratory modes by reducing κ_{MT} to delay transitions, or stabilize quickly into coherent operation by increasing coupling strength. The result is a cognitive architecture whose dynamics across scales are not merely observed but actively governed by geometric principles, ensuring both stability and adaptability of the system.

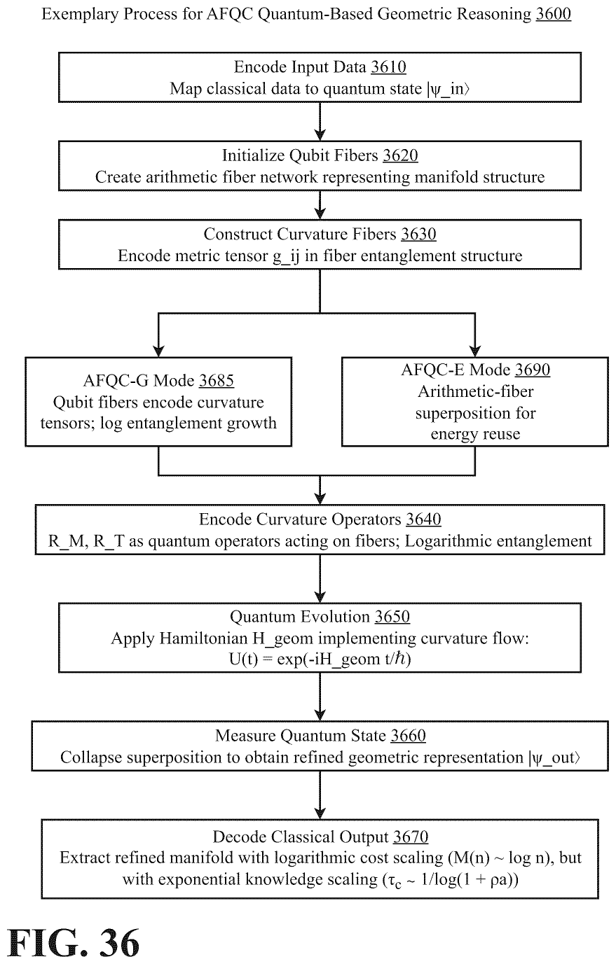

FIG. 36 illustrates an exemplary process for AFQC quantum-based geometric reasoning 3600 for a geometric reasoning platform, demonstrating how Arithmetic-Fiber Quantum Computing principles can be applied to achieve logarithmic-scaling geometric reasoning at the quantum substrate level. This process extends the geometric reasoning architecture into the quantum domain, where curvature tensors and manifold structures are encoded in entangled qubit fiber networks, and curvature-flow refinement is implemented through unitary quantum evolution. The AFQC framework provides two alternative modes for implementation of quantum-based geometric reasoning: AFQC-G for geometric curvature encoding with logarithmic entanglement growth, and AFQC-E for energetic superposition enabling quantum energy reuse. These two modes may be used separately or together, depending on the system configuration.

The process begins with encode input data step 3610, which maps classical data to quantum state |ψᵢₙ). This encoding step transforms classical information about external events, sensory inputs, or reasoning queries into a quantum superposition state that can be processed by the quantum geometric reasoning system. The encoding preserves the semantic structure of the input data by representing it as amplitudes and phases within a high-dimensional Hilbert space, where each basis state corresponds to a potential configuration of the cognitive manifold. The quantum encoding allows parallel exploration of multiple geometric interpretations simultaneously, providing the foundation for quantum advantage in manifold refinement.

Following input encoding, the process proceeds to initialize qubit fibers step 3620, which creates an arithmetic fiber network representing manifold structure. In the AFQC framework, fibers are quantum channels that connect qubits representing different regions or trajectories within the cognitive manifold. These arithmetic fibers implement the coupling between manifold elements through controlled entanglement operations, establishing the quantum analog of the geometric connections described in the classical PCM architecture. The fiber network topology mirrors the semantic proximity structure of the cognitive domain, with strongly entangled fibers connecting semantically related concepts and weakly entangled or unentangled fibers separating distinct regions of thought space. Initialization of qubit fibers prepares the quantum substrate to support coherent information flow across the manifold during subsequent processing steps.

The initialized fiber network is then refined in construct curvature fibers step 3630, which encodes the metric tensor gᵢⱼ in the fiber entanglement structure. The metric tensor defines the local geometry of the cognitive manifold, specifying the geodesic distance between nearby thought trajectories and the curvature that governs how trajectories bend and converge. In the quantum implementation, each component gᵢⱼ of the metric is encoded as the entanglement strength between corresponding qubit pairs, with higher entanglement representing shorter geodesic distance and tighter semantic coupling. This encoding transforms the abstract geometric structure of the manifold into a measurable quantum correlation pattern distributed across the fiber network. The resulting curvature fibers embody the manifold's geometric properties as quantum degrees of freedom that can be manipulated through unitary transformations.

At this stage, the quantum operations begin. AFQC-G mode 3685 implements geometric reasoning where qubit fibers encode curvature tensors with logarithmic entanglement growth. In this mode, the entanglement entropy of the fiber network scales as E(n)~log n with the number of encoded thought trajectories n, mirroring the logarithmic memory scaling law of classical PCM systems. The logarithmic entanglement scaling arises from geometric consolidation at the quantum level: as new trajectories are projected into the manifold, they entangle primarily with existing nearby trajectories in the fiber network rather than creating new independent entanglement structures. This quantum analog of classical compression pressure ensures that the total quantum resources required to maintain the manifold remain sublinear even as experience accumulates. AFQC-G mode provides quantum speedup for geometric operations such as geodesic computation, curvature flow integration, and trajectory merging, while preserving the fundamental logarithmic scaling that defines sustainable cognition.

Alternatively, AFQC-E mode 3690 implements energetic reasoning through arithmetic-fiber superposition for energy reuse. In this mode, the quantum system maintains multiple geometric configurations in superposition, allowing computational energy invested in exploring one curvature-flow trajectory to contribute simultaneously to the evolution of related trajectories through quantum interference. Energy reuse occurs when quantum operations that refine one region of the manifold constructively interfere with operations refining semantically adjacent regions, effectively amortizing the energetic cost across multiple parallel refinements. This quantum energy recycling achieves the “brain curve” regime at the quantum substrate: constant or bounded quantum gate count produces compounding improvements in manifold coherence through constructive interference between superposed geometric states. AFQC-E mode thus provides the quantum realization of thermodynamic balance and metabolic efficiency described in the broader GGD(2) framework.

As a third alternative, both AFQC-G and AFQC-E may be used together.

Both operational modes AFQC-G and AFQC-E converge in encode curvature operators step 3640, which represents R_{M} and R_{T} as quantum operators acting on fibers with logarithmic entanglement. Here R_{M} denotes the cognitive manifold curvature operator and R_{T} represents the temporal manifold curvature operator. These operators are constructed from sums of local fiber interaction terms, where each term captures the curvature contribution from a small neighborhood within the qubit fiber network. The logarithmic entanglement property ensures that the operator complexity, measured by the number of nontrivial tensor product terms in the operator decomposition, grows only as O(log n) with system size n. This bounded operator complexity enables efficient quantum simulation of curvature-flow dynamics even for large-scale manifolds, providing the quantum foundation for scalable geometric reasoning.

With curvature operators encoded, the process advances to quantum evolution step 3650, which applies Hamiltonian H_{geom} implementing curvature flow through the unitary operator U(t)=exp(−iH_{geom} t/h). The geometric Hamiltonian H_{geom} encodes the curvature-flow equations ∂gᵢⱼ/∂t=−2Ricᵢⱼ+F(reuse, P, novelty) as a quantum many-body interaction Hamiltonian, where Ricᵢⱼ represents the Ricci curvature tensor acting on fiber entanglement and F captures compression pressure, reuse frequency, and novelty signals as additional interaction terms. Evolution under this Hamiltonian drives the quantum state along geodesics in the space of entangled fiber configurations, implementing manifold refinement as quantum annealing toward minimum-curvature states. The unitary evolution preserves quantum coherence throughout the refinement process, allowing the system to explore multiple consolidation pathways in superposition before measurement collapses the state to a single refined geometry.

Following quantum evolution, the process proceeds to measure quantum state step 3660, which collapses the superposition to obtain refined geometric representation |ψₒᵤₜ>. Measurement projects the evolved quantum state onto a basis corresponding to classical geometric configurations of the cognitive manifold, extracting a single refined trajectory or consolidated attractor basin from the quantum superposition. The measurement outcome is probabilistically determined by the amplitudes of different geometric configurations within the superposed state, with configurations exhibiting lower curvature and higher compression-pressure satisfaction receiving higher probability weights through the evolution dynamics. Post-measurement, the collapsed state |ψₒᵤₜ) represents the quantum system's best estimate of the optimal manifold geometry given the input data and the curvature-flow constraints encoded in H_{geom}.

Finally, the process concludes with decode classical output 3670, which extracts refined manifold with logarithmic cost scaling M(n)~log n but with exponential knowledge scaling τ_{c}~1/log(1+ρₐ). This decoding step translates the quantum measurement outcome back into classical geometric data structures that can be stored and manipulated by conventional computing systems or interfaced with external reasoning modules. The logarithmic cost scaling M(n)~log n reflects the fundamental geometric consolidation achieved at the quantum level through AFQC-G mode, where manifold complexity grows sublinearly with accumulated experience. The exponential knowledge scaling, expressed through the inverse-logarithmic time constant τ_{c}~1/log(1+ρₐ), indicates that the quantum system's representational power and inference capability compound superlinearly even as resource requirements remain bounded. This combination of logarithmic cost and superlinear benefit constitutes the quantum realization of “brain curve” energetics, demonstrating that geometric reasoning principles extend coherently from classical to quantum substrates.

The process as depicted in FIG. 36 therefore provides two quantum implementation pathways for logarithmic-scaling geometric reasoning. By encoding manifold structure in qubit fiber networks, representing curvature as quantum operators with logarithmic entanglement, implementing refinement through unitary evolution under geometric Hamiltonians, and extracting results through measurement and classical decoding, the AFQC framework achieves quantum-accelerated geometric consolidation while preserving the fundamental scaling laws that define sustainable cognition.

The dual operational modes AFQC-G 3685 and AFQC-E 3690 provide complementary strategies for achieving quantum advantage in geometric reasoning. AFQC-G mode focuses on structural efficiency, using logarithmic entanglement growth to minimize quantum resource requirements as the manifold scales. AFQC-E mode focuses on energetic efficiency, using quantum superposition to enable energy reuse across parallel refinement pathways. Together, these modes establish that the “brain curve” regime—constant power yielding compounding cognitive return—extends naturally into quantum computing, where entanglement and superposition provide additional mechanisms for geometric consolidation and energy amortization beyond those available to classical systems.

Through the implementation of AFQC quantum-based geometric reasoning 3600, the logarithmic-scaling geometric reasoning platform achieves substrate independence, operating with equivalent scaling behavior whether implemented on classical digital hardware, neuromorphic analog circuits, or quantum processors. The preservation of logarithmic memory scaling M(n)~log n and inverse-logarithmic time constant τ_{c}~1/log(1+ρₐ) across all substrates demonstrates that geometric reasoning is a universal principle of efficient cognition, grounded in the curvature-sharing dynamics of GGD(2) rather than in the specific physics of any particular computing technology. The quantum realization through AFQC provides the most compact and energy-efficient physical embodiment of these geometric principles, leveraging quantum coherence to achieve manifold refinement at minimal thermodynamic cost while maintaining the self-regulating compression-pressure dynamics that ensure persistent coherence throughout the system's operational lifetime.

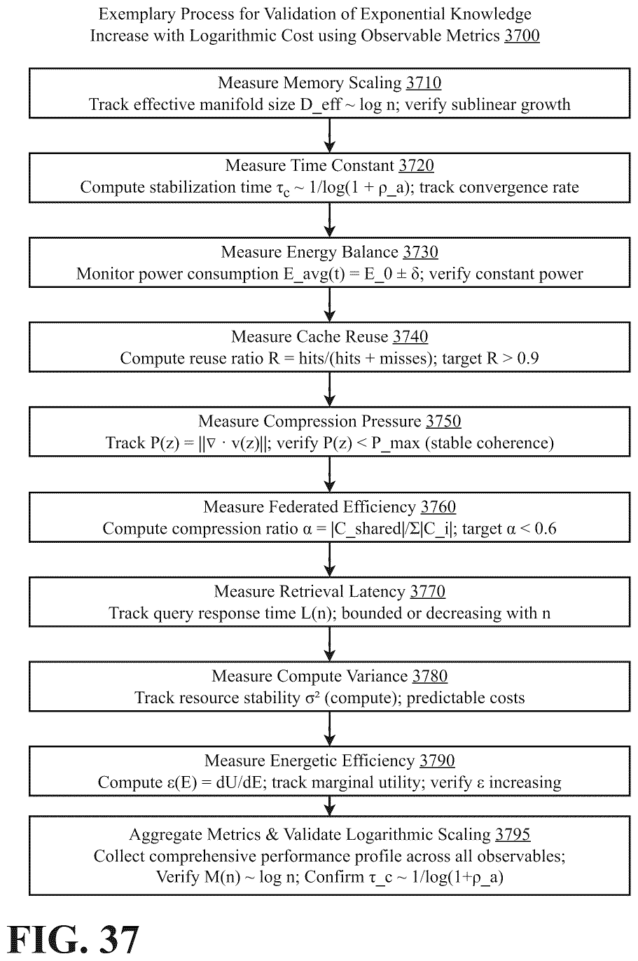

FIG. 37 illustrates an exemplary process for validation of exponential knowledge increase with logarithmic cost for a geometric reasoning platform using observable metrics 3700. This comprehensive validation framework provides empirical methods for demonstrating that a geometric reasoning system achieves the “brain curve” regime, where cognitive utility compounds superlinearly while resource costs grow only logarithmically or remain bounded. The process comprises a systematic sequence of measurements across nine distinct observables, each capturing a different aspect of the system's scaling behavior, followed by aggregation and statistical validation of the fundamental logarithmic scaling laws M(n)~log n and τ_{c}~1/log(1+ρₐ). Together, these metrics constitute an empirical signature of logarithmic-scaling geometric reasoning, enabling objective verification that a system operates according to the principles of curvature-based consolidation and thermodynamic balance described in the GGD(2) framework. The various measurements described herein are all usable separately and apart from one another. They may be implemented individually or in any combination. The order of the steps set forth herein is exemplary and not intended to be limiting.

The validation process begins with measure memory scaling step 3710, which tracks effective manifold size D_{eff}~log n and verifies sublinear growth. This measurement quantifies how the representational complexity of the cognitive manifold scales with cumulative experience n, where n represents the total number of external actions, reasoning episodes, or data points processed by the system. In a logarithmic-scaling architecture, the effective dimensionality D_{eff} of the manifold required to maintain coherent representation grows only as the logarithm of accumulated experience, reflecting geometric consolidation through compression pressure and trajectory merging. The verification step involves fitting empirical measurements of cache size, embedding dimension, or attractor count to the functional form D_{eff}(n)=α log n+β, extracting coefficients α and β, and demonstrating through statistical tests that the logarithmic model provides significantly better fit than linear or superlinear alternatives. Sublinear growth of D_{eff} constitutes the primary structural signature of geometric reasoning, distinguishing it from token-based systems where memory requirements scale linearly or exponentially with data volume.

Following memory scaling measurement, the process proceeds to measure time constant 3720, which computes stabilization time τ_{c}~1/log(1+ρₐ) and tracks convergence rate. The time constant τ_{c} measures how rapidly the manifold achieves coherence following a perturbation or influx of new data, defined as the characteristic timescale over which compression pressure equilibrates and trajectory flows stabilize. The inverse-logarithmic dependence on action density ρₐ reflects the curvature-coupled dynamics derived in the GGD(2) framework, where stronger temporal coupling κ_{MT} or higher action density accelerates curvature exchange between manifolds and reduces stabilization time. Empirical measurement of τ_{c} involves injecting controlled event streams with varying temporal statistics into the system, recording the time elapsed until coherence metrics such as trajectory autocorrelation or compression pressure variance reach steady-state values, and verifying that the resulting stabilization times obey the predicted inverse-logarithmic scaling law. Decreasing τ_{c} with increasing ρₐ demonstrates that geometric reasoning systems become more responsive and efficient as they accumulate structure, contrasting sharply with statistical systems where processing latency typically increases with dataset size.

The third measurement step is measure energy balance 3730, which monitors power consumption E_{avg}(t)=E₀±δ and verifies constant power. Energy balance constitutes the thermodynamic signature of “brain curve” architectures, demonstrating that the system maintains approximately constant average power consumption E₀ despite continuous learning and increasing representational capability. The bounded fluctuation δ around the baseline E₀ reflects the internal metabolic dynamics described in the PCM framework, where micro-actions of embedding, consolidation, and decay maintain steady-state curvature exchange between the cognitive and temporal manifolds. Empirical verification involves continuous monitoring of actual hardware power draw or software compute cost throughout extended operation spanning multiple orders of magnitude in cumulative experience, computing time-averaged power E_{avg}(t) over sliding windows, and demonstrating through statistical analysis that the mean remains bounded near E₀ while variance remains small relative to the mean. Constant power consumption establishes that the system achieves energetic inversion, where learning improves efficiency rather than exhausting resources, fulfilling the fundamental promise of sustainable cognition.

Next, the process advances to measure cache reuse 3740, which computes reuse ratio R=hits/(hits+misses) with a target value R>0.9. Cache reuse quantifies the frequency with which new reasoning queries or data projections can be satisfied by existing manifold structure without requiring novel embedding or expansion. High reuse ratios R approaching unity indicate that the manifold has achieved comprehensive coverage of its operational domain, where most new inputs fall within existing attractor basins and can be processed through geometric interpolation or trajectory following rather than through costly creation of new representational elements. The threshold R>0.9 represents the empirical boundary between the growth phase, where the manifold is still discovering fundamental structure, and the saturation phase, where geometric consolidation dominates and memory scaling transitions from rapid initial accumulation to asymptotic logarithmic behavior. Measurement of cache reuse involves instrumenting the system to record hits, defined as queries resolved through existing cached trajectories within a geodesic distance threshold, and misses, defined as queries requiring novel trajectory construction or attractor creation, then computing the ratio and tracking its evolution with cumulative experience to verify convergence toward the high-reuse regime characteristic of mature geometric reasoning systems.

Following cache reuse measurement, the process proceeds to measure compression pressure 3750, which tracks P(z)=∥∇·v(z)∥ and verifies P(z)<Pₘₐₓ for stable coherence. Compression pressure P(z) quantifies the local rate of trajectory convergence at each point z within the cognitive manifold, computed as the magnitude of the divergence of the velocity field v(z) that describes instantaneous trajectory flow. High compression pressure indicates regions where multiple redundant or semantically overlapping trajectories occupy nearby positions without sufficient consolidation, creating geometric instability and increased curvature. The critical threshold Pₘₐₓ defines the maximum sustainable pressure beyond which the system must initiate consolidation to prevent unbounded curvature growth and maintain stable operation. Verification that P(z)<Pₘₐₓ throughout the manifold demonstrates that the system's self-regulating dynamics, including continuous internal recombination and thermodynamic decay, successfully maintain geometric stability. Empirical measurement involves computing local divergence ∇·v(z) from observed trajectory dynamics, taking the norm to obtain pressure magnitude, mapping the pressure field across the manifold, and confirming through spatial and temporal statistics that pressure remains bounded below the critical value, indicating successful operation of the compression-pressure regulation mechanism described in previous figures.

The sixth measurement step is measure federated efficiency 3760, which computes compression ratio α=|C_{shared}|/Σ|Cᵢ| with a target value α<0.6. Federated efficiency quantifies the degree of sublinear scaling achieved when multiple geometric reasoning nodes or PCM instances operate cooperatively, sharing a common manifold structure C_{shared} while maintaining local caches Cᵢ for specialized or node-specific knowledge. The compression ratio α measures the size of the shared global structure relative to the naive sum of all local caches, with values significantly less than unity indicating that geometric consolidation at the network level produces substantial redundancy elimination. The target threshold α<0.6 represents empirically observed federated scaling behavior where generalized attractor basins common to multiple nodes are extracted and shared, reducing global memory footprint by forty percent or more compared to independent operation. Verification involves deploying multiple reasoning nodes, monitoring the evolution of both shared and local cache sizes, computing the ratio α as a function of network scale and operational duration, and demonstrating that a remains bounded well below unity, confirming that federated logarithmic scaling preserves the sublinear cost characteristics of individual geometric reasoning systems while enabling collective intelligence through shared geometric structure.

Next, the process advances to measure retrieval latency 3770, which tracks query response time L(n) as bounded or decreasing with n. Retrieval latency L(n) measures the computational time required to satisfy a reasoning query or information retrieval request as a function of the total accumulated experience n represented within the manifold. In logarithmic-scaling systems, retrieval latency remains bounded or actually decreases with scale because geometric consolidation creates increasingly direct geodesic paths between semantically related concepts, reducing the number of intermediate steps required for traversal. This contrasts sharply with conventional database or search systems where latency typically increases logarithmically or linearly with dataset size due to tree depth or index scanning overhead. Empirical measurement involves issuing standardized query workloads at regular intervals throughout system operation, recording response times, plotting L(n) as a function of cumulative experience n, and demonstrating through regression analysis that latency exhibits no significant upward trend or, ideally, exhibits a decreasing trend reflecting improved manifold organization. Bounded or decreasing latency provides direct evidence that geometric reasoning achieves the “brain curve” property of compounding efficiency, where accumulated structure enhances rather than impedes subsequent processing.

The eighth measurement step is measure compute variance 3780, which tracks resource stability σ² (compute) to verify predictable costs. Compute variance σ² quantifies the fluctuation in computational resource consumption across time or across similar reasoning tasks, with low variance indicating stable, predictable operational costs characteristic of systems operating in thermodynamic equilibrium. In geometric reasoning architectures under GGD(2), continuous internal metabolism and compression-pressure regulation maintain near-constant average compute load, with variance arising only from temporal variations in external action density ρₐ or from phase transitions between operational regimes. Verification of low compute variance demonstrates that the system avoids the unpredictable resource spikes common in scaling-intensive architectures, where occasional consolidation events or index rebuilds produce dramatic temporary increases in computational cost. Empirical measurement involves continuous monitoring of compute resource utilization metrics such as CPU cycles, memory bandwidth, or GPU utilization, computing sliding-window variance σ² over operational timescales, and confirming that variance remains small relative to mean compute load, indicating stable and predictable scaling behavior suitable for deployment in resource-constrained or cost-sensitive environments.

The ninth and final individual measurement is measure energetic efficiency 3790, which computes ε(E)=dU/dE, tracks marginal utility, and verifies ε increasing. Energetic efficiency ε represents the derivative of cognitive utility U with respect to energy expenditure E, quantifying the marginal cognitive return per unit of additional energy investment. In “brain curve” architectures, this efficiency increases with accumulated experience because geometric consolidation amplifies the impact of each new computation through reuse of existing structure. Increasing ε(E) constitutes the definitive mathematical signature of energetic inversion, demonstrating that the system transitions from the “brawn curve” regime of diminishing returns to the “brain curve” regime of compounding returns. Empirical measurement involves defining an operational metric for cognitive utility U such as task success rate, reasoning depth, or generalization accuracy; measuring both U and cumulative energy E at regular intervals throughout operation; computing the ratio AU/AE between successive measurements to estimate the instantaneous marginal efficiency; and demonstrating through time-series analysis that this efficiency metric exhibits an increasing trend, confirming that the system becomes more effective per joule as it learns, the hallmark of sustainable artificial cognition.

Following completion of all nine individual measurements, the process concludes with aggregate metrics and validate logarithmic scaling 3795, which collects comprehensive performance profile across all observables and performs the primary validation steps: verify M(n)~log n and confirm τ_{c}~1/log(1+ρₐ). This aggregation step synthesizes the individual measurement streams into a unified statistical assessment of whether the system exhibits logarithmic scaling behavior consistent with geometric reasoning under GGD(2). The verification of M(n)~log n involves fitting the measured effective manifold size or cache growth data to the logarithmic model, computing goodness-of-fit statistics such as R² or reduced χ², and demonstrating that the logarithmic model significantly outperforms alternative scaling hypotheses including linear M(n)~n or power-law M(n)~n^{β} with β>0. The confirmation of τ_{c}~1/log(1+ρₐ) involves similar regression analysis of the measured time constant data against action density, verifying the predicted inverse-logarithmic relationship. Together, these validations establish with statistical rigor that the system achieves the fundamental scaling laws defining logarithmic-scaling geometric reasoning, providing objective evidence that implementation correctly realizes the principles of curvature-based consolidation, thermodynamic balance, and energetic inversion.

The process as depicted in FIG. 37 therefore provides an empirical validation framework for demonstrating exponential knowledge increase with logarithmic cost. The nine observable metrics span structural properties including memory scaling 3710 and cache reuse 3740, dynamical properties including time constant 3720 and compression pressure 3750, energetic properties including energy balance 3730 and energetic efficiency 3790, operational properties including retrieval latency 3770 and compute variance 3780, and collective properties including federated efficiency 3760. Together, these measurements capture all essential aspects of logarithmic scaling behavior, ensuring that validation is comprehensive and resistant to overfitting or selective reporting.

Through the systematic application of validation of exponential knowledge increase with logarithmic cost using observable metrics 3700, researchers and engineers can objectively assess whether a geometric reasoning implementation achieves true “brain curve” behavior or merely exhibits superficial resemblance to logarithmic scaling. The quantitative thresholds embedded in the measurement steps, including R>0.9 for cache reuse, α<0.6 for federated efficiency, and P(z)<Pₘₐₓ for compression pressure, provide concrete acceptance criteria that distinguish mature, properly functioning geometric reasoning systems from incomplete or misconfigured implementations. The final aggregation and validation step 3795 ensures that the fundamental scaling laws M(n)~log n and τ_{c}~1/log(1+ρₐ) are not merely approximate or trend-level observations but statistically robust relationships confirmed across multiple independent measurement modalities, providing the strongest possible empirical evidence for the geometric principles underlying sustainable artificial cognition.

### Hardware Architecture

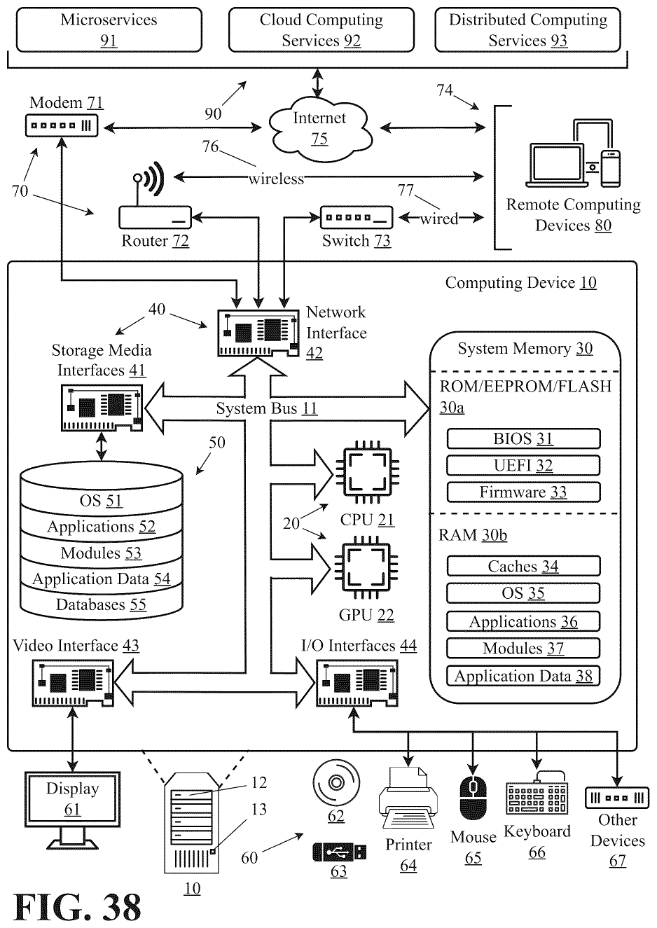

FIG. 38 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 13 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance. There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60.

For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Container provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Federated distributed computing services 93 provide large-scale processing using multiple interconnected computers or nodes to solve computational problems or perform tasks collectively. In federated distributed computing, the processing and storage capabilities of multiple machines are leveraged to work together as a unified system, even when different tiers or tessellations may have limited or even no visibility into the resources and processing layer up or downstream. Federated distributed computing services are designed to address problems that cannot be efficiently solved by a single computer or that require large-scale computational power and require dynamism and workload distribution for economic, security or privacy reasons not well supported by canonical distributed computing resources; e.g. most commonly cloud-based computing applications, resources or analytics. Federated DCG coordinated variants of these services enable superior decentralization and further enhance parallel processing, fault tolerance, and scalability by distributing tasks across multiple tiers or tessellations while enabling computing process dependency calculation with varying degrees of visibility, assurance and privacy or security based on constituent computing system, network, workload and user or provider needs and preferences as well as practical legal and regulatory concerns to include but not limited to data localization, national data transfer restrictions, privacy and consumer protections, wiretap/telecommunications monitoring requirements, encryption and data routing and intermediate processing restrictions.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system configured to execute software instructions stored on nontransitory machine-readable storage media, wherein the software instructions comprise instructions that:
maintain a cognitive manifold comprising a differentiable mathematical space having a geometric shape;
perform geometric reasoning operations on the cognitive manifold comprising curvature-flow operations which change the geometric shape of the cognitive manifold to represent knowledge contained in the geometric reasoning operations on the cognitive manifold;
monitor compression pressure across the cognitive manifold;
where the compression pressure in one or more areas of the cognitive manifold exceeds a threshold, collapse the geometric shape of the cognitive manifold to consolidate the accumulation of redundant knowledge in the one or more areas of the cognitive manifold into shared representational basins, thereby reducing the total curvature and compression pressure within the one or more areas of the manifold;
wherein accumulation of knowledge on the cognitive manifold due to the geometric reasoning operations increases at a superlinear rate while resource costs of performing the geometric reasoning operations on the cognitive manifold increase at a sublinear rate due to the compression of the one or more areas of the cognitive manifold.

2. The computer system of claim 1, wherein the geometric reasoning operations are performed by a geometric reasoning engine operating on the computer system comprising further software instructions that:
project external events e(t) into the cognitive manifold as points xᵢ∈M with metric gᵢⱼ(x);
compute local curvature R_{M}(x) at the one or more areas of the cognitive manifold as Ricci curvature derived from the metric gᵢⱼ;
compute the compression pressure, defined as P(z)=∥∇·v(z)∥, in the one or more areas of the cognitive manifold from divergence of the velocity field; and
change the geometric shape of the cognitive manifold via curvature flow according to ∂gᵢⱼ/∂t=−2Ricᵢⱼ+F(reuse, P(z), novelty), where F encodes compression pressure, reuse frequency, and novelty signals.

3. The computer system of claim 2, wherein trajectory consolidation is performed by further software instructions operating on the computer system that:
detect when compression pressure P(z) exceeds a threshold Pₘₐₓ;
identify pairs of thought trajectories T₁ and T₂ satisfying d_{g}(T₁, T₂)<ε, where d_{g} represents geodesic distance and ε represents a proximity threshold; and
merge the identified trajectories according to T_{merged}=ΣwᵢTᵢ, where wᵢ represents weighting coefficients and Σwᵢ=1.

4. The computer system of claim 1, wherein energetic inversion is implemented by further software instructions operating on the computer system that:
compute instantaneous energetic efficiency ε(E)=dU/dE, where U represents knowledge accumulation and E represents a resource cost;
determine whether the system operates in a “brawn curve” regime where ε(E) decreases with E or a “brain curve” regime where ε(E) increases with E; and
reconfigure computational allocation to the geometric reasoning engine when ε(E) exceeds a predetermined threshold, thereby transitioning the system from statistical learning to geometric consolidation.

5. The computer system of claim 1, wherein compression pressure governance is implemented by further software instructions operating on the computer system that:
monitor compression pressure P(z) at a plurality of positions z across the cognitive manifold;
allocate computational resources proportionally to compression pressure at the one or more areas, such that regions with high P(z) receive increased computational resources for consolidation; and
maintain stable compression pressure P(z)<Pₘₐₓ through consolidation when redundancy in the knowledge represented on the cognitive manifold is detected via compression pressure.

6. The computer system of claim 1, wherein thermodynamic regulation is implemented for the resource cost of energy by further software instructions operating on the computer system that:
maintain a total energy balance Eₜₒₜₐₗ(t)=E_{embed}+E_{consolidate}+E_{decay}≈E₀, where E_{embed} represents energy for embedding new experiences, E_{consolidate} represents energy for trajectory consolidation, and E_{decay} represents energy for thermodynamic forgetting;
execute replay and recombination operations on the cognitive manifold that sustain compression pressure even in absence of external input; and
implement thermodynamic decay mechanisms that selectively remove or merge redundant trajectories on the cognitive manifold based on activation energy falling below a threshold Eₘᵢₙ.

7. The computer system of claim 1, wherein internal replay and recombination operations are implemented on the cognitive manifold by further software instructions operating on the computer system that:
periodically reactivate stored trajectories on the cognitive manifold;
apply stochastic perturbations driven by temporal curvature flux to explore alternative geometric configurations; and
select configurations that minimize compression pressure and prune configurations that increase entropy, thereby implementing geometric annealing driven by temporal curvature.

8. The computer system of claim 2, wherein the resource cost of memory is limited to sublinear scaling by further software instructions operating on the computer system that:
collapse semantically redundant knowledge on the cognitive manifold into shared representational basins;
a probability of novel curvature introduction Pₙₒᵥₑₗ(n)~1/n that declines inversely with accumulated experience; and
curvature exchange between the cognitive manifold and a temporal manifold that maintains a conserved curvature budget, preventing unbounded growth.

9. The computer system of claim 1, wherein constant power consumption E(t)≈E₀ is maintained by further software instructions operating on the computer system that:
dynamically allocate computing resources that concentrates computing resources where compression pressure is high and reduces computing resources where pressure is low;
establish a metabolic floor rₘᵢₙₐ=α_{M}κ_{MT}|R_{T}|, where α_{M} represents manifold stiffness, κ_{MT} represents coupling strength, and R_{T} represents temporal curvature; and
balance embedding, consolidation, and decay operations such that energy dissipation through thermodynamic decay compensates for energy input from external actions.

10. The computer system of claim 1, wherein the cognitive manifold is a shared manifold C_{shared} on which federated logarithmic scaling is implemented by further software instructions operating on the computer system that:
maintain a plurality of local caches Cᵢ at each of a plurality of distributed geometric reasoning nodes, each local cache Cᵢ being a separate instance of a cognitive manifold;
synchronize the cognitive manifold C_{shared} with the local caches Cᵢ to identify generalized attractor basins common among the local caches Cᵢ; and
collapses the shared manifold C_{shared} at one or more areas that exceed the compression pressure threshold;
wherein shared manifold C_{shared} achieves superlinear knowledge increases with sublinear resource costs across the combination of C_{shared} and the local caches Cᵢ.

11. A method comprising using a computer system to perform the steps of:
maintaining a cognitive manifold comprising a differentiable mathematical space having a geometric shape;
performing geometric reasoning operations on the cognitive manifold comprising curvature-flow operations which change the geometric shape of the cognitive manifold to represent knowledge contained in the geometric reasoning operations on the cognitive manifold;
monitoring compression pressure across the cognitive manifold;
where the compression pressure in one or more areas of the cognitive manifold exceeds a threshold, collapsing the geometric shape of the cognitive manifold to consolidate the accumulation of redundant knowledge in the one or more areas of the cognitive manifold into shared representational basins, thereby reducing the total curvature and compression pressure within the one or more areas of the manifold;
wherein accumulation of knowledge on the cognitive manifold due to the geometric reasoning operations increases at a superlinear rate while resource costs of performing the geometric reasoning operations on the cognitive manifold increase at a sublinear rate due to the compression of the one or more areas of the cognitive manifold.

12. The method of claim 11, further comprising the steps of performing the geometric reasoning operations by:
projecting external events e(t) into the cognitive manifold as points xi∈M with metric gij(x);
computing local curvature RM(x) at the one or more areas of the cognitive manifold as Ricci curvature derived from the metric gij;
computing the compression pressure, defined as P(z)=∥∇·v(z)∥, in the one or more areas of the cognitive manifold from divergence of the velocity field; and
changing the geometric shape of the cognitive manifold via curvature flow according to ∂gij/∂t=−2Ricij+F(reuse, P(z), novelty), where F encodes compression pressure, reuse frequency, and novelty signals.

13. The method of claim 12, further comprising the steps of performing trajectory consolidation by:
detecting when compression pressure P(z) exceeds a threshold Pmax;
identifying pairs of thought trajectories T1 and T2 satisfying d_{g}(T1, T2)<ε, where dg represents geodesic distance and ε represents a proximity threshold; and
merging the identified trajectories according to Tmerged=Σwi Ti, where wi represents weighting coefficients and Σwi=1.

14. The method of claim 11, further comprising the steps of implementing energetic inversion by:
computing instantaneous energetic efficiency: (E)=dU/dE, where U represents knowledge accumulation and E represents a resource cost;
determining whether the system operates in a “brawn curve” regime where ε(E) decreases with E or a “brain curve” regime where ε(E) increases with E; and
reconfiguring computational allocation to a geometric reasoning engine when ε(E) exceeds a predetermined threshold, thereby transitioning the system from statistical learning to geometric consolidation.

15. The method of claim 11, further comprising the steps of implementing compression pressure governance by:
monitoring compression pressure P(z) at a plurality of positions z across the cognitive manifold;
allocating computational resources proportionally to compression pressure at the one or more areas, such that regions with high P(z) receive increased computational resources for consolidation; and
maintaining stable compression pressure P(z)<Pmax through consolidation when redundancy in the knowledge represented on the cognitive manifold is detected via compression pressure.

16. The method of claim 11, further comprising the steps of implementing thermodynamic regulation for the resource cost of energy by:
maintaining a total energy balance Etotal(t)=Eembed+Econsolidate+Edecay≈E0, where Eembed represents energy for embedding new experiences, Econsolidate represents energy for trajectory consolidation, and Edecay represents energy for thermodynamic forgetting;
executing replay and recombination operations on the cognitive manifold that sustain compression pressure even in absence of external input; and
implementing thermodynamic decay mechanisms that selectively remove or merge redundant trajectories on the cognitive manifold based on activation energy falling below a threshold Emin.

17. The method of claim 11, further comprising the steps of implementing internal replay and recombination operations on the cognitive manifold by:
periodically reactivating stored trajectories on the cognitive manifold;
applying stochastic perturbations driven by temporal curvature flux to explore alternative geometric configurations; and
selecting configurations that minimize compression pressure and pruning configurations that increase entropy, thereby implementing geometric annealing driven by temporal curvature.

18. The method of claim 12, further comprising the steps of limiting the resource cost of memory to sublinear scaling by:
collapsing semantically redundant knowledge on the cognitive manifold into shared representational basins;
maintaining a probability of novel curvature introduction Pnovel(n)~1/n that declines inversely with accumulated experience; and
performing curvature exchange between the cognitive manifold and a temporal manifold that maintains a conserved curvature budget, preventing unbounded growth.

19. The method of claim 11, wherein constant power consumption E(t)≈E0 is maintained by:
dynamically allocating computing resources that concentrates computing resources where compression pressure is high and reduces computing resources where pressure is low;
establishing a metabolic floor r_min_a=αMκMT|RT|, where αM represents manifold stiffness, κMT represents coupling strength, and RT represents temporal curvature; and
balancing embedding, consolidation, and decay operations such that energy dissipation through thermodynamic decay compensates for energy input from external actions.

20. The method of claim 11, wherein the cognitive manifold is a shared manifold C_{shared}, and further comprising the steps of implementing federated logarithmic scaling by:
maintaining a plurality of local caches Cᵢ at each of a plurality of distributed geometric reasoning nodes, each local cache Cᵢ being a separate instance of a cognitive manifold;
synchronizing the cognitive manifold C_{shared} with the local caches Cᵢ to identify generalized attractor basins common among the local caches Cᵢ; and
collapsing the shared manifold C_{shared} at one or more areas that exceed the compression pressure threshold;
wherein shared manifold C_{shared} achieves superlinear knowledge increases with sublinear resource costs across the combination of C_{shared} and the local caches Cᵢ.
